(19) United States
(12) Patent Application Publication
(10) Pub. No.: US 2014/0066321 A1
(43) Pub. Date: Mar. 6, 2014

(54) STRUCTURES OF HUMAN HISTIDYL-TRNA SYNTHETASE AND METHODS OF USE

(71) Applicants: aTyr Pharma, Inc., San Diego, CA (US); The Scripps Research Institute, La Jolla, CA (US); Pangu BioPharma Limited, (unknown)

(72) Inventors: Zhiwen Xu, Kowloon (CN); Zhiyi Wei, Kowloon (CN); Xiang-Lei Yang, San Diego, CA (US); Mingjie Zhang, Kowloon (CN); Paul Schimmel, La Jolla, CA (US)

(73) Assignees: Pangu BioPharma Limited; aTyr Pharma, Inc., San Diego, CA (US)

(21) Appl. No.: 13/948,982

(22) Filed: Jul. 23, 2013

Related U.S. Application Data
(60) Provisional application No. 61/674,639, filed on Jul. 23, 2012.

(51) Int. Cl. G06F 19/16

(52) U.S. Cl. CPC G06F 19/16
USPC 506/8; 435/7.4; 703/11

(57) ABSTRACT

Provided are histidyl-tRNA synthetase variant polypeptides, X-ray crystallographic and NMR spectroscopy structures of HRS polypeptides, and related compositions and methods for therapy and drug discovery.

### CROSS-REFERENCE TO RELATED APPLICATIONS

This application claims priority under 35 U.S.C. §119(e) to U.S. Provisional Application No. 61/674,639, filed Jul. 23, 2012, which is incorporated by reference in its entirety.

### STATEMENT REGARDING THE SEQUENCE LISTING

The Sequence Listing associated with this application is provided in text format in lieu of a paper copy, and is hereby incorporated by reference into the specification. The name of the text file containing the Sequence Listing is ATYR_{—}111_{—}01US_ST25.txt. The text file is about 84 KB, was created on Jul. 23, 2013, and is being submitted electronically via EFS-Web.

### BACKGROUND

1. Technical Field

The present invention relates to histidyl-tRNA synthetase (HRS) variant polypeptides and polynucleotides that encode the same, X-ray crystallographic and NMR spectroscopy structures of HRS polypeptides, and related compositions and methods for therapy and drug discovery.

2. Description of the Related Art

Physiocrines are generally small, naturally occurring, protein domains found in the aminoacyl tRNA synthetases (AARS) gene family of higher organisms, which are not required for the well-established role of aminoacyl tRNA synthetases in protein synthesis. Until the Physiocrine paradigm was discovered, aminoacyl tRNA synthetases, a family of about 20 enzymes, were known only for their ubiquitous expression in all living cells, and their essential role in the process of protein synthesis. More recent scientific findings however now suggest that aminoacyl tRNA synthetases possess additional roles beyond protein synthesis and in fact have evolved in multicellular organisms to play important homeostatic roles in tissue physiology and disease.

Evidence for the existence of the non-canonical function of ARRS includes well defined sequence comparisons that establish that during the evolution from simple unicellular organisms to more complex life forms, AARS have evolved to be more structurally complex through the addition of appended domains, without losing the ability to facilitate protein synthesis.

Consistent with this hypothesis, a rich and diverse set of expanded functions for AARS have been found in higher eukaryotes, and in particular for human tRNA synthetases. This data, which is based both on the direct analysis of individual domains, as well as the discovery of mutations in genes for tRNA synthetases that are causally linked to disease, but do not affect aminoacylation or protein synthesis activity, suggests that these newly appended domains, or Physiocrines, are central to the newly acquired non canonical functions of AARS.

Additionally there is now increasing recognition that specific tRNA synthetases can be released or secreted from living cells and can provide important locally acting signals immunomodulatory, chemotactic, and angiogenic properties. Direct confirmation of the role of AARS as extracellular signaling molecules has been obtained through studies showing the secretion and extracellular release of specific tRNA synthetases, as well as the direct demonstration that the addition of fragments of the tRNA synthetases comprising the newly appended domains (Physiocrines), but not other fragments lacking these domains, are active in a range of extracellular signaling pathways (Sajish et al., Nature Chem Biol. (2012)/DOI 10.1038/NCHEMBIO.937; Bonfils et al., Mol. Cell. (2002) DOI 10.016/j.molcel.2012.02.009; Park et al., PNAS (2012) 109 E640-E647). These Physiocrines represent a new and previously untapped opportunity to develop new first in class therapeutic proteins to treat human disease.

Specifically for example, the Physiocrine “Resokine” is an N-terminal fragment of Histidyl tRNA synthetase (HisRS) (originally discovered as a splice variant of HisRS in muscle tissue), which comprises amino acids 1-60 of HisRS, and which appears to have broad anti-inflammatory activity (See generally PCT publication WO2010/107825). Resokine comprises an appended domain (the WHEP domain) that appears to play a central role in the non-canonical activity (anti-inflammatory activity) inherent in HisRS and the Physiocrines derived therefrom.

Recent studies have also established that some tRNA synthetases include novel regulatory genetic elements, including ALU elements (Rudinger-Thirion et al., PNAS (2011) 108(40) E794-E802) that provide for increased cell type specific expression, or alternative splicing of specific tRNA synthetases in specific tissues, or in the context of specific diseases. Moreover some Physiocrines are proteolytically produced in response to particular stimuli in a cell type specific fashion. Consistent with the cell type specific over expression and extracellular release of Physiocrines, several autoimmune diseases, (generally referred to as ant-synthetase syndromes) are associated with the production of antibodies to a defined group of tRNA synthetases (Tzioufas Orphanet (2001) 1-5; Park et al., (2011) Rheumatol. Int. 31 529-512).

Autoimmune disorders arise when the immune system reacts against its own tissues. Autoimmune diseases are often classified on the basis of whether a single organ or tissue is involved or whether multiple organs or tissues are involved. Generalized or systemic autoimmune diseases, such as systemic lupus erythematosus (SLE), characterized by the involvement of multiple organs and tissues, are often associated with the presence of autoantibodies to fundamental cellular components. Other autoimmune diseases are characterized by autoantibodies to antigens associated with a single organ or tissue.

Systemic autoimmune diseases are typically characterized by the presence of autoantibodies. Some of the autoantibodies associated with the particular disease may be disease specific and others may be common to many autoimmune diseases. For example, SLE, which is a prototypical immune disorder, is characterized by the presence of autoantibodies that are detectable in other autoimmune disease, such as anti-single-strand DNA antibodies, anti-histone antibodies, and anti-ribonuclear particle (RNP) antibodies, and also by the presence of autoantibodies that are SLE-specific, such as the anti-double-stranded DNA antibodies. Other systemic autoimmune disorders, such as rheumatoid arthritis and idiopathic inflammatory myopathies, are also characterized by the presence of autoantibodies in the sera of patients that react with fundamental nuclear and cytoplasmic intracellular components. As with SLE, some of these autoantibodies are associated with other autoimmune disorders and some are specifically associated with autoimmune myositis.

The idiopathic inflammatory myopathies polymyositis, dermatomyositis and the related disorders, such as polymyositis-scleroderma overlap, are inflammatory myopathies that are characterized by chronic muscle inflammation and proximal muscle weakness. The muscle inflammation causes muscle tenderness, muscle weakness, and ultimately muscle atrophy and fibrosis as described by Plotz et al., Annals of Internal Med. 111:143-157, 1989; Wallace et al., J. Musculoskelat Med. 27 (12) 470-479, 2010). Also associated with the muscle inflammation are elevated serum levels of aldolase, creatine kinase, transaminases (such as alanine aminotransferase and aspartate aminotransferase) and lactic dehydrogenase. Other systems besides muscle can be affected by these conditions, resulting in arthritis, Reynaud's phenomenon, and interstitial lung disease. Clinically, polymyositis and dermatomyositis are distinguished by the presence of a characteristic rash in patients with dermatomyositis. Differences in the myositis of these conditions can be distinguished in some studies of muscle pathology.

Interstitial lung disease (ILD) comprises a heterogeneous group of disorders in which fibrosis and inflammation occur within alveolar walls or in the loose tissue surrounding peribronchovascular sheaths, interlobular septa and the visceral pleura. Different forms of ILD are known which comprise, or are associated with, various autoimmune diseases in addition to myositis, including for example, hypersensitivity pneumonitis, scleroderma, Systemic Lupus Erythematosus, Rheumatoid Arthritis, Churg-Strauss syndrome, Wegener's granulomatosis, and Good-pasture Syndrome.

Inflammatory muscle disease (IMD) and interstitial lung disease (ILD) are serious chronic potentially life threatening autoimmune diseases, for which the current standard of care includes non-specific anti-inflammatory drugs such as corticosteroids with the potential for important side effects. The cause of the on-set of these diseases has not yet been established, although autoantibodies can be detected in about 90% of patients with polymyositis and dermatomyositis according to Reichlin and Arnett, Arthritis and Rheum. 27:1150-1156, 1984. Sera from about 60% of these patients form precipitates with bovine thymus or human spleen extracts on Ouchterlony immunodiffusion (ID), while sera from about 80% of these patients stain tissue culture substrates, such as HEp-2 cells, by indirect immunofluorescence (IIF) (Targoff and Reichlin, Arthritis and Rheum. 28:796-803, 1985; Nishikai and Reichlin, Arthritis and Rheum. 23:881-888, 1980; Reichlin et al., J. Clin. Immunol. 4:40-44, 1984. There are numerous precipitating autoantibody specificities in myositis patients, but each individual antibody specificity occurs in only a fraction of the patients.

Many autoantibodies associated with myositis or myositis-overlap syndrome have been defined and in some cases the antibodies have been identified (See U.S. Pat. No. 6,610,823, Antigens associated with polymyositis and with dermatomyositis). These include antibodies that are present in other disorders and also disease-specific antibodies as described by Targoff and Reichlin, Mt. Sinai J. of Med. 55:487-493, 1988.

For example, a group of myositis-associated autoantibodies have been identified which are directed at cytoplasmic proteins that are related to tRNA and protein synthesis, particularly aminoacyl-tRNA synthetases. These include anti-Jo-1, which is directed against histidyl-tRNA synthetase and is the most common autoantibody associated with myositis autoimmune disorders (about 20 to 40% of such patients according to Nishikai and Reichlin, Arthritis Rheum. 23:881-888, 1980); anti-PL-7, which is directed against threonyl-tRNA synthetase; anti-PL-12, which is directed against alanyl-tRNA synthetase, anti-OJ, which is directed against isoleucyl-tRNA synthetase, anti-EJ, which is directed against glycyl-tRNA synthetase, anti-KS which is directed against asparaginyl-tRNA synthetase (see generally Targoff, Curr. Opin. Rheumatol. 12:475-481, 2000) and against phenylalanine-tRNA synthetase (Betteridge et al., Rheumat. 46 1005-1008, 2007). A characteristic group of features is often associated with anti-synthetases (Love et al., Medicine. 70:360-374, 1991).

Anti-U1 RNP, which is frequently found in patients with SLE, may also be founds in mixed connective tissue disease, overlap syndromes involving myositis, or in some cases of myositis alone. This antibody reacts with proteins that are uniquely present on the U1 small nuclear ribonucleoprotein, one of the nuclear RNPs that are involved in splicing mRNA. Autoantibodies that are associated with other conditions are sometimes found in patients with overlap syndrome such as anti-Sm anti-Ro/SSA and anti-La/SSB. Anti-Ku has been found in myositis-scleroderma overlap syndrome and in SLE. The Ku antigen is a DNA binding protein complex with two polypeptide components, both of which have been cloned. Anti-Jo-1 and other anti-synthetases are disease-specific. Other myositis-associated antibodies are anti-PM-Scl, which is present in about 5-10% of myositis patients, many of whom have polymyositis-scleroderma overlap, and anti-Mi-2, which is present in about 8% of myositis patients, almost exclusively in dermatomyositis. Anti-Mi-2 is found in high titer in about 20% of all dermatomyositis patients and in low titer, by ELISA only, in less than 5% of polymyositis patients (Targoff and Reichlin, Mt. Sinai J. of Med. 55:487-493, 1988).

Accordingly it is not clear whether any one or more of these autoimmune-antibodies are the cause of these diseases, or merely reflect the destruction of the host cell tissues, and resulting antibody development.

Typically patients with inflammatory muscle disease (IMD) and interstitial lung disease (ILD) present when relatively young and in otherwise in good health, unfortunately in a sub set of patients disease progression can result in significant disability and high morbidity. Moreover currently there are no drugs specifically approved for the treatment of the general population of IMD and ILD. The current standard of care, is to administer non-specific anti-inflammatory and immune modulatory drugs such as methotrexate or azathioprine, and if symptoms don't abate, cyclosporine (Wallace et al., J. Musculoskelat Med. 27 (12):470-479, 2010). These drugs carry a substantive risk of side effects that can be severe with chronic administration. In severe progressive disease, individuals may be treated with intravenous immune globulin (IVIG). The burden and cost of care of treating patients with IVIG is high (as much as $10,000 per patient per monthly treatment), and a significant fraction of patients fail treatment and die.

Accordingly there remains a significant unmet need for improved methods of treatment of inflammatory muscle disease and related conditions that are both therapeutically and cost effective.

The current discovery, by providing for the first time a detailed structural understanding of the domain structure of human HRS, enables insights into the development of new HRS-based therapeutics, including, for example, anti-inflammatory agents, and antibody blocking agents that retain a stable conformation.

### BRIEF DESCRIPTION OF THE DRAWINGS

FIGS. 1A-E show the identification and validation of a HRS splice variant that skips the entire catalytic domain. FIG. 1A shows a schematic illustration of human HRS protein and the identified exon-skipping splicing events. Human HRS is composed of an N-terminal WHEP domain, a core catalytic aminoacylation domain (CD) and a C-terminal anticodon binding domain (ABD). The three conserved sequence motifs in its core active site are indicated by green, blue and orange bars, respectively. The mRNA transcript of human HARS gene is shown below and aligns with its encoded protein. Canonical exons are drawn in scale to the nucleotide length and are labeled consecutively. The splicing events identified by deep sequencing in the current study are illustrated by dashed lines to indicate non-canonical exon junctions. Targeting sites of the PCR primers are indicated by blue arrows and those of qPCR primers by green arrows. FIG. 1B shows validation by PCR of the splice variant that skips exons 3 to 10. PCR was performed using cDNA of IMR-32 neuronal cells and a pair of primers targeting 5′-UTR/Exon1 (FP1) and 3′-UTR (RP1) of the HARS gene. PCR products were separate by agarose gel electrophoresis. Lane 1: PCR by FP1 and RP1, Lane 2: PCR by primers targeting GAPDH as control. FIG. 1C shows the sequence of the exon 2-11 junction in the HRSΔCD transcript. FIG. 1D shows a schematic of protein products of human HRS (full-length; FL) and HRSΔCD. The protein product of splice variant HRSΔCD has the entire aminoacylation domain (aa 61-398) removed due to skipping of exons 3 to 10 and therefore directly connects the WHEP domain to the ABD. FIG. 1E shows detection of endogenous HRSΔCD protein by western blot analysis. HRSΔCD protein was detected in whole extracts of IMR-32 cells using antibodies against, separately, the N- and C-terminus of HRS(N-mAb, monoclonal antibody against HRS aa1-97; C-pAb, polyclonal antibody against HRS C-terminus). Total lysates of HEK293T cells transiently transfected with a HRSΔCD construct were run in parallel with IMR32 cell extracts to serve as a control that shows the size of HRSΔCD. The expected running position of the HRSΔCD protein is indicated by an arrow.

FIGS. 2A-D show the structure determination of human HRS by X-ray crystallography. FIG. 2A shows optimization of the boundary of human HRS for high quality crystals. The amino acid range included in each mutant and the corresponding crystal resolutions are shown. FIG. 2B shows a ribbon diagram of the 2.4 Å crystal structure of HRS Δ1-53_{—}507-509 (dark grey left: CD, dark grey right: ABD) FIG. 2C shows a structure comparison of HRSs of different species including human, trypanosoma (PDB: 3HR1), archaea (1WU7) and bacterium (1QE0). FIG. 2D shows a superposition of the insertion domains of human, trypanosoma and archaea shows differences in the orientations of this domain.

FIGS. 3A-E show a structure determination of the splice variant HRSΔCD by nuclear magnetic resonance (NMR) spectroscopy. FIG. 3A shows a schematic of the HRSΔCD* (2C2S_W94Q) mutant employed for structural characterizations. The mutational sites are labeled in red and the corresponding C507, C509 and W432 residues in the native HRS sequence are also indicated. FIG. 3B shows the ¹H-¹⁵N HSQC spectrum of HRSΔCD* used for structure determination. In FIG. 3C, the backbone superimposition of 20 calculated lowest-energy structures of the WHEP domain and the ABD of HRSΔCD* are shown, and the HRSΔCD* structure is shown below by ribbon representations. The WHEP domain and ABD domain are well-folded and linked by a flexible loop. FIG. 3D shows superposition of the NMR structures of HRSΔCD* and of the WHEP domain alone (PDB: 1X59). These structures are shown in ribbon diagram. Dark grey: WHEP domain of HRSΔCD*, light grey: 1X59, FIG. 3E shows the superposition of the human HRS Δ1-53_{—}507-509 crystal structure and the HRSΔCD* NMR structure. The W432 in HRS FL (corresponding to W94 in ΔCD) is shown. The circled area including helix α15 and the preceding loop had the most prominent differences. The structures are shown in ribbon diagram format. Dark grey: ABD of FL, shallow grey: ABD of HRSΔCD*, light grey: CD of HRS FL.

FIG. 4 illustrates the potential association of HRSΔCD with IIM/ILD. As shown in FIG. 4, Jo-1 antibodies from two different IIM patients reacted with recombinant human HRS FL (hsHisRS) and HRSΔCD*, but not with E. coli HRS (ecHisRS). The optical density at 450 nm was used to monitor the formation of antibody complexes in the xx ELISA assay. The “7B” stands for lot 7B04507 of Jo-1 antibodies and “4L” stands for lot 4L34811. Granzyme B digestion of HRSΔCD releases the two domains (not shown).

FIGS. 5A-D show the analysis of mRNA and protein expression of native HRS and HRSΔCD. FIG. 5A shows the tissue distribution of the native (FL) human HRS transcript. The HRS mRNA expression level was normalized to housekeeping genes (RPL9 and RPS11). The value in the total leukocytes was taken as 1.0. Dotted line indicates the median values. FIG. 5B shows the tissue distribution of the HRSΔCD transcript. The HRSΔCD mRNA expression level was normalized to housekeeping genes (RPL9 and RPS11). The values in the total leukocytes were taken as 1.0. Dotted line indicates the median value. The qPCR of HRSΔCD in certain tissues (shown in brackets) produced non-specific PCR products which were not included for calculation purposes. FIG. 5C shows the ratio of mRNA expression for HRSΔCD over that for HRS FL. FIG. 5D shows the detection of HRS proteins in whole lysates of IMR-32 cells by western blot analysis. HRS proteins were probed by antibodies against the N- and C-terminus of HRS. Total lysates of HEK293T cells overexpressing HRSΔCD were run in parallel with IMR32 cell extracts. Expected running positions of HRS (arrow head) and HRSΔCD (arrow) are indicated. The antibodies each also recognized a protein product with a size between 28 and 38 kDa (dashed arrow). Because both N- and C-terminal regions of HRS were detected, this protein could be derived from another splice variant with an internal in-frame deletion of around 200 amino acids. Lastly, protein products that were smaller than native HRS were detected by western blotting with either the anti-N- or anti-C-terminal antibody, but not with both. These proteins could be proteolytic fragments of HRS.

FIGS. 6A-E show the characterizations of human HRS variant proteins by size exclusion chromatography and X-ray crystallography. FIG. 6A shows the crystals of HRS Δ507-509 and Δ1-53_{—}507-509. FIG. 6B shows the superposition of backbone structures of HRS Δ507-509 and HRS Δ1-53_{—}507-509 (WHEP domain not visible). FIG. 6C shows the dimeric size of the HRS Δ507-509 protein demonstrated by size exclusion chromatography. FIGS. 6D-E show the sequence alignment of HRSs of various species. HRS sequences of human (SEQ ID NO:1), bovine (SEQ ID NO:11), mouse (SEQ ID NO:9), zebrafish (SEQ ID NO:14), drosophila (SEQ ID NO:32), C. elegans (SEQ ID NO:33), mold, yeast (SEQ ID NO:34), parasite (T. brucei) (SEQ ID NO:35), archaea (T. thermophilus) (SEQ ID NO:36) and bacterium (E. coli) (SEQ ID NO:37) were aligned by ClustalW and displayed by Espript. Secondary structure elements of the human HRS structure are shown above the sequences. The WHEP domain and insertion domain are indicated.

FIGS. 7A-F show the characterizations of HRSΔCD wild-type and mutant proteins by size exclusion chromatography and NMR spectroscopy. FIG. 7A shows the results of size exclusion chromatography, where HRSΔCD mutants 2C2S and Δ169-171 showed improved homogeneity compared to the wild-type (WT) HRS in buffer conditions containing DTT. As shown in FIG. 7B, the HRSΔCD mutants 2C2S and Δ169-171 showed improved homogeneity compared to HRS in buffer conditions even without DTT. FIG. 7C shows the ¹H-¹⁵N HSQC spectrum of HRSΔCD wild-type protein, and FIG. 7D shows the ¹H-¹⁵N HSQC spectrum of the HRSΔCD_{—}2C2S mutant protein. FIG. 7E shows an overlay of the ¹H-¹⁵N HSQC spectrum of HRSΔCD* with HRSΔCD_{—}2C2S mutant, and FIG. 7F shows an overlay of the ¹H-¹⁵N HSQC spectrum of HRSΔCD with ABD alone.

### BRIEF SUMMARY OF THE INVENTION

Embodiments of the present invention relate to the discovery of new histidyl-tRNA synthetase (HRS) variant polypeptides and the first X-ray crystallographic and NMR spectroscopy structures of human HRS polypeptides. The HRS polypeptides can be useful in a variety of therapeutic situations, and the HRS structures can be useful in drug design or discovery applications, for instance, to identify agents including small molecules that interact with and potentially modulate the activity and/or binding of HRS polypeptides.

Certain embodiments therefore include isolated human histidyl-tRNA synthetase (HRS) polypeptides, comprising (a) a deletion of residues 1-44 to 1-53 of SEQ ID NO:1 (full-length HRS), (b) a deletion of residues 507-509 of SEQ ID NO:1, or both (a) and (b). In some embodiments, the HRS polypeptide comprises both (a) and (b).

In some embodiments, the HRS polypeptide comprises an amino acid sequence at least 80%, 90%, or 95% identical to SEQ ID NO: 3 (Δ1-44). In some embodiments, the HRS polypeptide comprises an amino acid sequence at least 80%, 90%, or 95% identical to SEQ ID NO: 4 (Δ1-53). In some embodiments, the HRS polypeptide comprises an amino acid sequence at least 80%, 90%, or 95% identical to SEQ ID NO: 5 (Δ507-509). In some embodiments, the HRS polypeptide comprises an amino acid sequence at least 80%, 90%, or 95% identical to SEQ ID NO: 6 (Δ1-53, Δ507-509). In some embodiments, the HRS polypeptide comprises residues 1-506, 45-506, or 54-506 of SEQ ID NO:1.

In certain embodiments, the polypeptide is up to about 464 amino acids in length and comprises an amino acid sequence at least 95% identical to SEQ ID NO: 3. In some embodiments, the polypeptide is up to about 456 amino acids in length comprising an amino acid sequence at least 95% identical to SEQ ID NO: 4. In particular embodiments, the polypeptide is up to about up to about 506 amino acids in length comprising an amino acid sequence at least 95% identical to SEQ ID NO: 5. In specific embodiments, the polypeptide is up to about up to about 453 amino acids in length comprising an amino acid sequence at least 95% identical to SEQ ID NO: 6.

Particular embodiments include an isolated human histidyl-tRNA synthetase polypeptide, comprising the N-terminal WHEP domain and the C-terminal anti-codon binding domain (ABD) of human HRS, but lacking the catalytic domain (CD; aminoacylation domain), where (a) Cys168 and/or Cys170 (as defined by SEQ ID NO:7 (HRSΔCD)) are truncated or substituted with another amino acid, (b) Trp94 (as defined by SEQ ID NO:7 (HRSΔCD)) is substituted with another amino acid, optionally a more hydrophilic amino acid, or both (a) and (b). In some embodiments, the HRS polypeptide comprises both (a) and (b).

In some embodiments, the HRS polypeptide comprises a deletion of residues 61-398 of human HRS, as defined by SEQ ID NO:1 (full-length HRS). In certain embodiments, the HRS polypeptide comprises an amino acid sequence at least 80%, 90%, or 95% identical to SEQ ID NO:7 (HRSΔCD). In some embodiments, Cys168 and/or Cys170 are substituted with serine. In particular embodiments, Trp94 is substituted with glutamine. In specific embodiments, Cys168 and Cys170 are substituted with serine, and Trp94 is substituted with glutamine.

In some aspects, the HRS polypeptide is fused to a heterologous protein. In specific aspects, the heterologous protein comprises a T cell ligand, an immuno-recognition domain, an immuno-co-stimulatory domain, a purification tag, an epitope tag, a targeting sequence, a signal peptide, a membrane translocating sequence, and/or a PK modifier.

Also included are methods of treating a disease associated with an autoantibody comprising administering to a subject in need thereof a composition comprising (a) an HRS polypeptide described herein, (b) a recombinant nucleic acid encoding a HRS polypeptide described herein, and/or (c) a recombinant host cell, where the host cell expresses at least one heterologous HRS polypeptide described herein.

In some aspects, the composition is administered to the subject prior to the appearance of disease symptoms. In some embodiments, the autoantibody is specific for human histidyl-tRNA synthetase. In certain embodiments, the HRS polypeptide comprises at least one epitope of the histidyl-tRNA synthetase recognized by the disease specific autoantibody. In particular embodiments, the epitope is an immunodominant epitope recognized by antibodies in sera from the subject. In certain embodiments, the HRS polypeptide blocks the binding of the autoantibody to native histidyl-tRNA synthetase. In some embodiments, the HRS polypeptide causes clonal deletion of auto-reactive T-cells. In certain embodiments, the HRS polypeptide causes functional inactivation of the T cells involved in the autoimmune response. In some embodiments, the HRS polypeptide results in reduced muscle or lung inflammation. In some embodiments, the HRS polypeptide induces tolerance. In specific embodiments, the composition is formulated for delivery via oral, intranasal, pulmonary, or parental administration.

In some embodiments, the disease is selected from the group consisting of inflammatory myopathies, including idiopathic inflammatory myopathies, polymyositis, dermatomyositis and related disorders, polymyositis-scleroderma overlap, inclusion body myositis (IBM), anti-synthetase syndrome, interstitial lung disease, arthritis, and Reynaud's phenomenon.

Also included are methods of reducing muscle or lung inflammation said method comprising administering to a subject a composition comprising (a) an HRS polypeptide described herein, (b) a recombinant nucleic acid encoding a HRS polypeptide described herein, and/or (c) a recombinant host cell, where the host cell expresses at least one heterologous HRS polypeptide described herein.

Also included are methods inducing tolerance to a histidyl tRNA synthetase (HisRS) autoantigen, said method comprising administering to a subject a composition comprising (a) a HRS polypeptide of described herein, (b) a recombinant nucleic acid encoding a HRS polypeptide described herein, and/or (c) a recombinant host cell, where the host cell expresses at least one heterologous HRS polypeptide described herein, where the HRS polypeptide comprises at least one epitope specifically recognized by the autoantibody, and where administration of the composition causes tolerization to the autoantigen.

Certain embodiments relate to methods for eliminating a set or subset of T cells involved in an autoimmune response to a histidyl tRNA synthetase (HisRS) autoantigen, the method comprising administering to a subject a composition comprising (a) a HRS polypeptide described herein, (b) a recombinant nucleic acid encoding a HRS polypeptide described herein, and/or (c) a recombinant host cell, where the host cell expresses at least one heterologous HRS polypeptide described herein, where the HRS polypeptide comprises at least one epitope specifically recognized by the autoantibody, and where administration of the composition causes clonal deletion of auto-reactive T-cells.

Also included are methods for inducing anergy in T cells involved in an autoimmune response to a histidyl-tRNA synthetase (HisRS) autoantigen, the method comprising administering to a subject a composition comprising (a) a HRS polypeptide described herein, (b) a recombinant nucleic acid encoding a HRS polypeptide described herein, and/or (c) a recombinant host cell, where the host cell expresses at least one heterologous HRS polypeptide described herein, where the HRS polypeptide comprises at least one epitope specifically recognized by the autoantibody, and where administration of the composition causes functional inactivation of the T cells involved in the autoimmune response.

Certain embodiments include methods for treating a disease associated with an sufficiency of histidyl tRNA synthetase, comprising administering to a subject in need thereof a composition comprising (a) a HRS polypeptide described herein, (b) a recombinant nucleic acid encoding a HRS polypeptide described herein, and/or (c) a recombinant host cell, where the host cell expresses at least one heterologous HRS polypeptide described herein, where the HRS polypeptide functionally compensates for the histidyl tRNA synthetase insufficiency.

In some embodiments, the HRS polypeptide binds to a human histocompatibility complex (MHC) class II molecule. In some embodiments, the nucleic acid is operatively coupled to one or more expression control sequences, and where expression of the nucleic acid causes tolerization. In some embodiments, the composition is formulated for delivery via oral, intranasal, pulmonary or parental administration. In some embodiments, the composition comprises a delivery vehicle selected from the group consisting of liposomes, micelles, emulsions and cells.

Also included are compositions for treating a disease associated with an autoantibody specific for human histidyl tRNA synthetase, the composition comprising at least one HRS polypeptide described herein, where the HRS polypeptide comprises at least one epitope specifically recognized by the autoantibody, and where the HRS polypeptide is capable of causing tolerization.

Also included are compositions for treating a disease associated with an autoantibody specific for human histidyl tRNA synthetase, the composition comprising a recombinant nucleic acid encoding a mammalian HRS polypeptide described herein, where the HRS polypeptide comprises at least one epitope specifically recognized by the autoantibody, and where the nucleic acid is operatively coupled to expression control sequences, and where expression of the nucleic acid causes tolerization.

Certain aspects relate to compositions for treating a disease associated with an autoantibody specific for histidyl tRNA synthetase, the composition comprising a recombinant host cell, where the host cell expresses at least one heterologous HRS polypeptide described herein, where the HRS polypeptide comprises at least one epitope specifically recognized by the autoantibody, and where the nucleic acid is operatively coupled to expression control sequences to enable expression of the HRS in the host cell.

Also included are compositions for treating a disease associated with an insufficiency of histidyl tRNA synthetase, the composition comprising at least one HRS polypeptide described herein, where the HRS polypeptide is capable of replacing at least one canonical or non-canonical function of the histidyl tRNA synthetase.

In certain compositions, the HRS polypeptide is at least about 95% pure and less than about 5% aggregated, and where the composition is substantially endotoxin free. In certain compositions, the composition is formulated for delivery via oral, intranasal, pulmonary or parental administration. In some aspects, the composition comprises a delivery vehicle selected from the group consisting of liposomes, micelles, emulsions and cells.

Also included is the use of an isolated human histidyl-tRNA synthetase (HRS) polypeptide described herein in the preparation of a medicament for the treatment of an autoimmune disease. Exemplary autoimmune diseases are described elsewhere herein.

Certain embodiments include methods of drug design, comprising the step of using the structural coordinates of a human histidyl tRNA synthetase (HRS) polypeptide comprising the coordinates of Table S2 or Table S3, to computationally evaluate an agent for binding to an (exposed) binding site of the HRS polypeptide.

Also included are methods of identifying an agent that binds to a human histidyl-tRNA synthetase (HRS) polypeptide, comprising: (a) obtaining structural coordinates of (i) an x-ray crystallographic structure of human HRS as characterized by Table S2, or (ii) a three-dimensional nuclear magnetic resonance (NMR) spectroscopy structure of human HRS as characterized by Table S3, +/− a root mean square deviation from the backbone atoms that is not more than 1.5 \acute{Å}; and (b) using the structural coordinates and one or more molecular modeling techniques to identify an agent that binds to the human HRS polypeptide.

Some embodiments include methods of identifying an agent that binds to a human histidyl-tRNA synthetase (HRS) polypeptide, comprising: (a) generating a three-dimensional representation of human HRS on a digital computer, where the three-dimensional representation has (i) the x-ray crystallographic structure coordinates of Table S2, or (ii) the three-dimensional nuclear magnetic resonance (NMR) spectroscopy structure coordinates of Table S3, +/− a root mean square deviation from the backbone atoms that is not more than 1.5 \acute{Å}; and (b) using the three-dimensional representation from (a) to identify an agent that binds to the HRS polypeptide.

In some methods, (b) comprises using software comprised by the digital computer to design the agent. In certain methods, the digital computer comprises (structural coordinates of) a library of candidate agents, and where (b) comprises using software comprised by the digital computer to identify (or select) the agent from the library of candidate agents. Particular methods include using the three-dimensional representation of human HRS to derivatize the agent and thereby alter its ability to bind to the HRS polypeptide.

Some methods include (c) optionally synthesizing or otherwise obtaining the agent; and (d) contacting the agent with the HRS polypeptide to determine the ability of the agent to bind to the HRS polypeptide. Certain methods include (c) optionally synthesizing or otherwise obtaining the agent; and (d) contacting the agent with the HRS polypeptide to measure the ability of the agent to modulate at least one non-canonical and/or canonical activity of a HRS polypeptide. In some aspects, the agent fully or partially antagonizes at least one non-canonical activity of the human HRS polypeptide. In certain aspects, the agent fully or partially agonizes at least one non-canonical activity of the human HRS polypeptide. In specific aspects, the agent antagonizes the binding of wild-type human HRS to a disease-associated autoantibody. In some aspects, the agent does not significantly antagonize the canonical activity of human HRS.

Certain methods include assessing the structure-activity relationship (SAR) of the agent, to correlate its structure with modulation of the non-canonical and/or canonical activity, and optionally derivatizing the compound to alter its ability to modulate the non-canonical and/or canonical activity. In any of the methods provided herein, the agent can be, for instance, a polypeptide or peptide, an antibody or antigen-binding fragment thereof, a peptide mimetic, an adnectin, a small molecule, or an aptamer, among other possibilities.

In certain embodiments, the crystallographic, structure is characterized by (i) a space group of P4₁2₁2 and unit cell dimensions of a=b=100.4 \acute{Å}, c=257.1 \acute{Å}, or (ii) a space group of P4₁2₁2 and unit cell dimensions of a=b=93.5 \acute{Å}, c=254.5 \acute{Å}.

Also included are computer programs for instructing a digital computer to perform the method of generating a three-dimensional model of a human histidyl-tRNA synthetase (HRS) polypeptide on a computer screen, where the three-dimensional model has (i) x-ray crystallographic structure coordinates of Table S2, or (ii) nuclear magnetic resonance (NMR) spectroscopy structure coordinates of Table S3, +/− a root mean square deviation from the backbone atoms that is not more than 1.5 \acute{Å}; and optionally the same or different computer program for instructing the digital computer to identify an agent that binds to the human HRS polypeptide. Certain computer programs are for instructing the digital computer to design an agent that binds to the human HRS polypeptide. In some computer programs, the digital computer comprises (structural coordinates of) a library of candidate agents, and the computer program is for instructing the digital computer to identify (or select) the agent from the library of candidate agents.

Some embodiments include a computer readable medium having computer-readable code embodied thereon, the computer-readable code comprising structural coordinates of a human histidyl-tRNA synthetase (HRS) polypeptide characterized by (a) the x-ray crystallographic structure of Table S2, or (b) the nuclear magnetic resonance (NMR) spectroscopy structure of Table S3, +/− a root mean square deviation from the backbone atoms that is not more than 1.5 \acute{Å}. In some aspects, the crystallographic structure is characterized by (i) a space group of P4₁2₁2 and unit cell dimensions of a=b=100.4 \acute{Å}, c=257.1 \acute{Å}, or (ii) a space group of P4₁2₁2 and unit cell dimensions of a=b=93.5 \acute{Å}, c=254.5 \acute{Å}.

Also included is a crystallized human histidyl-tRNA synthetase polypeptide, that is characterized by (a) a space group of P4₁2₁2 and unit cell dimensions of a=b=100.4 \acute{Å}, c=257.1 \acute{Å}, or (b) a space group of P4₁2₁2 and unit cell dimensions of a=b=93.5 \acute{Å}, c=254.5 \acute{Å}.

### Sequence Listing

SEQ ID NO:1 is the amino acid sequence of full-length, wild-type human histidyl-tRNA synthetase (HRS).

SEQ ID NO:2 is the amino acid sequence of full-length, mitochondrial wild-type human histidyl-tRNA synthetase (HRS).

SEQ ID NO:3 is the is the amino acid sequence of a human HRS variant having a deletion of residues 1-44 (Δ1-44).

SEQ ID NO:4 is the amino acid sequence of a human HRS variant having a deletion of residues 1-53 (Δ1-53).

SEQ ID NO:5 is the amino acid sequence of a human HRS variant having a deletion of residues 507-509 (Δ507-509).

SEQ ID NO:6 is the amino acid sequence of a human HRS variant having a deletion of residues 1-53 and residues 507-509 (Δ1-53_{—}Δ507-509).

SEQ ID NO:7 is the amino acid sequence of a human HRS splice variant having a deletion of the aminoacylation domain of residues 61-398 (HRSΔCD).

SEQ ID NO:8 is the amino acid sequence of a human HRS variant having a deletion of residues 61-398, and substitution of residues Trp94Gln, Cys168Ser, and Cys170Ser, the numbering of the substituted residues being defined by SEQ ID NO:7.

SEQ ID NO:9 is amino acid sequence of HRS from Mus musculus.

SEQ ID NO:10 is amino acid sequence of HRS from Canis lupus familiaris.

SEQ ID NO: 11 is amino acid sequence of HRS from Bos taurus.

SEQ ID NO:12 is amino acid sequence of HRS from Rattus norvegicus.

SEQ ID NO:13 is amino acid sequence of HRS from Gallus gallas.

SEQ ID NO:14 is amino acid sequence of HRS from Dania rerio.

SEQ ID NO:15 is a polynucleotide sequence that encodes the full-length HRS polypeptide of SEQ ID NO:1

SEQ ID NO:16 is a polynucleotide sequence that encodes the HRSΔCD variant of SEQ ID NO:7, having a deletion exons 3-10.

SEQ ID NOS:17-21 are SNP sequences associated with human histidyl-tRNA synthetase.

SEQ ID NOS:22-31 are nucleotide primer sequences.

### DETAILED DESCRIPTION

The practice of the present invention will employ, unless indicated specifically to the contrary, conventional methods of molecular biology and recombinant DNA techniques within the skill of the art, many of which are described below for the purpose of illustration. Such techniques are explained fully in the literature. See, e.g., Sambrook et al., Molecular Cloning: A Laboratory Manual (3^{rd} Edition, 2000); DNA Cloning: A Practical Approach, vol. I & II (D. Glover, ed.); Oligonucleotide Synthesis (N. Gait, ed., 1984); Oligonucleotide Synthesis: Methods and Applications (P. Herdewijn, ed., 2004); Nucleic Acid Hybridization (B. Hames & S. Higgins, eds., 1985); Nucleic Acid Hybridization: Modern Applications (Buzdin and Lukyanov, eds., 2009); Transcription and Translation (B. Hames & S. Higgins, eds., 1984); Animal Cell Culture (R. Freshney, ed., 1986); Freshney, R. I. (2005) Culture of Aminal Cells, a Manual of Basic Technique, 5^{th} Ed. Hoboken N.J., John Wiley & Sons; B. Perbal, A Practical Guide to Molecular Cloning (3^{rd} Edition 2010); Farrell, R., RNA Methodologies: A Laboratory Guide Isolation and Characterization (3^{rd} Edition 2005), Poly(ethylene glycol), Chemistry and Biological Applications, ACS, Washington, 1997; Veronese, F., and J. M. Harris, Eds., Peptide and protein PEGylation, Advanced Drug Delivery Reviews, 54(4) 453-609 (2002); Zalipsky et al., “Use of functionalized Poly(Ethylene Glycols) for modification of polypeptides” in Polyethylene Glycol Chemistry: Biotechnical and Biomedical Applications. The publications discussed above are provided solely for their disclosure before the filing date of the present application. Nothing herein is to be construed as an admission that the invention is not entitled to antedate such disclosure by virtue of prior invention.

### DEFINITIONS

Unless defined otherwise, all technical and scientific terms used herein have the same meaning as commonly understood by those of ordinary skill in the art to which the invention belongs. Although any methods and materials similar or equivalent to those described herein can be used in the practice or testing of the present invention, preferred methods and materials are described. For the purposes of the present invention, the following terms are defined below.

The articles “a” and “an” are used herein to refer to one or to more than one (i.e., to at least one) of the grammatical object of the article. By way of example, “an element” means one element or more than one element.

By “about” is meant a quantity, level, value, number, frequency, percentage, distension, size, amount, weight or length that varies by as much as 30, 25, 20, 15, 10, 9, 8, 7, 6, 5, 4, 3, 2 or 1% to a reference quantity, level, value, number, frequency, percentage, dimension, size, amount, weight or length.

The term “anergy” refers to the functional inactivation of a T-cell, or B-cell response to re-stimulation by antigen.

As used herein, the term “amino acid” is intended to mean both naturally occurring and non-naturally occurring amino acids as well as amino acid analogs and mimetics. Naturally occurring amino acids include the 20 (L)-amino acids utilized during protein biosynthesis as well as others such as 4-hydroxyproline, hydroxylysine, desmosine, isodesmosine, homocysteine, citrulline and ornithine, for example. Non-naturally occurring amino acids include, for example, (D)-amino acids, norleucine, norvaline, p-fluorophenylalanine, ethionine and the like, which are known to a person skilled in the art. Amino acid analogs include modified forms of naturally and non-naturally occurring amino acids. Such modifications can include, for example, substitution or replacement of chemical groups and moieties on the amino acid or by derivatization of the amino acid. Amino acid mimetics include, for example, organic structures which exhibit functionally similar properties such as charge and charge spacing characteristic of the reference amino acid. For example, an organic structure which mimics Arginine (Arg or R) would have a positive charge moiety located in similar molecular space and having the same degree of mobility as the e-amino group of the side chain of the naturally occurring Arg amino acid. Mimetics also include constrained structures so as to maintain optimal spacing and charge interactions of the amino acid or of the amino acid functional groups. Those skilled in the art know or can determine what structures constitute functionally equivalent amino acid analogs and amino acid mimetics.

An “autoimmune disease” as used herein is a disease or disorder arising from and directed against an individual's own tissues. Examples of autoimmune diseases or disorders include, but are not limited to, inflammatory responses such as inflammatory skin diseases including psoriasis and dermatitis (e.g. atopic dermatitis); systemic scleroderma and sclerosis; responses associated with inflammatory bowel disease (such as Crohn's disease and ulcerative colitis); respiratory distress syndrome (including adult respiratory distress syndrome; ARDS); dermatitis; meningitis; encephalitis; uveitis; colitis; glomerulonephritis; allergic conditions such as eczema and asthma and other conditions involving infiltration of T cells and chronic inflammatory responses; atherosclerosis; leukocyte adhesion deficiency; rheumatoid arthritis; systemic lupus erythematosus (SLE); diabetes mellitus (e.g. Type I diabetes mellitus or insulin dependent diabetes mellitus); multiple sclerosis; Reynaud's syndrome; autoimmune thyroiditis; allergic encephalomyelitis; Sjogren's syndrome; juvenile onset diabetes; and immune responses associated with acute and delayed hypersensitivity mediated by cytokines and T-lymphocytes typically found in tuberculosis, sarcoidosis, polymyositis, inflammatory myopathies, interstitial lung disease, granulomatosis and vasculitis; pernicious anemia (Addison's disease); diseases involving leukocyte diapedesis; central nervous system (CNS) inflammatory disorder; multiple organ injury syndrome; hemolytic anemia (including, but not limited to cryoglobinemia or Coombs positive anemia); myasthenia gravis; antigen-antibody complex mediated diseases; anti-glomerular basement membrane disease; antiphospholipid syndrome; allergic neuritis; Graves' disease; Lambert-Eaton myasthenic syndrome; pemphigoid bullous; pemphigus; autoimmune polyendocrinopathies; Reiter's disease; stiff-man syndrome; Behcet disease; giant cell arteritis; immune complex nephritis; IgA nephropathy; IgM polyneuropathies; immune thrombocytopenic purpura (ITP) or autoimmune thrombocytopenia etc.

The term “binding” refers to a direct association between two molecules, due to, for example, covalent, electrostatic, hydrophobic, and ionic and/or hydrogen-bond interactions, including interactions such as salt bridges and water bridges. Binding proteins include for example antibodies and antibody alternatives including binding agents, as described herein.

The term “clonal deletion” refers to the deletion (i.e., loss, or death) of auto-reactive T-cells. Clonal deletion can be achieved centrally in the thymus, in the periphery, or both.

Throughout this specification, unless the context requires otherwise, the words “comprise,” “comprises,” and “comprising” will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The term “endotoxin free” or “substantially endotoxin free” relates generally to compositions, solvents, and/or vessels that contain at most trace amounts (e.g., amounts having no clinically adverse physiological effects to a subject) of endotoxin, and preferably undetectable amounts of endotoxin. Endotoxins are toxins associated with certain micro-organisms, such as bacteria, typically gram-negative bacteria, although endotoxins may be found in gram-positive bacteria, such as Listeria monocytogenes. The most prevalent endotoxins are lipopolysaccharides (LPS) lipo-oligo-saccharides (LOS) found in the outer membrane of various Gram-negative bacteria, and which represent a central pathogenic feature in the ability of these bacteria to cause disease. Small amounts of endotoxin in humans may produce fever, a lowering of the blood pressure, and activation of inflammation and coagulation, among other adverse physiological effects.

Therefore, in pharmaceutical production, it is often desirable to remove most or all traces of endotoxin from drug products and/or drug containers, because even small amounts may cause adverse effects in humans. A depyrogenation oven may be used for this purpose, as temperatures in excess of 300° C. are typically required to break down most endotoxins. For instance, based on primary packaging material such as syringes or vials, the combination of a glass temperature of 250° C. and a holding time of 30 minutes is often sufficient to achieve a 3 log reduction in endotoxin levels. Other methods of removing endotoxins are contemplated, including, for example, chromatography and filtration methods, as described herein and known in the art. Also included are methods of producing HRS polypeptides in and isolating them from eukaryotic cells such as mammalian cells to reduce, if not eliminate, the risk of endotoxins being present in a composition of the invention. Preferred are methods of producing HRS polypeptides in and isolating them from serum free cells.

Endotoxins can be detected using routine techniques known in the art. For example, the Limulus Amoebocyte Lysate assay, which utilizes blood from the horseshoe crab, is a very sensitive assay for detecting presence of endotoxin. In this test, very low levels of LPS can cause detectable coagulation of the limulus lysate due a powerful enzymatic cascade that amplifies this reaction. Endotoxins can also be quantitated by enzyme-linked immunosorbent assay (ELISA). To be substantially endotoxin free, endotoxin levels may be less than about 0.001, 0.005, 0.01, 0.02, 0.03, 0.04, 0.05, 0.06, 0.08, 0.09, 0.1, 0.5, 1.0, 1.5, 2, 2, 5, 3, 4, 5, 6, 7, 8, 9, or 10 EU/mg of protein. Typically, 1 ng lipopolysaccharide (LPS) corresponds to about 1-10 EU.

“Epitope” refers to that portion of an antigen or other macromolecule capable of forming a binding interaction that interacts with the variable region of an antibody (or like protein), antibody alternative, binding agent, or T cell receptor. In the case of antibodies, such binding interactions can be manifested as an intermolecular contact with one or more amino acid residues of a CDR. Antigen binding can involve a CDR3 or a CDR3 pair. An epitope can be a linear peptide sequence (e.g., “continuous”) or can be composed of noncontiguous amino acid sequences (e.g., “conformational” or “discontinuous” sequences which may separately, or together form a recognizable shape). A binding protein can recognize one or more amino acid sequences; therefore an epitope can define more than one distinct amino acid sequence. Epitopes recognized by binding protein can be determined by peptide mapping and sequence analysis techniques well known to one of skill in the art. A “cryptic epitope” or a “cryptic binding site” is an epitope or binding site of a protein sequence that is not exposed or substantially protected from recognition within an unmodified polypeptide, or protein complex or multimer, but is capable of being recognized by a binding protein to a proteolyzed polypeptide, or non complexed, dissociated polypeptide. Amino acid sequences that are not exposed, or are only partially exposed, in the unmodified, multimeric polypeptide structure are potential cryptic epitopes. If an epitope is not exposed, or only partially exposed, then it is likely that it is buried within the interior of the polypeptide, or masked in the polypeptide complex by the binding of other proteins or factors. Candidate cryptic epitopes can be identified, for example, by examining the three-dimensional structure of an unmodified polypeptide.

“Expression control sequences” are regulatory sequences of nucleic acids, or the corresponding amino acids, such as promoters, leaders, enhancers, introns, recognition motifs for RNA, or DNA binding proteins, polyadenylation signals, terminators, internal ribosome entry sites (IRES), secretion signals, subcellular localization signals, and the like, that have the ability to affect the transcription or translation, or subcellular or cellular location of a coding sequence in a host cell. Exemplary expression control sequences are described in Goeddel; Gene Expression Technology; Methods in Enzymology 185, Academic Press, San Diego, Calif. (1990).

The term “heterologous” refers to a nucleic acid or protein which has been introduced into an organism (such as a plant, animal, or prokaryotic cell), or a nucleic acid molecule (such as chromosome, vector, or nucleic acid construct), which are derived from another source, or which are from the same source, but are located in a different (i.e., non-native) context.

“Homology” refers to the percentage number of amino acids that are identical or constitute conservative substitutions. Homology may be determined using sequence comparison programs such as GAP (Deveraux et al., 1984, Nucleic Acids Research 12, 387-395), which is incorporated herein by reference. In this way sequences of a similar or substantially different length to those cited herein could be compared by insertion of gaps into the alignment, such gaps being determined, for example, by the comparison algorithm used by GAP.

The term “half maximal effective concentration” or “EC₅₀” refers to the concentration of an agent (e.g., HRS polypeptide, or other agent) as described herein at which it induces a response halfway between the baseline and maximum after some specified exposure time; the EC₅₀ of a graded dose response curve therefore represents the concentration of a compound at which 50% of its maximal effect is observed. EC₅₀ also represents the plasma concentration required for obtaining 50% of a maximum effect in vivo. Similarly, the “EC₉₀” refers to the concentration of an agent or composition at which 90% of its maximal effect is observed. The “EC₉₀” can be calculated from the “EC₅₀” and the Hill slope, or it can be determined from the data directly, using routine knowledge in the art. In some embodiments, the EC₅₀ of an agent is less than about 0.01, 0.05, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 25, 30, 40, 50, 60, 70, 80, 90, 100, 200 or 500 nM. In some embodiments, a biotherapeutic composition will have an EC₅₀ value of about 1 nM or less.

An “immunogenic composition” of the invention, as used herein, refers to any composition that elicits an immune response in an animal, such as a mammal. An “immune response” is the reaction of the body to foreign substances, without implying a physiologic or pathologic consequence of such a reaction, i.e., without necessarily conferring protective immunity on the animal. An immune response may include one or more of the following: (a) a cell mediated immune response, which involves the production of lymphocytes by the thymus (T cells) in response to exposure to the antigen; and/or (b) a humoral immune response, which involves production of plasma lymphocytes (B cells) in response to antigen exposure with subsequent antibody production.

By “isolated” is meant material that is substantially or essentially free from components that normally accompany it in its native state. For example, an “isolated peptide” or an “isolated polypeptide” and the like, as used herein, includes the in vitro isolation and/or purification of a peptide or polypeptide molecule from its natural cellular environment, and from association with other components of the cell; i.e., it is not significantly associated with in vivo substances.

The term “modulating” includes “increasing,” “enhancing” or “stimulating,” as well as “decreasing” or “reducing,” typically in a statistically significant or a physiologically significant amount as compared to a control. An “increased,” “stimulated” or “enhanced” amount is typically a “statistically significant” amount, and may include an increase that is 1.1, 1.2, 2, 3, 4, 5, 6, 7, 8, 9, 10, 15, 20, 30 or more times (e.g., 500, 1000 times) (including all integers and decimal points in between and above 1, e.g., 1.5, 1.6, 1.7, 1.8, etc.) the amount produced by no composition (e.g. in the absence of any of the HRS polypeptides of the invention) or a control composition, sample or test subject. A “decreased” or “reduced” amount is typically a “statistically significant” amount, and may include a 1%, 2%, 3%, 4%, 5%, 6%, 7%, 8%, 9%, 10%, 11%, 12%, 13%, 14%, 15%, 16%, 17%, 18%, 19%, 20%, 25%, 30%, 35%, 40%, 45%, 50%, 55%, 60%, 65%, 70%, 75%, 80%, 85%, 90%, 95%, or 100% decrease in the amount produced by no composition (the absence of an agent or compound) or a control composition, including all integers in between.

The terms “operably linked,” “operatively linked,” or “operatively coupled” as used interchangeably herein, refer to the positioning of two or more nucleotide sequences or sequence elements in a manner which permits them to function in their intended manner. In some embodiments, a nucleic acid molecule according to the invention includes one or more DNA elements capable of opening chromatin and/or maintaining chromatin in an open state operably linked to a nucleotide sequence encoding a recombinant protein. In other embodiments, a nucleic acid molecule may additionally include one or more DNA or RNA nucleotide sequences chosen from: (a) a nucleotide sequence capable of easing translation; (b) a nucleotide sequence capable of increasing secretion of the recombinant protein outside a cell; (c) a nucleotide sequence capable of increasing the mRNA stability, and (d) a nucleotide sequence capable of binding a trans-acting factor to modulate transcription or translation, where such nucleotide sequences are operatively linked to a nucleotide sequence encoding a recombinant protein. Generally, but not necessarily, the nucleotide sequences that are operably linked are contiguous and, where necessary, in reading frame. However, although an operably linked DNA element capable of opening chromatin and/or maintaining chromatin in an open state is generally located upstream of a nucleotide sequence encoding a recombinant protein; it is not necessarily contiguous with it. Operable linking of various nucleotide sequences is accomplished by recombinant methods well known in the art, e.g., using PCR methodology, by ligation at suitable restrictions sites or by annealing. Synthetic oligonucleotide linkers or adaptors can be used in accord with conventional practice if suitable restriction sites are not present.

“Non-canonical” activity as used herein, includes non-aminoacylation activities such as (i) a new biological activity possessed by HRS polypeptide of the invention that is not possessed to any significant degree by the intact native full length parental protein, and (ii) an activity that was possessed by the intact native full length parental protein, where the HRS polypeptide (a) exhibits a significantly higher (e.g., at least 20% greater) specific activity with respect to the non-canonical activity compared to the intact native full length parental protein, and/or (b) exhibits the activity in a new context; for example by isolating the activity from other activities possessed by the intact native full length parental protein, or in the context of an extracellular environment, compared to the classical cytoplasmic intracellular compartment.

A “promoter” is a DNA regulatory region capable of binding RNA polymerase in a cell and initiating transcription of a downstream (3′ direction) coding sequence. As used herein, the promoter sequence is bounded at its 3′ terminus by the transcription initiation site and extends upstream (5′ direction) to include the minimum number of bases or elements necessary to initiate transcription at levels detectable above background. A transcription initiation site (conveniently defined by mapping with nuclease S1) can be found within a promoter sequence, as well as protein binding domains (consensus sequences) responsible for the binding of RNA polymerase. Eukaryotic promoters can often, but not always, contain “TATA” boxes and “CAT” boxes. Prokaryotic promoters contain Shine-Dalgarno sequences in addition to the −10 and −35 consensus sequences.

A large number of promoters, including constitutive, inducible and repressible promoters, from a variety of different sources are well known in the art. Representative sources include for example, viral, mammalian, insect, plant, yeast, and bacterial cell types), and suitable promoters from these sources are readily available, or can be made synthetically, based on sequences publicly available on line or, for example, from depositories such as the ATCC as well as other commercial or individual sources. Promoters can be unidirectional (i.e., initiate transcription in one direction) or bi-directional (i.e., initiate transcription in either a 3′ or 5′ direction). Non-limiting examples of promoters include, for example, the T7 bacterial expression system, pBAD (araA) bacterial expression system, the cytomegalovirus (CMV) promoter, the SV40 promoter, the RSV promoter. Inducible promoters include the Tet system, (U.S. Pat. Nos. 5,464,758 and 5,814,618), the Ecdysone inducible system (No et al., Proc. Natl. Acad. Sci. (1996) 93 (8): 3346-3351; the T-REₓ™ system (Invitrogen Carlsbad, Calif.), LacSwitch® (Stratagene, (San Diego, Calif.) and the Cre-ER^{T} tamoxifen inducible recombinase system (Indra et al. Nuc. Acid. Res. (1999) 27 (22): 4324-4327; Nuc. Acid. Res. (2000) 28 (23): e99; U.S. Pat. No. 7,112,715; and Kramer & Fussenegger, Methods Mol. Biol. (2005) 308: 123-144) or any promoter known in the art suitable for expression in the desired cells.

In certain embodiments, the “purity” of any given agent (e.g., HRS polypeptide) in a composition may be specifically defined. For instance, certain compositions may comprise an agent that is at least 80, 85, 90, 91, 92, 93, 94, 95, 96, 97, 98, 99, or 100% pure, including all decimals in between, as measured, for example and by no means limiting, by high pressure liquid chromatography (HPLC), a well-known form of column chromatography used frequently in biochemistry and analytical chemistry to separate, identify, and quantify compounds.

The terms “polypeptide” and “protein” are used interchangeably herein to refer to a polymer of amino acid residues and to variants and synthetic analogues of the same. Thus, these terms apply to amino acid polymers in which one or more am acid residues are synthetic non-naturally occurring acids, such as a chemical analogue of a corresponding naturally occurring amino acid, as well as to naturally-occurring amino acid polymers.

The term “specific” is applicable to a situation in which one member of a specific binding pair will not show any significant binding to molecules other than its specific binding partner(s). The term is also applicable where, for example, an antigen binding domain is specific for a particular epitope which is carried by a number of antigens, in which case the specific binding member carrying the antigen binding domain will be able to bind to the various antigens carrying the epitope.

By “statistically significant”, it is meant that the result was unlikely to have occurred by chance. Statistical significance can be determined by any method known in the art. Commonly used measures of significance include the p-value, which is the frequency or probability with which the observed event would occur, if the null hypothesis were true. If the obtained p-value is smaller than the significance level, then the null hypothesis is rejected. In simple cases, the significance level is defined at a p-value of 0.05 or less.

The term “solubility” refers to the property of an agent (e.g., HRS polypeptide) provided herein to dissolve in a liquid solvent and form a homogeneous solution. Solubility is typically expressed as a concentration, either by mass of solute per unit volume of solvent (g of solute per kg of solvent, g per dL (100 mL), mg/ml, etc.), molarity, molality, mole fraction or other similar descriptions of concentration. The maximum equilibrium amount of solute that can dissolve per amount of solvent is the solubility of that solute in that solvent under the specified conditions, including temperature, pressure, pH, and the nature of the solvent. In certain embodiments, solubility is measured at physiological pH, or other pH, for example, at pH 5.0, pH 6.0, pH 7.0, or pH 7.4. In certain embodiments, solubility is measured in water or a physiological buffer such as PBS or NaCl (with or without NaP). In specific embodiments, solubility is measured at relatively lower pH (e.g., pH 6.0) and relatively higher salt (e.g., 500 mM NaCl and 10 mM NaP) In certain embodiments, solubility is measured in a biological fluid (solvent) such as blood or serum. In certain embodiments, the temperature can be about room temperature (e.g., about 20, 21, 22, 23, 24, 25° C.) or about body temperature (37° C.). In certain embodiments, an agent (e.g., HRS polypeptide) has a solubility of at least about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 25, 30, 40, 50, 60, 70, 80, 90 or 100 mg/ml at room temperature or at 37° C.

A “subject,” as used herein, includes any animal that exhibits a symptom, or is at risk for exhibiting a symptom, which can be treated or diagnosed with an HRS polypeptide or other agent described herein. Suitable subjects (patients) include laboratory animals (such as mouse, rat, rabbit, or guinea pig), farm animals, and domestic animals or pets (such as a cat or dog). Non-human primates and, preferably, human patients, are included.

“Substantially” or “essentially” means nearly totally or completely, for instance, 95% or greater of some given quantity.

“Therapeutic response” refers to improvement of symptoms (whether or not sustained) based on the administration of the therapeutic response (whether or not tolerance is induced).

The term “tolerance” refers to a sustained, (e.g., one month or more) specific reduced responsiveness of the immune system to an antigen (e.g., self-antigen) in the setting of an otherwise substantially normal immune system. Tolerance is distinct from generalized immunosuppression in which all, or all of a class of a class such as B cell mediated immune responses of immune responses are diminished. “Tolerization” refers to a process leading to the state of tolerance.

As used herein, the terms “therapeutically effective amount”, “therapeutic dose,” “prophylactically effective amount,” or “diagnostically effective amount” is the amount of an agent (e.g., HRS polypeptide) needed to elicit the desired biological response following administration. Similarly the tem “HRS polypeptide therapy” includes a therapy that maintains the average steady state concentration an HRS polypeptide in the patient's plasma above the minimum effective therapeutic level.

“Treatment” or “treating,” as used herein, includes any desirable effect on the symptoms or pathology of a disease or condition, and may include even minimal changes or improvements in one or more measurable markers of the disease or condition being treated. “Treatment” or “treating” does not necessarily indicate complete eradication or cure of the disease or condition, or associated symptoms thereof. The subject receiving this treatment is any subject in need thereof. Exemplary markers of clinical improvement will be apparent to persons skilled in the art.

The term “vaccine”, as used herein, broadly refers to any compositions that may be administered to an animal to illicit a protective immune response to the vaccine or co-administered antigen. The terms “protect”, “protective “immune response” or “protective immunity”, as used herein describes the development of antibodies or cellular systems that specifically recognize the vaccine antigen.

The terms “vector,” “cloning vector” and “expression vector” mean the vehicle by which a DNA or RNA sequence (e.g., a foreign gene) can be introduced into a host cell so as to transform the host and promote expression (e.g., transcription and translation) of the introduced sequence. Vectors may include plasmids, phages, viruses, etc. and are discussed in greater detail below.

Unless defined otherwise, all technical and scientific terms used herein have the same meaning as commonly understood by one of ordinary skill in the art to which the invention belongs. Although any methods, compositions, reagents, cells, similar or equivalent to those described herein can be used in the practice or testing of the invention, the preferred methods and materials are described herein. All publications and references, including but not limited to patents and patent applications, cited in this specification are herein incorporated by reference in their entirety as if each individual publication or reference were specifically and individually indicated to be incorporated by reference herein as being fully set forth. Any patent application to which this application claims priority is also incorporated by reference herein in its entirety in the manner described above for publications and references.

### Structure of HRS Polypeptides and Methods of Drug Discovery

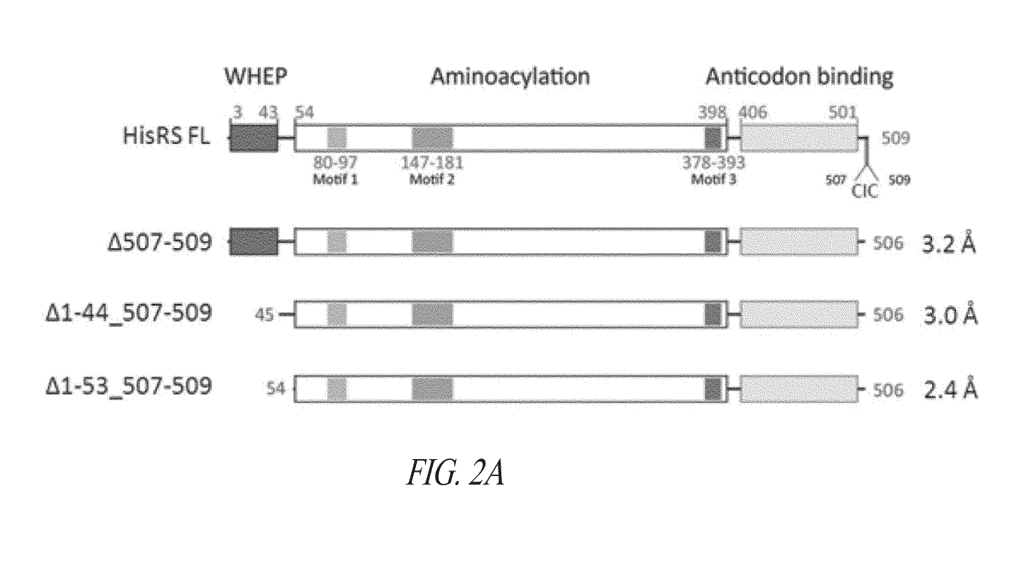

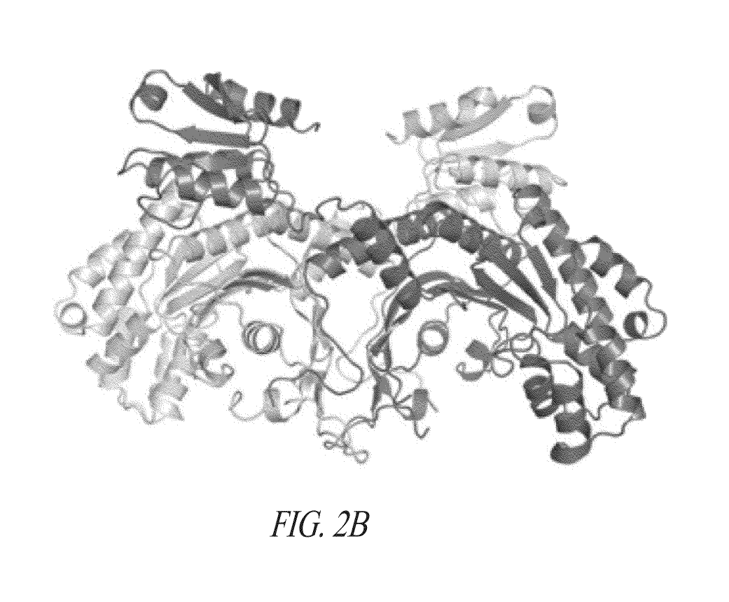

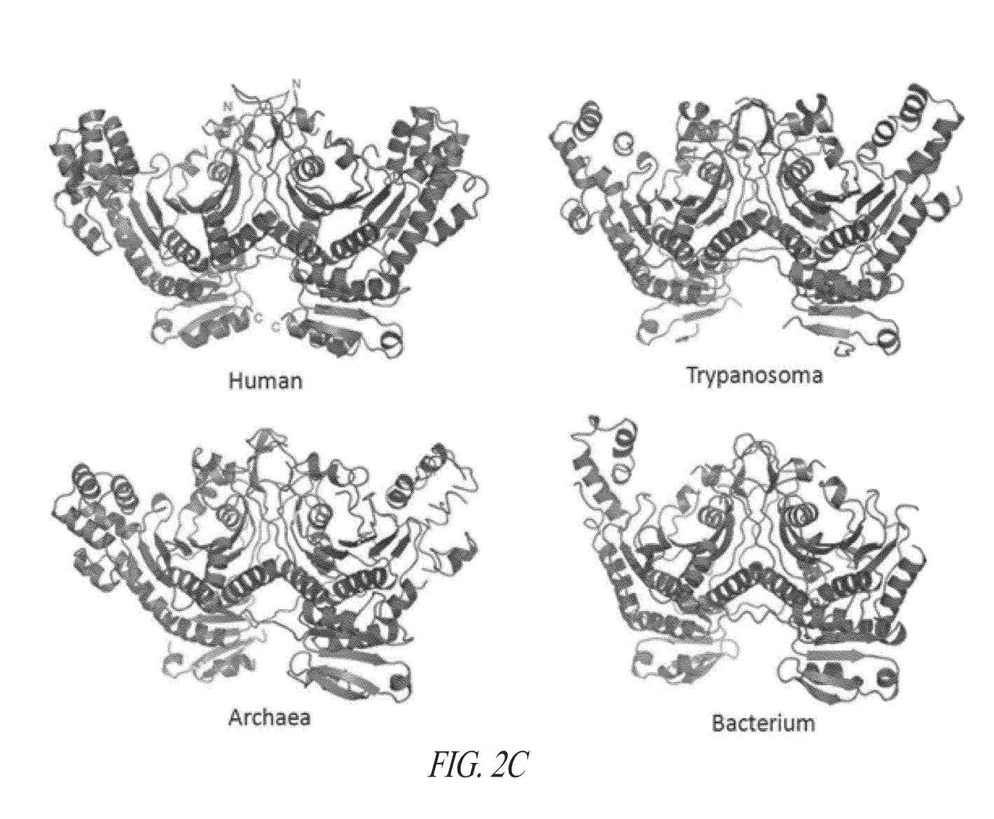

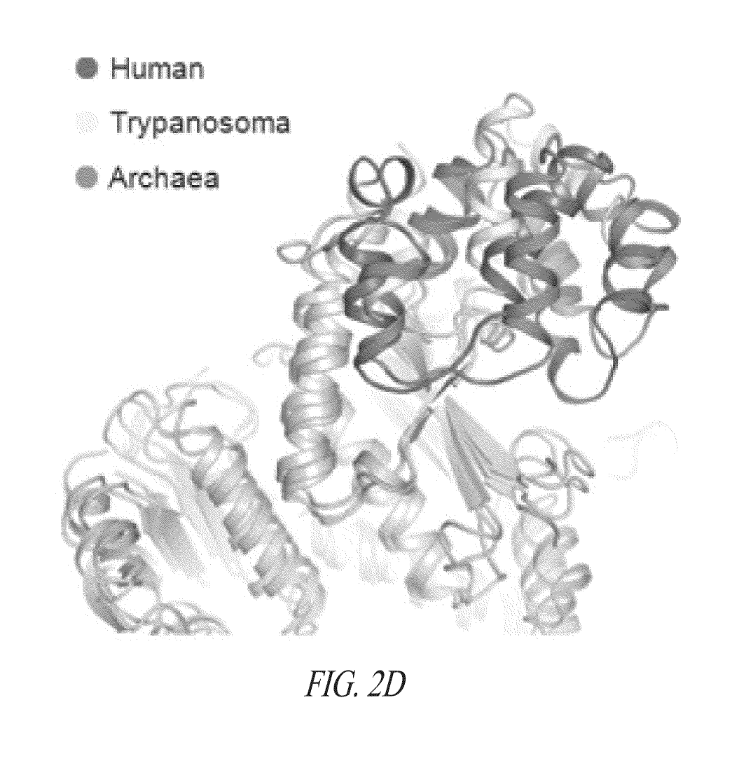

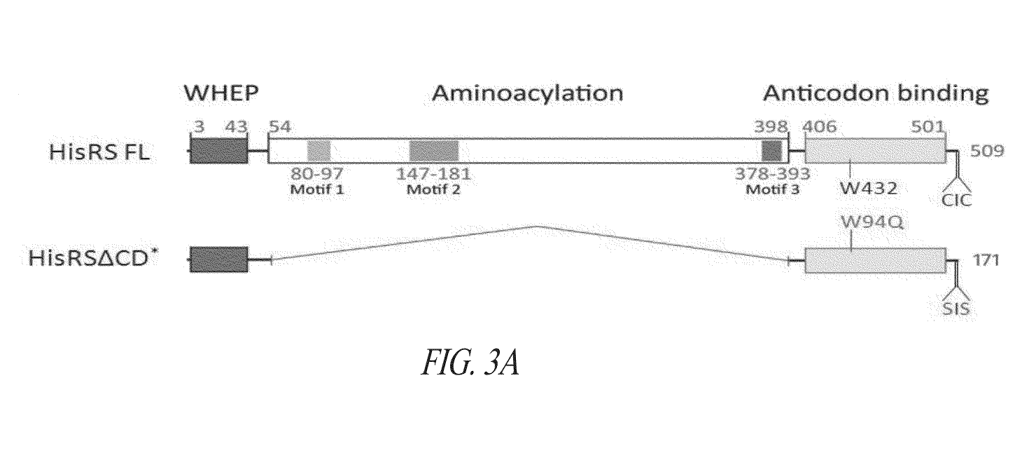

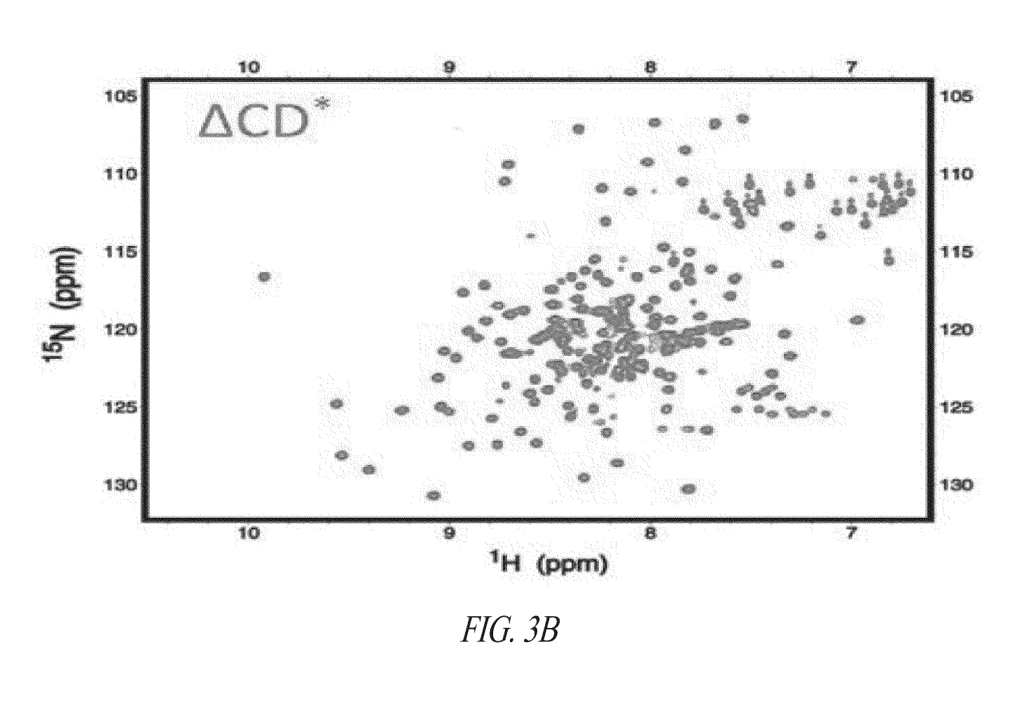

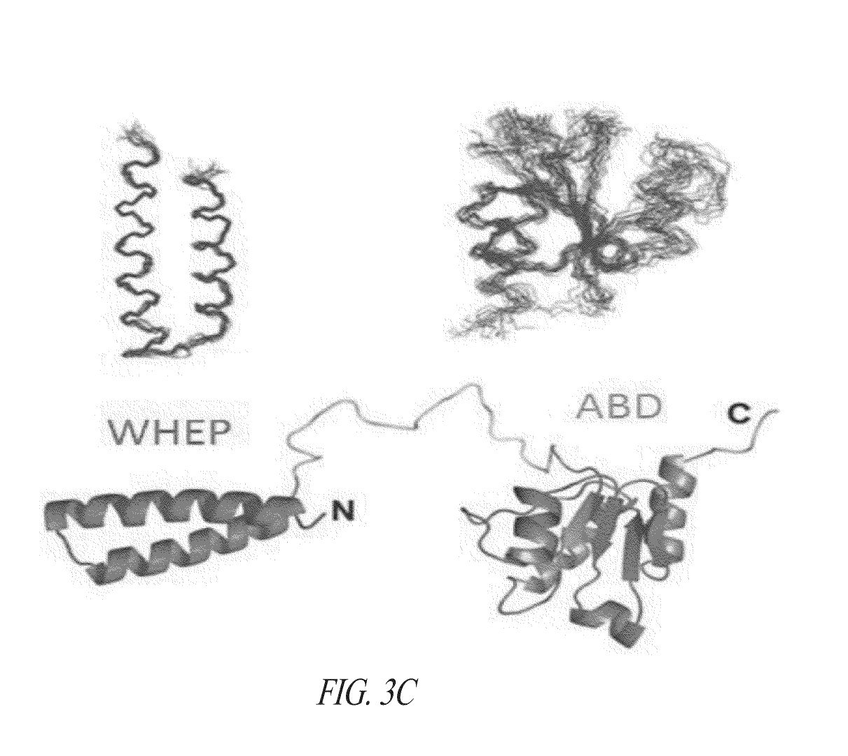

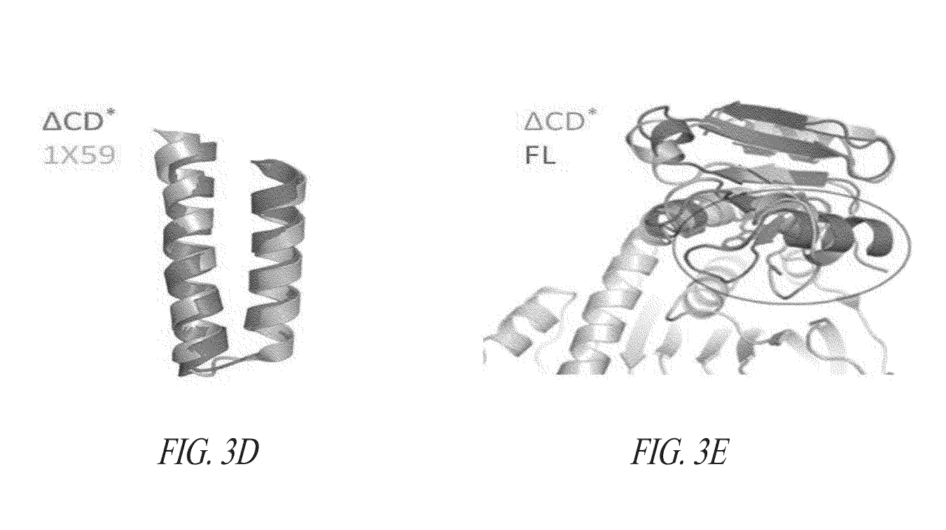

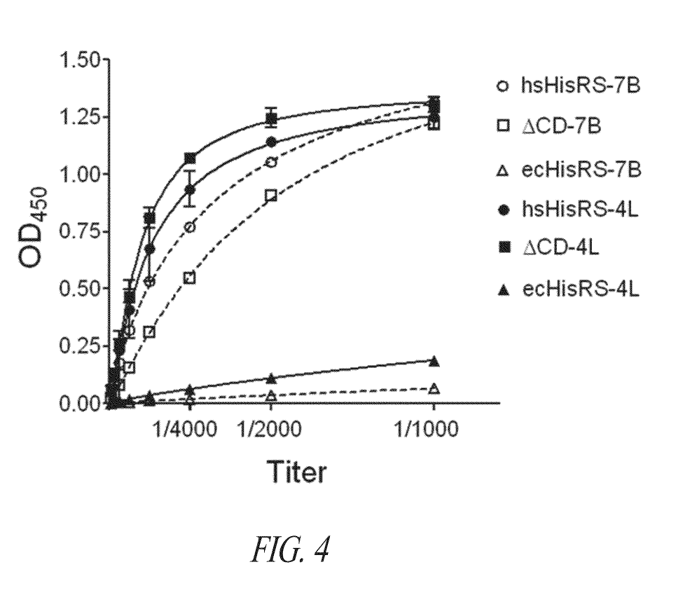

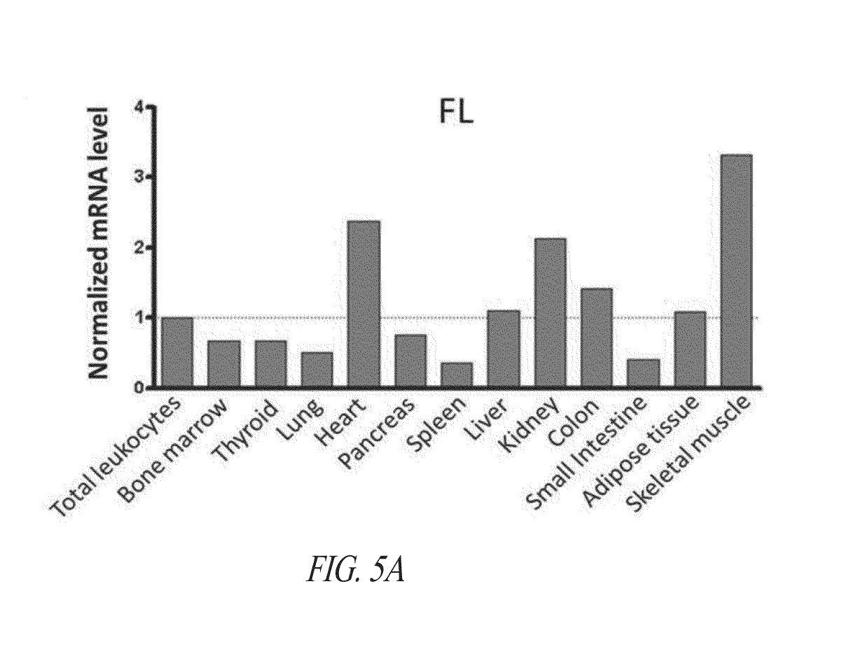

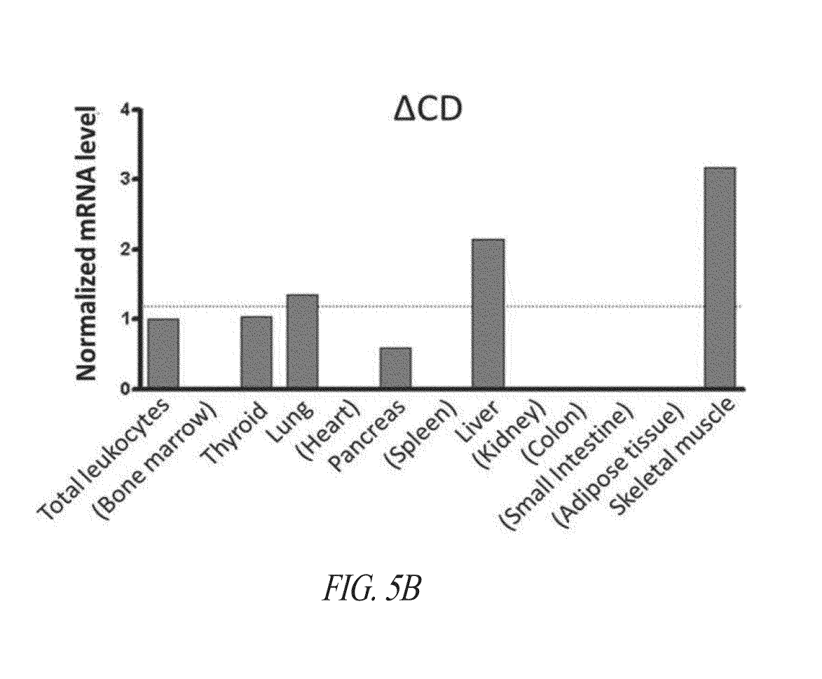

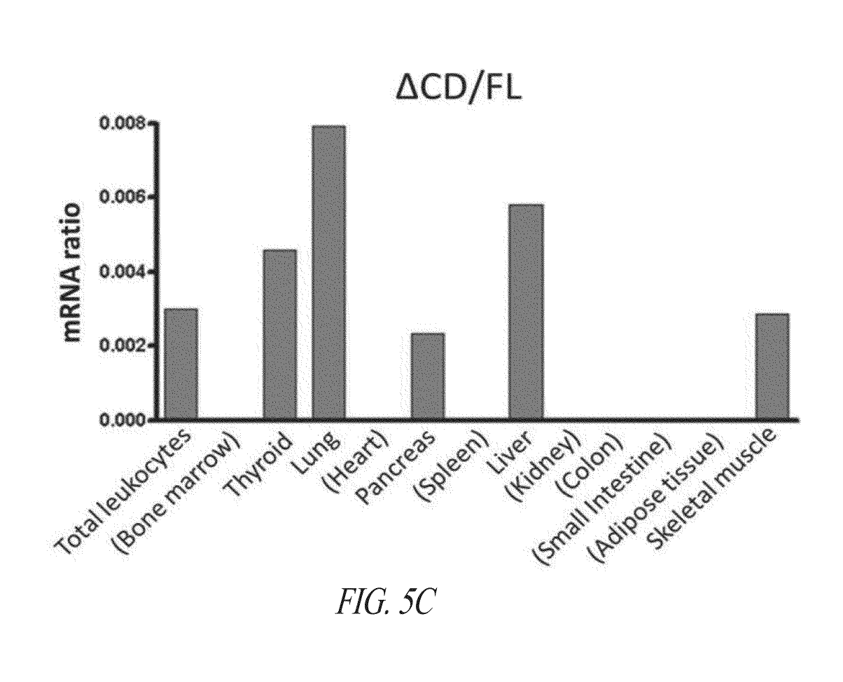

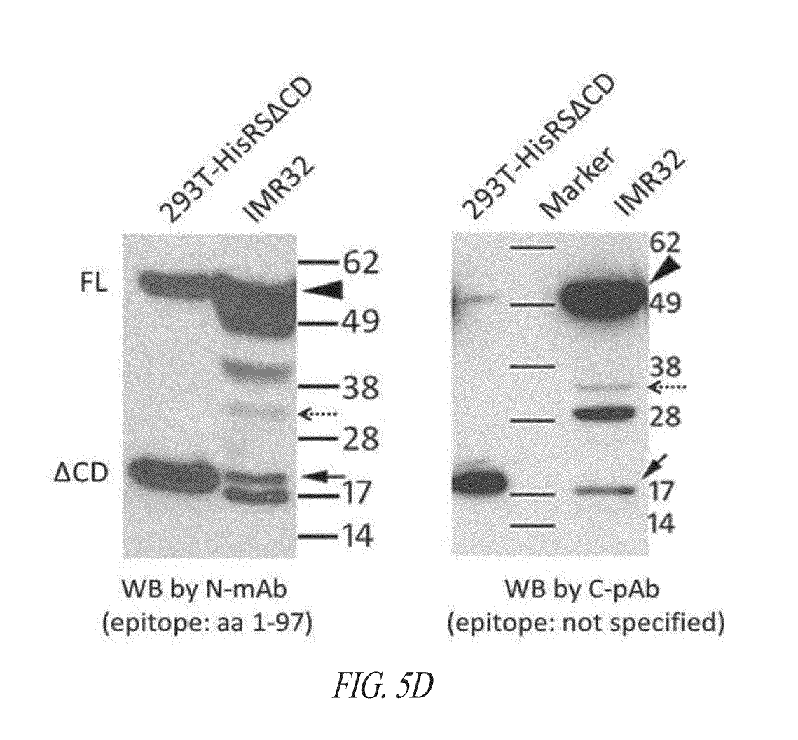

As noted above, certain embodiments of the present invention relate to X-ray crystallographic and NMR spectroscopy structures of human HRS polypeptides. For instance, the accompanying Examples describe the X-ray crystallographic structure of at least two human HRS variants, including the Δ507-509 (SEQ ID NO:5) and Δ1-53_{—}Δ507-509 (SEQ ID NO:6) variants of full-length human HRS (see Table S3 and FIG. 2 for structural coordinates/statistics). Further described is the NMR spectroscopy structure of a splice variant of full-length human HRS, having a deletion of the entire aminoacylation domain defined by residues 61-398 of SEQ ID NO:1, and also having three amino acid substitutions W94Q, C168S, and C170S (referred to as HRSΔCD_{—}2C2S_W94Q; SEQ ID NO:8) (see Table S4 and FIG. 3 for structural coordinates/statistics).

The atomic or structural coordinates provided by these X-ray and NMR structures can be employed in a variety of ways, including the discovery of agents that bind to and (selectively) modulate the canonical or non-canonical biological activities of an HRS polypeptide, anchor which modulate the interaction between an HRS polypeptide and a disease-related auto-antibody or auto-reactive immune cell. The discovery of such agents can include, for instance, the de novo design of agents, the selection of agents from a library of known agents, and/or the optimization (e.g., derivatization) of previously designed or previously known agents, among other possibilities apparent to persons skilled in the art drug design.

Accordingly, certain embodiments include methods of drug design, comprising the step of using the structural or atomic coordinates of a human histidyl tRNA synthetase (HRS) polypeptide comprising the coordinates of Table S2 or Table S3, to computationally evaluate an agent for its ability to associate with or bind to a binding site (or a binding pocket) of the HRS polypeptide. Certain methods computationally evaluate an agent that binds to the HRS polypeptide or a binding site thereof.

The terms “atomic coordinates” and “structure coordinates” include mathematical coordinates derived from mathematical equations related to the X-ray diffraction patterns obtained by diffracting X-rays off a crystal. The diffraction data are used to calculate an electron density map(s) of the repeating unit of the crystal, and the electron density map(s) are used to establish the positions of the individual atoms (i.e., the structure coordinates) within the unit cell of the crystal. These terms also include mathematical coordinates derived from Nuclear Overhauser Effect Spectroscopy (NOESY) experiments to measure distances between pairs of atoms within a protein, where the obtained distances are used to generate a 3D structure of the protein by solving a distance geometry problem.

The term “crystal” refers to any three-dimensional ordered array of molecules that diffracts X-rays to give spots. The term “crystallographic origin” refers to a reference point in the unit cell with respect to the crystallographic symmetry operation. In certain of the methods provided herein, the x-ray crystallographic structure is characterized by (i) a space group of P4₁2₁2 and unit cell dimensions of a=b=100.4 \acute{Å}, c=257.1 \acute{Å}, or (ii) a space group of P4₁2₁2 and unit cell dimensions of a=b=93.5 \acute{Å}, c=254.5 \acute{Å}. (see Table S3). Here, the term “unit cell” refers to a basic parallelepiped shaped block. The entire volume of crystal may be constructed by regular assembly of such blocks. Each unit cell comprises a complete representation of the unit of pattern, the repetition of which builds up the crystal. The term “space group” refers to the arrangement of symmetry elements of a crystal. The term “symmetry operation” refers to an operation in the given space group to place the same atom in one asymmetric unit cell to another, and the term “asymmetric unit” refers to a minimal set of atomic coordinates that can be used to generate the entire repetition in a crystal.

Persons skilled in the art understand that a set of structure coordinates determined by x-ray crystallography or NOESY spectroscopy may contain standard errors. Hence, in certain embodiments, a set of structure coordinates for an HRS polypeptide that has a root mean square deviation of backbone atoms of less than about 2.0, 1.5, 1.25, 1.0, 0.75, or 0.50 Angstroms (\acute{Å}) when superimposed on the structure coordinates of Table S3 or Table S4, can be considered structurally equivalent to the HRS structures described herein. The term “root mean square deviation” refers to the square root of the arithmetic mean of the squares of the deviations. It is a way to express the deviation or variation from a trend or object. The term “root mean square deviation” defines the variation in the backbone of a protein from the backbone of HRS or a binding site portion thereof, as defined by the structure coordinates of HRS described herein.

The terms “associates with” or “interacts with” refers to a condition of proximity between a chemical entity, agent, or portion(s) thereof, with another chemical entity, agent, or portion(s) thereof. The association or interaction may be non-covalent, i.e., where the juxtaposition is energetically favored by hydrogen bonding, van der Waals interactions, electrostatic interactions, or hydrophobic interactions, or it may be covalent. The term “binding site” or “binding pocket” refers to a region of an HRS polypeptide that binds to or interacts with a particular agent. In some instances, the binding site is an exposed site, or a site that is at least partially found on an exposed (e.g., solvent-exposed) surface of the three-dimensional representation or model of the HRS protein.

In some aspects, an agent is designed or selected based on its expected or predicted ability to bind or specifically bind to the HRS protein, or a binding site or binding pocket of the HRS polypeptide. In certain aspects, an agent binds or specifically binds to the HRS polypeptide, or to a binding site or binding pocket of the HRS polypeptide. In some instances, an agent is said to “bind” or “specifically bind” to an HRS polypeptide or binding site thereof if it reacts or is predicted to react at a detectable level (within, for example, an ELISA assay) with the polypeptide, and optionally does not react or is not predicted to react detectably in a statistically significant manner with unrelated polypeptides or other molecules under similar conditions. In certain illustrative embodiments, an agent has or is predicted to have an affinity for the HRS polypeptide or an HRS binding site of at least about 0.01, 0.05, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 40, or 50 nM.

Certain embodiments include methods of identifying an agent that binds to a human HRS polypeptide, comprising: (a) obtaining structural coordinates of (i) an x-ray crystallographic structure of human HRS as characterized by Table S2, or (ii) a three-dimensional nuclear magnetic resonance (NMR) spectroscopy structure of human HRS as characterized by Table S3, +/− a root mean square deviation from the backbone atoms that is not more than about 2.0 to 1.5 to 0.5 \acute{Å}; and (b) using the structural coordinates and one or more molecular modeling techniques to identify an agent that binds to the human HRS polypeptide.

The term “molecular modeling” includes the use of computers to draw a realistic model of what a molecule looks like, for instance, in either two or three dimensions, and can also include theoretical methods and computational techniques used to mimic the behavior of the molecule. The methods used in molecular modeling can range from molecular graphics to computational chemistry. The term “molecular model” refers to the three dimensional arrangement or representation of the atoms of a molecule connected by covalent bonds, optionally including the predicted surface of the molecule (e.g., space-filling models), and molecular graphics refers to the three-dimensional representation of the molecule on a graphical display device. The term “computational chemistry” includes calculations of the physical and chemical properties of a given molecule.

Using molecular modeling, rational drug design programs can analyze a range of different molecular structures of agents that may fit into a selected binding site or active site of an HRS polypeptide, and by moving or altering them on the computer screen can determine which structures might be expected to fit or hind to the site (see William Bains, Biotechnology from A to Z, second edition, 1998, Oxford University Press, page 259). For basic information on molecular modeling, see M. Schlecht, Molecular Modeling on the PC, 1998, John Wiley & Sons; Gans et al., Fundamental Principals of Molecular Modeling, 1996, Plenum Pub. Corp.; N. C. Cohen (editor), Guidebook on Molecular Modeling in Drug Design, 1996, Academic Press; and W. B. Smith, Introduction to Theoretical Organic Chemistry and Molecular Modeling, 1996; A. R. Leach, Molecular Modeling: Principles and Applications, 2001; D. C. Rapaport, The Art of Molecular Dynamics Simulation, 2004; K. I. Ramachandran, G Deepa and Krishnan Namboori. P. K. Computational Chemistry and Molecular Modeling Principles and Applications, 2008; and U.S. Pat. Nos. 6,093,573; 6,080,576; 5,612,894; 5,583,973; 5,030,103; 4,906,122; and 4,812,12, each of which is incorporated by reference in its entirety.

Embodiments of the present invention allow the use of molecular and computer modeling techniques to identify agents that interact with human HRS. Certain aspects therefore include methods of identifying an agent that binds to a human histidyl-tRNA synthetase (HRS) polypeptide, comprising: (a) generating a three-dimensional model or representation of human HRS on a digital computer, where the three-dimensional representation has (i) the x-ray crystallographic structure coordinates of Table S2, or (ii) the three-dimensional nuclear magnetic resonance (NMR) spectroscopy structure coordinates of Table S3, +/− a root mean square deviation from the backbone atoms that is not more than 1.5 \acute{Å}; and (b) using the three-dimensional representation from (a) to identify an agent that binds to the HRS polypeptide. In certain aspects, the step of identifying includes the de novo design of an agent. In some instances, the step of identifying includes selecting an agent from a library of known agents. In particular instances, the step of identifying includes the alteration or derivatization of a previously identified agent, for instance, to optimize its ability to bind to a targeted site of HRS.

In some embodiments, the methods provided herein allow for computationally screening small molecule databases for agents that can bind to human HRS. In this type of screening, the quality of fit of such agents to the binding site may be analyzed, for instance, by shape complementarity or estimated interaction energy. In some aspects, these and related methods use software comprised by the digital computer to select the agent from a library of existing small molecules, or to de novo design the small molecule. In particular aspects, the digital computer comprises a library of candidate small molecules, and (b) comprises using software comprised by the digital computer to select the small molecule from the library of candidates. Typically, the library of candidate small molecules is part of a chemical database, containing information about chemical and crystal structures, spectra, reactions and syntheses, and thermophysical data, among other information. In some aspects, the chemical database contains information on properties such as structure (i.e., the structural coordinates or the expected positions of constituent atoms), absolute and relative (interaction) energies, electronic charge distributions, dipoles and higher multipole moments, vibrational frequencies, reactivity or other spectroscopic quantities, and cross sections for collision with other particles. In particular aspects, the chemical database contains information on the 3D conformation of the library of small molecules, allowing the skilled artisan, for instance, to search the database by matching the 3D conformation of the molecules to that of the HRS polypeptide, and/or by specifying spatial constraints. Exemplary approximate methods include BCUTS, special function representations, moments of inertia, ray-tracing histograms, maximum distance histograms, and shape multipoles, among others. See Pearlman et al., J. Chem. Inf. Comput. Sci. 39:28-35, 1999; Lin et al., JCIM. 45:1010-1016, 2005; Meek et al., DDT. 19-20:895-904, 2006; Grant et al., JCIC. 17:1653-1666, 1996; Ballester et al., Proc R Soc A. 463:1307-1321, 2007; and Rahman et al., Journal of Cheminformatics. 1:12, 2009.

In certain aspects, the three-dimensional representation of human HRS can be used to derivatize (e.g., virtually derivatize) an agent such as small molecule and thereby alter its ability or predicted ability to bind to the HRS polypeptide. As one example, a known or previously identified binding agent of HRS can be virtually derivatized, for instance, by altering its 3D conformation or polarity, including the presence, absence, or number of hydrophobic centroids, aromatic rings, hydrogen bond acceptors or donor, cations, and anions, to optimize its predicted association with the 3D representation of the HRS polypeptide. Additional exemplary alterations include substitutions of one or more atoms or side groups. In some instances, the initial substitutions are conservative, where the replacement group has approximately the same size, shape, hydrophobicity, and/or charge as the original group. Such derivatized chemical compounds may then be analyzed for efficiency of fit to HRS by the same computer methods described supra. If desired, such derivatized agents can then be obtained (e.g., synthesized) and empirically tested for their ability to associate with and/or modulate one or more activities of the HRS polypeptide, and optionally repeatedly derivatized (e.g., virtually derivatize) and tested to further optimize the interaction between the agent and the HRS polypeptide.

Certain aspects include methods of generating a pharmacophore, comprising: (a) generating a three-dimensional representation of human HRS on a digital computer, where the three-dimensional representation has (i) the x-ray crystallographic structure coordinates of Table S2, or (ii) the three-dimensional nuclear magnetic resonance (NMR) spectroscopy structure coordinates of Table S3, +/− a root mean square deviation from the backbone atoms that is not more than 1.5 \acute{Å}; and (b) using the three-dimensional representation from (a) to generate the pharmacophore. A “pharmacophore” is an abstract description of molecular features which are necessary for molecular recognition of a ligand or other agent by a biological macromolecule. More specifically, the term “pharmacophore” refers to an ensemble of steric and electronic features that ensure the optimal supramolecular interactions between an agent and a specific biological target structure (e.g., macromolecule such as a protein). Certain aspects include (c) using the pharmacophore of (b) to identify (e.g., design or select) an agent that binds to the HRS polypeptide.

Exemplary pharmacophore features include hydrophobic centroids, aromatic rings, hydrogen bond acceptors or donor, cations, and anions. These pharmacophoric points may be located on the agent itself or may be projected points presumed to be located in the target structure. The features typically need to match different chemical groups with similar properties, in order to identify (novel) binding agents. Agent-target structure interactions are often characterized as “polar positive,” “polar negative” or “hydrophobic.” A well-defined pharmacophore model includes both hydrophobic volumes and hydrogen bond vectors. In modern computational chemistry, pharmacophores can be used to define the essential features of one or more agents with the same biological activity. A database of diverse chemical agents can then be searched for more molecules which share the same features arranged in the same relative orientation. Hence, in certain aspects, a pharmacophore may be used to de novo design or virtually screen one or more candidate agents that comprise all or most of the ensemble of steric and electronic features present in the pharmacophore, and that are predicted to associate with a targeted binding site of HRS, and optionally agonize or antagonize a biological response or other interaction between HRS and a binding partner. Exemplary computer software programs such as Phase, MOE, ICM-Chemist, ZINCPharmer, Discovery Studio, and LigandScout can be employed to model the pharmacophore using a variety of computational chemistry methods.

Once a compound has been designed or selected by the above methods, the efficiency which that compound may bind to HRS may be tested and optimized by computational evaluation. In some instances, an agent will demonstrate a relatively small difference in energy between its bound and free states (i.e., a small deformation energy of binding). Thus, in some aspects, a relatively efficient HRS-binding agent can be designed with a deformation energy of binding of less than about 10 kcal/mole, or preferably less than about 7 kcal/mole (e.g., less than about 10, 9, 8, 7, 6, or 5 kcal/mole). In some instances, the deformation energy of binding is taken to be the difference between the energy of the free compound and the average energy of the conformations observed when the inhibitor binds to the HRS polypeptide. A compound designed or selected as binding to HRS can also be computationally optimized to reduce or minimize in its bound state any repulsive electrostatic interaction with the desired binding site of the HRS polypeptide. Such non-complementary (e.g., electrostatic) interactions include repulsive charge-charge, dipole-dipole and charge-dipole interactions. In particular instances, the sum of all the electrostatic interactions between the agent and the HRS polypeptide, in their bound state, preferably make a neutral or favorable contribution to the enthalpy of binding. Computer software is available to evaluate compound deformation energy and electrostatic interactions.

Exemplary “agents” or “binding agents” include small molecules, polypeptides such as antibodies, peptides, peptide mimetics, peptoids, adnectins, and aptamers, among others.

In certain embodiments, an agent or binding agent may include one or more small molecules, A “small molecule” refers to an organic compound that is of synthetic or biological origin (biomolecule), but is typically not a polymer. Organic compounds refer to a large class of chemical compounds whose molecules contain carbon, typically excluding those that contain only carbonates, simple oxides of carbon, or cyanides. A “biomolecule” refers generally to an organic molecule that is produced by a living organism, including large polymeric molecules (biopolymers) such as peptides, polysaccharides, and nucleic acids as well, and small molecules such as primary secondary metabolites, lipids, phospholipids, glycolipids, sterols, glycerolipids, vitamins, and hormones. A “polymer” refers generally to a large molecule or macromolecule composed of repeating structural units, which are typically connected by covalent chemical bond. In certain embodiments, a small molecule has a molecular weight of less than 1000-2000 Daltons, typically between about 300 and 700 Daltons, and including about 50, 100, 150, 200, 250, 300, 350, 400, 450, 500, 550, 500, 650, 600, 750, 700, 850, 800, 950, 1000 or 2000 Daltons. Small molecule libraries are described elsewhere herein

Certain agents include polypeptides or proteins, described elsewhere herein. In certain aspects, the polypeptide agent (or candidate agent) is an antibody, or an antigen-binding fragment thereof. The typical antibody or immunoglobulin is a “Y”-shaped molecule composed of four polypeptide chains; two identical heavy chains and two identical light chains, which are connected by disulfide bonds. The term antibody includes variations of the same, such as FABs, humanized antibodies, modified human antibodies, Fv fragments, single chain Fv (sFv) polypeptides, nonhuman antibodies, single domain antibodies (sdAbs or “nanobodies”), and other derivatives of the immunoglobulin fold that underly immune system ligands for antigens, as described herein and known in the art.

An “antigen-binding site,” or “binding portion” of an antibody, refers to the part of the immunoglobulin molecule that participates in antigen binding. The antigen binding site is formed by amino acid residues of the N-terminal variable (“V”) regions of the heavy (“H”) and light (“L”) chains. Three highly divergent stretches within the V regions of the heavy and light chains are referred to as “hypervariable regions” which are interposed between more conserved flanking stretches known as “framework regions,” or “FRs.” Thus the term “FR” refers to amino acid sequences which are naturally found between and adjacent to hypervariable regions in immunoglobulins. In an antibody molecule, the three hypervariable regions of a light chain and the three hypervariable regions of a heavy chain are disposed relative to each other in three dimensional space to form an antigen-binding surface. The antigen-binding surface is complementary to the three-dimensional surface of a bound antigen, and the three hypervariable regions of each of the heavy and light chains are referred to as “complementarity-determining regions,” or “CDRs.”

As noted above, “peptides” are included as agents. The term peptide typically refers to a polymer of amino acid residues and to variants and synthetic analogues of the same. In certain embodiments, the term “peptide” refers to relatively short polypeptides, including peptides that consist of about 2, 3, 4, 5, 6, 7, 8, 9, 10, 11, 12, 13, 14, 15, 16, 17, 18, 19, 20, 25, 30, 35, 40, 45, or 50 amino acids, including all integers and ranges (e.g., 5-10, 8-12, 10-15) in between. Peptides can be composed of naturally-occurring amino acids and/or non-naturally occurring amino acids, as described herein.

In addition to peptides consisting only of naturally-occurring amino acids, peptidomimetics or peptide analogs are also provided. Peptide analogs are commonly used in the pharmaceutical industry as non-peptide drugs with properties analogous to those of the template peptide. These types of non-peptide agents are termed “peptide mimetics” or “peptidomimetics” (Luthman et al., A Textbook of Drug Design and Development, 14:386-406, 2nd Ed., Harwood Academic Publishers (1996); Joachim Granter, Angew. Chem. Int. Ed. Engl., 33:1699-1720 (1994); Fauchere, Adv. Drug Res., 15:29 (1986); Veber and Freidinger TINS, p. 392 (1985); and Evans et al., J. Med. Chem. 30:229 (1987)). A peptidomimetic is a molecule that mimics the biological activity of a peptide but is no longer peptidic in chemical nature. Peptidomimetic compounds are known in the art and are described, for example, in U.S. Pat. No. 6,245,886.

Peptoids are also included as agents. Peptoid derivatives of peptides represent another form of modified peptides that retain the important structural determinants for biological activity, yet eliminate the peptide bonds, thereby conferring resistance to proteolysis (Simon, et al., PNAS USA. 89:9367-9371, 1992). Peptoids are oligomers of N-substituted glycines. A number of N-alkyl groups have been described, each corresponding to the side chain of a natural amino acid. The peptidomimetics of the present invention include agents in which at least one amino acid, a few amino acids or all amino acid residues are replaced by the corresponding N-substituted glycines. Peptoid libraries are described, for example, in U.S. Pat. No. 5,811,387

Aptamers are also included as binding agents (see, e.g. Ellington et al., Nature. 346, 818-22, 1990; and Tuerk et al., Science. 249, 505-10, 1990). Examples of aptamers included nucleic acid aptamers (e.g., DNA aptamers, RNA aptamers) and peptide aptamers. Nucleic acid aptamers refer generally to nucleic acid species that have been engineered through repeated rounds of in vitro selection or equivalent method, such as SELEX (systematic evolution of ligands by exponential enrichment), to bind to various molecular targets such as small molecules, proteins, nucleic acids, and even cells, tissues and organisms. See, e.g., U.S. Pat. Nos. 6,376,190; and 6,387,620.

Peptide aptamers typically include a variable peptide loop attached at both ends to a protein scaffold, a double structural constraint that typically increases the binding affinity of the peptide aptamer to levels comparable to that of an antibody's (e.g., in the nanomolar range). In certain embodiments, the variable loop length may be composed of about 10-20 amino acids (including all integers in between), and the scaffold may include any protein that has good solubility and compacity properties. Certain exemplary embodiments may utilize the bacterial protein Thioredoxin-A as a scaffold protein, the variable loop being inserted within the reducing active site (-Cys-Gly-Pro-Cys- loop in the wild protein), with the two cysteines lateral chains being able to form a disulfide bridge. Methods for identifying peptide aptamers are described, for example, in U.S. Application No. 2003/0108532. Peptide aptamer selection can be performed using different systems known in the art, including the yeast two-hybrid system.

Also included as agents are Adnectins™, Avimers™, and anticalins. Adnectins™ refer to a class of targeted biologics derived from human fibronectin, an abundant extracellular protein that naturally binds to other proteins. See, e.g., U.S. Application Nos. 2007/0082365; 2008/0139791; and 2008/0220049. Adnectins™ typically consists of a natural fibronectin backbone, as well as the multiple targeting domains of a specific portion of human fibronectin. The targeting domains can be engineered to enable an Adnectin™ to specifically recognize a therapeutic target of interest, such as an AARS protein fragment of the invention.

Avimers™ refer to multimeric binding proteins or peptides engineered using in vitro exon shuffling and phage display. Multiple binding domains are linked, resulting in greater affinity and specificity compared to single epitope immunoglobulin domains. See, e.g., Silverman et al., Nature Biotechnology. 23:1556-1561, 2005; U.S. Pat. No. 7,166,697; and U.S. Application Nos. 2004/0175756, 2005/0048512, 2005/0053973, 2005/0089932 and 2005/0221384.

Also included are designed ankyrin repeat proteins (DARPins), which include a class of non-immunoglobulin proteins that can offer advantages over antibodies for target binding in drug discovery and drug development. Among other uses, DARPins are ideally suited for in vivo imaging or delivery of toxins or other therapeutic payloads because of their favorable molecular properties, including small size and high stability. The low-cost production in bacteria and the rapid generation of many target-specific DARPins make the DARPin approach useful for drug discovery. Additionally, DARPins can be easily generated in multispecific formats, offering the potential to target an effector DARPin to a specific organ or to target multiple receptors with one molecule composed of several DARPins. See, e.g., Stumpp et al., Curr Opin Drug Discov Devel 10:153-159, 2007; U.S. Application No. 2009/0082274; and PCT/EP2001/10454.

Certain embodiments include “monobodies,” which typically utilize the 10th fibronectin type III domain of human fibronectin (FNfn10) as a scaffold to display multiple surface loops for target binding. FNfn10 is a small (94 residues) protein with a β-sandwich structure similar to the immunoglobulin fold. It is highly stable without disulfide bonds or metal ions, and it can be expressed in the correctly folded form at a high level in bacteria. The FNfn10 scaffold is compatible with virtually any display technologies. See, e.g., Batori et al., Protein Eng. 15:1015-20, 2002; and Wojcik et al., Nat Struct Mol Biol., 2010; and U.S. Pat. No. 6,673,901.

Anticalins refer to a class of antibody mimetics, which are typically synthesized from human lipocalins, a family of binding proteins with a hypervariable loop region supported by a structurally rigid framework. See, e.g., U.S. Application No. 2006/0058510. Anticalins typically have a size of about 20 kDa. Anticalins can be characterized by a barrel structure formed by eight antiparallel β-strands (a stable β-barrel scaffold) that are pairwise connected by four peptide loops and an attached α-helix. In certain aspects, conformational deviations to achieve specific binding are made in the hypervariable loop region(s). See, e.g., Skerra, FEBS J. 275:2677-83, 2008, herein incorporated by reference

In some embodiments, the agent or binding agent is an agonist. An “agonist” refers to an agent that intensifies or mimics a relevant activity of the HRS polypeptide, such as non-canonical biological activity. Included are partial and full agonists. In other embodiments, the agent or binding agent is an antagonist. The term “antagonist” refers to an agent that reduces or attenuates a relevant interaction or biological activity of an HRS polypeptide such as a non-canonical biological activity or interaction with a disease-associated antibody. Included are partial and full antagonists.

In some aspects, the agent or binding agent is a competitive inhibitor, uncompetitive non-competitive inhibitor of the interaction between the HRS polypeptide and a substrate, such as a cellular binding partner of the HRS polypeptide or an antibody (e.g., disease-associated antibody). The term “competitive inhibitor” refers to an inhibitor that binds to the same form of HRS as its substrate(s) bind, and directly competes with the substrate(s) for binding to the active site(s) of HRS. Competitive inhibition can be reversed partially or completely by increasing the substrate concentration. The term “uncompetitive inhibitor” refers to an inhibitor that binds to a different kinetic form of the HRS than does the substrate. For instance, such inhibitors bind to the substrate-bound form but not to the free form of HRS. Uncompetitive inhibition cannot be reversed completely by increasing the substrate concentration. The term “non-competitive inhibitor” refers to an inhibitor that binds to either the free or substrate bound form of HRS.

Further to the computational methods of using the structural information described herein to design, identify, or derivatize an HRS-binding agent, certain methods include synthesizing or otherwise obtaining the agent; and (d) contacting the agent with the HRS polypeptide to measure the ability of the agent to modulate at least one non-canonical and/or canonical activity of a HRS polypeptide. Also included are methods of assessing the structure-activity relationship (SAR) of the agent, to correlate its structure with modulation of the non-canonical and/or canonical activity, and optionally derivatizing the agent to alter its ability to modulate the non-canonical and/or canonical activity. Hence, certain embodiments can employ a variety of in vitro or cellular binding and/or activity assays.

In certain embodiments, in vitro systems may be designed to screen agents for their ability to associate with and/or modulate the activity of an HRS polypeptide. Certain of the agents identified by such systems may be useful, for example, in modulating the activity of the pathway, and in elaborating components of the pathway itself. They may also be used in screens for identifying other agents that disrupt interactions between components of the pathway; or may disrupt such interactions directly. One exemplary approach involves preparing a reaction mixture of the HRS polypeptide and a candidate agent under conditions and for a time sufficient to allow the two to interact and bind, thus forming a complex that can be removed from and/or detected in the reaction mixture.

In vitro screening assays can be conducted in a variety of ways. For example, an HRS polypeptide or the candidate agent(s) can be anchored onto a solid phase. In these and related embodiments, the resulting complexes may be captured and detected on the solid phase at the end of the reaction. In one example of such a method, the HRS polypeptide is anchored onto a solid surface, and the test agent(s), which are not anchored, are labeled, either directly or indirectly, so that their capture by the component on the solid surface can be detected. In other examples, the test agent(s) are anchored to the solid surface, and the HRS polypeptide, which is not anchored, is labeled or in some way directly or indirectly detectable. In certain embodiments, microtiter plates may conveniently be utilized as the solid phase. The anchored component (or test agent) may be immobilized by non-covalent or covalent attachments. Non-covalent attachment may be accomplished by simply coating the solid surface with a solution of the protein and drying. Alternatively, an immobilized antibody, preferably a monoclonal antibody, specific for the protein to be immobilized may be used to anchor the protein to the solid surface. The surfaces may be prepared in advance and stored.

To conduct an exemplary assay, the non-immobilized component is typically added to the coated surface containing the anchored component. After the reaction is complete, un-reacted components are removed (e.g., by washing) under conditions such that any specific complexes formed will remain immobilized on the solid surface. The detection of complexes anchored on the solid surface can be accomplished in a number of ways. For instance, where the previously non-immobilized component is pre-labeled, the detection of label immobilized on the surface indicates that complexes were formed. Where the previously non-immobilized component is not pre-labeled, an indirect label can be used to detect complexes anchored on the surface; e.g., using a labeled antibody specific for the previously non-immobilized component (the antibody, in turn, may be directly labeled or indirectly labeled with a labeled anti-Ig antibody).

Alternatively, the presence or absence of binding of to a candidate agent can be determined, for example, using surface plasmon resonance (SPR) and the change in the resonance angle as an index, where the HRS polypeptide is immobilized onto the surface of a commercially available sensorchip (e.g., manufactured by Biacore™). According to a conventional method, the candidate agent is contacted therewith, and the sensorchip is illuminated with a light of a particular wavelength from a particular angle. The binding of a test agent can also be measured by detecting the appearance of a peak corresponding to the candidate agent by a method wherein an HRS polypeptide is immobilized onto the surface of a protein chip adaptable to a mass spectrometer, a candidate agent is contacted therewith, and an ionization method such as MALDI-MS, ESI-MS, FAB-MS and the like is combined with a mass spectrometer (e.g., double-focusing mass spectrometer, quadrupole mass spectrometer, time-of-flight mass spectrometer, Fourier transformation mass spectrometer, ion cyclotron mass spectrometer, and the like).

In certain embodiments, cell-based assays, membrane vesicle-based assays, or membrane fraction-based assays can be used to identify or characterized candidate agents that modulate interactions in the non-canonical pathway of the selected HRS polypeptide. To this end, cell lines that express an HRS polypeptide and/or a binding partner, or a fusion protein containing a domain or fragment of such proteins (or a combination thereof), or cell lines (e.g., COS cells, CHO cells, HEK293 cells, Hela cells) that have been genetically engineered to express such protein(s) or fusion protein(s) can be used. Test agent(s) that influence the non-canonical activity can be identified by monitoring a change (e.g., a statistically significant change) in that activity as compared to a control or a predetermined amount.

Antibodies to HRS polypeptides can also be used in screening assays, such as to identify an agent that specifically binds to the HRS polypeptide, confirm the specificity or affinity of an agent that binds to the HRS polypeptide, or identify the site of interaction between the agent and the HRS polypeptide. Disease-associated antibodies (e.g., anti-Jo-1 antibodies) can also be used to identify agents that antagonize or inhibit the binding of the disease-associated antibody to an HRS polypeptide. Included are assays in which the antibody is used as a competitive inhibitor of the agent, or vice versa. For instance, an antibody that specifically binds to the HRS polypeptide with a known affinity can act as a competitive inhibitor of a selected agent, and be used to calculate the affinity of the agent for the HRS polypeptide. Also, one or more antibodies that specifically bind to known epitopes or sites of an HRS polypeptide can be used as a competitive inhibitor to confirm whether or not the agent binds at that same site. Other variations will be apparent to persons skilled in the art.

Also included are any of the above methods, or other screening methods known in the art, which are adapted for high-throughput screening (HTS). HTS typically uses automation to run a screen of an assay against a library of candidate agents, for instance, an assay that measures an increase or a decrease in binding and/or a non-canonical activity, as described herein.

Any of the screening methods provided herein may utilize small molecule libraries or libraries generated by combinatorial chemistry. As one example, such libraries can be used to screen for small molecules that associate or interact with an HRS polypeptide. The HRS structure coordinates provided herein can then be used to model the association or interaction between the small molecule and the HRS polypeptide, and virtually derivatize or otherwise alter the small molecule to optimize that interaction. Libraries of chemical and/or biological mixtures, such as fungal, bacterial, or algal extracts, are known in the art. Examples of methods for the synthesis of molecular libraries can be found in: (Carell et al., 1994a; Carell et al., 1994b; Cho et al., 1993; DeWitt et al., 1993; Gallop et al., 1994; Zuckermann et al., 1994).

Libraries of agents may be presented in solution (Houghten et al., 1992) or on beads (Lam et al., 1991), on chips (Fodor et al., 1993), bacteria, spores (Ladner et al., U.S. Pat. No. 5,223,409, 1993), plasmids (Cull et al., 1992) or on phage (Cwirla et al., 1990; Devlin et al., 1990; Felici et al., 1991; Ladner et al., U.S. Pat. No. 5,223,409, 1993; Scott and Smith, 1990). Libraries useful for the purposes of the invention include, but are not limited to, (1) chemical libraries, (2) natural product libraries, and (3) combinatorial libraries comprised of random peptides, oligonucleotides and/or organic molecules.

Chemical libraries consist of structural analogs of known agents or agents that are identified as “hits” or “leads” via natural product screening. Natural product libraries are derived from collections of microorganisms, animals, plants, or marine organisms which are used to create mixtures for screening by: (1) fermentation and extraction of broths from soil, plant or marine microorganisms or (2) extraction of plants or marine organisms. Natural product libraries include polyketides, non-ribosomal peptides, and variants (non-naturally occurring) thereof. See, e.g., Cane et al., Science 282:63-68, 1998. Combinatorial libraries may be composed of large numbers of peptides or organic compounds as a mixture. They are relatively easy to prepare by traditional automated synthesis methods, PCR, cloning or proprietary synthetic methods.

More specifically, a combinatorial chemical library is a collection of diverse chemical agents generated by either chemical synthesis or biological synthesis, by combining a number of chemical “building blocks” such as reagents. For example, a linear combinatorial chemical library such as a polypeptide library is formed by combining a set of chemical building blocks (amino acids) in every possible way for a given compound length (i.e., the number of amino acids in a polypeptide agent). Millions of chemical agents can be synthesized through such combinatorial mixing of chemical building blocks.

For a review of combinatorial chemistry and libraries created therefrom, see, e.g. Hue and Nguyen, (2001) Comb. Chem. High Throughput Screen. 4:53-74; Lepre, (2001) Drug Discov. Today 6:133-140; Peng, (2000) Biomed. Chromatogr. 14:430-441; Bohm, H. J. and Stahl, M. (2000) Curr. Opin. Chem. Biol. 4:283-286; Barnes and Balasubramanian, (2000) Curr. Opin. Chem. Biol. 4:346-350; Lepre et al., (2000) Mass Septrom Rev. 19:139-161; Hall, (2000) Nat. Biotechnol. 18:262-262; Lazo and Wipf, (2000) J. Pharmacol. Exp. Ther. 293:705-709; Houghten, (2000) Ann. Rev. Pharmacol. Toxicol. 40:273-282; Kobayashi (2000) Curr. Opin. Chem. Biol. (2000) 4:338-345; Kopylov Spiridonova, (2000) Mol. Biol. (Musk) 34:1097-1113; Weber, (2000) Curr. Opin. Chem. Biol. 4:295-302; Dolle, (2000) J. Comb. Chem. 2:383-433; Floyd et al., (1999) Prog. Med. Chem. 36:91-168; Kundu et al., (1999) Prog. Drug Res. 53:89-156; Cabilly, (1999) Mol. Biotechnol. 12:143-148; Lowe, (1999) Nat. Prod. Rep. 16:641-651; Dolle and Nelson, (1999) J. Comb. Chem. 1:235-282; Czarnick and Keene, (1998) Curr. Biol. 8:R705-R707; Dolle, (1998) Mol. Divers. 4:233-256; Myers, (1997) Curr. Opin. Biotechnol. 8:701-707; and Pluckthun and Cortese, (1997) Biol. Chem. 378:443.

Devices for the preparation of combinatorial libraries are commercially available (see, e.g., 357 MPS, 390 MPS, Advanced Chem Tech, Louisville Ky. Symphony, Rainin, Woburn, Mass., 433A Applied Biosystems, Foster City, Calif., 9050 Plus, Millipore, Bedford, Mass.). In addition, numerous combinatorial libraries are themselves commercially available (see, e.g., ComGenex, Princeton, N.J., Asinex, Moscow, Ru, Tripos, Inc., St. Louis. Mo., ChemStar. Ltd., Moscow, RU, 3D Pharmaceuticals, Exton, Pa., Martek Biosciences, Columbia, Md., etc.).

As noted above, the atomic or structural coordinates of certain exemplary HRS polypeptides are provided in Table S3 and Table S4. Table S3 provides the data from x-ray crystallographic structures of the HRS polypeptides of SEQ ID NO:5 (HRSΔ507-509) and 6 (HRSΔ1-53_{—}Δ507-509), and Table S4 provides the NMR structural statistics for the family of 20 structures of the HRS polypeptide of SEQ ID NO:8 (HRSΔCD_{—}2C2S_W94Q). Certain embodiments thus include crystallized human histidyl-tRNA synthetase polypeptides, characterized by the structure coordinates of Table S3. For instance, particular embodiments include a crystallized human HRS polypeptide having a deletion of residues 507-509 of SEQ ID NO:1 (i.e., an HRS polypeptide of SEQ ID NO:5), which has the atomic coordinates in Table S3, including a structure that is characterized by a space group of P4₁2₁2 and unit cell dimensions of a=b=100.4 \acute{Å}, c=257.1 \acute{Å}. Some embodiments include a crystallized human HRS polypeptide having a deletion of residues 1-53 and residues 507-509 of SEQ ID NO:1 (i.e., an HRS polypeptide of SEQ ID NO:6), which has the atomic coordinates in Table S3, including a structure that is characterized by a space group of P4₁2₁2 and unit cell dimensions of a=b=93.5 \acute{Å}, c=254.5 \acute{Å}.

Data stored in a machine-readable storage medium that is capable of displaying a graphical three-dimensional representation of the structure of human HRS or a structurally homologous molecule, as identified herein, or portions thereof may be advantageously used for drug discovery. The structure coordinates of the chemical entity can be used to generate a three-dimensional image that can be computationally fit to the three-dimensional image of HRS or a structurally homologous molecule. The three-dimensional molecular structure encoded by the data in the data storage medium can then be computationally evaluated for its ability to associate with a candidate agent. When the molecular structures encoded by the data are displayed in a graphical three-dimensional representation on a computer screen, the HRS protein structure can also be visually inspected for potential association with a candidate agent.

Certain embodiments thus include a computer program for instructing a digital computer to perform the method of general three-dimensional model of a human histidyl-tRNA synthetase (HRS) polypeptide on a computer screen, where the three-dimensional model has (i) x-ray crystallographic structure coordinates of Table S2, or (ii) nuclear magnetic resonance (NMR) spectroscopy structure coordinates of Table S3, +/− a root mean square deviation from the backbone atoms that is not more than 1.5 \acute{Å}; and optionally the same or different computer program for instructing the digital computer to identify an agent that binds to the human HRS polypeptide. Certain aspects include a program for instructing the digital computer to de novo design or select an agent that binds to the human HRS polypeptide. Hence, in some aspects, the digital computer comprises a library of candidate agents, as described herein, and the computer program is for instructing the digital computer to identify (or select) the agent from the library of candidate agents.

Certain related aspects include a computer readable medium having computer-readable code embodied thereon, the computer-readable code comprising structural coordinates of a human histidyl-tRNA synthetase (HRS) polypeptide characterized by (a) the x-ray crystallographic structure of Table S2, or (b) the nuclear magnetic resonance (NMR) spectroscopy structure of Table S3, +/− a root mean square deviation from the backbone atoms that is not more than 1.5 \acute{Å}. In specific aspects, the crystallographic structure is characterized by (i) a space group of P4₁2₁2 and unit cell dimensions of a=b=100.4 \acute{Å}, c=257.1 \acute{Å}, or (ii) a space group of P4₁2₁2 and unit cell dimensions of a=b=93.5 \acute{Å}, c=254.5 \acute{Å}

### Histidyl-tRNA Synthetase Derived Polypeptides

Certain embodiments include histidyl-tRNA synthetase polypeptides, comprising a reference HRS amino acid sequence described herein, and variants thereof. Histidyl-tRNA synthetases belong to the class II tRNA synthetase family, which has three highly conserved sequence motifs. Class I and II tRNA synthetases are widely recognized as being responsible for the specific attachment of an amino acid to its cognate tRNA in a 2 step reaction: the amino acid (AA) is first activated by ATP to form AA-AMP and then transferred to the acceptor end of the tRNA. The cytosolic full length Histidyl-tRNA synthetases typically exist either as a cytosolic homodimer, or an alternatively spliced mitochondrial form.

More recently it has been established that some biological fragments, or alternatively spliced isoforms of eukaryotic histidyl-tRNA synthetases (Physiocrines, or HRS polypeptides), or in some contexts the intact synthetase, modulate certain cell-signaling pathways, or have anti-inflammatory properties. These activities, which are distinct from the classical role of tRNA synthetases in protein synthesis, are collectively referred to herein as “non canonical activities.” These Physiocrines may be produced naturally by either alternative splicing or proteolysis, and can act in a cell autonomous (i.e., within the host cell), or non-cell autonomous fashion (i.e., outside the host cell) to regulate a variety of homeostatic mechanisms. In addition, certain mutations or deletions relative to the full-length HRS polypeptide sequence confer increased activities, or altered biochemical and/or pharmacokinetic properties. The reference sequences of various exemplary HRS polypeptides are provided in Table D1.

TABLE D1
Exemplary HRS polypeptides

| | Type/ | | |
|---|---|---|---|
| | species/ | | |
| Name | Residues | Amino acid and Nucleic Acid Sequences | SEQ. ID. NO. |
| Full-length | Protein/ | MAERAALEELVKLQGERVRGLKQQKASAELIEEEVAKLLKLKAQ | SEQ ID NO: 1 |
| cytosolic | Human/ | LGPDESKQKFVLKTPKGTRDYSPRQMAVREKVFDVIIRCFKRHG | |
| wild type | | AEVIDTPVFELKETLMGKYGEDSKLIYDLKGQGGELLSLRYDLT | |
| | | VPFARYLAMNKLTNIKRYHIAKVYRRDNPAMTRGRYREFYQCDF | |
| | | DIAGNFDPMIPDAECLKIMCEILSSLQIGDFLVKVNDRRILDGM | |
| | | FAICGVSDSKFRTICSSVDKLDKVSWEEVKNMEVGEKGLAPEVA | |
| | | DRIGDYVQQHGGVSLVEQLLCQDPKLSQNKQALEGLGDLKKLFE | |
| | | YLTLFGIDDKISFDLSLARGLDYYTGVIYEAVLLQTPAQAGEEP | |
| | | LGVGSVAAGGRYDGLVGMFDPKGRKVPCVGLSIGCERIFSIVEQ | |
| | | RLEALEEKIRTTETQVLVASAQKKLLEERLKLVSELWDAGIKAE | |
| | | LLYKKNPKLLQNLQYCEEAGIPLVAIIGEQELKDGVIKLRSVTS | |
| | | REEVDVRREDLVEEIKRRTGQPLCIC | |
| Full length | Protein/ | MPLLGLLPRRAWASLLSQLLRPPCASCTGAVRCQSQVAEAVLTS | SEQ ID NO: 2 |
| mitochondrial | Human/ | QLKAHQEKPNFIIKTPKGTRDLSPQHMVVREKILDLVISCFKRH | |
| wild type | | GAKGMDTPAFELKETLTEKYGEDSGLMYDLKDQGGELLSLRYDL | |
| | | TVPFARYLAMNKVKKMKRYHVKGVWRRESPTIVQGRYREFCQCD | |
| | | FDIAGQFDPMIPDAECLKIMCEILSGLQLGFDLIKVNDRRIVDG | |
| | | MFAVCGVPESKFRAISCSSIDKLDKMAWKDVRHEMVVKKGLAPE | |
| | | VADRIGDYVQCHGGVSLVEQMFQKPRLSQNKQALEGLGDLKLLF | |
| | | EYLTLFGIADKISFDLSLARGLDYYTGVIYEAVLLQTPTQAGEE | |
| | | PLNVGSVAAGGRYDGLVGMFDPKGHKVPCVGLSIGVERIFYIVE | |
| | | QRMKTKGEKVRTTETQVFVATPQKNVLQERLKLIAELWDSGIKA | |
| | | EMLYKNNPKLLTQLHYCESTGIPLVVIIGEQELKEGVIKIRSVA | |
| | | SREEVAIKRENFVAEIQKRLSES | |
| HRS Δ1-44 | Protein/ | LGPDESKQKFVLKTPKGRRDYSPRQMAVREKVFDVIIRCFKRHG | SEQ ID NO: 3 |
| | Human/ | AEVIDTPVFELKETLMGKYGEDSKLIYDLKDQGGELLSLRYDLT | |
| | 45-509 | VPFARYLAMNKLTNIKRYHIAKVYRRDNPAMTRGRYREFYQCDF | |
| | | DIAGNFDPMIPDAECLKIMCEILSSLQIGDFLVKVNDRRILDGM | |
| | | FAICGVSDSKFRTICSSVDKLDKVSWEEVKNEMVGEKGLAPEVA | |
| | | DRIGDYVQQHGGVSLVEQLLQDPKLSQNKQALEGLGDLKLLFEY | |
| | | LTLFGIDDKISFDLSLARGLDYYTGVIYEAVLLQTPAQAGEEPL | |
| | | GVGSVAAGGRYDGLVGMFDPKGRKVPCVGLSIGVERIFSIVEQR | |
| | | LEALEEKIRTTETQVLVASAQKKLLEERLKLVSELWDAGIKAEL | |
| | | LYKKNPKLLNQLQYCEEAGIPLVAIIGEQELKDGVIKLRSVTSR | |
| | | EEVDVRREDLVEEIKRRTGQPLCIC | |
| HRS Δ1-53 | Protein/ | FVLKTPKGTRDYSPRQMAVREKVFDIIRCFKRHGAEVIDTPVFE | SEQ ID NO: 4 |
| | Human/ | LKETLMGKYGEDSKIYDLKDQGGELLSLRYDLTVPFARYLAMNK | |
| | 54-509 | LTNIKRYHIAKVYRRDNPAMTRGRYREFYQCDFDIAGNFDPMIP | |
| | | DAECLKIMCEILSSLQIGDFLVKVNDRRILDGMFAICGVSDKFR | |
| | | TICSSVDKLDKVSWEEVKNEMVGEKGLAPEVADRIGDYVQQHGG | |
| | | VSLVEQLLQDPKLSQNKQALEGLGDLKLLFEYLTLFGIDDKISF | |
| | | DLSLARGLDYYTGVIYEAVLLQTPAQAGEEPLGVGSVAAGGRYD | |
| | | GLVGMFDPKGRKVPCVGLSIGVERIFSIVEQRLEALEEKIRTTE | |
| | | TQVLVASAQKKLLEERLKLVSELWDAGIKAELLYKKNPKLLNQL | |
| | | QYCEEAGIPVAIIGEQELKDGVIKLRSVTSREEVDVRREDLVEE | |
| | | IKRRTGQPLCIC | |
| HRS Δ507-509 | Protein/ | MAERAALEELVKLQGERVRGLKQQKASAELIEEEVAKLLKLKAQ | SEQ ID NO: 5 |
| | Human/ | LGPDESKQKFVLKTPKGTRDYSPRQMAVREKVFDVIIRCFKRHG | |
| | 1-506 | AEVIDTPVFELKETLMGKYGEDSKLIYDLKDQGGELLSLRYDLT | |
| | | VPFARYLAMNKLTNIKRYHIAKVYRRDNPAMTRGRYREFYQCDF | |
| | | DIAGNFDPMIPDAECLKIMCEILSSLQIGDFLVKVNDRRILDGM | |
| | | FAICGVSDSKFRTICSSVDKLDKVSWEEVKNEMVGEKGLAPEVA | |
| | | DRIGDYVQQHGGVSLVEQLLQDPKLSQNKQALEGLGDLKLLFEY | |
| | | LTLFGIDDKISFDLSLARGLDYYTGVIYEAVLLQTPAQAGEEPL | |
| | | GVGSVAAGGRYDGLVGMFDPKGRKVPCVGLSIGVERIFSIVEQR | |
| | | LEALEEKIRTTETQVLVASAQKKLLEERLKLVSELWDAGIKAEL | |
| | | LYKKNPKLLNQLQYCEEAGIPLVAIIGGEQELKDGVIKLRSVTS | |
| | | REEVDVRREDLVEEIKRRTGQPL | |
| HRS Δ1-53_Δ507-509 | Protein/ | FVLKTPKGTRDYSPRQMAVREKVFDVIIRCFKRHGAEVIDTPVF | SEQ ID NO: 6 |
| | Human/ | ELKETLMGKYGEDSKLIYDLKDQGGELLSLRYDLTVPFARYLAM | |
| | 54-506 | NKLTNIKRYHIAKVYRRDNPAMTRGRYREFYQCDFDIAGNFDPM | |
| | | IPDAECLKIMCEILSSLQIGDFLVKVNDRRILDGMFAICGVSDS | |
| | | KFRTICSSVDKLDKVSWEEVKNEMVGEKGLAPEVADRIGDYVQQ | |
| | | HGGVSLVEQLLQDPKLSQNKQALEGLGDLKLLFEYLTLFGIDDK | |
| | | ISFDLSLARGLDYYTGVIYEAVLLQTPAQAGEEPLGVGSVAAGG | |
| | | RYDGLVGMFDPKGRKVPCVGLSIGVERIFSIVEQRLEALEEKIR | |
| | | TTETQVLVASAQKKLLEERLKLVSELWDAGIKAELLYKKNPKLL | |
| | | NQLQYCEEAGIPLVAIIGEQELKDGVIKLRSVTSREEVDVRRED | |
| | | LVEEIKRRTGQPL | |
| HRSΔCD | Protein/ | MAERAALEELVKLQGERVRGLKQQKASAELIEEEVAKLLKLKAQ | SEQ ID NO: 7 |
| | Human/ | LGPDESKQKFVLKTPKALEEKIRTTETQVLVASAQKKLLEERLK | |
| | 1-60/ | LVSELWDAGIKAELLYKKNPKLLNQQYCEEAGIPLVAIIGEQEL | |
| | 399-509 | KDGVIKLRSVTSREEVDVRREDLVEEIKRRTGQPLCIC | |
| HRSΔCD* | Protein/ | MAERAALEELVKLQGERVRGLKQQKASAELIEEEVAKLLKLKAQ | SEQ ID NO: 8 |
| | Human/ | LGPDESKQKFVLKTPKALEEKIRTTETQVLVASAQKKLLEERLK | |
| | 1-60/ | LVSELQDAGIKAELLLYKKNPKLLNQQYCEEAGIPLVAIIGEQE | |
| | 399-509 | LKDGVIKLRSVTSREEVDVRREDLVEEIKRRTGQPLSIS | |

A number of naturally occurring histidyl-tRNA synthetase single nucleotide polymorphisms (SNPs) and naturally occurring variants of the human gene have been sequenced, and are known in the art to be at least partially functionally interchangeable. Several such variants of histidyl-tRNA synthetase (i.e., representative histidyl-tRNA synthetase SNP's) are shown in Table D2.

TABLE D2
Human Histidyl tRNA synthetase SNPs

| Gene Bank | Nucleotide | Gene Bank | Nucleotide |
|---|---|---|---|
| Accession Number | Change | Accession Number | Change |
| rs193103291 | A/G | rs186312047 | A/G |
| rs192923161 | C/T | rs186176857 | C/T |
| rs192784934 | A/G | rs186043734 | C/G |
| rs192164884 | A/G | rs185867584 | C/T |
| rs192090865 | A/C | rs185828130 | A/G |
| rs192015101 | A/T | rs185537686 | A/G |
| rs191999492 | A/G | rs185440931 | C/T |
| rs191852363 | C/T | rs185100584 | A/C |
| rs191532032 | A/T | rs185077558 | C/T |
| rs191391414 | C/T | rs184748736 | C/G |
| rs191385862 | A/G | rs184591417 | C/T |
| rs191205977 | A/G | rs184400035 | C/G |
| rs191104160 | A/G | rs184098206 | C/T |
| rs190989313 | C/G | rs183982931 | C/T |
| rs190818970 | A/T | rs183942045 | A/G |
| rs190476138 | C/T | rs183854085 | A/G |
| rs190289555 | C/T | rs183430882 | G/T |
| rs190065567 | A/G | rs183419967 | A/C |
| rs189624055 | C/T | rs183366286 | A/G |
| rs189563577 | G/T | rs183084050 | C/T |
| rs189404434 | A/G | rs182948878 | C/T |
| rs189268935 | A/G | rs182813126 | A/G |
| rs189103453 | A/T | rs182498374 | A/G |
| rs188839103 | A/G | rs182161259 | A/T |
| rs188766717 | A/G | rs182119902 | C/T |
| rs188705391 | A/G | rs182106891 | C/T |
| rs188490030 | A/G | rs181930530 | A/G |
| rs188345926 | C/T | rs181819577 | A/G |
| rs188174426 | A/G | rs181706697 | C/T |
| rs187897435 | C/T | rs181400061 | G/T |
| rs187880261 | A/G | rs181240610 | G/T |
| rs187729939 | G/T | rs181150977 | A/C |
| rs187617985 | A/T | rs180848617 | A/G |
| rs187344319 | C/T | rs180765564 | A/G |
| rs187136933 | C/T | rs151330569 | C/G |
| rs186823043 | C/G | rs151258227 | C/T |
| rs186764765 | C/T | rs151174822 | C/T |
| rs186663247 | A/G | rs150874684 | C/T |
| rs186526524 | A/G | rs150589670 | A/G |
| rs150274370 | C/T | rs145059663 | C/T |
| rs150090766 | A/G | rs144588417 | C/T |
| rs149977222 | A/G | rs144457474 | A/G |
| rs149821411 | C/T | rs144322728 | C/T |
| rs149542384 | A/G | rs143897456 | -/C |
| rs149336018 | C/G | rs143569397 | G/T |
| rs149283940 | C/T | rs143476664 | C/T |
| rs149259830 | C/T | rs143473232 | C/G |
| rs149241235 | C/T | rs143436373 | G/T |
| rs149018062 | C/T | rs143166254 | A/G |
| rs148935291 | C/T | rs143011702 | C/G |
| rs148921342 | -/A | rs142994969 | A/G |
| rs148614030 | C/T | rs142880704 | A/G |
| rs148584540 | C/T | rs142630342 | A/G |
| rs148532075 | A/C | rs142522782 | -/AAAC |
| rs148516171 | C/T | rs142443502 | C/T |
| rs148394305 | -/AA | rs142305093 | C/T |
| rs148267541 | C/T | rs142289599 | A/G |
| rs148213958 | C/T | rs142088963 | A/C |
| rs147637634 | A/G | rs141765732 | A/C |
| rs147372931 | A/C/G | rs141386881 | A/T |
| rs147350096 | A/C | rs141291994 | A/G |
| rs147288996 | C/T | rs141285041 | C/T |
| rs147194882 | G/T | rs141220649 | C/T |
| rs147185134 | C/T | rs141147961 | -/C |
| rs147172925 | A/G | rs141123446 | -/A |
| rs147011612 | C/T | rs140516034 | A/G |
| rs147001782 | A/G | rs140169815 | C/T |
| rs146922029 | C/T | rs140005970 | G/T |
| rs146835587 | A/G | rs139699964 | C/T |
| rs146820726 | C/T | rs139555499 | A/G |
| rs146801682 | C/T | rs139447495 | C/T |
| rs146571500 | G/T | rs139364834 | -/A |
| rs146560255 | C/T | rs139362540 | A/G |
| rs146205151 | -/A | rs139300653 | -/A |
| rs146159952 | A/G | rs139251223 | A/G |
| rs145532449 | C/G | rs139145072 | A/G |
| rs145446993 | A/G | rs138612783 | A/G |
| rs145112012 | G/T | rs138582560 | A/G |
| rs138414368 | A/G | rs111863295 | C/T |
| rs138377835 | A/G | rs111519226 | C/G |
| rs138300828 | C/T | rs111314092 | C/T |
| rs138067637 | C/T | rs80074170 | A/T |
| rs138035024 | A/G | rs79408883 | A/C |
| rs137973748 | C/G | rs78741041 | G/T |
| rs137917558 | A/G | rs78677246 | A/T |
| rs117912126 | A/T | rs78299006 | A/G |
| rs117579809 | G/T | rs78085183 | A/T |
| rs116730458 | C/T | rs77844754 | C/T |
| rs116411189 | A/C | rs77585983 | A/T |
| rs116339664 | C/T | rs77576083 | A/G |
| rs116203404 | A/T | rs77154058 | G/T |
| rs115091892 | G/T | rs76999025 | A/G |
| rs114970855 | A/G | rs76496151 | C/T |
| rs114176478 | A/G | rs76471225 | G/T |
| rs113992989 | C/T | rs76085408 | G/T |
| rs113720830 | C/T | rs75409415 | A/G |
| rs113713558 | A/C | rs75397255 | C/G |
| rs113627177 | G/T | rs74336073 | A/G |
| rs113489608 | A/C | rs73791750 | C/T |
| rs113408729 | G/T | rs73791749 | A/T |
| rs113255561 | A/G | rs73791748 | C/T |
| rs113249111 | C/T | rs73791747 | A/T |
| rs113209109 | A/G | rs73273304 | C/T |
| rs113066628 | G/T | rs73271596 | C/T |
| rs112967222 | C/T | rs73271594 | C/T |
| rs112957918 | A/T | rs73271591 | A/G |
| rs112859141 | A/G | rs73271586 | A/T |
| rs112769834 | C/G | rs73271585 | A/G |
| rs112769758 | A/C | rs73271854 | A/G |
| rs112701444 | A/C | rs73271581 | C/T |
| rs112585944 | A/G | rs73271578 | A/T |
| rs112439761 | A/G | rs72800925 | G/T |
| rs112427345 | A/C | rs72800924 | C/T |
| rs112265354 | C/T | rs72800922 | A/T |
| rs112113896 | C/G | rs72432753 | -/A |
| rs112033118 | C/T | rs72427948 | -/A |
| rs112029988 | A/G | rs72388191 | -/A |
| rs72317985 | -/A | rs6873628 | C/T |
| rs71583608 | G/T | rs5871749 | -/C |
| rs67251579 | -/A | rs4334930 | A/T |
| rs67180750 | -/A | rs3887397 | A/G |
| rs63429961 | A/T | rs3776130 | A/C |
| rs61093427 | C/T | rs3776129 | C/T |
| rs61059042 | -/A | rs3776128 | A/G |
| rs60936249 | -/AA | rs3177856 | A/C |
| rs60916571 | -/A | rs2563307 | A/G |
| rs59925457 | C/T | rs2563306 | A/G |
| rs59702263 | -/A | rs2563305 | C/T |
| rs58302597 | C/T | rs2563304 | A/G |
| rs57408905 | A/T | rs2530242 | C/G |
| rs35790592 | A/C | rs2530241 | A/G |
| rs35609344 | -/A | rs2530240 | A/G |
| rs35559471 | -/A | rs2530239 | A/G |
| rs35217222 | -/C | rs2530235 | A/C |
| rs34903998 | -/A | rs2230361 | C/T |
| rs34790864 | C/G | rs2073512 | C/T |
| rs34732372 | C/T | rs1131046 | C/T |
| rs34291233 | -/C | rs1131045 | C/G |
| rs34246519 | -/T | rs1131044 | C/T |
| rs34176495 | -/C | rs1131043 | C/G |
| rs13359823 | A/G | rs1131042 | A/C |
| rs13182544 | A/C | rs1131041 | C/G |
| rs12653992 | A/C | rs1131040 | A/G |
| rs12652092 | A/G | rs1131039 | C/T |
| rs11954514 | A/C | rs1131038 | A/G |
| rs11745372 | C/T | rs1131037 | A/G |
| rs11548125 | A/G | rs1131036 | A/G |
| rs11548124 | C/G | rs1131035 | C/T |
| rs11344157 | -/C | rs1131034 | A/G |
| rs11336085 | -/A | rs1131033 | A/G |
| rs11318345 | -/A | rs1131032 | A/G |
| rs11309606 | -/A | rs1089305 | A/G |
| rs10713463 | -/A | rs1089304 | A/C |
| rs7706544 | C/T | rs1065342 | A/C |
| rs7701545 | A/T | rs1050252 | C/T |
| rs6880190 | C/T | rs1050251 | A/T |
| rs1050250 | A/G | rs145769024 | -/AAACAAAACAAAACA |
| | | | (SEQ ID NO: 17) |
| rs1050249 | C/T | rs10534452 | -/AAAAC |
| rs1050248 | A/C/T | rs10534451 | -/AAACAAAACA |
| | | | (SEQ ID NO: 18) |
| rs1050247 | C/T | rs59554063 | -/CAAAACAAAA |
| | | | (SEQ ID NO: 19) |
| rs1050246 | C/G | rs58606188 | -/CAAAACAAAACAAAA |
| | | | (SEQ ID NO: 20) |
| rs1050245 | C/T | rs71835204 | (LARGEDELETION)/- |
| rs1050222 | C/T | rs71766955 | (LARGEDELETION)/- |
| rs813897 | A/G | rs144998196 | -/AAACAAAACA |
| | | | (SEQ ID NO: 18) |
| rs812381 | C/G | rs68038188 | -/ACAAAACAAA |
| | | | (SEQ ID NO: 21) |
| rs811382 | C/T | rs71980275 | -/AAAAC |
| rs801189 | C/T | rs71848069 | -/AAAC |
| rs801188 | A/C | rs60987104 | -/AAAC |
| rs801187 | A/T | rs801185 | C/T |
| rs801186 | A/G | rs702396 | C/G |

Additionally homologs and orthologs of the human gene exist in other species, as listed in Table D3, and it would thus be a routine matter to select a naturally occurring amino acid, or nucleotide variant present in a SNP, or other naturally occurring homolog in place of any of the human HRS polypeptide sequences listed in Table D1.

TABLE D3
Homologs of Human Histidyl tRNA synthetase

| Type/ | | |
|---|---|---|
| species/Residues | Amino acid Sequences | SEQ ID NO: |
| Mus musculus | MADRAALEELVRLQGAHVRGLKEQKASAEQIEEEVTKLLKLKAQ | SEQ ID NO: 9 |
| | LGQDEGKQKFVLKTPKGTRDYSPRQMAVREKVFDVIIRCFKRHG | |
| | AEVIDTPVFELKETLTGKYGEDSKLIYDLKDQGGELLSLRYDLT | |
| | VPFARYLAMNKLTNIKRYHIAKVYRRDNPAMTRGRYREFYQCDF | |
| | DIAGQFDPMIPDAECLKIMCEILSSLQIGNFLVKVNDRRILDGM | |
| | FAVCGVPDSKFRTICSSVDKLDKVSWEEVKNEMVGEKGLAPEVA | |
| | DRIGDYVQQHGGVSLVEQLLQDPKLSQNKQAVEGLGDKKLLFEY | |
| | LILFGIDDKISFDLSLARGLDYYTGVIYEAVLLQMPTQAGEEPL | |
| | GVGSIAAGGRYDGLVGMFDPKGRKVPCVGLSIGVERIFSIVEQR | |
| | LEASEEKVRTTETQVLVASAQKKLLEERLKLVSELWDAGIKAEL | |
| | LYKKNPKLLNQLQYWEEAGIPLVAIIGEQELRDGVIKLRSVASR | |
| | EEVDVRREDLVEEIRRRTNQPLSTC | |
| Canis lupus | MAERAALEELVRQGERVRGLKQQKASAEQIEEEVAKLLKLKAQL | SEQ ID NO: 10 |
| familiaris | GPDEGKQKFVLKTPKGTRDYSPRQMAVREKVFDVIISCFKRHGA | |
| | EVIDTPVFELKETLTGKYGEDSKLIYDLKDQGGELLSLRYDLTV | |
| | PFARYLAMNKLTNIKRYHIAKVYRRDNPAMTRGRYREFYQCDFD | |
| | IAGQFDPMIPDAECLEIMCEILRSLQIGDFLVKVNDRRILDGMF | |
| | AICGVPDSKFRTICSSVDKLDKVSWEEVKNEMVGEKGLAPEVAD | |
| | HIGDYVQQHGGISLVEQLLQDPELSQNKQALEGLGDLKLLFEYL | |
| | TLFGIADKISFLLSLARGLDYYTGVIYEAVLLQTPVQAGEEPLG | |
| | VGSVAAGGRYDGLVGMFDPKGRKVPCVGLSIGVERIFSIVEQRL | |
| | EATEEKVRTTETQVLVASAQKKLLEERLKLVSELWNAGIKAELL | |
| | YKKNPKLLNQLQYCEEAGIPLVAIIGEQELKDGVIKLRSVASRE | |
| | EVDVPREDLVEEIKRRTSQPFCIC | |
| Bos taurus | MADRAALEDLVRVQGERVRGLKQQKASAEQIEEEVAKLLKLKAQ | SEQ ID NO: 11 |
| | LGPDEGKPKFVLKTPKGTRDYSPRQMAVREKVFDVIISCFKRHG | |
| | AEVIDTPVFELKETLTGKYGEDSKLIYDLKDQGGELLSLRYDLT | |
| | VPFARYLAMNKLTNIKRYHIAKVYRRDNPAMTRGRYREFYQCDF | |
| | DIAGQFDPMLPDAECLKIMCEILSSLQIGDFLVKVNDRRILDGM | |
| | FAICGVPDSKFRTICSSVDKLDKVSWEEVKNEMVGEKGLAPEVA | |
| | DRIGDYVQQHGGVSLVEQLLQDPKLSQNKQALEGLGDLKLLFEY | |
| | LTLFGIADKISFDLSLARGLDYYTGVIYEAVLLQPPARAGEEPL | |
| | GVGSVAAGGRYDGLVGMFDPKGRKVPCVGLSIGVERIFSIVEQR | |
| | LEALEEKVRTTETQVLVASAQKKLLEERLKISELWDAGIKAELL | |
| | YKKNPKLLNQLQYCEETGIPLVAIIGEQELKDGVIKLRSVASRE | |
| | EVDVRREDLVEEIKRRTSQPLCIC | |
| Rattus | MADRAALEELVRLQGAHVRGLKEQKASAEQIEEEVTKLLKLKAQ | SEQ ID NO: 12 |
| norvegicus | LGHDEGKQKFVLKTPKGTRDYSPRQMAVREKVFDVIIRCFKRHG | |
| | AEVIDTPVFELKETLTGKYGEDSKLIYDLKDQGGELLSLRYDLT | |
| | VPFARYLAMNKLTNIKRYHIAKVYRRDNPAMTRGRYREFYQCDF | |
| | IAGQFDPMIPDAECLKIMCEILSSLQIGNFQVKVNDRRILDGMF | |
| | AVCGVPDSKFRTICSSVDKLDKVSWEEVKNEMVGEKGLAPEVAD | |
| | RIGDYVQQHGGVSLVEQLLQDPKLSQNKQAVELGLGDLKLLFEY | |
| | LTLFGIDDKISFDLSLARGLDYYTGVIYEAVLLQMPTQAGEEPL | |
| | GVGSIAAGGRYDGLVGMFDPKGRKVPCVGLSIGVERIFSIVEQK | |
| | LEASEEKVRTTETQVLVASAQKKLLEERLKLISELWDAGIKAEL | |
| | LYKKNPKLLNQLQYCEEAGIPLVAIIGEQELKDGVIKLRSVTSR | |
| | EEVDVRREDLVEEIRRRTSQPLSM | |
| Gallus gallus | MADEAAVRQQAEVVRRLKQDKAEPDEIAKEVAKLLEMKAHLGGD | SEQ ID NO: 13 |
| | EGKHKFVLKTPKGTRDYGPKQMAIRERVFSAIIACFKRHGAEVI | |
| | DTPVFELKETLTGKYGEDSKLIYDLKDQGGELLSLRYDLTVPFA | |
| | RYLAMNKITNIKRYHIAKVYRRDNPAMTRGRYREFYQCDFDIAG | |
| | QFDPMIPDAECLKIVQEILSDLQLGDFLIKVNDRRILDGMFAVC | |
| | GVPDSKFRTICSSVDKLDKMPWEEVRNEMVGEKGLSPEAADRIG | |
| | EYVQLHGGMDLIEQLLQDPKLSQNKLVKEGLGDMKLLFEYLTLF | |
| | GITGKSIFDLSLARGLDYYTGVIYEAVLLQQNDHGEESVSVGSV | |
| | AGGGRYDGLVGMFDPKGRKVPCVGISIGIERIFSILEQRVEASE | |
| | EKIRTTETQVLVASAQKKLLEERLKLISELWDAGIKAEVLYKKN | |
| | PKLLNQLQYCEDTGIPLVAIVGEQELKDGVVKLRVVATGEEVNI | |
| | RRESLVEEIRRRTNQL | |
| Danio rerio | MAALGLVSMRLCAGLMGRRSAVRLHSLRVCSGMTISQIDEEVAR | SEQ ID NO: 14 |
| | LLQLKAQLGGDEGKHVGVLKTAKGTRDYNPKQMAIREKVFNIII | |
| | NCFKRHGAETIDSPVFELLKETLTGKYGEDSKLIYDLKDQGGEL | |
| | LSLRYDLTVPFARYLAMNKITNIKRYHIAKVYRRDNPAMTRGRY | |
| | REFYQCDFDIAGQYDAMIPDAECLKLVYEILSELDLGDFRIKVN | |
| | DRRILDGMFAICGVPDEKFRTICSTVDKLDKLAWEEVKKEMVNE | |
| | KGLSEEVADRIRDYVSMQGGKDLAERLLQDPKLSQSKQACAGIT | |
| | DMKLLFSYLELFQITDKVVFDLSLARGLDYYTGVIYEALTQANP | |
| | APASTPAEQNGAEDAGVSVGSVAGGGRYDGLVGMFDPKAGKCPV | |
| | WGSALALRGSSPSWSRRQSCLQRRCAPLKLKCLWLQHRRTF | |

Accordingly, in any of the methods, compositions and kits of the invention, the terms “HRS polypeptide” “HRS protein” or “HRS protein fragment” includes all naturally-occurring and synthetic forms of a reference histidyl-tRNA synthetase, which optionally comprise at least one epitope that specifically cross reacts with an auto-antibody or auto reactive T-cell from a disease associated with autoantibodies to histidyl tRNA synthetase, and/or which possesses a non canonical activity. Such HRS polypeptides include the full-length human protein, as well as the HRS peptides derived from the full length protein listed in Table D1, as well as naturally-occurring variants, for example as disclosed in Tables D2 and D3. In some embodiments, the term HRS polypeptide refers to a polypeptide sequence derived from human histidyl-tRNA synthetase (SEQ ID NO:1 in Table D1) of about 50 to about 250 amino acids in length.

### HRS Variants

Thus all such homologues, orthologs, and naturally-occurring, or synthetic isoforms of histidyl-tRNA synthetase (e.g., any of the proteins listed in Tables D1 to D3) are included in any of the methods, kits and pharmaceutical compositions of the invention, optionally as long as they retain at least one epitope which specifically cross reacts with an auto-antibody or auto reactive T-cell from a subject with a disease associated with autoantibodies to histidyl tRNA synthetase, and/or possess at least one non-canonical activity. The HRS polypeptides may be in their native form, i.e., as different variants as they appear in nature in different species which may be viewed as functionally equivalent variants of human histidyl-tRNA synthetase, or they may be functionally equivalent natural derivatives thereof, which may differ in their amino acid sequence, e.g., by truncation (e.g., from the N- or C-terminus or both) or other amino acid deletions, additions, insertions, substitutions, or post-translational modifications. Naturally-occurring chemical derivatives, including post-translational modifications and degradation products of any HRS polypeptide, are also specifically included in any of the methods and pharmaceutical compositions of the invention including, e.g., pyroglutamyl, iso-aspartyl, proteolytic, phosphorylated, glycosylated, oxidatized, isomerized, and deaminated variants of a HRS polypeptide. HRS polypeptides can also be composed of naturally-occurring amino acids and/or non-naturally occurring amino acids, as described herein.

In addition to HRS polypeptides consisting only of naturally-occurring amino acids, peptidomimetics or peptide analogs are also provided. Peptide analogs are commonly used in the pharmaceutical industry as non-peptide drugs with properties analogous to those of the template peptide. These types of non-peptide agents are termed “peptide nineties” or “peptidomimetics” (Luthman et al., A Textbook of Drug Design and Development, 14:386-406, 2nd Ed., Harwood Academic Publishers (1996); Joachim Grante, Angew. Chem. Int. Ed. Engl., 33:1699-1720 (1994); Fauchere, J., Adv. Drug Res., 15:29 (1986); Veber and Freidinger TINS, p. 392 (1985); and Evans et al., J. Med. Chem. 30:229 (1987)). A peptidomimetic is a molecule that mimics the biological activity of a peptide but is no longer peptidic in chemical nature. Peptidomimetic agents are known in the art and are described, for example, in U.S. Pat. No. 6,245,886.

It is known in the art to synthetically modify the sequences of proteins or peptides, while retaining their useful activity, and this may be achieved using techniques which are standard in the art and widely described in the literature, e.g., random or site-directed mutagenesis, cleavage, and ligation of nucleic acids, or via the chemical synthesis or modification of amino acids or polypeptide chains. Similarly it is within the skill in the art to address and/or mitigate immunogenicity concerns if they arise using a HRS polypeptide or variant thereof, e.g., by the use of automated computer recognition programs to identify potential T cell epitopes, and directed evolution approaches to identify less immunogenic forms.

As noted above, embodiments of the present invention include all homologues, orthologs, and naturally-occurring isoforms of histidyl-tRNA synthetase (e.g., any of the proteins, or their corresponding nucleic acids listed in Tables D1 to D3) which retain at least one epitope which specifically cross reacts with an auto-antibody or auto reactive T-cell from a subject with a disease associated with autoantibodies to histidyl tRNA synthetase. Also included are “variants” of these HRS reference polypeptides. The recitation polypeptide “variant” refers to polypeptides that are distinguished from a reference HRS polypeptide by the addition, deletion, and/or substitution of at least one amino acid residue, and which typically retain (e.g., mimic) or modulate (e.g., antagonize) one or more non-canonical activities of a reference HRS polypeptide. Variants also include polypeptides that have been modified by the addition, deletion, anchor substitution of at least one amino acid residue to have improved stability or other pharmaceutical properties. Further to the X-ray crystallographic and NMR structures of human HRS polypeptides described herein, the NMR structure of human histidyl tRNA synthetase WHEP domain (Nameki et al., Accession 1X59_A) has also been determined, which in conjunction with the primary amino acid sequence provide precise insights into the roles played by specific amino acids within the protein. Accordingly it is within the skill of those in the art to identify amino acids suitable for substitution and to design variants with substantially unaltered, improved, or decreased activity with no more than routine experimentation.

In certain embodiments, a polypeptide variant is distinguished from a reference polypeptide by one or more substitutions, which may be conservative or non-conservative, as described herein and known in the art. In certain embodiments, the polypeptide variant comprises conservative substitutions and, in this regard, it is well understood in the art that some amino acids may be changed to others with broadly similar properties without changing the nature of the activity of the polypeptide.

Specific examples of HRS polypeptide variants useful in any of the methods and compositions of the invention include full-length HRS polypeptides, or truncations or splice variants thereof (e.g., any of the proteins or nucleic acids listed in Tables D1 to D3) which have one or more additional amino acid substitutions, insertions, or deletions. In certain embodiments, a variant polypeptide includes an amino acid sequence having at least about 50%, 55%, 60%, 65%, 70%, 75%, 80%, 85%, 90%, 91%, 92%, 93%, 94%, 95%, 96%, 97%, 98% or more sequence identity or similarity to a corresponding sequence of a HRS reference polypeptide, as described herein, (e.g., any of the proteins or their corresponding nucleic acids listed in Tables D1 to D3), and substantially retains the non-canonical activity or auto-antibody/auto reactive T-cell binding properties of that reference polypeptide. Also included are sequences differing from the reference HRS sequences by the addition, deletion, or substitution of 1, 2, 3, 4, 5, 6, 7, 8, 9, 10, 11, 12, 13, 14, 15, 16, 17, 18, 19, 20, 30, 40, 50, 60, 70, 80, 90, 100, 110, 120, 130, 140, 150 or more amino acids but which retain the properties of the reference HRS polypeptide. In certain embodiments, the amino acid additions or deletions occur at the C-terminal end and/or the N-terminal end of the HRS reference polypeptide. In certain embodiments, the amino acid additions include 1, 2, 3, 4, 5, 6, 7, 8, 9, 10, 11, 12, 13, 14, 15, 16, 17, 18, 19, 20, 30, 40, 50 or more wild-type residues (i.e., from the corresponding full-length HRS polypeptide) that are proximal to the C-terminal end and/or the N-terminal end of the HRS reference polypeptide. In particular aspects, Trp94 (as defined by SEQ ID NO:7) or Trp432 (as defined by SEQ ID NO:1) is substituted with a relatively hydrophilic amino acid, such as Gln.

In some embodiments, the HRS polypeptides comprise a polypeptide fragment of the full-length histidyl-tRNA synthetase of about, up to about, or at least about 50 to about 250 to about 455 to about 465 amino acids, which comprises, or consists essentially of the amino acids of the HRS polypeptide sequence set forth in SEQ ID NO:1 (or an HRS reference sequence in Tables D1-D3). In some embodiments, the HRS polypeptide comprises one or more polypeptides selected from residues 45-509, 46-509, 47-509, 48-509, 49-509, 50-509, 51-509, 52-509, 53-509, 54-509, 55-509, 1-506, 45-506, 46-506, 47-506, 48-506, 49-506, 50-506, 51-506, 52-506, 53-506, 54-506 or 55-506 of SEQ ID NO:1.

In some aspects, the HRS polypeptide is a splice variant having a full or partial deletion of the aminoacylation domain (AD; or catalytic domain—CD). The aminoacylation domain is typically defined by residues 54-398 of full-length, wild-type human HRS (SEQ ID NO:1). Hence, certain embodiments include an HRS polypeptide having a deletion of about residues 54-398 of SEQ ID NO:1. In some aspects, the HRS polypeptide is selected from splice variants that comprise residues 1-60+399-509, or residues 1-60+399-506 of SEQ ID NO: 1. In specific embodiments, the HRS (splice) variant comprises a substitution of at least one of Trp94, Cys168, and Cys170 (e.g., Trp94Gln, Cys168Ser, Cys170Ser), the numbering of residues being defined by SEQ ID NO:7. In certain of these and related embodiments, the HRS polypeptide is about, up to about, or at least about 160-250, 160-200, 160-190, 160-180, 160-170, 170-250, 170-200, 170-190, 170-180, 180-250, 180-200, 180-190, 190-250, 190-200, or 200-250 amino acids in length, including those that are about, up to about, or at least about 160, 161, 162, 163, 164, 165, 166, 167, 168, 169, 170, 171, 172, 173, 714, 175, 176, 177, 178, 179, 180, 181, 182, 183, 184, 185, 186, 187, 188, 189, 190, 191, 192, 193, 194, 195, 196, 197, 198, 199, 200, 210, 220, 230, 240, or 250 or more amino acids in length, including all ranges of these values.

In certain embodiments, an HRS polypeptide of the invention comprises the minimal as live fragment of a full-length HRS polypeptide capable of modulating anti-inflammatory activity etc., in vivo or having antibody or auto-reactive T-cell blocking activities. In one aspect, such a minimal active fragment consists essentially of the WHEP domain, (i.e., about amino acids 1-43 of SEQ ID NO: 1). In some aspects, the minimal active fragment consists essentially of the aminoacylation domain, (i.e., about amino acids 54-398 of SEQ ID NO:1). In some aspects, of either of these embodiments, the minimal active fragment consists essentially of the anticodon binding domain (i.e., about amino acids 406-501 of SEQ ID NO:1).

In some embodiments, such minimal active fragments may comprise 1, 2, 3, 4, 5, 6, 7, 8, 9, 10, 12, 13, 14, 15, 16, 17, 18, 19, 20, 21, 22, 23, 24, 25, 26, 27, 28, or 29 amino acids of a flexible linker connecting the minimum domain to a heterologous protein, or splice variant.

Without wishing to be bound by any one theory, the unique orientation, or conformation, of the WHEP domain in certain HRS polypeptides may contribute to the enhanced non canonical, and/or antibody blocking activities observed in these proteins.

The recitations “sequence identity” or, for example, comprising a “sequence 50% identical to,” as used herein, refer to the extent that sequences are identical on a nucleotide-by-nucleotide basis or an amino acid-by-amino acid basis over a window of comparison. Thus, a “percentage of sequence identity” may be calculated by comparing two optimally aligned sequences over the window of comparison, determining the number of positions at which the identical nucleic acid base (e.g., A, T, C, G, I) or the identical amino acid residue (e.g., Ala, Pro, Ser, Thr, Gly, Val, Leu, Ile, Phe, Tyr, Trp, Lys, Arg, His, Asp, Glu, Asn, Gln, Cys and Met) occurs in both sequences to yield the number of matched positions, dividing the number of matched positions by the total number of positions in the window of comparison (i.e., the window size), and multiplying the result by 100 to yield the percentage of sequence identity.

Terms used to describe sequence relationships between two or more polypeptides include “reference sequence,” “comparison window,” “sequence identity,” “percentage of sequence identity” and “substantial identity.” A “reference sequence” is at least 12 but frequently 15 to 18 and often at least 25 monomer units, inclusive of nucleotides and amino acid residues, in length. Because two polypeptides may each comprise (1) a sequence (i.e., only a portion of the complete polypeptides sequence) that is similar between the two polypeptides, and (2) a sequence that is divergent between the two polypeptides, sequence comparisons between two (or more) polypeptides are typically performed by comparing sequences of the two polypeptides over a “comparison window” to identify and compare local regions of sequence similarity. A “comparison window” refers to a conceptual segment of at least 6 contiguous positions, usually about 50 to about 100, more usually about 100 to about 150 in which a sequence is compared to a reference sequence of the same number of contiguous positions after the two sequences are optimally aligned. The comparison window may comprise additions or deletions (i.e., gaps) of about 20% or less as compared to the reference sequence (which does not comprise additions or deletions) for optimal alignment of the two sequences. Optimal alignment of sequences for aligning a comparison window may be conducted by computerized implementations of algorithms (GAP, BESTFIT, FASTA, and TFASTA in the Wisconsin Genetics Software Package Release 7.0, Genetics Computer Group, 575 Science Drive Madison, Wis., USA) or by inspection and the best alignment (i.e., resulting in the highest percentage homology over the comparison window) generated by any of the various methods selected. Reference also may be made to the BLAST family of programs as for example disclosed by Altschul et al., 1997, Nucl. Acids Res. 25:3389. A detailed discussion of sequence analysis can be found in Unit 19.3 of Ausubel et al., “Current Protocols in Molecular Biology,” John Wiley & Sons Inc, 1994-1998, Chapter 15.

Calculations of sequence similarity or sequence identity between sequences (the terms are used interchangeably herein) can be performed as follows. To determine the percent identity of two amino acid sequences, or of two nucleic acid sequences, the sequences can be aligned for optimal comparison purposes (e.g., gaps can be introduced in one or both of a first and a second amino acid or nucleic acid sequence for optimal alignment and non-homologous sequences can be disregarded for comparison purposes). In certain embodiments, the length of a reference sequence aligned for comparison purposes is at least 30%, preferably at least 40%, more preferably at least 50%, 60%, and even more preferably at least 70%, 80%, 90%, 100% of the length of the reference sequence. The amino acid residues or nucleotides at corresponding amino acid positions or nucleotide positions are then compared. When a position the first sequence is occupied by the same amino acid residue or nucleotide as the corresponding position in the second sequence, then the molecules are identical at that position.

The percent identity between the two sequences is a function of the number of identical positions shared by the sequences, taking into account the number of gaps, and the length of each gap, which need to be introduced for optimal alignment of the two sequences.

The comparison of sequences and determination of percent identity between two sequences can be accomplished using a mathematical algorithm. In a preferred embodiment, the percent identity between two amino acid sequences is determined using the Needleman and Wunsch, (1970, J. Mol. Biol. 48: 444-453) algorithm which has been incorporated into the GAP program in the GCG software package, using either a Blossum 62 matrix or a PAM250 matrix, and a gap weight of 16, 14, 12, 10, 8, 6, or 4 and a length weight of 1, 2, 3, 4, 5, or 6. In yet another preferred embodiment, the percent identity between two nucleotide sequences is determined using the GAP program in the GCG software package, using a NWSgapdna.CMP matrix and a gap weight of 40, 50, 60, 70, or 80 and a length weight of 1, 2, 3, 4, 5, or 6. A particularly preferred set of parameters (and the one that should be used unless otherwise specified) are a Blossom 62 scoring matrix with a gap penalty of 12, a gap extend penalty of 4, and a frameshift gap penalty of 5. The percent identity between two amino acid or nucleotide sequences can also be determined using the algorithm of E. Meyers and W. Miller (1989, Cabios, 4: 11-17) which has been incorporated into the ALIGN program (version 2.0), using a PAM120 weight residue table, a gap length penalty of 12 and a gap penalty of 4.

The nucleic acid and protein sequences described herein can be used as a “query sequence” to perforce a search against public databases to, for example, identify other family members or related sequences. Such searches can be performed using the NBLAST and XBLAST programs (version 2.0) of Altschul, et al., (1990, J. Mol. Biol., 215: 403-10). BLAST nucleotide searches can be performed with the NBLAST program, score=100, wordlength=12 to obtain nucleotide sequences homologous to nucleic acid molecules of the invention. BLAST protein searches can be performed with the XBLAST program, score=50, wordlength=3 to obtain amino acid sequences homologous to protein molecules of the invention. To obtain gapped alignments for comparison purposes, Gapped BLAST can be utilized as described in Altschul et al., (1997, Nucleic Acids Res, 25: 3389-3402). When utilizing BLAST and Gapped BLAST programs, the default parameters of the respective programs (e.g., XBLAST and NBLAST) can be used.

In certain embodiments, variant polypeptides differ from the corresponding HRS reference sequences by at least 1% but less than 20%, 15%, 10% or 5% of the residues. (If this comparison requires alignment, the sequences should be aligned for maximum similarity. “Looped” out sequences from deletions or insertions, or mismatches, are considered differences.). The differences are, suitably, differences or changes at a non-essential residue or a conservative substitution. In certain embodiments, the molecular weight of a variant HRS polypeptide differs from that of the HRS reference polypeptide by about 1%, 2%, 3%, 4%, 5%, 6%, 7%, 8%, 9%, 10%, 11%, 12%, 13%, 14%, 15%, 16%, 17%, 18%, 19%, 20%, or more.

Also included are biologically active “fragments” of the HRS reference polypeptides, i.e., biologically active fragments of the HRS protein fragments. Representative biologically active fragments generally participate in an interaction, e.g., an intramolecular or an inter-molecular interaction. An inter-molecular interaction can be a specific binding interaction or an enzymatic interaction. An inter-molecular interaction can be between a HRS polypeptide and a cellular binding partner, such as a cellular receptor or other host molecule that participates in the non-canonical activity of the HRS polypeptide.

A biologically active fragment of an HRS reference polypeptide can be a polypeptide fragment which is, for example, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 110, 120, 130, 140, 150, 160, 170, 180, 190, 200, 220, 240, 260, 280, 300, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 38, 359, 360, 361, 362, 363, 364, 365, 380, 400, 450, 500, 505, or more contiguous or non-contiguous amino acids, including all integers (e.g., 101, 102, 103) and ranges (e.g., 50-100, 50-150, 50-200) in between, of the amino acid sequences set forth in any one of the HRS reference polypeptides described herein. In certain embodiments, a biologically active fragment comprises a non-canonical activity-related sequence, domain, or motif. In certain embodiments, the C-terminal or N-terminal region of any HRS reference polypeptide may be truncated by about 1, 2, 3, 4, 5, 6, 7, 8, 9, 10, 11, 12, 13, 14, 15, 16, 17, 18, 19, 20, 25, 30, 35, 40, 45, 50, 60, 70, 80, 90, 100, 110, 120, 130, 140, 150, 160, 170, 180, 190, 200, 250, 300, 350, 400, 450, 500 or more amino acids, or by about 10-50, 20-50, 50-100, 100-150, 150-200, 200-250, 250-300, 300-350, 350-400, 400-450, 450-500 or more amino acids, including all integers and ranges in between (e.g., 101, 102, 103, 104, 105), so long as the truncated HRS polypeptide retains the non-canonical activity of the reference polypeptide. Typically, the biologically-active fragment has no less than about 1%, 10%, 25%, or 50% of an activity of the biologically-active (i.e., non-canonical activity) HRS reference polypeptide from which it is derived. Exemplary methods for measuring such non-canonical activities are described in the Examples.

In some embodiments, HRS proteins, variants, and biologically active fragments thereof, bind to one or more cellular binding partners with an affinity of at least about 0.01, 0.05, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 40, 50, 100, or 150 nM. In some embodiments, the binding affinity of a HRS protein fragment for a selected cellular binding partner, particularly a binding partner that participates in a non-canonical activity, can be stronger than that of the corresponding full length HRS polypeptide or a specific alternatively spliced HRS polypeptide variant, by at least about 1.5×, 2×, 2.5×, 3×, 3.5×, 4×, 4.5×, 5×, 6×, 7×, 8×, 9×, 10×, 15×, 20×, 25×, 30×, 40×, 50×, 60×, 70×, 80×, 90×, 100×, 200×, 300×, 400×, 500×, 600×, 700×, 800×, 900×, 1000× or more (including all integers in between).

As noted above, a HRS polypeptide may be altered in various ways including amino acid substitutions, deletions, truncations, and insertions. Methods for such manipulations are generally known in the art. For example, amino acid sequence variants of a HRS reference polypeptide can be prepared by imitations in the DNA. Methods for mutagenesis and nucleotide sequence alterations are well known in the art. See, for example, Kunkel (1985, Proc. Natl. Acad. Sci. USA. 82: 488-492), Kunkel et al., (1987, Methods in Enzymol, 154: 367-382), U.S. Pat. No. 4,873,192, Watson, J. D. et al., (“Molecular Biology of the Gene”, Fourth Edition, Benjamin/Cummings, Menlo Park, Calif., 1987) and the references cited therein. Guidance as to appropriate amino acid substitutions that do not affect biological activity of the protein of interest may be found in the model of Dayhoff et al., (1978) Atlas of Protein Sequence and Structure (Natl. Biomed. Res. Found., Washington, D.C.).

Biologically active truncated and/or variant HRS polypeptides may contain conservative amino acid substitutions at various locations along their sequence, as compared to a reference HRS amino acid residue, and such additional substitutions may further enhance the activity or stability of the HRS polypeptides with altered cysteine content. A “conservative amino acid substitution” is one in which the amino acid residue is replaced with an amino acid residue having a similar side chain. Families of amino acid residues having similar side chains have been defined in the art, which can be generally sub-classified as follows:

Acidic: The residue has a negative charge due to loss of H ion at physiological pH and the residue is attracted by aqueous solution so as to seek the surface positions in the conformation of a peptide in which it is contained when the peptide is in aqueous medium at physiological pH. Amino acids having an acidic side chain include glutamic acid and aspartic acid.

Basic: The residue has a positive charge due to association with H ion at physiological pH or within one or two pH units thereof (e.g., histidine) and the residue is attracted by aqueous solution so as to seek the surface positions in the conformation of a peptide in which it is contained when the peptide is in aqueous medium at physiological pH. Amino acids having a basic side chain include arginine, lysine and histidine.

Charged: The residues are charged at physiological pH and, therefore, include amino acids having acidic or basic side chains (i.e., glutamic acid, aspartic acid, arginine, lysine and histidine).

Hydrophobic: The residues are not charged at physiological pH and the residue is repelled by aqueous solution so as to seek the inner positions in the conformation of a peptide in which it is contained when the peptide is in aqueous medium. Amino acids having a hydrophobic side chain include tyrosine, isoleucine, leucine, methionine, phenylalanine and tryptophan.

Neutral/polar: The residues are not charged at physiological pH, but the residue is not sufficiently repelled by aqueous solutions so that it would seek inner positions in the conformation of a peptide in which it is contained when the peptide is in aqueous medium. Amino acids having a neutral/polar side chain include asparagine, glutamine, cysteine, histidine, serine and threonine.

This description also characterizes certain amino acids as “small” since their side chains are not sufficiently large, even if polar groups are lacking, to confer hydrophobicity. With the exception of proline, “small” amino acids are those with four carbons or less when at least one polar group is on the side chain and three carbons or less when not. Amino acids having a small side chain include glycine, serine, alanine and threonine. The gene-encoded secondary amino acid proline is a special case due to its known effects on the secondary conformation of peptide chains. The structure of proline differs from all the other naturally-occurring amino acids in that its side chain is bonded to the nitrogen of the α-amino group, as well as the α-carbon. Several amino acid similarity matrices are known in the art (see e.g., PAM120 matrix and PAM250 matrix as disclosed for example by Dayhoff et al., 1978. A model of evolutionary change in proteins). Matrices for determining distance relationships In M. O. Dayhoff, (ed.), Atlas of protein sequence and structure, Vol. 5, pp. 345-358. National Biomedical Research Foundation, Washington D.C.; and by Gonnet et al., (Science, 256: 14430-1445, 1992), however, include proline in the same group as glycine, serine, alanine and threonine. Accordingly, for the purposes of the present invention, proline is classified as a “small” amino acid.

The degree of attraction or repulsion required for classification as polar or nonpolar arbitrary and, therefore, amino acids specifically contemplated by the invention have been classified as one or the other. Most amino acids not specifically named can be classified on the basis of known behavior.

Amino acid residues can be further sub-classified as cyclic or non-cyclic, and aromatic or non-aromatic, self-explanatory classifications with respect to the side-chain substituent groups of the residues, and as small or large. The residue is considered small if it contains a total of four carbon atoms or less, inclusive of the carboxyl carbon, provided an additional polar substituent is present; three or less if not. Small residues are, of course, always non-aromatic. Dependent on their structural properties, amino acid residues may fall in two or more classes. For the naturally-occurring protein amino acids, sub-classification according to this scheme is presented in Table A.

TABLE A
Amino acid sub-classification

| Sub-classes | Amino acids |
|---|---|
| Acidic | Aspartic acid, Glutamic acid |
| Basic | Noncyclic: Arginine, Lysine; Cyclic: Histidine |
| Charged | Aspartic acid, Glutamic acid, Arginine, Lysine, Histidine |
| Small | Glycine, Serine, Alanine, Threonine, Proline |
| Polar/neutral | Asparagine, Histidine, Glutamine, Cysteine, Serine, |
| | Threonine |
| Polar/large | Asparagine, Glutamine |
| Hydrophobic | Tyrosine, Valine, Isoleucine, Leucine, Methionine, |
| | Phenylalanine, Tryptophan |
| Aromatic | Tryptophan, Tyrosine, Phenylalanine |
| Residues that | Glycine and Proline |
| influence chain | |
| orientation | |

Conservative amino acid substitution also includes groupings based on side chains. For example, a group of amino acids having aliphatic side chains is glycine, alanine, valine, leucine, and isoleucine; a group of amino acids having aliphatic-hydroxyl side chains is serine and threonine; a group of amino acids having amide-containing side chains is asparagine and glutamine; a group of amino acids having aromatic side chains is phenylalanine, tyrosine, and tryptophan; a group of amino acids having basic side chains is lysine, arginine, and histidine; and a group of amino acids having sulphur-containing side chains is cysteine and methionine. For example, it is reasonable to expect that replacement of a leucine with an isoleucine or valine, an aspartate with a glutamate, a threonine with a serine, or a similar replacement of an amino acid with a structurally related amino acid will not have a major effect on the properties of the resulting variant polypeptide. Whether an amino acid change results in a functional truncated and/or variant HRS polypeptide can readily be determined by assaying its non-canonical activity, as described herein. Conservative substitutions are shown in Table B under the heading of exemplary substitutions. Amino acid substitutions falling within the scope of the invention, are, in general, accomplished by selecting substitutions that do not differ significantly in their effect on maintaining (a) the structure of the peptide backbone in the area of the substitution, (b) the charge or hydrophobicity of the molecule at the target site, (c) the bulk of the side chain, or (d) the biological function. After the substitutions are introduced, the variants are screened for biological activity.

TABLE B
Exemplary Amino Acid Substitutions

| Original | | |
|---|---|---|
| Residue | Exemplary Substitutions | Preferred Substitutions |
| Ala | Val, Leu, Ile | Val |
| Arg | Lys, Gln, Asn | Lys |
| Asn | Gln, His, Lys, Arg | Gln |
| Asp | Glu | Glu |
| Cys | Ser, Ala, Leu, Val | Ser, Ala |
| Gln | Asn, His, Lys, | Asn |
| Glu | Asp, Lys | Asp |
| Gly | Pro | Pro |
| His | Asn, Gln, Lys, Arg | Arg |
| Ile | Leu, Val, Met, Ala, Phe, Norleu | Leu |
| Leu | Norleu, Ile, Val, Met, Ala, Phe | Ile |
| Lys | Arg, Gln, Asn | Arg |
| Met | Leu, Ile, Phe | Leu |
| Phe | Leu, Val, Ile, Ala | Leu |
| Pro | Gly | Gly |
| Ser | Thr | Thr |
| Thr | Ser | Ser |
| Trp | Tyr | Tyr |
| Tyr | Trp, Phe, Thr, Ser | Phe |
| Val | Ile, Leu, Met, Phe, Ala, Norleu | Leu |

Alternatively, similar amino acids for making conservative substitutions can be grouped into three categories based on the identity of the side chains. The first group includes glutamic acid, aspartic acid, arginine, lysine, histidine, which all have charged side chains; the second group includes glycine, serine, threonine, cysteine, tyrosine, glutamine, asparagine; and the third group includes leucine, isoleucine, valine, alanine, proline, phenylalanine, tryptophan, methionine, as described in Zubay, G., Biochemistry, third edition, Wm.C. Brown Publishers (1993).

Thus, a predicted non-essential amino acid residue in a truncated anchor variant HRS polypeptide is typically replaced with another amino acid residue from the same side chain family. Alternatively, mutations can be introduced randomly along all or part of a HRS coding sequence, such as by saturation mutagenesis, and the resultant mutants can be screened for an activity of the parent polypeptide to identify mutants which retain that activity. Following mutagenesis of the coding sequences, the encoded peptide can be expressed recombinantly and the activity of the peptide can be determined. A “non-essential” amino acid residue is a residue that can be altered from the reference sequence of an embodiment polypeptide without abolishing or substantially altering one or more of its non canonical activities. Suitably, the alteration does not substantially abolish one of these activities, for example, the activity is at least 20%, 40%, 60%, 70% or 80% 100%, 500%, 1000% or more of the reference HRS sequence. An “essential” amino acid residue is a residue that, when altered from the reference sequence of a HRS polypeptide, results in abolition of an activity of the parent molecule such that less than 20% of the reference activity is present. For example, such essential amino acid residues include those that are conserved in HRS polypeptides across different species, including those sequences that are conserved in the active binding site(s) or motif(s) of HRS polypeptides from various sources.

### HRS Polynucleotides

Certain embodiments relate to polynucleotides that encode a HRS polypeptide. Among other uses, these embodiments may be utilized to recombinantly produce a desired HRS polypeptide or variant thereof, or to express the HRS polypeptide in a selected cell or subject. Representative naturally occurring nucleotide sequences encoding the native HRS polypeptides include for example GeneBank Accession Nos. AK000498.1 and U18937.1.

It will be appreciated by those of ordinary skill in the art that, as a result of the degeneracy of the genetic code, there are many nucleotide sequences that encode a HRS polypeptide as described herein. Some of these polynucleotides may bear minimal homology to the nucleotide sequence of any native gene. Nonetheless, polynucleotides that vary due to differences in codon usage are specifically contemplated by the present invention, for example polynucleotides that are optimized for human, yeast or bacterial codon selection.

Therefore, multiple polynucleotides can encode the HRS polypeptides of the invention. Moreover, the polynucleotide sequence can be manipulated for various reasons. Examples include but are not limited to the incorporation of preferred codons to enhance the expression of the polynucleotide in various organisms (see generally Nakamura et al., Nuc. Acid. Res. 28 (1): 292, 2000). In addition, silent mutations can be incorporated in order to introduce, or eliminate restriction sites, decrease the density of CpG dinucleotide motifs (see for example, Kameda et al., Biochem. Biophys. Res. Common. 349(4): 1269-1277, 2006) or reduce the ability of single stranded sequences to form stein-loop structures: (see, e.g., Zuker, Nucl. Acid Res. 31(13): 3406-3415, 2003). In addition, mammalian expression can be further optimized by including a Kozak consensus sequence [i.e., (a/g)cc(a/g)ccATGg] at the start codon. Kozak consensus sequences useful for this purpose are known in the art (Mantyh et al., PNAS. 92: 2662-2666, 1995; Mantyh et al., Prot. Exp. & Purif. 6,124, 1995). Exemplary wild type and codon optimized versions of various HRS polypeptide are provided in Table D4, below.

TABLE D4
Wild-Type and Codon Optimized DNA Sequence

| | Amino Acid | | |
|---|---|---|---|
| | Residue Range | | SEQ |
| Name | of SEQ ID NO: 1 | Nucleic acid sequence | ID NO: |
| Wild type | 1-509 | ATGGCAGAGCGTGCGGCGCTGGAGGAGCTGGTGAAAC | SEQ ID NO: 15 |
| (Full length | | TTCAGGGAGAGCGCGTGCGAGGCCTCAAGCAGCAGAA | |
| HisRS) | | GGCCAGCGCCGAGCTGATCGAGGAGGAGGTGGCGAAA | |
| | | CTCCTGAAACTGAAGGCACAGCTGGGTCCTGATGAAA | |
| | | GCAAACAGAAATTTGTGCTCAAAACCCCCAAGGGCAC | |
| | | AAGAGACTATAGTCCCCGGCAGATGGCAGTTCGCGAG | |
| | | AAGGTGTTTGACGTAATCATCCGTTGCTTCAAGCGCC | |
| | | ACGGTGCAGAAGTCATTGATCACCTGTATTTGAACTA | |
| | | AAGGAAACACTGATGGGAAAGTATGGGGAAGACTCCA | |
| | | AGCTTATCTATGACCTGAAGGACCAGGGCGGGGAGCT | |
| | | CCTGTCCCTTCGCTATGACCTCACTGTTCCTTTTGCT | |
| | | CGGTATTTGGCAATGAATAAACTGACCAACATTAAAC | |
| | | GCTACCACATAGCAAAGGTATATCGGCGGGATAACCC | |
| | | AGCCATGACCCGTGGCCGATACCGGGAATTCTACCAG | |
| | | TGTGATTTTGACATTGCTGGGAACTTTGATCCCATGA | |
| | | TCCCTGATGCAGAGTGCCTGAAGATCATGTGCGAGAT | |
| | | CCTGAGTTCACTTCAGATAGGCGACTTCCTGGTCAAG | |
| | | GTAAACGATCGACGCATTCTAGATGGGATGTTTGCTA | |
| | | TCTGTGGTGTTTCTGACAGCAAGTTCCGTACCATCTG | |
| | | CTCCTCAGTAGACAAGCTGGACAAGGTGTCCTGGGAA | |
| | | GAGGTGAAGAATGAGATGGTGGGAGAGAAGGGCCTTG | |
| | | CACCTGAGGTGGCTGACCGCATTGGGGACTATGTCCA | |
| | | GCAACATGGTGGGGTATCCCTGGTGGAACAGCTGCTC | |
| | | CAGGATCCTAAACTATCCCAAAACAAGCAGGCCTTGG | |
| | | AGGGCCTGGGAGACCTGAAGTTGCTCTTTGAGTACCT | |
| | | GACCCTATTTGGCATTGATGACAAAATCTCCTTTGAC | |
| | | CTGAGCCTTGCTCGAGGGCTGGATTACTACACTGGGG | |
| | | TGATCTATGAGGCAGTGCTGCTACAGACCCCAGCCCA | |
| | | GGCAGGGGAAGAGCCCCTGGGTGTGGGCAGTGTGGCT | |
| | | GCTGGAGGACGCTATGATGGGCTAGTGGGCATGTTCG | |
| | | ACCCCAAAGGGCGCAAGGTGCCATGTGTGGGGCTCAG | |
| | | CATTGGGGTGGAGCGGATTTTCTCCATCGTGGAACAG | |
| | | AGACTAGAGGCTTTGGAGGAGAAGATACGGACCACGG | |
| | | AGACACAGGTGCTTGTGGCATCTGCACAGAAGAAGCT | |
| | | GCTAGAGGAAAGACTAAAGCTTGTCTCAGAACTGTGG | |
| | | GATGCTGGGATCAAGGCTGAGCTGCTGTACAAGAAGA | |
| | | ACCCAAAGCTACTGAACCAGTTACAGTACTGTGAGGA | |
| | | GGCAGGCATCCCACTGGTGGCTATCATCGGCGAGCAG | |
| | | GAACTCAAGGATGGGGTCATCAAGCTCCGTTCAGTGA | |
| | | CGAGCAGGGAAGAGGTGGATGTCCGAAGAGAAGAGCC | |
| | | TTGTGGAGGAAATCAAAAGGAGAACAGGCCAGCCCCT | |
| | | CTGCATCTGC | |
| HRSΔCD/ | 1-60 + 399-509/ | ATGGCAGAGCGTGCGGCGCTGGAGGAGCTGGTGAAAC | SEQ ID NO: 16 |
| Δexons 3-10 | Exons 1-2 and | TTCAGGGAGAGCGCGTGCGAGGCCTCAAGCAGCAGAA | |
| | 11-13 | GGCCAGCGCCGAGCTGATCGAGGAGGAGGTGGCGAAA | |
| | | CTCCTGAAACTGAAGGCACAGCTGGGTCCTGATGAAA | |
| | | GCAAACAGAAATTTGTGCTCAAAACCCCCAAGGCTTT | |
| | | GGAGGAGAAGATACGGACCACGGAGACACAGGTGCTT | |
| | | GTGGCATCTGCACAGAAGAAGCTGCTAGAGGAAAGAC | |
| | | TAAAGCTTGTCTCAGAACTGTGGGATGCTGGGATCAA | |
| | | GGCTGAGCTGCTGTACAAGAAGAACCCAAAGCTACTG | |
| | | AACCAGTTACAGTACTGTGAGGAGGCAGGCATCCCAC | |
| | | TGGTGGCTATCATCGGCGAGCAGGAACTCAAGGATGG | |
| | | GGTCATCAAGCTCCGTTCAGTGACGAGCAGGGAAGAG | |
| | | GTGGATGTCCGAAGAGAAGACCTTGTGGAGGAAATCA | |
| | | AAAGGAGAACAGGCCAGCCCCTCTGCATCTGC | |

Additional coding or non-coding sequences may, but need not, be present within a polynucleotide of the present invention, and a polynucleotide may, but need not, be linked to other molecules and/or support materials. Hence, the polynucleotides of the present invention, regardless of the length of the coding sequence itself, may be combined with and operatively coupled to other DNA sequences, such as expression control sequences, including for example, promoters, polyadenylation signals. Additionally, the polynucleotides can further comprise restriction enzyme sites, multiple cloning sites, other coding segments, and the like, such that their overall length may vary considerably.

It is therefore contemplated that a polynucleotide fragment of almost any length may be employed; with the total length preferably being limited by the ease of preparation and use in the intended recombinant DNA protocol. Included are polynucleotides of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 41, 43, 44, 45, 46, 47, 48, 49, 50, 60, 70, 80, 90, 100, 110, 120, 130, 140, 150, 160, 170, 180, 190, 200, 220, 240, 260, 270, 280, 300, 350, 400, 450, 500, 550, 600, 650, 700, 750, 800, 850, 900, 950, 1000, 1100, 1200, 1300, 1400, 1500, 1600, 1700, 1800, 1900, 2000, 2100, 2200, 2300, 2400, 2500, 2600, 2700, 2800, 2900, 3000 or more (including all integers in between) bases in length, including any portion or fragment (e.g., greater than about 6, 7, 8, 9, or 10 nucleotides in length) of an HRS reference polynucleotide (e.g., base number X-Y, in which X is about 1-3000 or more and Y is about 10-3000 or more), or its complement.

Embodiments of the present invention also include “variants” of the HRS polypeptide reference polynucleotide sequences. Polynucleotide “variants” may contain one or ore substitutions, additions, deletions and/or insertions in relation to a reference polynucleotide. Generally, variants of an HRS polypeptide reference polynucleotide sequence may have at least about 30%, 40% 50%, 55%, 60%, 65%, 70%, generally at least about 75%, 80%, 85%, desirably about 90% to 95% or more, and more suitably about 98% or more sequence identity to that particular nucleotide sequence (for example, SEQ ID NOS:15 or 16) as determined by sequence alignment programs described elsewhere herein using default parameters. In certain embodiments, variants may differ from a reference sequence by about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 41, 43, 44, 45, 46, 47, 48, 49, 50, 60, 70, 80, 90, 100 (including all integers in between) or more bases. In certain embodiments, such as when the polynucleotide variant encodes a HRS polypeptide having a non-canonical activity, the desired activity of the encoded HRS polypeptide is not substantially diminished relative to the unmodified polypeptide. The effect on the activity of the encoded polypeptide may generally be assessed as described herein, including for example the methods described in the examples sections. In some embodiments, the variants can alter the aggregation state of the HRS polypeptides, for example to provide for HRS polypeptides that exist in different embodiments primarily as a monomer, dimer or multimer.

In some embodiments, the variants can include mutants in which the endogenous cysteine residues have been mutated to alternative amino acids, or deleted. Exemplary cysteine mutations include for example, any combination of the mutation, or deletion of Cys83, Cys174, Cys191, Cys196, Cys224, Cys235, Cys379, Cys455, Cys507 and Cys 509 of SEQ ID NO: 1. In some embodiments, such cysteine residues are mutated to an amino acid selected from the group consisting of Ser, Ala, Thr, Val, and Leu. In certain embodiments, amino acid residues for specific cysteine substitutions can be selected from naturally occurring substitutions that are found in HisRS orthologs from other species and organisms. Exemplary substitutions of this type are presented in Table D5.

TABLE D5
Naturally-occurring sequence variation at positions occupied by cysteine residues in human HRS

| Homo | | | | | | | | | | | | |
|---|---|---|---|---|---|---|---|---|---|---|---|---|
| sapiens | | | | | | | | | | | | |
| cysteine | P. | M. | B. | M. | R. | G. | X. | D. | D. | C. | S. | E. |
| residue # | troglodyte | mulatta | aturus | musculus | norvegicus | gallus | laevis | rerio | melanogaster | elegans | cerevisiae | coli |
| 83 | C | C | C | C | C | C | C | C | V | T | L | V |
| 174 | C | C | C | C | C | C | C | C | C | C | C | L |
| 191 | C | C | C | C | C | C | C | C | C | V | C | A/L |
| 196 | C | C | C | C | C | Q | H | Y | S | M | V | L/A |
| 224 | C | C | C | C | C | C | C | C | C | S | A | A |
| 235 | C | C | C | C | C | C | C | C | C | C | S | E |
| 379 | C | C | C | C | C | C | C | V | C | C | C | A |
| 455 | C | C | C | C | C | C | C | — | C | C | A | A |
| 507 | C | R | C | S | S | — | — | — | — | S/Q | S/E | — |
| 509 | C | C | C | C | — | — | — | — | — | I | I/G | — |

In some embodiments, the cysteines selected for mutagenesis are selected based on their surface exposure. Accordingly, in one aspect the cysteine residues selected for substitution are selected from Cys224, Cys235, Cys507 and Cys509. In some embodiments, of these cysteine mutants, the last three residues of HRS are deleted so as to delete residues 507 to 509. In some embodiments, of these cysteine mutants, the cysteines are selected so as to eliminate an intramolecular cysteine pair for example Cys174 and Cys191.

Certain embodiments include polynucleotides that hybridize to a reference HRS polynucleotide sequence, (such as for example, any of SEQ ID NOS:15 or 16) or to their complements, under stringency conditions described below. As used herein, the term “hybridizes under low stringency, medium stringency, high stringency, or very high stringency conditions” describes conditions for hybridization and washing. Guidance for performing hybridization reactions can be found in Ausubel et al., (1998, supra), Sections 6.3.1-6.3.6. Aqueous and non-aqueous methods are described in that reference and either can be used.

Reference herein to low stringency conditions include and encompass from at least about 1% v/v to at least about 15% v/v formamide and from at least about 1 M to at least about 2 M salt for hybridization at 42° C., and at least about 1 M to at least about 2 M salt for washing at 42° C. Low stringency conditions also may include 1% Bovine Serum Albumin (BSA), 1 mM EDTA, 0.5 M NaHPO₄ (pH 7.2), 7% SDS for hybridization at 65° C., and (i) 2×SSC, 0.1% SDS; or (ii) 0.5% BSA, 1 mM EDTA, 40 mM NaHPO₄ (pH 7.2), 5% SDS for washing at room temperature. One embodiment of low stringency conditions includes hybridization in 6× sodium chloride/sodium citrate (SSC) at about 45° C., followed by two washes in 0.2×SSC, 0.1% SDS at least at 50° C. (the temperature of the washes can be increased to 55° C. for low stringency conditions).

Medium stringency conditions include and encompass from at least about 16% v/v to at least about 30% v/v formamide and from at least about 0.5 M to at least about 0.9 M salt for hybridization at 42° C., and at least about 0.1 M to at least about 0.2 M salt for washing at 55° C. Medium stringency conditions also may include 1% Bovine Serum Albumin (BSA), 1 mM EDTA, 0.5 M NaHPO₄ (pH 7.2), 7% SDS for hybridization at 65° C., and (i) 2×SSC, 0.1% SDS; or (ii) 0.5% BSA, 1 mM EDTA, 40 mM NaHPO₄ (pH 7.2), 5% SDS for washing at 60-65° C. One embodiment of medium stringency conditions includes hybridizing in 6×SSC at about 45° C., followed by one or more washes in 0.2×SSC, 0.1% SDS at 60° C. High stringency conditions include and encompass from at least about 31% v/v to at least about 50% v/v formamide and from about 0.01 M to about 0.15 M salt for hybridization at 42° C., and about 0.01 M to about 0.02 M salt for washing at 55° C.

High stringency conditions also may include 1% BSA, 1 mM EDTA, 0.5 M NaHPO₄ (pH 7.2), 7% SDS for hybridization at 65° C., and (i) 0.2×SSC, 0.1% SDS; or (ii) 0.5% BSA, 1 mM EDTA, 40 mM NaHPO₄ (pH 7.2), 1% SDS for washing at a temperature in excess of 65° C. One embodiment of high stringency conditions includes hybridizing in 6×SSC at about 45° C., followed by one or more washes in 0.2×SSC, 0.1% SDS at 65° C. One embodiment of very high stringency conditions includes hybridizing in 0.5 M sodium phosphate, 7% SDS at 65° C., followed by one or more washes in 0.2×SSC, 1% SDS at 65° C.

Other stringency conditions are well known in the all and a skilled artisan will recognize that various factors can be manipulated to optimize the specificity of the hybridization. Optimization of the stringency of the final washes can serve to ensure a high degree of hybridization. For detailed examples, see Ausubel et al., supra at pages 2.10.1 to 2.10.16 and Sambrook et al. (1989, supra) at sections 1.101 to 1.104. While stringent washes are typically carried out at temperatures from about 42° C. to 68° C., one skilled in the art will appreciate that other temperatures may be suitable for stringent conditions. Maximum hybridization rate typically occurs at about 20° C. to 25° C. below the Tₘ for formation of a DNA-DNA hybrid. It is well known the art that the Tₘ is the melting temperature, or temperature at which two complementary polynucleotide sequences dissociate. Methods for estimating Tₘ are well known in the art (see Ausubel et al., supra at page 2.10.8).

In general, the Tₘ of a perfectly matched duplex of DNA may be predicted as an approximation by the formula: Tₘ=81.5+16.6 (log₁₀ M)+0.41 (% G+C)−0.63 (% formamide)−(600/length) wherein: M is the concentration of Na⁺, preferably in the range of 0.01 molar to 0.4 molar; % G+C is the sum of guanosine and cytosine bases as a percentage of the total number of bases, within the range between 30% and 75% G+C; % formamide is the percent formamide concentration by volume; length is the number of base pairs in the DNA duplex. The Tₘ of a duplex DNA decreases by approximately 1° C. with every ease of 1% in the number of randomly mismatched base pairs. Washing is generally carried out at Tₘ−15° C. for high stringency, or Tₘ−30° C. for moderate stringency.

In one example of a hybridization procedure, a membrane (e.g., a nitrocellulose membrane or a nylon enthrone) containing immobilized DNA is hybridized overnight at 42° C. in a hybridization buffer (50% deionized formamide, 5×SSC, 5×Denhardt's solution (0.1% ficoll, 0.1% polyvinylpyrollidone and 0.1% bovine serum albumin), 0.1% SDS and 200 mg/mL denatured salmon sperm DNA) containing a labeled probe. The membrane is then subjected to two sequential medium stringency washes (i.e., 2×SSC, 0.1% SDS for 15 min at 45° C., followed by 2×SSC, 0.1% SDS for 15 min at 50° C.), followed by two sequential higher stringency washes (i.e., 0.2×SSC, 0.1% SDS for 12 min at 55° C. followed by 0.2×SSC and 0.1% SDS solution for 12 min at 65-68° C.

### Modified HRS Polypeptides

Certain embodiments of the present invention also contemplate the use of modified HRS polypeptides, including modifications that improved the desired characteristics of a HRS polypeptide, as described herein. Modifications of HRS polypeptides of the invention include chemical and/or enzymatic derivatizations at one or more constituent amino acid, including side chain modifications, backbone modifications, and N- and C-terminal modifications including acetylation, hydroxylation, methylation, amidation, and the attachment of fusion proteins, carbohydrate or lipid moieties, cofactors, the substitution of D amino acids and the like. Exemplary modifications also include PEGylation of a HRS polypeptide (see e.g., Veronese and Harris, Advanced Drug Delivery Reviews 54: 453-456, 2002; and Pasut et al., Expert Opinion. Ther. Patents. 14(6) 859-894 2004, both herein incorporated by reference) In some embodiments, such PEGylated HRS polypeptides comprise a mutation to add or remove an endogenous cysteine, to enable selective coupling via an exogenous, or endogenous cysteine, or other residue.

PEG is a well-known polymer having the properties of solubility in water and in many organic solvents, lack of toxicity, and lack of immunogenicity. It is also clear, colorless, odorless, and chemically stable. For these reasons and others, PEG has been selected as the preferred polymer for attachment, but it has been employed solely for purposes of illustration and not limitation. Similar products may be obtained with other water-soluble polymers, including without limitations polyvinyl alcohol, other poly(alkylene oxides) such as poly(propylene glycol) and the like, poly(oxyethylated polyols) such as poly(oxyethylated glycerol) and the like, carboxymethylcellulose, dextran, polyvinyl alcohol, polyvinyl purrolidone, poly-1,3-dioxolane, poly-1,3,6-trioxane, ethylene/maleic anhydride, and polyaminoacids. One skilled in the art will be able to select the desired polymer based on the desired dosage, circulation time, resistance to proteolysis, and other considerations.

In particular a wide variety of PEG derivatives are both available and suitable for use in the preparation of PEG-conjugates. For example, NOF Corporation's PEG reagents sold under the trademark SUNBRIGHT® Series provides numerous PEG derivatives, including methoxypolyethylene glycols and activated PEG derivatives such as methoxy-PEG amines, maleimides, N-hydroxysuccinimide esters, and carboxylic acids, for coupling by various methods to the N-terminal, C-terminal or any internal amino acid of the AARS polypeptide. Nektar Therapeutics' Advanced PEGylation technology also offers diverse PEG-coupling technologies to potentially improve the safety and efficacy of an HRS polypeptide based therapeutic.

Patents, published patent applications, and related publications will also provide those skilled in the art reading this disclosure with significant possible PEG-coupling technologies and PEG-derivatives. See, e.g., U.S. Pat. Nos. 6,436,386; 5,932,462; 5,900,461; 5,824,784; and 4,904,584; the contents of which are incorporated by reference in their entirety, describe such technologies and derivatives, and methods for their manufacture.

In certain aspects, chemoselective ligation technology may be utilized to modify HRS polypeptides of the invention, such as by attaching polymers in a site-specific and controlled manner. Such technology typically relies on the incorporation of chemoselective anchors into the protein backbone by either chemical, or recombinant means, and subsequent modification with a polymer carrying a complementary linker. As a result, the assembly process and the covalent stricture of the resulting protein-polymer conjugate may be controlled, enabling the rational optimization of drug properties, such as efficacy and pharmacokinetic properties (Nee, e.g., Kochendoerfer, Current Opinion in Chemical Biology 9:555-560, 2005).

In other embodiments, fusion proteins of HRS polypeptide to other proteins are also included, and these fusion proteins may modulate the HRS polypeptide's biological activity, secretion, antigenicity, targeting, biological life, ability to penetrate cellular membranes, or the blood brain barrier, or pharmacokinetic properties. Examples of fusion proteins that improve pharmacokinetic properties (“PK modifiers”) include without limitation, fusions to human albumin (Osborn et al.: Eur. J. Pharmacol. 456(1-3): 149-158, (2002)), antibody Fc domains, poly Glu or poly Asp sequences, and transferrin. Additionally, fusion with conformationally disordered polypeptide sequences composed of the amino acids Pro, Ala, and Ser (‘PASylation’) or hydroxyethyl starch (sold under the trademark HESYLATION®) provides a simple way to increase the hydrodynamic volume of the HRS polypeptide. This additional extension adopts a bulky random structure, which significantly increases the size of the resulting fusion protein. By this means the typically rapid clearance of smaller HRS polypeptides via kidney filtration is retarded by several orders of magnitude. Additionally use of Ig G fusion proteins has also been shown to enable some fusion protein proteins to penetrate the blood brain barrier (Fu et al., (2010) Brain Res. 1352:208-13).

Examples of fusion proteins that modulate the antigenicity, or immunomodulatory properties of the HRS polypeptide include fusions to T cell binding ligands, including for example, MHC Class I and II proteins, b-2 microglobulin, portions of LFA-3, portions of the Fc region of the heavy chain, and conjugates and derivatives thereof; Examples of such fusion proteins are described in for example EP 1 964 854, U.S. Pat. Nos. 5,468,481; 5,130,297; 5,635,363; 6,451,314 and US 2009/0280135.

Additionally in some embodiments, the HRS polypeptide can include synthetic, or naturally occurring secretion signal sequences, derived from other well characterized secreted proteins. In some embodiments such proteins, may be processed by proteolytic cleavage to form the HRS polypeptide in situ. In some embodiments the HRS polypeptide can comprise heterologous proteolytic cleavage sites, to enable the in situ expression, and production of the HRS polypeptide either at an intracellular, or an extracellular location. Other fusions proteins may also include for example fusions of HRS polypeptide to ubiquitin to provide a new N-terminal amino acid, or the use of a secretion signal to mediate high level secretion of the HRS polypeptide into the extracellular medium, or N, or C-terminal epitope tags to improve purification or detection.

### Production of HRS Polypeptides

HRS polypeptide may be prepared by any suitable procedure known to those of skill in the art for example, by using standard solid-phase peptide synthesis (Merrifield, J. Am. Chem. Soc. 85:2149-2154 (1963)), or by recombinant technology using a genetically modified host. Protein synthesis may be performed using manual techniques or by automation. Automated synthesis may be achieved, for example, using Applied Biosystems 431A Peptide Synthesizer (Perkin Elmer). Alternatively, various fragments may be chemically synthesized separately and combined using chemical methods to produce the desired molecule.

HRS polypeptides can also be produced by expressing a DNA sequence encoding the HRS polypeptide in question) in a suitable host cell by well-known techniques. The polynucleotide sequence coding for the HRS polypeptide may be prepared synthetically by established standard methods, e.g., the phosphoamidite method described by Beaucage et al. (1981) Tetrahedron Letters 22:1859-1869, or the method described by Matthes et al. (1984) EMBO Journal 3:801-805. According to the phosphoramidite method, oligonucleotides are synthesized, e.g., in an automatic DNA synthesizer, purified, duplexed and ligated to form the synthetic DNA construct. Alternatively the DNA construct can be constructed using standard recombinant molecular biological techniques including restriction enzyme mediated cloning and PCR based gene amplification.

The polynucleotide sequences may also be of mixed genomic, cDNA, and synthetic origin. For example, a genomic or cDNA sequence encoding a leader peptide may be joined to a genomic or cDNA sequence encoding the HRS polypeptide, after which the DNA sequence may be modified at a site by inserting synthetic oligonucleotides encoding the desired amino acid sequence or by PCR using suitable oligonucleotides. In some embodiments a signal sequence can be included before the coding sequence. This sequence encodes a signal peptide N-terminal to the coding sequence which communicates to the host cell to direct the polypeptide to the cell surface or secrete the polypeptide into the media. Typically the signal peptide is clipped off by the host cell before the protein leaves the cell. Signal peptides can be found in variety of proteins in prokaryotes and eukaryotes.

A variety of expression vector/host systems are known and may be utilized to contain and express polynucleotide sequences. These include, but are not limited to, microorganisms such as bacteria transformed with recombinant bacteriophage, plasmid, or cosmid DNA expression vectors; yeast transformed with yeast expression vectors; insect cell systems infected with virus expression vectors (e.g., baculovirus); plant cell systems transformed with virus expression vectors (e.g., cauliflower mosaic virus, CaMV; tobacco mosaic virus, TMV) or with bacterial expression vectors (e.g., Ti or pBR322 plasmids); or animal cell systems, including mammalian cell and more specifically human cell systems transformed with viral, plasmid, episomal or integrating expression vectors.

Such expression vectors can comprise expression control sequences, including for example, enhancers, promoters, 5′ and 3′ untranslated regions—which interact with host cellular proteins to carry out transcription and translation. Such elements may vary in their strength and specificity. Depending on the vector system and host utilized, any number of suitable transcription and translation elements, including constitutive and inducible promoters, may be used. For example, when cloning in bacterial systems, inducible promoters such as the hybrid lacZ promoter of the PBLUESCRIPT phagemid (Stratagene, La Jolla, Calif.) or PSPORT1 plasmid (Gibco BRL, Gaithersburg, Md.) and the like may be used. In mammalian cell systems, promoters from mammalian genes or from mammalian viruses are generally preferred. If it is necessary to generate a cell line that contains multiple copies of the sequence encoding a polypeptide, vectors based on SV40 or EBV may be advantageously used with an appropriate selectable marker.

Certain embodiments may employ E. coli-based expression systems (see, e.g., Structural Genomics Consortium et al., Nature Methods. 5:135-146, 2008). These and related embodiments may rely partially or totally on ligation-independent cloning (LIC) to produce a suitable expression vector. In specific embodiments, protein expression may be controlled by a T7 RNA polymerase (e.g., pET vector series). These and related embodiments may utilize the expression host strain BL21(DE3), a λDE3 lysogen of BL21 that supports T7-mediated expression and is deficient in lon and ompT proteases for improved target protein stability. Also included are expression host strains carrying plasmids encoding tRNAs rarely used in E. coli; such as ROSETTA™ (DE3) and Rosetta 2 (DE3) strains. Cell lysis and sample handling may also be improved using reagents sold under the trademarks BENZONASE® nuclease and BUGBUSTER® Protein Extraction Reagent. For cell culture, auto-inducing media can improve the efficiency of many expression systems, including high-throughput expression systems. Media of this type (e.g., OVERNIGHT EXPRESS™ Autoinduction System) gradually elicit protein expression through metabolic shift without the addition of artificial inducing agents such as IPTG.

Particular embodiments employ hexahistidine tags, or other affinity or purification tags, followed by immobilized metal affinity chromatography (IMAC) purification, or related techniques. In certain aspects, however, clinical grade proteins can be isolated from E. coli inclusion bodies, without or without the use of affinity tags (see, e.g., Shimp et al., Protein Expr Purif. 50:58-67, 2006). As a further example, certain embodiments may employ a cold-shock induced E. coli high-yield production system, because over-expression of proteins in Escherichia coli at low temperature improves their solubility and stability (see, e.g., Qing et al., Nature Biotechnology. 22:877-882, 2004).

Also included are high-density bacterial fermentation systems. For example, high cell density cultivation of Ralstonia eutropha allows protein production at cell densities of over 150 g/L, and the expression of recombinant proteins at titers exceeding 10 g/L. In the yeast Saccharomyces cerevisiae, a number of vectors containing constitutive or inducible promoters such as alpha factor, alcohol oxidase, and PGH may be used. For reviews, see Ausubel et al. (supra) and Grant et al., Methods Enzymol. 153:516-544 (1987). Also included are Pichia pandoris expression systems (see, e.g. Li et al., Nature Biotechnology. 24, 210-215, 2006; and Hamilton et al., Science, 301:1244, 2003). Certain embodiments include yeast systems that are engineered to selectively glycosylate protein's, including yeast that have humanized N-glycosylation pathways, among others (see, e.g., Hamilton et al., Science. 313:1441-1443, 2006; Wildt et al., Nature Reviews Microbiol. 3:119-28, 2005; and Gerngross et al., Nature-Biotechnology. 22:1409-1414, 2004; U.S. Pat. Nos. 7,629,163; 7,326,681; and 7,029,872). Merely by way of example, recombinant yeast cultures can be grown in Fernbach Flasks or 15 L, 50 L, 100 L, and 200 L fermentors, among others.

In cases where plant expression vectors are used, the expression of sequences encoding polypeptides may be driven by any of a number of promoters. For example, viral promoters such as the 35S and 19S promoters of CaMV may be used alone or in combination with the omega leader sequence from TMV (Takamatsu, EMBO J. 6:307-311 (1987)). Alternatively, plant promoters such as the small subunit of RUBISCO or heat shock promoters may be used (Coruzzi et al., EMBO J. 3:1671-1680 (1984); Broglie et al., Science 221:838-843 (1984); and Winter et al., Results Probl. Cell Differ. 17:85-105 (1991)). These constructs can be introduced into plant cells by direct DNA transformation or pathogen-mediated transfection. Such techniques are described in a number of generally available reviews (see, e.g., Hobbs in McGraw Hill, Yearbook of Science and Technology, pp. 191-196 (1992)).

An insect system may also be used to express a polypeptide of interest. For example, in one such system, Autographa californica nuclear polyhedrosis virus (AcNPV) is used as a vector to express foreign genes in Spodoptera frugiperda cells or in Trichoplusia cells. The sequences encoding the polypeptide may be cloned into a non-essential region of the virus, such as the polyhedrin gene, and placed under control of the polyhedrin promoter. Successful insertion of the polypeptide-encoding sequence will render the polyhedrin gene inactive and produce recombinant virus lacking coat protein. The recombinant viruses may then be used to infect, for example, S. frugiperda cells or Trichoplusia cells in which the polypeptide of interest may be expressed (Engelhard et al., Proc. Natl. Acad. Sci. U.S.A. 91:3224-3227 (1994)). Also included are baculovirus expression systems, including those that utilize SF9, SF21, and T. ni cells (see, e.g., Murphy and Piwnica-Worms, Curr Potoc Protein Sci. Chapter 5:Unit5.4, 2001). Insect systems can provide post-translation modifications that are similar to mammalian systems.

In mammalian host cells, a number of expression systems are well known in the art and commercially available. Exemplary mammalian vector systems include for example, pCEP4, pREP4, and pREP7 from Invitrogen, the PerC6 system from Crucell, and Lentiviral based systems such as pLP1 from Invitrogen and others. For example, in cases where an adenovirus is used as an expression vector, sequences encoding a polypeptide of interest may be ligated into an adenovirus transcription/translation complex consisting of the late promoter and tripartite leader sequence. Insertion in a non-essential E1 or E3 region of the viral genome may be used to obtain a viable virus which is capable of expressing the polypeptide in infected host cells (Logan & Shenk, Proc. Natl. Acad. Sci. U.S.A. 81:3655-3659 (1984)). In addition, transcription enhancers, such as the Rous sarcoma virus (RSV) enhancer, may be used to increase expression in mammalian host cells.

Examples of useful mammalian host cell lines include monkey kidney CV1 line transformed by SV40 (COS-7, ATCC CRL 1651); human embryonic kidney line (293 or 293 cells sub-cloned for growth in suspension culture, Graham et al., J. Gen Virol. 36:59 (1977)); baby hamster kidney cells (BHK, ATCC CCL 10); mouse sertoli cells (TM4, Mather, Biol. Reprod. 23:243-251 (1980)); monkey kidney cells (CV1 ATCC CCL 70); African green monkey kidney cells (VERO-76, ATCC CRL-1587); human cervical carcinoma cells (HELA, ATCC CCL 2); canine kidney cells (MDCK, ATCC CCL 34); buffalo rat liver cells (BRL 3A, ATCC CRL 1442); human lung cells (W138, ATCC CCL 75); human liver cells (Hep G2, HB 8065); mouse mammary tumor (MMT 060562, ATCC CCL51); TR1 cells (Mather et al., Annals N.Y. Acad. Sci. 383:44-68 (1982)); MRC 5 cells; FS4 cells; and a human hepatoma line (Hep G2). Other useful mammalian host cell lines include Chinese banister ovary (CHO) cells, including DHFR-CHO cells (Urlaub et al., PNAS USA 77:4216 (1980)); and myeloma cell lines such as NSO and Sp2/0. For a review of certain mammalian host cell lines suitable for antibody production, see, e.g., Yazaki and Wu, Methods in Molecular Biology, Vol. 248 (B. K. C. Lo, ed., Humana Press, Totowa, N.J., 2003), pp. 255-268. Certain preferred mammalian cell expression systems include CHO and HEK293-cell based expression systems. Mammalian expression systems can utilize attached cell lines, for example, in T-flasks, roller bottles, or cell factories, or suspension cultures, for example, in 1 L and 5 L spinners, 5 L, 14 L, 40 L, 100 L and 200 L stir tank bioreactors, or 20/50 L and 100/200 L WAVE bioreactors, among others known in the art.

Also included is cell-free expression of proteins. These and related embodiments typically utilize purified RNA polymerase, ribosomes, tRNA and ribonucleotides; these reagents may be produced by extraction from cells or from a cell-based expression system.

In addition, a host cell strain may be chosen for its ability to modulate the expression of the inserted sequences or to process the expressed protein in the desired fashion. Such modifications of the polypeptide include, but are not limited to, post-translational modifications such as acetylation, carboxylation, glycosylation, phosphorylation, lipidation, and acylation, or the insertion of non-naturally occurring amino acids (see generally U.S. Pat. No. 7,939,496; U.S. Pat. No. 7,816,320; U.S. Pat. No. 7,947,473; U.S. Pat. No. 7,883,866; U.S. Pat. No. 7,838,265; U.S. Pat. No. 7,829,310; U.S. Pat. No. 7,820,766; U.S. Pat. No. 7,820,766; U.S. Pat. No. 7,737,226, U.S. Pat. No. 7,736,872; U.S. Pat. No. 7,638,299; U.S. Pat. No. 7,632,924: and U.S. Pat. No. 7,230,068). Post-translational processing which cleaves a “prepro” form of the protein may also be used to facilitate correct insertion, folding and/or function. Different host cells such as yeast, CHO, HeLa MDCK, HEK293, and W138, in addition to bacterial cells, which have or even lack specific cellular machinery and characteristic mechanisms for such post-translational activities, may be chosen to ensure the correct modification and processing of the foreign protein.

The HRS polypeptides produced by a recombinant cell can be purified and characterized according to a variety of techniques known in the art. Exemplary systems for performing protein purification and analyzing protein purity include fast protein liquid chromatography (FPLC) (e.g., AKTA and Bio-Rad FPLC systems), high-pressure liquid chromatography (HPLC) (e.g., Beckman and Waters HPLC). Exemplary chemistries for purification include ion exchange chromatography (e.g., Q, S), size exclusion chromatography, salt gradients, affinity purification (e.g., Ni, Co, FLAG, maltose, glutathione, protein A/G), gel filtration, reverse-phase, ceramic HYPERD® ion exchange chromatography, and hydrophobic interaction columns (HIC), among others known in the art. Several exemplary methods are also disclosed in the Examples sections.

### Recombinant Vectors

Another embodiment of the invention provides for recombinant vectors and recombinant viral vectors comprising a polynucleotide whose sequence comprises a nucleotide sequence which encodes for any of the HRS polypeptides disclosed herein. The selection of recombinant vectors suitable for expressing the HRS polypeptides of the invention, methods for inserting nucleic acid sequences for expressing the HRS polypeptides into the vector, and methods of delivering the recombinant vector to the cells of interest are within the skill in the art. See, for example Tuschl, T. (2002), Nat. Biotechnol. 20: 446-448; Brummelkamp T R et al. (2002), Science. 296: 550-553; Miyagishi M et al. (2002), Nat. Biotechnol. 20: 497-500; Paddison P J et al. (2002), Genes Dev. 16: 948-958; Lee N S et al. (2002), Nat. Biotechnol. 20: 500-505; Paul C P et al. (2002), Nat. Biotechnol. 20: 505-508, Conese et al., Gene Therapy. 11: 1735-1742 (2004), and Fjord-Larsen et al., (2005) Exp Neurol. 195:49-60, the entire disclosures of which are herein incorporated by reference.

Representative commercially available recombinant expression vectors include, for example, pREP4, pCEP4, pREP7 and pcDNA3.1 and pcDNA™5/FRT from Invitrogen, and pBK-CMV and pExchange-6 Core Vectors from Stratagem. Representative commercially available viral expression vectors include, but are not limited to, the adenovirus-based systems, such as the Per.C6 system available from Crucell, Inc., lentiviral-based systems such as pLP1 from Invitrogen, and retroviral vectors such as Retro viral Vectors pFB-ERV and pCFB-EGSH from Stratagene (US).

In general, any recombinant or viral vector capable of accepting the coding sequences for the HRS polypeptides to be expressed can be used, for example vectors derived from adenovirus (AV); adeno-associated virus (AAV); retroviruses (e.g., lentiviruses (LV), Rhabdoviruses, murine leukemia vitals); herpes virus, papillomavirus (U.S. Pat. No. 6,399,383, & 7,205,126) and the like. The tropism of the viral vectors can also be modified by pseudotyping the vectors with envelope proteins or other surface antigens from other viruses. For example, an AAV vector of the invention can be pseudotyped with surface proteins from vesicular stomatitis virus (VSV), rabies, Ebola, Mokola, and the like. Non infectious pseudovirions, for example of Papillomavirus, may also be used to enable the efficient delivery of genes to mucosal membranes (U.S. Pat. No. 7,205,126, Peng et al., Gene Ther. 2010 Jul. 29 epub).

In one aspect, viral vectors derived from AV and AAV may be used in the present invention. Suitable AAV vectors for expressing the HRS polypeptides of the invention, methods for constructing the recombinant AAV vector, and methods for delivering the vectors into target cells are described in Samulski R et al. (1987), J. Virol. 61: 3096-3101; Fisher K J et al. (1996) J. Virol. 70: 520-532; Samulski R et al. (1989), J. Virol. 63: 3822-3826; U.S. Pat. No. 5,252,479; U.S. Pat. No. 5,139,941; International Patent Application No. WO 94/13788; and International Patent Application No. WO 93/24641, the entire disclosures of which are herein incorporated by reference.

Typically the recombinant vectors and recombinant viral vectors include expression control sequences that direct the expression of the polynucleotide of the invention in various systems, both in vitro and in vivo. For instance, one set of regulatory elements will direct expression certain mammalian cells or tissues and another set of regulatory elements will direct expression to bacterial cells and yet a third set of regulatory elements will direct expression in baculovirus systems. Some vectors are hybrid vectors that contain regulatory elements necessary for expression in more than one system. Vectors containing these various regulatory systems are commercially available and one skilled in the art will readily be able to clone the polynucleotides of the invention into such vectors.

In some instances, the vectors will possess promoters for expression of the HRS polypeptides in a wide variety of cells. In other instances, the vectors will possess promoters that are tissue specific. For example, the promoters direct expression only in immune cells, muscle cells. In one aspect, the vector of the invention comprises a polynucleotide whose nucleotide sequence encodes, or comprises, any of SEQ. ID. NOs 1 to 38, 39, or 70-73, where the encoded protein comprises at least one autoimmune associated epitope.

Recombinant vectors can be administered to a patient directly or in conjunction with a suitable delivery reagent, including the Minis Transit LT1 lipophilic reagent; lipofectin; lipofectamine; cellfectin; polycations (e.g., polylysine) or liposomes. Selection of recombinant viral vectors suitable for use in the invention, methods for inserting nucleic acid sequences for expressing the HRS polypeptides into the vector, and methods of delivering the viral vector to the cells of interest are within the skill in the art. See, for example, Dornburg R (1995), Gene Therap. 2: 301-310; Eglitis M A (1988), Biotechniques 6: 608-614; Miller A D (1990), Hum Gene Therap. 1: 5-14; and Anderson W F (1998), Nature 392: 25-30, the entire disclosures of which are herein incorporated by reference.

### Host Cells

In another embodiment, the invention provide host cell transformed with a vector of the invention. In one aspect, the HRS polypeptides of the invention are expressed by the host cell in order to produce or manufacture a HRS polypeptide as described previously. Such host cells include bacteria, insect cells, yeast cells or mammalian cells.

In another aspect, the host cells may be used to express and deliver a HRS polypeptide via cell therapy. Accordingly in another aspect, the current invention includes a cell therapy for treating an autoimmune disease or disorder, comprising administering a host cell expressing, or capable of expressing, a HRS polypeptide of the invention. In one aspect the disease or disorder is selected from idiopathic inflammatory myopathies polymyositis, dermatomyositis, polymyositis-scleroderma overlap, interstitial lung disease hypersensitivity pneumonitis, scleroderma, Systemic Lupus Erythematosus, Rheumatoid Arthritis, Churg-Strauss syndrome, Wegener's granulomatosis, Good-pasture Syndrome and asthma.

Cell therapy involves the administration of cells which have been selected, multiplied and pharmacologically treated or altered (i.e., genetically modified) outside of the body (Bordignon, C. et al, Cell Therapy: Achievements and Perspectives (1999), Haematologica, 84, pp. 1110-1149). Such host cells ode for example, primary cells, including muscle cells, PBMCs, macrophages, and stem cells which have been genetically modified to express a HRS polypeptide of the invention. The aim of cell therapy is to replace, repair or enhance the biological function of damaged tissues or organs (Bordignon, C. et al, (1999), Haematologica, 84, pp. 1110-1149).

In one aspect of such methods the host cell secretes the HRS polypeptide and thus provides a sustainable source of the HRS polypeptide within the tissue or organ into which the host cell is implanted.

### Methods of Using HRS Polypeptides and Polynucleotides

Some embodiments of the claimed methods, the present invention relates to the use of histidyl-tRNA synthetase derived polypeptides (HRS Polypeptides), or polynucleotides that encode such polypeptides, for instance, as antibody blocking and/or immuno-regulatory agents, or replacement proteins, in some aspects, the present invention includes the development of improved therapeutic compositions, diagnostics and methods for treating autoimmune diseases, and in one aspect to the treatment of inflammatory myopathies, and related diseases and disorders, including lung diseases associated with the development of auto-antibodies to histidyl tRNA synthetase, related proteins, and other antibodies. Significantly, such treatments provide for significantly improved efficacy compared to existing methods of treatment, and exhibit a significantly improved side effect profile.

Accordingly, in one aspect, the invention includes a method of reducing muscle or lung inflammation associated with an autoimmune disease comprising administering to a subject in need thereof a composition comprising (a) an HRS polypeptide described herein, (b) a recombinant nucleic acid encoding a HRS polypeptide, and/or (c) a recombinant host cell, where the host cell expresses at least one heterologous HRS polypeptide described herein.

In another embodiment, the current invention includes a method of treating a disease associated with an autoantibody comprising administering to a subject in need thereof a therapeutic composition comprising (a) an HRS polypeptide described herein, (b) a recombinant nucleic acid encoding a HRS polypeptide, and/or (c) a recombinant host cell, where the host cell expresses at least one heterologous HRS polypeptide described herein; wherein the HRS polypeptide comprises at least one epitope specifically recognized by the autoantibody.

In another embodiment, the invention includes a method of inducing tolerance to a histidyl tRNA synthetase (HisRS) antigen, said method comprising administering to a subject a composition comprising (a) an HRS polypeptide described herein, (b) a recombinant nucleic acid encoding a HRS polypeptide, and/or (c) a recombinant host cell, where the host cell expresses at least one heterologous HRS polypeptide described herein; wherein the HRS polypeptide comprises at least one epitope specifically recognized by the autoantibody, and wherein administration of the composition causes tolerization to the autoantigen.

In another embodiment, the invention includes a method for eliminating a set or subset of T cells involved in an autoimmune response to a histidyl tRNA synthetase (HisRS) autoantigen, the method comprising administering to a subject a composition comprising (a) an HRS polypeptide described herein, (b) a recombinant nucleic acid encoding a HRS polypeptide, and/or (c) a recombinant host cell, where the host cell expresses at least one heterologous HRS polypeptide described herein; wherein the HRS polypeptide comprises at least one epitope specifically recognized by the autoantibody, and wherein administration of the composition causes clonal deletion of auto-reactive T-cells.

In another embodiment, the invention includes a method for inducing anergy in T cells involved in an autoimmune response to a histidyl tRNA synthetase (HisRS) autoantigen, the method comprising administering to a subject a composition comprising (a) an HRS polypeptide described herein, (b) a recombinant nucleic acid encoding a HRS polypeptide, and/or (c) a recombinant host cell, where the host cell expresses at least one heterologous HRS polypeptide described herein; wherein the HRS polypeptide comprises at least one epitope specifically recognized by the autoantibody, and wherein administration of the composition causes functional inactivation of the T cells involved in the autoimmune response.

In another embodiment, the current invention includes a replacement therapy for treating a disease associated with an insufficiency of histidyl tRNA synthetase comprising administering to a subject in need thereof a therapeutic composition comprising (a) an HRS polypeptide described herein, (b) a recombinant nucleic acid encoding a HRS polypeptide, and/or (c) a recombinant host cell, where the host cell expresses at least one heterologous HRS polypeptide described herein; wherein the HRS polypeptide functionally compensates for the histidyl tRNA synthetase insufficiency.

In one aspect of this replacement therapy, the histidyl tRNA synthetase insufficiency is caused by the presence of anti-Jo-1 antibodies. In one aspect of this replacement therapy, the histidyl tRNA synthetase insufficiency is caused by mutations in an endogenous histidyl tRNA synthetase which modulate the activity, expression or cellular distribution of the endogenous histidyl tRNA synthetase. In one aspect the histidyl tRNA synthetase insufficiency is associated with Perrault syndrome or Usher syndrome.

In any of these methods, the term “tolerance” refers to the sustained reduction or absence of an immune response to a specific antigen in a mammal, particularly a human. Tolerance is distinct from generalized immunosuppression, in which all, or all of a specific class of immune cells, such as B cell mediated immune responses, of an immune responses are diminished, or eliminated. The development of tolerance may be routinely monitored by the absence, or a decrease, in the concentration of antibodies to HRS polypeptides in the serum of the host subject after administration, in single or successive doses of the treating HRS polypeptide. The development of tolerance will typically be sufficient to decrease the symptoms of the autoimmune disease in the patient, for example a patient may be sufficiently improved so as to maintain normal activities in the absence, or in the presence of reduced amounts, of general immunosuppressant's, e.g. corticosteroids.

In any of these methods, and compositions tolerance will typically be sustained, meaning that it will have a duration of about one month, about two months, about three months, about 4 months, about 5 months, or about 6 months or longer. Tolerance may result in selective B-cell allergy, or T-cell allergy or both.

In any of these methods, treatments and therapeutic compositions, the term “a disease associated with autoantibodies specific for histidyl tRNA synthetase” refers to any disease or disorder in which antibodies to histidyl tRNA synthetase are detected, or detectable, irrespective of whether other autoantibodies are also detected, or thought to play a role in disease progression or cause. Methods for detecting antibodies in patient samples may be carried out by any standard procedure including for example, by RIA, ELISA, by immunoprecipitation, by staining of tissues or cells (including transfected cells) antigen microarrays, mass spec analysis, specific neutralization assays or one of a number of other methods known in the art for identifying desired antigen specificity. In some aspects, antibody specificity can be further characterized by determining the ability of the antibodies to selectively bind to different splice variants and truncated or proteolytic forms of histidyl tRNA synthetase. A relatively well known human auto-antibody to histidyl tRNA synthetase includes for example antibodies to Jo-1.

In some embodiments of any of the claimed methods, and compositions, the HRS polypeptide comprises an epitope from histidyl tRNA synthetase which specifically cross reacts with a disease associated auto-antibody to histidyl-tRNA synthetase. In some embodiments of any of the claimed methods, and compositions, the HRS polypeptide comprises an epitope from histidyl tRNA synthetase which specifically cross reacts with a disease associated auto-reactive T cell to histidyl-tRNA synthetase. In some embodiments of any of the claimed methods, and compositions, the HRS polypeptide comprises an epitope which specifically cross reacts with a disease associated auto-antibody to either another tRNA synthetase, or to a non tRNA synthetase auto antibody.

In some embodiments, the HRS polypeptide comprises an immunodominant epitope which is specifically recognized by the majority of antibodies from the sera of a patient with a disease associated with auto antibodies to histidyl-tRNA synthetase. In some embodiments, the HRS polypeptide comprises an immunodominant epitope which is specifically recognized by the majority of autoreactive T cells from the sera of a patient with a disease associated with auto antibodies to histidyl-tRNA synthetase.

In some embodiments, the epitope is comprised within the WHEP domain of the HRS polypeptide (approximately amino acids 1-43 of SEQ ID NO:1); the aminoacylation domain (approximately amino acids 54-398 of SEQ ID NO:1); or the anticodon binding domain (approximately amino acids 406-501 of SEQ ID NO:1) or any combination thereof.

In some embodiments, the HRS polypeptide does not comprise an epitope which specifically cross reacts with a disease associated auto-antibody to histidyl-tRNA synthetase, in one aspect, the auto-antibody to histidyl-tRNA synthetase is directed to the Jo-1 antigen.

Examples of diseases associated with autoantibodies specific for histidyl tRNA synthetase (as well as diseases associated with an insufficiency of histidyl tRNA synthetase) include without limitation, inflammatory myopathies, including idiopathic inflammatory myopathies, polymyositis, statin induced myopathies, dermatomyositis, interstitial lung disease (and other pulmonary fibrotic conditions) and related disorders, such as polymyositis-scleroderma overlap and inclusion body myositis (IBM) and conditions such as those found in anti-synthetase syndromes, including for example, interstitial lung disease, arthritis, esophageal dysmotility, cardiovascular disease and other vascular manifestations such as Reynaud's phenomenon; other examples of diseases associated with an insufficiency of histidyl tRNA synthetase include genetic disorders that result in an sufficiency of active histidyl tRNA synthetase including Usher syndrome and Perrault syndrome.

Polymyositis affects skeletal muscles (involved with making movement) on both sides of the body. It is rarely seen in persons under age 18; most cases are in people between the ages of 31 and 60. In addition to symptoms listed above, progressive muscle weakness leads to difficulty swallowing, speaking, rising from a sitting position, climbing stairs, lifting objects, or reaching overhead. People with polymyositis may also experience arthritis, shortness of breath, and heart arrhythmias.

Dermatomyositis is characterized by a skin rash that precedes or accompanies progressive muscle weakness. The rash looks patchy, with purple or red discolorations, and characteristically develops on the eyelids and on muscles used to extend or straighten joints, including knuckles, elbows, knees, and toes. Red rashes may also occur on the face, neck, shoulders, upper chest, back, and other locations, and there may be swelling in the affected areas. The rash sometimes occurs without obvious muscle involvement. Adults with dermatomyositis may experience weight loss or a low-grade fever, have inflamed lungs, and be sensitive to light. Adult dermatomyositis, unlike polymyositis, may accompany tumors of the breast, lung, female genitalia, or bowel. Children and adults with dermatomyositis may develop calcium deposits, which appear as hard bumps under the skin or in the muscle (called calcinosis). Calcinosis most often occurs 1-3 years after disease onset but may occur many years later. These deposits are seen more often in childhood dermatomyositis than in dermatomyositis that begins in adults. Dermatomyositis may be associated with collagen-vascular or autoimmune diseases.

In some cases of polymyositis and dermatomyositis, distal muscles (away from the trunk of the body, such as those in the forearms and around the ankles and wrists) may be affected as the disease progresses. Polymyositis and dermatomyositis may be associated with collagen-vascular or autoimmune diseases. Polymyositis may also be associated with infectious disorders.

Inclusion body myositis (IBM) is characterized by progressive muscle weakness and wasting. The onset of muscle weakness is generally gradual (over months or years) and affects both proximal and distal muscles. Muscle weakness may affect only one side of the body. Small holes called vacuoles are sometimes seen in the cells of affected muscle fibers. Falling and tripping are usually the first noticeable symptoms of IBM. For some individuals the disorder begins with weakness in the wrists and fingers that causes difficulty with pinching, buttoning, and gripping objects. There may be weakness of the wrist and finger muscles and atrophy (thinning or loss of muscle bulk) of the forearm muscles and quadricep muscles in the legs. Difficulty swallowing occurs in approximately half of IBM cases. Symptoms of the disease usually begin after the age of 50, although the disease can occur earlier. Unlike polymyositis and dermatomyositis, IBM occurs more frequently in men than in women.

Juvenile myositis has some similarities to adult dermatomyositis and polymyositis. It typically affects children ages 2 to 15 years, with symptoms that include proximal muscle weakness and inflammation, edema (an abnormal collection of fluids within body tissues that causes swelling), muscle pain, fatigue, skin rashes, abdominal pain, fever, and contractures (chronic shortening of muscles or tendons around joints, caused by inflammation in the muscle tendons, which prevents the joints from moving freely). Children with juvenile myositis may also have difficulty swallowing and breathing, and the heart may be affected. Approximately 20 to 30 percent of children with juvenile dermatomyositis develop calcinosis. Affected children may not show higher than normal levels of the muscle enzyme creatine kinase in their blood but have higher than normal levels of other muscle enzymes.

Statin Induced Myopathies are associated with the long term use of Matins which act via the inhibition of 3-hydroxy-3-methylglutaryl coenzyme A reductase (HMGCR). Generally well-tolerated, these medications have been described as inducers of myotoxicity. More recently, there have been reports of patients in whom statin myopathies persist even after drug cessation, which are hypothesized to have an autoimmune cause. The benefits of statins are undisputed in reducing the risk of coronary heart disease and the progression of coronary atherosclerosis. Nevertheless, associated complications can be life-threatening. More than 38 million people in the U.S. are currently estimated to be taking statins and up to 7% (>2.6 million) of these are predicted to develop muscle symptoms with up to 0.5% (>190,000) of these potentially going on to develop life-threatening myopathies.

All the statins can cause muscle problems and the risk increases along with increases in their lipophilicity, cholesterol-lowering potency, and dosage. Cerivastatin in particular has been implicated as having a higher risk and it has been withdrawn from the US market. Of the remaining statins, atorvastatin and simvastatin have higher myotoxicity rates. Other nonstatin lipid-lowering agents such as niacin and fibrates also carry risks of muscle problems, particularly when combined with statins. While it is not possible to predict what patients will have statin-induced muscle problems, prior muscle problems may be a risk factor and should be considered when initialing statin treatment. A family history of myopathy is relevant if a patient night be a carrier of a genetic myopathy because it could be unmasked by the added stress of statin treatment. Other risk factors may include age over 80 years, low body weight, female sex, hypothyroidism, certain genetic defects and Asian descent, as well as concomitant use of certain medications, including calcium channel blockers, macrolide antibiotics, omeprazole, amiodarone, azole antifungals, histamine H₂ receptor antagonists, nefazodone, cyclosporin, HIV protease inhibitors, warfarin, and grapefruit juice.

The most common muscle symptom caused by statins is muscle pain or myalgia and it occurs in about 7% of statin users. The myalgia can be anywhere from mild to severe and is often worsened by muscle activity. If the symptom is tolerable and the indication for statin treatment strong, for example, in a patient with hypercholesterolemia and a recent myocardial infarction, continued statin treatment may be appropriate.

Baseline creatine kinase (CK) levels are not uniformly recommended before initiation of statin treatment by the organizations guiding statin treatment, but CK levels can provide very useful information if muscle symptoms later develop. Muscle weakness can also occur, and it is often fatigable in quality and combined with pain and elevated CK. Like most myopathies, the weakness is most pronounced proximally. Rare episodes of rhabdomyolysis have also occurred with statin therapy; these are far less frequent but can possibly be fatal. The changes that can be seen on muscle histology that are most typical of a statin myopathy are cytochrome oxidase negative fibers, increased lipid content, and ragged red fibers. Autoimmune necrotizing myopathy is a rare form of statin myopathy. In these patients, discontinuation of the statin drug does not translate into recovery even after several months off the drug. Patients have a predominantly proximal, often painless weakness.

Diagnosis is based on the individual's medical history, results of a physical exam and tests of muscle strength, and blood samples that show elevated levels of various muscle enzymes and autoantibodies. Diagnostic tools include electromyography to record the electrical activity that controls muscles during contraction and at rest, ultrasound to look for muscle inflammation, and magnetic resonance imaging to reveal abnormal muscle and evaluate muscle disease. A muscle biopsy can be examined by microscopy for signs of chronic inflammation, muscle fiber death, vascular deformities, or the changes specific to the diagnosis of IBM. A skin biopsy can show changes in the skin layer in patients with dermatomyositis.

Interstitial lung disease (ILD) is a broad category of lung diseases that includes more than 130 disorders characterized by scarring (i.e., “fibrosis”) and/or inflammation of the lungs. ILD accounts for 15 percent of the cases seen by pulmonologists. Interstitial lung disease (ILD) can develop from a variety of sources, ranging from other diseases to environmental factors. Some of the known causes of ILD include: Connective Tissue or Autoimmune Disease, including for example, Scleroderma/Progressive systemic sclerosis, Lupus (systemic lupus erythematosus), Rheumatoid arthritis and Polymyositis/Dermatomyositis; Occupational and Environmental Exposures, including for example, exposure to dust and certain gases, poisons, chemotherapy and radiation therapy.

In ILD, the tissue in the lungs becomes inflamed and/or scarred. The interstitium of the lung includes the area in and around the small blood vessels and alveoli (air sacs) where the exchange of oxygen and carbon dioxide takes place. Inflammation and scarring of the interstitium disrupts this tissue and leads to a decrease in the ability of the lungs to extract oxygen from the air.

The progression of ILD varies from disease to disease and from person to person. Because interstitial lung disease disrupts the transfer of oxygen and carbon dioxide in the lungs, its symptoms typically manifest as problems with breathing. The two most common symptoms of ILD are shortness of breath with exercise and a non-productive cough.

Usher Syndrome is the most common condition that affects both hearing and vision. The major symptoms of Usher syndrome are hearing loss and retinitis pigmentosa, (RP). RP causes night-blindness and a loss of peripheral vision (side vision) through the progressive degeneration of the retina. As RP progresses, the field of vision narrows until only central vision remains. Many people with Usher syndrome also have severe balance problems. Approximately 3 to 6 percent of all children who are deaf and another 3 to 6 percent of children who are hard-of-hearing have Usher syndrome. In developed countries such as the United States, about four babies in every 100,000 births have Usher syndrome. Usher syndrome is inherited as an autosomal recessive trait. Several genetic loci have been associated with Usher syndrome including histidyl t-RNA synthetase (Puffenberger et al., (2012) PLoS ONE 7 (1) e28936 doi: 10.1371/journal. pone.0028936).

There are three clinical types of Usher syndrome: type 1, type 2, and type 3. In the United States, types 1 and 2 are the most common types. Together, they account for approximately 90 to 95 percent of all cases of children who have Usher syndrome.

Children with type 1 Usher syndrome are profoundly deaf at birth and have severe balance problems. Because of the balance problems associated with type 1 Usher syndrome, children with this disorder are slow to sit without support and typically don't walk independently before they are 18 months old. These children usually begin to develop vision problems in early childhood, almost always by the time they reach age 10. Vision problems most often begin with difficulty seeing at night, but tend to progress rapidly until the person is completely blind.

Children with type 2 Usher syndrome are born with moderate to severe hearing loss and normal balance. Although the severity of hearing loss varies, most of these children can benefit from hearing aids and can communicate orally. The vision problems in type 2 Usher syndrome tend to progress more slowly than those in type 1, with the onset of RP often not apparent until the teens.

Children with type 3 Usher syndrome have normal hearing at birth. Although most children with the disorder have normal to near-normal balance, some may develop balance problems later on. Hearing and sight worsen over time, but the rate at which they decline can vary from person to person, even within the same family. A person with type 3 Usher syndrome may develop hearing loss by the teens, and he or she will usually require hearing aids by mid- to late adulthood. Night blindness usually begins sometime during puberty. Blind spots appear by the late teens to early adulthood, and, by mid-adulthood, the person is usually legally blind.

Perrault syndrome (PS) is characterized by the association of ovarian dysgenesis in females with sensorineural hearing impairment, and in some subjects, neurologic abnormalities, including progressive cerebellar ataxia and intellectual deficit. The exact prevalence for Perrault syndrome is unknown, and is probably underdiagnosed, particularly in males where hypogonadism is not a feature and the syndrome remains undetected. Mean age at diagnosis is 22 years following presentation with delayed puberty in females with sensorineural deafness. Hearing defects were noted in all but one of the reported cases (mean age at diagnosis of 8 years). The hearing loss is always sensorineural and bilateral but the severity is variable (mild to profound), even in affected patients from the same family. Ovarian dysgenesis has been reported in all female cases but no gonad defects are detected in males. Amenorrhea is generally primary but secondary amenorrhea has also been reported. Delayed growth (height below the third percentile) was reported in half the documented cases. The exact frequency of the neurological abnormalities is unknown, but nine females and two males (16-37 years old) lacking neurological abnormalities have been reported. Neurological signs are progressive and generally appear later in life, however, walking delay or early frequent falls have been noted in young PS patients. Common neurological signs are ataxia, dyspraxia, limited extraocular movements, and polyneuropathy. Some cases with scoliosis have also been reported. Transmission of PS is autosomal recessive and mutations in mitochondrial histidyl tRNA synthetase have recently been identified to cause the ovarian dysgenesis and sensorineural hearing loss associated with Perrault syndrome. (Pierce et al., (2011) P.N.A.S. 108(16) 6543-6548).

Accordingly, by possessing non-canonical activities of therapeutic relevance, and/or by blocking the binding, action, or production of ant-histidyl-tRNA synthetase antibodies, the HRS polypeptides described herein have utility in the treatment of a broad range of auto-immune diseases and disorders associated with anti-histidyl-tRNA synthetase antibodies or other auto-antibodies, and in the treatment of other causes of histidyl-tRNA synthetase insufficiency.

### Pharmaceutical Formulations, Administration, and Kits

In another aspect, the current invention also includes therapeutic compositions for treating any of the diseases or conditions described herein, including those associated with autoantibodies specific for histidyl tRNA synthetase, the composition comprising at least one HRS polypeptide.

In another embodiment, the invention includes therapeutic compositions for treating any of the diseases or conditions described herein, including those associated with autoantibodies specific for histidyl tRNA synthetase, the composition comprising a recombinant nucleic acid encoding a mammalian HRS polypeptide, wherein the nucleic acid is operatively coupled to expression control sequences to enable expression of the HRS in a cell. In particular aspects, the HRS polypeptide comprises at least one epitope of the histidyl tRNA synthetase.

In another embodiment, the invention includes therapeutic compositions for treating any of the diseases or conditions described herein, including those associated with autoantibodies specific for histidyl tRNA synthetase, the composition comprising a recombinant host cell, wherein the host cell expresses at least one heterologous HRS polypeptide, and wherein the nucleic acid is operatively coupled to expression control sequences to enable expression of the HRS in a cell.

In particular aspects, the HRS polypeptide comprises at least one relevant epitope of the histidyl tRNA synthetase (e.g., an epitope that interacts with an autoantibody), and/or possesses at least one non-canonical activity. In specific aspects, the epitope is a T-helper (Th) epitope.

Also includes are new medical uses of the HRS polypeptides in the preparation of a medicament for the treatment of an autoimmune disease.

In any of these therapeutic compositions and uses, the compositions can be formulated in pharmaceutically-acceptable or physiologically-acceptable solutions for administration to a cell, subject, or an animal, either alone, or in combination with one or more other modalities of therapy. It will also be understood that, if desired, the compositions of the invention may be administered in combination with other agents as well, such as, e.g., other proteins or polypeptides or pharmaceutically-active agents. (In this context “administered in combination” means (1) part of the same unitary dosage form; (2) administration separately, but as part of the same therapeutic treatment program or regimen, typically, but not necessarily, on the same day.

In some embodiments, the compositions comprise a mixture of 2 or more HRS polypeptides. In some aspects the compositions may comprise about 2 to about 50, or about 2 to about 25, or about 2 to about 15, or about two, three, four, five, six, seven, eight, nine, ten, eleven, twelve, or thirteen HRS polypeptides of the invention.

For pharmaceutical production, HRS polypeptide therapeutic compositions will typically be substantially endotoxin free. Endotoxins are toxins associated with certain bacteria, typically gram-negative bacteria, although endotoxins may be found in gram-positive bacteria, such as Listeria monocytogenes. The most prevalent endotoxins are lipopolysaccharides (LPS) or lipo-oligo-saccharides (LOS) found in the outer membrane of various Gram-negative bacteria, and which represent a central pathogenic feature in the ability of these bacteria to cause disease. Small amounts of endotoxin in humans may produce fever, a lowering of the blood pressure, and activation of inflammation and coagulation, among other adverse physiological effects.

Endotoxins can be detected using routine techniques known in the art. For example, the Limulus Ameobocyte Lysate assay, which utilizes blood from the horseshoe crab, is a very sensitive assay for detecting presence of endotoxin. In this test, very low levels of LPS can cause delectable coagulation of the limulus lysate due a powerful enzymatic cascade that amplifies this reaction. Endotoxins can also be quantitated by enzyme-linked immunosorbent assay (ELISA).

To be substantially endotoxin free, endotoxin levels may be less than about 0.001, 0.005, 0.01, 0.02, 0.03, 0.04, 0.05, 0.06, 0.08, 0.09, 0.1, 0.5, 1.0, 1.5, 2, 2.5, 3, 4, 5, 6, 7, 8, 9, or 10 EU/mg of protein. Typically, 1 ng lipopolysaccharide (LPS) corresponds to about 1-10 EU.

In certain embodiments, as noted herein, the HRS polypeptide compositions have an endotoxin content of less than about 10 EU/mg of HRS polypeptide, or less than about 5 EU/mg of HRS polypeptide, less than about 3 EU/mg of HRS polypeptide, or less than about 1 EU/mg of HRS polypeptide, or less than about 0.1 EU/mg of HRS polypeptide, or less than about 0.01 EU/mg of HRS polypeptide. In certain embodiments, as noted above, the HRS polypeptide pharmaceutical compositions are about 95% endotoxin free, preferably about 99% endotoxin free, and more preferably about 99.99% endotoxin free on wt/wt protein basis.

Pharmaceutical compositions comprising a therapeutic dose of a HRS polypeptide include all homologues, orthologs, and naturally-occurring isoforms of histidyl-tRNA synthetase (e.g., any of the proteins or nucleic acids listed in Tables D1 to D4.

In one aspect such compositions may comprises HRS polypeptides that are substantially monodisperse, meaning that the HRS polypeptide compositions exist primarily (i.e., at least about 90%, or greater) in one apparent molecular weight form when assessed for example, by size exclusion chromatography, dynamic light scattering, or analytical ultracentrifugation. In some aspects, such compositions may comprise DTT, or other suitable reducing agents to prevent disulfide bond formation.

In another aspect, such compositions have a purity (on a protein basis) of at least about 90%, or in some aspects at least about 95% purity, or in some embodiments, at least 98% purity. Purity may be determined via any routine analytical method as known in the art.

In another aspect, such compositions have a high molecular weight aggregate content of less than about 10%, compared to the total amount of protein present, or in some embodiments such compositions have a high molecular weight aggregate content of less than about 5%, or in some aspects such compositions have a high molecular weight aggregate content of less than about 3%, or in some embodiments a high molecular weight aggregate content of less than about 1%. High molecular weight aggregate content may be determined via a variety of analytical techniques including for example, by size exclusion chromatography, dynamic light scattering, or analytical ultracentrifugation.

Pharmaceutical compositions may include pharmaceutically acceptable salts of a HRS polypeptide. For a review on suitable salts, see Handbook of Pharmaceutical Salts: Properties, Selection, and Use by Stahl and Wermuth (Wiley-VCH, 2002). Suitable base salts are formed from bases which form non-toxic salts. Representative examples include the aluminum, arginine, benzathine, calcium, choline, diethylamine, diolamine, glycine, lysine, magnesium, meglumine, olamine, potassium, sodium, tromethamine, and zinc salts. Hemisalts of acids and bases may also be formed, e.g., hemisulphate and hemicalcium salts. Compositions to be used in the invention suitable for parenteral administration may comprise sterile aqueous solutions and for suspensions of the pharmaceutically active ingredients preferably made isotonic with the blood of the recipient, generally using sodium chloride, glycerin, glucose, mannitol, sorbitol, and the like. Organic acids suitable for forming pharmaceutically acceptable acid addition salts include, by way of example and not limitation, acetic acid, trifluoroacetic acid, propionic acid, hexanoic acid, cyclopentanepropionic acid, glycolic acid, oxalic acid, pyruvic acid, lactic acid, malonic acid, succinic acid, malic acid, maleic acid, fumaric acid, tartaric acid, citric acid, palmitic acid, benzoic acid, 3-(4-hydroxybenzoyl) benzoic acid, cinnamic acid, mandelic acid, alkylsulfonic acids (e.g., methanesulfonic acid, ethanesulfonic acid, 1,2-ethane-disulfonic acid, 2-hydroxyethanesulfonic acid, etc.), arylsulfonic acids (e.g., benzenesulfonic acid, 4-chlorobenzenesulfonic acid, 2-naphthalenesulfonic acid, 4-toluenesulfonic acid, camphorsulfonic acid, etc.), 4-methylbicyclo(2.2.2)-oct-2-ene-1-carboxylic acid, glucoheptonic acid, 3-phenylpropionic acid, trimethylacetic acid, tertiary butylacetic acid, lauryl sulfuric acid, gluconic acid, glutamic acid, hydroxynaphthoic acid, salicylic acid, stearic acid, muconic acid, and the like.

In particular embodiments, the carrier may include water. In some embodiments, the carrier may be an aqueous solution of saline for example, water containing physiological concentrations of sodium, potassium, calcium, magnesium, and chloride at a physiological pH. In some embodiments, the carrier may be water and the formulation may further include NaCl. In some embodiments, the formulation may be isotonic. In some embodiments, the formulation may be hypotonic. In other embodiments, the formulation may be hypertonic. In some embodiments, the formulation may be isomostic. In some embodiments, the formulation is substantially free of polymers (e.g., gel-forming polymers, polymeric viscosity-enhancing agents). In some embodiments, the formulation is substantially free of viscosity-increasing agents (e.g., carboxymethylcellulose, polyanionic polymers). In some embodiments, the formulation is substantially free of gel-forming polymers. In some embodiments, the viscosity of the formulation is about the same as the viscosity of a saline solution containing the same concentration of a HRS polypeptide (or a pharmaceutically acceptable salt thereof).

In the pharmaceutical compositions of the invention, formulation of pharmaceutically-acceptable excipients and carrier solutions is well-known to those of skill in the art, as is the development of suitable dosing and treatment regimens for using the particular compositions described herein in a variety of treatment regimens, including e.g., oral, parenteral, intravenous, intranasal, and intramuscular administration and formulation.

In certain embodiments, the HRS polypeptides have a solubility that is desirable for the particular mode of administration, such intravenous administration. Examples of desirable solubility's include at least about 1 mg/ml, at least about 10 mg/ml, at least about 25 mg/ml, and at least about 50 mg/ml.

In certain applications, the pharmaceutical compositions disclosed herein may be delivered via oral administration to a subject. As such, these compositions may be formulated with an inert diluent or with an assimilable edible carrier, or they may be enclosed in hard- or soft-shell gelatin capsule, or they may be compressed into tablets, or they may be incorporated directly with the food of the diet.

Pharmaceutical compositions suitable for the delivery of HRS polypeptides and methods for their preparation will be readily apparent to those skilled in the art. Such compositions and methods for their preparation may be found, e.g., in Remington's Pharmaceutical Sciences, 19th Edition (Mack Publishing Company, 1995).

Administration of a therapeutic dose of a HRS polypeptide may be by any suitable method known in the medicinal arts, including for example, oral, rectal, intranasal, parenteral administration include intravitreal, subconjuctival, sub-tenon, retrobulbar, suprachoroidal intravenous, intra-arterial, intraperitoneal, intrathecal, intraventricular, intraurethral, intrasternal, intracranial, intramuscular, intrasynovial, intraocular, topical and subcutaneous. Suitable devices for parenteral administration include needle (including microneedle) injectors, needle-free injectors, and infusion techniques.

Parenteral formulations are typically aqueous solutions which may contain excipients such as salts, carbohydrates, and buffering agents (preferably to a pH of from 3 to 9), but, for some applications, they may be more suitably formulated as a sterile non-aqueous solution or as a dried form to be used in conjunction with a suitable vehicle such as sterile, pyrogen-free water. The preparation of parenteral formulations under sterile conditions, e.g., by lyophilization, may readily be accomplished using standard pharmaceutical techniques well-known to those skilled in the art.

Formulations for parenteral administration may be formulated to be immediate and/or sustained release. Sustained release compositions include delayed, modified, pulsed, controlled, targeted and programmed release. Thus a HRS polypeptide may be formulated as a suspension or as a solid, semi-solid, or thixotropic liquid for administration as an implanted depot providing sustained release of HRS polypeptides. Examples of such formulations include it limitation, drug-coated stents and semi-solids and suspensions comprising drug-loaded poly(DL-lactic-co-glycolic)acid (PGLA), poly(DL-lactide-co-glycolide) (PLG) or poly(lactide) (PLA) lamellar vesicles or microparticles, hydrogels (Hoffman A S: Ann. N.Y. Acad. Sci. 944: 62-73 (2001)), poly-amino acid nanoparticles systems, such as the Medusa system developed by Flamel Technologies Inc., non aqueous gel systems such as Atrierel developed by Atrix, Inc., and SABER (Sucrose Acetate Isobutyrate Extended Release) developed by Durect Corporation, and lipid-based systems such as DepoFoam developed by SkyePharma.

Solutions of the active compounds as free base or pharmacologically acceptable salts may be prepared in water suitably mixed with a surfactant, such as hydroxypropylcellulose. Dispersions may also be prepared in glycerol, liquid polyethylene glycols, and mixtures thereof and in oils. Under ordinary conditions of storage and use, these preparations contain a preservative to prevent the growth of microorganisms.

The pharmaceutical forms suitable for injectable use include sterile aqueous solutions or dispersions and sterile powders for the extemporaneous preparation of sterile injectable solutions or dispersions (U.S. Pat. No. 5,466,468, specifically incorporated herein by reference in its entirety). In all cases the form should be sterile and should be fluid to the extent that easy syringability exists. It should be stable under the conditions of manufacture and storage and should be preserved against the contaminating action of microorganisms, such as bacteria and fungi. The carrier can be a solvent or dispersion medium containing, for example, water, ethanol, polyol (e.g., glycerol, propylene glycol, and liquid polyethylene glycol, and the like), suitable mixtures thereof, and/or vegetable oils. Proper fluidity may be maintained, for example, by the use of a coating, such as lecithin, by the maintenance of the required particle size in the case of dispersion and by the use of surfactants. The prevention of the action of microorganisms can be facilitated by various antibacterial and antifungal agents, for example, parabens, chlorobutanol, phenol, sorbic acid, thimerosal, and the like. In many cases, it will be preferable to include isotonic agents, for example, sugars or sodium chloride. Prolonged absorption of the injectable compositions can be brought about by the use in the compositions of agents delaying absorption, for example, aluminum monostearate and gelatin.

For parenteral administration in an aqueous solution, for example, the solution should be suitably buffered if necessary and the liquid diluent first rendered isotonic with sufficient saline or glucose. These particular aqueous solutions are especially suitable for intravenous, intramuscular, subcutaneous and intraperitoneal administration. In this connection, a sterile aqueous medium that can be employed will be known to those of skill in the art in light of the present disclosure. For example, one dosage may be dissolved in 1 ml of isotonic NaCl solution and either added to 1000 nil of hypodermoclysis fluid or injected at the proposed site of infusion (see, e.g., Remington's Pharmaceutical Sciences, 15th Edition, pp. 1035-1038 and 1570-1580). Some variation in dosage will necessarily occur depending on the condition of the subject being treated. The person responsible for administration will, in any event, determine the appropriate dose for the individual subject. Moreover, for human administration, preparations should meet sterility, pyrogenicity, and the general safety and purity standards as required by FDA Office of Biologics standards.

Sterile injectable solutions can be prepared by incorporating the active compounds in the required amount in the appropriate solvent with the various other ingredients enumerated above, as required, followed by filtered sterilization. Generally, dispersions are prepared by incorporating the various sterilized active ingredients into a sterile vehicle which contains the basic dispersion medium and the required other ingredients from those enumerated above. In the case of sterile powders for the preparation of sterile injectable solutions, the preferred methods of preparation are vacuum-drying and freeze-drying techniques which yield a powder of the active ingredient plus any additional desired ingredient from a previously sterile-filtered solution thereof.

The compositions disclosed herein may be formulated in a neutral or salt form. Pharmaceutically-acceptable salts, include the acid addition salts (formed with the free amino groups of the protein) and which are formed with inorganic acids such as, for example, hydrochloric or phosphoric acids, or such organic acids as acetic, oxalic, tartaric, mandelic, and the like. Salts formed with the free carboxyl groups can also be derived from inorganic bases such as, for example, sodium, potassium, ammonium, calcium, or ferric hydroxides, and such organic bases as isopropylamine, trimethylamine, histidine, procaine and the like. Upon formulation, solutions will be administered in a manner compatible with the dosage formulation and in such amount as is therapeutically effective. The formulations are easily administered in a variety of dosage forms such as injectable solutions, drug-release capsules, and the like.

As used herein, “carrier” includes any and all solvents, dispersion media, vehicles, coatings, diluents, antibacterial and antifungal agents, isotonic and absorption delaying agents, buffers, carrier solutions, suspensions, colloids, and the like. The use of such media and agents for pharmaceutical active substances is well known in the art. Except insofar as any conventional media or agent is incompatible with the active ingredient, its use in the therapeutic compositions is contemplated. Supplementary active ingredients can also be incorporated into the compositions.

The phrase “pharmaceutically-acceptable” refers to molecular entities and compositions that do not produce an allergic or similar untoward reaction when administered to a human. The preparation of an aqueous composition that contains a protein as an active ingredient is well understood in the art. Typically, such compositions are prepared as injectables, either as liquid solutions or suspensions; solid forms suitable for solution in, or suspension in, liquid prior to injection can also be prepared. The preparation can also be emulsified.

Methods of formulation are well known in the art and are disclosed, for example, in Remington: The Science and Practice of Pharmacy, Mack Publishing Company, Easton, Pa., 19th Edition (1995). The compositions and agents provided herein may be administered according to the methods of the present invention in any therapeutically effective dosing regimen. The dosage amount and frequency are selected to create an effective level of the agent without harmful effects. The effective amount of a compound of the present invention will depend on the route of administration, the type of warm-blooded animal being treated, and the physical characteristics of the specific warm-blooded animal under consideration. These factors and their relationship to determining this amount are well known to skilled practitioners in the medical arts. This amount and the method of administration can be tailored to achieve optimal efficacy but will depend on such factors as weight, diet, concurrent medication and other factors which those skilled in the medical arts will recognize.

In certain embodiments, the pharmaceutical compositions may be delivered by intranasal sprays, inhalation, and/or other aerosol delivery vehicles. Methods for delivering genes, polynucleotides, and peptide compositions directly to the lungs via nasal aerosol sprays have been described e.g., in U.S. Pat. No. 5,756,353 and U.S. Pat. No. 5,804,212 (each specifically incorporated herein by reference in its entirety). Likewise, the delivery of drugs using intranasal microparticle resins (Takenaga et al., 1998) and lysophosphatidyl-glycerol compounds (U.S. Pat. No. 5,725,871, specifically incorporated herein by reference in its entirety) are also well-known in the pharmaceutical arts. Likewise, transmucosal drug delivery in the form of a polytetrafluoroethylene support matrix is described in U.S. Pat. No. 5,780,045 (specifically incorporated herein by reference in its entirety).

In certain embodiments, the delivery may occur by use of liposomes, nanocapsules, microparticles, microspheres, lipid particles, vesicles, and the like, for the introduction of the compositions of the present invention into suitable host cells. In particular, the compositions of the present invention may be formulated for delivery either encapsulated in a lipid particle, a liposome, a vesicle, a nanosphere, a nanoparticle or the like. The formulation and use of such deliver vehicles can be carried out using known and conventional techniques.

In certain embodiments, the agents provided herein may be attached to a pharmaceutically acceptable solid substrate, including biocompatible and biodegradable substrates such as polymers and matrices. Examples of such solid substrates include, without limitation polyesters, hydrogels (for example, poly(2-hydroxyethyl-methacrylate), or poly(vinylalcohol)), polylactides (U.S. Pat. No. 3,773,919), copolymers of L-glutamic acid and γ-ethyl-L-glutamate, non-degradable ethylene-vinyl acetate, degradable lactic acid-glycolic acid copolymers such as polylactic-co-glycolic acid) (PLEA) and the LUPRON DEPOT™ (injectable microspheres composed of lactic acid-glycolic acid copolymer and leuprolide acetate), poly-D-(−)-3-hydroxybutyric acid, collagen, metal, hydroxyapatite, bioglass, aluminate, bioceramic materials, and purified proteins.

In one particular embodiment, the solid substrate comprises ATRIGEL™ (QLT, Inc., Vancouver, B.C.). The ATRIGEL® drug delivery system consists of biodegradable polymers dissolved in biocompatible carriers. Pharmaceuticals may be blended into this liquid delivery system at the time of manufacturing or, depending upon the product, may be added later by the physician at the time of use. When the liquid product is injected into the subcutaneous space through a small gauge needle or placed into accessible tissue sites through a cannula, water in the tissue fluids causes the polymer to precipitate and trap the drug in a solid implant. The drug encapsulated within the implant is then released in a controlled manner as the polymer matrix biodegrades with time.

In particular embodiments, the amount of a HRS composition the agent administered will generally range from a dosage of from about 0.1 to about 100 mg/kg/day, and typically from about 0.1 to 10 mg/kg where administered orally or intravenously. In particular embodiments, a dosage is 5 mg/kg or 7.5 mg/kg. For humans, the daily dosage used may range from, about 0.1 mg/kg to 0.5 mg/kg, about 1 mg/kg to 5 mg/kg, about 5 mg/kg to 10 mg/kg, about 10 mg/kg to 20 mg/kg, about 20 mg/kg to 30 mg/kg, about 30 mg/kg to 50 mg/kg, and about 50 mg/kg to 100 mg/kg/24 hours.

In certain embodiments, a composition or agent is administered in a single dosage of 0.1 to 10 mg/kg or 0.5 to 15 mg/kg. In other embodiments, a composition or agent is administered in a dosage of 0.1 to 50 mg/kg/day, 0.5 to 20 mg/kg/day, or 5 to 20 mg/kg/day, or about 20 to 80 mg/kg/day, or about 80 to 150 mg/kg/day.

In various embodiments, the dosage is about 50-2500 mg per day, 100-2500 mg/day, 300-1800 mg/day, or 500-1800 mg/day. In one embodiment, the dosage is between about 100 to 600 mg/day. In another embodiment, the dosage is between about 300 and 1200 mg/day. In particular embodiments, the composition or agent is administered at a dosage of 100 mg/day, 240 mg/day 300 mg/day, 600 mg/day, 1000 mg/day, 1200 mg/day, or 1800 mg/day, in one or more doses per day (i.e., inhere the combined doses achieve the desired daily dosage). In related embodiments, a dosage is 200 mg bid, 300 mg hid, 400 mg bid, 500 mg bid, 600 mg bid, or 700 mg bid, 800 mg bid, 900 mg bid, or 1000 mg bid. In various embodiments, the composition or agent is administered in single or repeal dosing. The initial dosage and subsequent dosages may be the same or different.

In some embodiments, the total dose administered may be about 1 mg, about 5 mg, about 10 mg, about 50 mg, about 100 mg, about 500 mg, 1,000 mg, about 2,000 mg, about 3,000 mg, about 4,000 mg, about 5,000 mg, about 6,000 mg, about 7,000 my about 8,000 mg, about 9,000 mg, about 10,000 mg, dosing interval. In different embodiments, the dosing interval may be once every day, once every two days, once every three days, once every four days, once every five days, once per week, or once per two weeks. For repeated administrations over several days or longer, depending on the condition, the treatment is sustained until a desired suppression of disease symptoms occurs. The progress of these and other therapies (e.g., ex vivo therapies) can be readily monitored by conventional methods and assays and based on criteria known to the physician or other persons of skill in the art.

It will be further appreciated that for sustained delivery devices and compositions the total dose of HRS contained in such delivery system will be correspondingly larger depending upon the release profile of the sustained release system. Thus, a sustained release composition or device that is intended to deliver HRS polypeptide over a period of 5 days will typically comprise at least about 5 to 10 times the daily dose of HRS polypeptide; a sustained release composition or device that is intended to deliver a HRS peptide over a period of 365 days will typically comprise at least about 400 to 800 times the daily dose of the HRS polypeptide (depending upon the stability and bioavailability of the HRS polypeptide when administered using the sustained release system).

In certain embodiments, a composition or agent is administered intravenously, e.g., by infusion over a period of time of about, e.g., 10 minutes to 90 minutes. In other related embodiments, a composition or agent is administered by continuous infusion, e.g., at a dosage of between about 001 to about 10 mg/kg/hr. over a time period. While the time period can vary, in certain embodiments the time period may be between about 10 minutes to about 24 hours or between about 10 mites to about three days.

In particular embodiments of the present invention, the effective amount of a composition or agent, or the blood plasma concentration of composition or agent is achieved or maintained, e.g., for at least 15 minutes, at least 30 minutes, at least 45 minutes, at least 60 minutes, at least 90 minutes, at least 2 hours, at least 3 hours, at least 4 hours, at least 8 hours, at least 1 hours, at least 24 hours, at least 48 hours, at least 3 days, at least 4 days, at least 5 days, at least 6 days, at least one week, at least 2 weeks, at least one month, at least 2 months, at least 4 months, at least 6 months, at least one year, at least 2 years, or greater than 2 years.

In certain HRS polypeptide-based embodiments, the amount of polypeptide administered will typically be in the range of about 0.1 mg/kg to about 15 mg/kg or to about 15 mg/kg to about 50 mg/kg of patient body weight. Depending on the type and severity of the disease, about 0.1 μg/kg to about 0.1 mg/kg to about 50 mg/kg body weight (e.g., about 0.1-15 mg/kg/dose) of polypeptide can be an initial candidate dosage for administration to the patient, whether, for example, by one or more separate administrations, or by continuous infusion. For example, a dosing regimen may comprise administering an initial loading dose of about 4 mg/kg, followed by a weekly maintenance dose of about 2 mg/kg of the polypeptide, or about half of the loading dose. However, other dosage regimens may be useful. A typical daily dosage might range from about 0.1 mg/kg to about 20 mg/kg to 100 mg/kg or more, depending on the factors mentioned above. For repeated administrations over several days or longer, depending on the condition, the treatment is sustained until a desired suppression of disease symptoms occurs. In particular embodiments, the effective dosage achieves the blood plasma levels or mean trough concentration of a composition or agent described herein. These may be readily determined using routine procedures.

In some embodiments, in any of these pharmaceutical compositions, the composition may also include one or more adjuvants, and such therapeutic immunogenic compositions may thus be used as vaccines. Adjuvants are substances that non-specifically enhance or potentiate the immune response (e.g., immune responses mediated by CTLs and helper-T (T_{H}) cells to an antigen, and would thus be considered useful in the therapeutic compositions of the present invention. Suitable adjuvants include, but are not limited to 1018 ISS, aluminium salts, Amplivax, AS15, BCG, CP-870,893, CpG7909, CyaA, dSLIM, flagellin or TLR5 ligands derived from flagellin, FLT3 ligand, GM-C SF, IC30, IC31, imiquimod (ALDARA), ImuFact IMP321, Interferon-alpha or -beta, or pegylated derivatives thereof, IS Patch, ISS, ISCOMATRIX, ISCOMs, JuvImmune, LipoVac, MALP2, MF59, monophosphoryl lipid A, Montanide IMS 1312, Montanide ISA 206, Montanide ISA 50V, Montanide ISA-51, water-in-oil and oil-in-water emulsions, OK-432, OM-174, OM-197-MP-EC, ONTAK, OspA, PepTel® vector system, PLG microparticles, resiquimod, SRL172, Virosomes and other Virus-like particles, YF-17D, VEGF trap, R848, beta-glucan, Pam3Cys, Aquila's QS21 stimulon, which is derived from saponin, mycobacterial extracts and synthetic bacterial cell wall mimics, and other proprietary adjuvants such as Ribi's Detox, Quil, or Superfos. Adjuvants such as Freund's or GM-CSF are preferred. Several immunological adjuvants (e.g., MF59) specific for dendritic cells and their preparation have been described previously (Dupuis M et al. 1998; Allison 1998). Also cytokines may be used. Several cytokines have been directly linked to influencing dendritic cell migration to lymphoid tissues (e.g., TNF-α), accelerating the maturation of dendritic cells into efficient antigen-presenting cells for T-lymphocytes (e.g., GM-CSF, IL-1 and IL-4) (U.S. Pat. No. 5,849,589, specifically incorporated herein by reference in its entirety) and acting as immunoadjuvants (e.g., IL-12, IL-15, IL-23, IL-7, TEN-alpha, IFN-beta) (Gabrilovich et al. 1996).

CpG immunostimulatory oligonucleotides have also been reported to enhance the effects of adjuvants in a vaccine setting. Without being bound by theory, CpG oligonucleotides act by activating the innate (non-adaptive) immune system via Toll-like receptors (TLR), mainly TLR9. CpG triggered TLR9 activation enhances antigen-specific humoral and cellular responses to a wide variety of antigens, including peptide or protein antigens, live or killed viruses, dendritic cell vaccines, autologous cellular vaccines and polysaccharide conjugates in both prophylactic and therapeutic vaccines. More importantly it enhances dendritic cell maturation and differentiation, resulting in enhanced activation of T_{H1} cells and strong cytotoxic T-lymphocyte (CTL) generation, even in the absence of CD4 T-cell help. The T_{H1} bias induced by TLR9 stimulation is maintained even in the presence of vaccine adjuvants such as alum or incomplete Freund's adjuvant (IFA) that normally promote a T_{H2} bias. CpG oligonucleotides show even greater adjuvant activity when formulated or co-administered with other adjuvants or in formulations such as microparticles, nano particles, lipid emulsions or similar formulations, which are especially necessary for inducing a strong response when the antigen is relatively weak. They also accelerate the illumine response and enabled the antigen doses to be reduced by approximately two orders of magnitude, comparable antibody responses to the full-dose vaccine without CpG in some experiments (Arthur M. Krieg, Nature Reviews, Drug Discovery, 5, JUNE 2006, 471-484). U.S. Pat. No. 6,406,705 B1 describes the combined use of CpG oligonucleotides, non-nucleic acid adjuvants and an antigen to induce an antigen-specific immune response. A commercially available CpG TLR9 antagonist is dSLIM (double Stem Loop Immunomodulator) by Mologen (Berlin, Germany), which is a preferred component of the pharmaceutical composition of the present invention. Other TLR binding molecules such as RNA binding TLR 7, TLR 8 and/or TLR 9 may also be used.

Other examples for useful adjuvants include, but are not limited to chemically modified CpGs (e.g. CpR, Idera), Poly(I:C), such as AmpliGen, non-CpG bacterial DNA or RNA as well as immunoactive small molecules and antibodies such as cyclophosphamide, sunitinib, Bavacizumab, celebrex, NCX-4016, sildenafil, tadalafil, vardenafil, sorafinib, XL-999, CP-547632, pazopanib, ZD2171, AZD2171, anti-CTLA4 and SC58175, which may act therapeutically and/or as an adjuvant. The amounts and concentrations of adjuvants and additives useful in the context of the present invention can readily be determined by the skilled artisan without undue experimentation.

### Combination Therapies

The present invention also includes combination therapies comprising administering to a patient a therapeutic dose of a HRS polypeptide in combination with a second active agent, or a device or a procedure for treating an autoimmune condition. In this context “administered in combination” includes: (1) part of the same unitary dosage form; and (2) administration separately, but as part of the same therapeutic treatment program or regimen, typically but not necessarily, on the same day.

In one aspect of these combination therapies, the second active agent is selected from one or more anti-histamines, one or more anti-inflammatory agents, one or more antineoplastic agents, one or more immunosuppressive agents, one or more antiviral agents, one or more agents that inhibit B cells, block B cell differentiation, or the activation of memory B cells, or one or more antioxidant agents. Pharmacologic or therapeutic agents which may find use in combination with the HRS polypeptides of the invention, include, without limitation, those disclosed in U.S. Pat. No. 4,474,451, columns 4-6 and U.S. Pat. No. 4,377,725, columns 7-8.

Examples of antihistamines include, but are not limited to, loradatine, hydroxyzine, diphenhydramine, chlorpheniramine, brompheniramine, cyproheptadine, terfenadine, clemastine, triprolidine, carbinoxamine, diphenylpyraline, phenindamine, azatadine, tripelennamine, dexchlorpheniramine, dexbrompheniramine, methdilazine, and trimeprazine doxylamine, pheniramine, pyrilamine, chiorcyclizine, thonzylamine, and derivatives thereof.

Examples of antineoplastic agents include, but are not limited to antibiotics and analogs (e.g., aclacinomycins, actinomycin f₁, anthramycin, azaserine, bleomycins, cactinomycin, carubicin, carzinophilin, chromomycins, dactinomycin, daunorubicin, 6-diazo-5-oxo-L-norleucine, doxorubicin, epirubicin, idarubicin, menogaril, mitomycins, mycophenolic acid, nogalamycin, olivomycines, peplomycin, pirarubicin, plicamycin, porfiromycin, puromycin, streptonigrin, streptozocin, tubercidin, zinostatin, zorubicin), antimetabolites (e.g. folic acid analogs (e.g., denopterin, edatrexate, methotrexate, piritrexim, pteropterin, Tomudex®, trimetrexate), purine analogs (e.g., cladribine, fludarabine, 6-mercaptopurine, thiamiprine, thioguanine), pyrimidine analogs (e.g., ancitabine, azacitidine, 6-azauridine, carmofur, cytarabine, doxifluridine, emitefur, enocitabine, floxuridine, fluorouracil, gemcitabine, tagafur).

Examples of anti-inflammatory agents include but are not limited to steroidal anti-inflammatory agents and non-steroidal anti-inflammatory Agents. Exemplary steroidal anti-inflammatory include acetoxypregnenolone, alclometasone, algestone, amcinonide, beclomethasone, betamethasone, budesonide, chloroprednisone, clobetasol, clobetasone, clocortolone, cloprednol, corticosterone, cortisone, cortivazol, deflazacort, desonide, desoximetasone, dexamethasone, diflorasone, diflucortolone, difluprednate, enoxolone, fluazacort, flucloronide, flumethasone, flunisolide, fluocinolone acetonide, fluocinonide, fluocortin butyl, fluocortolone, fluorometholone, fluperolone acetate, fluprednidene acetate, fluprednisolone, flurandrenolide, fluticasone propionate, formocortal, halcinonide, halobetasol propionate, halometasone, halopredone acetate, hydrocortamate, hydrocortisone, loteprednol etabonate, mazipredone, medrysone, meprednisone, methylprednisolone, mometasone furoate, paramethasone, prednicarbate, prednisolone, prednisolone 25-diethylamino-acetate, prednisolone sodium phosphate, prednisone, prednival, prednylidene, rimexolone, tixocortol, triamcinolone, triamcinolone acetonide, triamcinolone benetonide, and triamcinolone hexacetonide.

Exemplary non-steroidal anti-inflammatory agents include aminoarylcarboxylic acid derivatives (e.g., enfenamic acid, etofenamate, flufenamic acid, isonixin, meclofenamic acid, mefenamic acid, niflumic acid, talniflumate, terofenamate, tolfenamic acid), arylacetic acid derivatives (e.g., aceclofenac, acemetacin, alclofenac, amfenac, amtolmetin guacil, bromfenac, bufexamac, cinmetacin, clopirac, diclofenac sodium, etodolac, felbinac, fenclozic acid, fentiazac, glucametacin, ibufenac, indomethacin, isofezolac, isoxepac, lonazolac, metiazinic acid, mofezolac oxametacine, pirazolac, proglumetacin, sulindac, tiaramide, tolmetin, tropesin, zomepirac), arylbutyric acid derivatives (e.g., bumadizon, butibufen, fenbufen, xenbucin), arylcarboxylic acids (e.g., clidanac, ketorolac, tinoridine), arylpropionic acid derivatives (e.g., alminoprofen, benoxaprofen, bermoprofen, bucloxic acid, carprofen, fenoprofen, flunoxaprofen, flurbiprofen, ibuprofen, ibuproxam, indoprofen, ketoprofen, loxoprofen, naproxen, oxaprozin, piketoprolen, pirprofen, pranoprofen, protizinic acid, suprofen, tiaprofenic acid, ximoprofen, zaltoprofen), pyrazoles (e.g., difenamizole, epirizole), pyrazolones (e.g., apazone, benzpiperylon, feprazone, mofebutazone, morazone, oxyphenbutazone, phenylbutazone, pipebuzone, propyphenazone, ramifenazone, suxibuzone, thiazolinobutazone), salicylic acid derivatives (e.g., acetaminosalol, aspirin, benorylate, bromosaligenin, calcium acetylsalicylate, diflunisal, etersalate, fendosal, gentisic acid, glycol salicylate, imidazole salicylate, lysine acetylsalicylate, mesalamine, morpholine salicylate, 1-naphthyl salicylate, olsalazine, parsalmide, phenyl acetylsalicylate, phenyl salicylate, salacetamide, salicylamide o-acetic acid, salicylsulfuric acid, salsalate, sulfasalazine), thiazinecarboxamides (e.g., ampiroxicam, droxicam, isoxicam, lornoxicam, piroxicam, tenoxicam), ε-acetamidocaproic acid, s-adenosylmethionine, 3-amino-4-hydroxybutyric acid, amixenine, bendazac, benzydamine, bucolome, difenpiramide, ditazol, emorfazone, fepradinol, guaiazulene, nabumetone, nimesulide, oxaceprol, paranyline, perisoxal, proquazone, superoxide dismutase, tenidap, and zileuton.

Examples of immunosuppressive agents include without limitation, 2-amino-6-aryl-5-substituted pyrimidines (see U.S. Pat. No. 4,665,077); azathioprine; cyclophosphamide; bromocryptine; danazol; dapsone; glutaraldehyde (which masks the MHC antigens, as described in U.S. Pat. No. 4,120,649); anti-idiotypic antibodies for MHC antigens and MHC fragments; cyclosporin A; steroids such as glucocorticosteroids, e.g., prednisone, methylprednisolone, and dexamethasone; cytokine or cytokine receptor antagonists including anti-interferon-γ, -β or -α antibodies, anti-tumor necrosis factor-α antibodies, anti-tumor necrosis factor-43 antibodies, anti-interleukin-2 antibodies and anti-IL-2 receptor antibodies; anti-LFA-1 antibodies, including anti-CD11a and anti-CD18 antibodies; anti-L3T4 antibodies; heterologous anti-lymphocyte globulin; pan-T antibodies, preferably anti-CD3 or anti-CD4/CD4a antibodies; soluble peptide containing a LFA-3 binding domain (WO 90/08187 published Jul. 26, 1990); streptokinase; TGF-β; streptodornase; RNA or DNA from the host; FK506; RS-61443; deoxyspergualin; rapamycin; T-cell receptor (Cohen et al., U.S. Pat. No. 5,114,721); T-cell receptor fragments (Offner et al., Science, 251: 430-432 (1991); WO 90/11294; Janeway, Nature, 341: 482 (1989); and WO 91/01133); and T cell receptor antibodies (EP 340,109) such as T10139; anti-CD19 antibodies as described in Hekman et al. Cancer Immunol. Immunother. 32:364-372 (1991) and Vlasveld et al. Cancer Immunol. Immunother, 40:37-47 (1995); the B4 antibody in Diesel et al. Leukemia Research II, 12: 1119 (1987); anti-CD22 antibodies including epratuzmab; anti-BLyS (CD257) antibodies including Belimumab (benalysta); anti-CD20 antibodies including Ocrelizumab, rituximab, and ofatumumab. “Rituximab” or “RITUXAN®” refers to the genetically engineered chimeric murine/human monoclonal antibody directed against the CD20 antigen and designated “C2B8” iii U.S. Pat. No. 5,736,137. The antibody is an IgG₁ kappa immunoglobulin containing murine light and heavy chain variable region sequences and human constant region sequences. Rituximab has a binding affinity for the CD20 antigen of approximately 8.0 nM.

Examples of antiviral agents include interferon gamma, zidovudine, amantadine hydrochloride, ribavirin, acyclovir, valciclovir, dideoxycytidine, phosphonoformic acid, ganciclovir, and derivatives thereof.

Examples of agents that inhibit B cells, block B cell differentiation, or the activation of memory B cells, include anti-CD19 antibodies, anti-CD22 antibodies including epratuzmab; anti-BLyS (CD257) antibodies including Belimumab (benalysta); anti-CD20 antibodies including Ocrelizumab, rituximab, ofatumumab and “Rituximab” or “RITUXAN®”

Examples of antioxidant agents include ascorbate, alpha-tocopherol, mannitol, reduced glutathione, various carotenoids, cysteine, uric acid, taurine, tyrosine, superoxide dismutase, lutein, zeaxanthin, cryotpxanthin, astazanthin, lycopene, N-acetyl-cysteine, carnosine, gamma-glutamylcysteine, quercitin, lactoferrin, dihydrolipoic acid, citrate, Ginkgo Biloba extract, tea catechins, bilberry extract, vitamins E or esters of vitamin E, retinyl palmitate, and derivatives thereof. Other therapeutic agents include squalamine, carbonic anhydrase inhibitors, alpha-2 adrenergic receptor agonists, antiparasitics, antifungals, and derivatives thereof.

Preferably, the HRS polypeptide may be administered at a fixed daily dosage, and the other active agents taken on an as needed basis. When the HRS polypeptide is administered as adjuvant therapy with a second active agent, a preferred daily dosage is about 0.1 mg/kg/24 hours to about 55 mg/kg/24 hours, more preferably about 2 mg/kg/24 hours to about 20 mg/kg 724 hours.

The exact dose of each component administered will, of course, differ depending on the specific components prescribed, on the subject being treated, on the severity of the disease, e.g. severity of the inflammatory reaction, on the manner of administration and on the judgment of the prescribing physician. Thus, because of patient-to-patient variability, the dosages given above are a guideline and the physician may adjust doses of the compounds to achieve the treatment that the physician considers appropriate.

### Kits

Embodiments of the present invention, in other aspects, provide kits comprising one or more containers filled with one or more of the polypeptides, polynucleotides, antibodies, maim it complexes, compositions thereof, etc., of the invention, as described herein. The kits can include written instructions on how to use such compositions (e.g., to modulate cellular signaling, angiogenesis, cancer, inflammatory conditions, diagnosis etc.).

The kits herein may also include a one or more additional therapeutic agents or other components suitable or desired for the indication being treated, or for the desired diagnostic application. An additional therapeutic agent may be contained in a second container, if desired. Examples of additional therapeutic agents include, but are not limited to anti-neoplastic agents, anti-inflammatory agents, antibacterial agents, antiviral agents, angiogenic agents, etc.

The kits herein can also include one or more syringes or other components necessary or desired to facilitate an intended mode of delivery (e.g., stents, implantable depots, etc.).

In another aspect of the invention, kits, comprising: a) a container comprising a HRS polypeptide component; and b) instructions for use. Instructions may include steps of how to handle the HRS polypeptides, how to store the HRS polypeptides, and what to expect from using the HRS polypeptides.

In another aspect of the invention, kits, comprising: a) a container comprising a recombinant vector comprising a nucleic acid encoding a HRS polypeptide component; and b) instructions for use. Instructions may include steps of how to handle the vectors, how to store the vectors, or how to construct HRS polypeptide fusion proteins.

In another aspect of the invention, kits for treating a disease or disorder are provided, comprising: a) a container comprising a pharmaceutical composition comprising a HRS polypeptide component in a pharmaceutically acceptable formulation and b) instructions, and/or a product insert or

### Diagnostics

HRS polypeptides, and the corresponding polynucleotides (HRS polynucleotides), can be used in diagnostic assays and diagnostic compositions. Included are biochemical, histological, and cell-based methods and compositions, among others.

These and related embodiments include the detection of the HRS polynucleotide sequence(s) or corresponding HRS polypeptide sequence(s) or portions thereof of. For instance, certain aspects include detection of the HRS polynucleotide sequence(s) or corresponding pub/peptide sequence(s) or portions thereof of one or more newly identified HRS splice variants, and/or one or more splice junctions of those splice variants. In certain embodiments, the polynucleotide or corresponding polypeptide sequence(s) of at least one of the splice junctions is unique to that particular HRS splice variant. In some embodiments such HRS splice variants can indicate a susceptibility to a disease, including for example, an autoimmune disease.

Also included is the direct detection of HRS protein fragments, including splice variants, proteolytic fragments, and others. In certain embodiments, the presence or levels of one or more newly identified HRS protein fragments associate or correlate with one or more cellular types or cellular states. Hence, the presence or levels of a HRS polypeptide or polynucleotide can be used to distinguish between different cellular types or different cellular states. The presence or levels of HRS protein fragments or their related polynucleotides can be detected according to polynucleotide and/or polypeptide-based diagnostic techniques, as described herein and known in the art.

Certain aspects can employ the HRS protein fragments, or HRS polynucleotides as part of a companion diagnostic method, typically to assess whether a subject or population subjects will respond favorably to a specific medical treatment. For instance, a given HRS polypeptide based therapeutic agent (e.g., protein fragment, antibody, binding agent) could be identified as suitable for a subject or certain populations of subjects based on whether the subject(s) have one or more selected biomarkers for a given disease or condition. Examples of biomarkers include serum/tissue markers as well as markers that can be identified by medical imaging techniques. In certain embodiments, a naturally-occurring HRS protein, or fragment thereof (or its corresponding polynucleotide) may itself provide a serum and/or tissue biomarker that can be utilized to measure anti-HRS polypeptide levels, or free HRS polypeptide levels in a specific subject or a specific population of subjects. In certain aspects, the identification of a HRS polypeptide or polynucleotide reference sequence may include characterizing the differential expression of that sequence, whether in a selected subject, selected tissue, or otherwise, as described herein and known in the art.

Certain of the methods provided herein rely on the differential expression of a HRS polypeptide or polynucleotide to characterize the condition or state of a cell, tissue, or subject, and to distinguish it from another cell, tissue, or subject. Non-limiting examples include methods of detecting the presence or levels of a HRS polypeptide or polynucleotide in a biological sample to distinguish between cells or tissues of different species, cells of different tissues or organs, cellular developmental states such as neonatal and adult, cellular differentiation states, conditions such as healthy, diseased and treated, intracellular and extracellular fractions, in addition to primary cell cultures and other cell cultures, such as immortalized cell cultures.

Differential expression includes a statistically significant difference in one or more gene expression levels of a HRS polynucleotide or polypeptide reference sequence compared to the expression levels of the same sequence in an appropriate control. The statistically significant difference may relate to either an increase or a decrease in expression levels, as measured by RNA levels, protein levels, protein function, or any other relevant measure of gene expression such as those described herein. Also included is a comparison between a HRS polynucleotide or polypeptide of the invention and a full-length or wild-type cytosolic or mitochondrial HRS sequence, typically of the same or corresponding type. Differential expression can be detected by a variety of techniques in the art and described herein, including polynucleotide and polypeptide based techniques, such as real-time PCR, subtractive hybridization, polynucleotide and polypeptide arrays, and others.

A result is typically referred to as statistically significant if it is unlikely to have occurred by chance. The significance level of a test or result relates traditionally to a frequentist statistical hypothesis testing concept. In simple cases, statistical significance may be defined as the probability of making a decision to reject the null hypothesis when the null hypothesis is actually true (a decision known as a Type I error, or “false positive determination”). This decision is often made using the p-value: if the p-value is less than the significance level, then the null hypothesis is rejected. The smaller the p-value, the more significant the result. Bayes factors may also be utilized to determine statistical significance (see, e.g. Goodman S., Ann Intern Med 130:1005-13, 1999).

In more complicated, but practically important cases, the significance level of a test or result may reflect an analysis in which the probability of making a decision to reject the null hypothesis when the null hypothesis is actually true is no more than the stated probability. This type of analysis allows for those applications in which the probability of deciding to reject may be much smaller than the significance level for some sets of assumptions encompassed within the null hypothesis.

In certain exemplary embodiments, statistically significant differential expression may include situations wherein the expression level of a given HRS sequence provides at least about a 1.2×, 1.3×, 1.4×, 1.5×, 1.6×, 1.7×, 1.8×, 1.9×, 2.0×, 2.2×, 2.4×, 2.6×, 2.8×, 3.0×, 4.0×, 5.0×, 6.0×, 7.0×, 8.0×, 9.0×, 10.0×, 15.0×, 20.0×, 50.0×, 100.0×, or greater difference in expression (i.e., differential expression that may be higher or lower expression) in a suspected biological sample as compared to an appropriate control, including all integers and decimal points in between (e.g., 1.24×, 1.25×, 2.1×, 2.5×, 60.0×, 75.0×, etc.). In certain embodiments, statistically significant differential expression may include situations wherein the expression level of a given HRS sequence provides at least about 4, 5, 6, 7, 8, 9, 10, 11, 12, 13, 14, 15, 16, 17, 18, 19, 20, 25, 30, 35, 40, 45, 50, 60, 70, 80, 90, 100, 200, 300, 400, 500, 600, 700, 800, 900, 1000 percent (%) or greater difference in expression (i.e., differential expression that may be higher or lower) in a suspected biological sample as compared to an appropriate control, including all integers and decimal points in between.

As an additional example, differential expression may also be determined by performing Z-testing, i.e., calculating an absolute Z score, as described herein and known in the art (see Example 1). Z-testing is typically utilized to identify significant differences between a sample mean and a population mean. For example, as compared to a standard normal table (e.g., a control tissue), at a 95% confidence interval (i.e., at the 5% significance level), a Z-score with an absolute value greater than 1.96 indicates non-randomness. For a 99% confidence interval, if the absolute Z is greater than 2.58, it means that p<0.01, and the difference is even more significant—the null hypothesis can be rejected with greater confidence. In these and related embodiments, an absolute Z-score of 1.96, 2, 2.58, 3, 4, 5, 6, 7, 8, 9, 10, 11, 12, 13, 14, 15, 16, 17, 18, 19, 20 or more, including all decimal points in between (e.g., 10.1, 10.6, 11.2, etc.), may provide a strong measure of statistical significance. In certain embodiments, an absolute Z-score of greater than 6 may provide exceptionally high statistical significance.

Substantial similarly relates generally to the lack of a statistically significant difference in the expression levels between the biological sample and the reference control. Examples of substantially similar expression levels may include situations wherein the expression level of a given SSCIGS provides less than about a 0.05×, 0.1×, 0.2×, 0.3×, 0.4×, 0.5×, 0.6×, 0.7×, 0.8×, 0.9×, 1.0×, 1.1×, 1.2×, 1.3×, or 1.4× difference in expression (i.e., differential expression that may be higher or lower expression) in a suspected biological sample as compared to a reference sample, including all decimal points in between (e.g., 0.15×, 0.25×, 0.35×, etc.). In certain embodiments, differential expression may include situations wherein the expression level of a given HRS sequence provides less than about 0.25, 0.5, 1, 2, 3, 4, 5, 6, 7, 8, 9, 10, 11, 12, 13, 14, 15, 16, 17, 18, 19, 20, 30, 40, 50 percent (%) difference in expression (i.e., differential expression that may be higher or lower) in a suspected biological sample as compared to a reference sample, including all decimal points in between.

In certain embodiments, such as when using an Affymetrix Microarray to measure the expression levels of an HRS polynucleotide or polypeptide reference sequence, differential expression may also be determined by the mean expression value summarized by Affymetrix Microarray Suite 5 software (Affymetrix, Santa Clara, Calif.), or other similar software, typically with a scaled mean expression value of 1000.

Embodiments of the present invention include methods of detecting the presence or levels of an HRS polynucleotide or polypeptide reference sequence to characterize or diagnose the condition or a cell, tissue, organ, or subject, in which that condition may be characterized as healthy, diseased, at risk for being diseased, or treated. For such diagnostic purposes, the term “diagnostic” or “diagnosed” includes identifying the presence or nature of a pathologic condition, characterizing the risk of developing such a condition, and/or measuring the change (or no change) of a pathologic condition in response to therapy. Diagnostic methods may differ in their sensitivity and specificity. In certain embodiments, the “sensitivity” of a diagnostic assay refers to the percentage of diseased cells, tissues or subjects which test positive (percent of “true positives”). Diseased cells, tissues or subjects not detected by the assay are typically referred to as “false negatives.” Cells, tissues or subjects that are not diseased and which test negative in the assay may be termed “true negatives.” In certain embodiments, the “specificity” of a diagnostic assay may be defined as one (1) minus the false positive rate, where the “false positive” rate is defined as the proportion of those samples or subjects without the disease and which test positive. While a particular diagnostic method may not provide a definitive diagnosis of a condition, it suffices if the method provides a positive indication that aids in diagnosis.

In certain instances, the presence or risk of developing a pathologic condition can be diagnosed by comparing the presence or levels of one or more selected HRS polynucleotide or polypeptide reference sequences or portions thereof that correlate with the condition, whether by increased or decreased levels, as compared to a suitable control. A “suitable control” or “appropriate control” includes a value, level, feature, characteristic, or property determined in a cell or other biological sample of a tissue or organism, e.g., a control or normal cell, tissue or organism, exhibiting, for example, normal traits, such as the absence of the condition. In certain embodiments, a “suitable control” or “appropriate control” is a predefined value, level, feature, characteristic, or property. Other suitable controls will be apparent to persons skilled in the art. Examples of diseases and conditions, for example, diseases associated with autoantibodies specific for histidyl tRNA synthetase, are described elsewhere herein.

Embodiments of the present invention include HRS polynucleotide or nucleic acid-based detection techniques, which offer certain advantages due to sensitivity of detection. Hence, certain embodiments relate to the use or detection of HRS polynucleotides as part of a diagnostic method or assay. The presence and/or levels of AARS polynucleotides may be measured by any method known in the art, including hybridization assays such as Northern blot, quantitative or qualitative polymerase chain reaction (PCR), quantitative or qualitative reverse transcriptase PCR (RT-PCR), microarray, dot or slot blots, or in situ hybridization such as fluorescent in situ hybridization (FISH), among others. Certain of these methods are described in greater detail below.

HRS polynucleotide such as DNA and RNA can be collected and/or generated from blood, biological fluids, tissues, organs, cell lines, or other relevant sample using techniques known in the art, such as those described in Kingston. (2002 Current Protocols in Molecular Biology, Greene Publ. Assoc. Inc. & John Wiley & Sons, Inc., NY, N.Y. (see, e.g., as described by Nelson et al. PNAS USA, 99: 11890-11895, 2002) and elsewhere. Further, a variety of commercially available kits for constructing RNA are useful for making the RNA to be used in the present invention. RNA may be constructed from organs/tissues/cells procured from normal healthy subjects; however, this invention also contemplates construction of RNA from diseased subjects. Certain embodiments contemplate using any type of organ from any type of subject or animal. For test samples RNA may be procured from an individual (e.g., any animal, including mammals) with or without visible disease and from tissue samples, biological fluids (e.g., whole blood) or the like.

In certain embodiments, amplification or construction of cDNA sequences may be helpful to increase detection capabilities. The instant disclosure, as well as the art, provides the requisite level of detail to perform such tasks. In one exemplary embodiment, whole blood is used as the source of RNA and accordingly, RNA stabilizing reagents are optionally used, such as PAX tubes, as described, for example, in Thach et al., J. Immunol. Methods. December 283(1-2):269-279, 2003 and Chai et al., J. Clin. Lab Anal. 19(5):182-188, 2005 (both of which are incorporated by reference). Complementary DNA (cDNA) libraries can be generated using techniques known in the art, such as those described in Ausubel et al. (2001 Current Protocols in Molecular Biology, Greene Publ. Assoc. Inc. &. John Wiley & Sons, Inc., NY, N.Y.); Sambrook et al. (1989 Molecular Cloning, Second Ed., Cold Spring Harbor Laboratory, Plainview, N.Y.); Maniatis et al. (1982 Molecular Cloning, Cold Spring Harbor Laboratory, Plainview, N.Y.) and elsewhere. Further, a variety of commercially available kits for constructing cDNA libraries are useful for making the cDNA libraries of the present invention. Libraries can be constructed from organs/tissues/cells procured from normal, healthy subjects.

Certain embodiments may employ hybridization methods for detecting HRS polynucleotide sequences. Methods for conducting polynucleotide hybridization assays have been well developed in the art. Hybridization assay procedures and conditions will vary depending on the application and are selected in accordance with the general binding methods known including those referred to in: Maniatis et al. Molecular Cloning: A Laboratory Manual (2nd Ed. Cold Spring Harbor, N.Y., 1989); Berger and Kimmel Methods in Enzymology, Vol. 152, Guide to Molecular Cloning Techniques (Academic Press, Inc., San Diego, Calif., 1987); Young and Davis, PNAS, 80: 1194 (1983). Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference

Certain embodiments may employ nucleic acid amplification methods for detecting HRS polynucleotide sequences. The term “amplification” or “nucleic acid amplification” refers to the production of multiple copies of a target nucleic acid that contains at least a portion of the intended specific target nucleic acid sequence. The multiple copies may be referred to as amplicons or amplification products. In certain embodiments, the amplified target contains less than the complete target gene sequence (introns and exons) or an expressed target gene sequence (spliced transcript of exons and flanking untranslated sequences). For example, specific amplicons may be produced by amplifying a portion of the target polynucleotide by using amplification primers that hybridize to, and initiate polymerization from, internal positions of the target polynucleotide. Preferably, the amplified portion contains a detectable target sequence that may be detected using any of a variety of well-known methods.

“Selective amplification” or “specific amplification,” as used herein, refers to the amplification of a target nucleic acid sequence according to the present invention wherein detectable amplification of the target sequence is substantially limited to amplification of target sequence contributed by a nucleic acid sample of interest that is being tested and is not contributed by target nucleic acid sequence contributed by some other sample source, e.g., contamination present in reagents used during amplification reactions or in the environment in which amplification reactions are performed.

The term “amplification conditions” refers to conditions permitting nucleic acid amplification according to the present invention. Amplification conditions may, in some embodiments, be less stringent than “stringent hybridization conditions” as described herein. Oligonucleotides used in the amplification reactions of the present invention hybridize to their intended targets under amplification conditions, but may or may not hybridize under stringent hybridization conditions. On the other hand, detection probes of the present invention typically hybridize under stringent hybridization conditions. Acceptable conditions to carry out nucleic acid amplifications according to the present invention can be easily ascertained by someone having ordinary skill in the art depending on the particular method of amplification employed.

Many well-known methods of nucleic acid amplification require thermocycling to alternately denature double-stranded nucleic acids and hybridize primers; however, other well-known methods of nucleic acid amplification are isothermal. The polymerase chain reaction (U.S. Pat. Nos. 4,683,195; 4,683,202; 4,800,159; 4,965,188), commonly referred to as PCR, uses multiple cycles of denaturation, annealing of primer pairs to opposite strands, and primer extension to exponentially increase copy numbers of the target sequence. In a variation called RT-PCR, reverse transcriptase (RT) is used to make a complementary DNA (cDNA) from mRNA, and the cDNA is then amplified by PCR to produce multiple copies of DNA.

As noted above, the term “PCR” refers to multiple amplification cycles that selectively amplify a target nucleic acid species. Included are quantitative PCR (qPCR), real-time PCR), reverse transcription PCR (RT-PCR) and quantitative reverse transcription PCR (qRT-PCR) is well described in the art. The term “pPCR” refers to quantitative polymerase chain reaction, and the term “qRT-PCR” refers to quantitative reverse transcription polymerase chain reaction. qPCR and qRT-PCR may be used to amplify and simultaneously quantify a targeted cDNA molecule. It enables both detection and quantification of a specific sequence in a cDNA pool, such as a selected AARS gene or transcript.

The term “real-time PCR” may use DNA-binding dye to bind to all double-stranded (ds) DNA in PCR, causing fluorescence of the dye. An increase in DNA product during PCR therefore leads to an ease in fluorescence intensity and is measured at each cycle, thus allowing DNA concentrations to be quantified. However, dsDNA dyes such as SYBR Green will bind to all dsDNA PCR products. Fluorescence is detected and measured in the real-time PCR thermocycler, and its geometric increase corresponding to exponential increase of the product is used to determine the threshold cycle (“Ct”) in each reaction.

The term “Ct Score” refers to the threshold cycle number, which is the cycle at which PCR amplification has surpassed a threshold level. If there is a higher quantity of mRNA for a particular gene in a sample, it will cross the threshold earlier than a lowly expressed gene since there is more starting RNA to amplify. Therefore, a low Ct score indicates high gene expression in a sample and a high Ct score is indicative of low gene expression.

Certain embodiments may employ the ligase chain reaction (Weiss, Science. 254: 1292, 1991), commonly referred to as LCR, which uses two sets of complementary DNA oligonucleotides that hybridize to adjacent regions of the target nucleic acid. The DNA oligonucleotides are covalently linked by a DNA ligase in repeated cycles of thermal denaturation, hybridization and ligation to produce a detectable double-stranded ligated oligonucleotide product.

Another method is strand displacement amplification (Walker, G. et al., 1992, Proc. Natl. Acad. Sci. USA 89:392-396; U.S. Pat. Nos. 5,270,184 and 5,455,166), commonly referred to as SDA, which uses cycles of annealing pairs of primer sequences to opposite strands of a target sequence, primer extension in the presence of a dNTPαS to produce a duplex hemiphosphorothioated primer extension product, endonuclease-mediated nicking of a hemimodified restriction endonuclease recognition site, and polymerase-mediated primer extension from the 3′ end of the nick to displace an existing strand and produce a strand for the next round of primer annealing, nicking and strand displacement, resulting in geometric amplification of product. Thermophilic SDA (tSDA) uses thermophilic endonucleases and polymerases at higher temperatures in essentially the same method (European Pat. No. 0 684 315).

Other amplification methods include, for example: nucleic acid sequence based amplification (U.S. Pat. No. 5,130,238), commonly referred to as NASBA; one that uses an RNA replicase to amplify the probe molecule itself (Lizardi, P. et al., 1988, BioTechnol. 6: 1197-1202), commonly referred to as Qβ replicase; a transcription based amplification method (Kwoh, D. et al., 1989, PNAS USA 86:1173-177); self-sustained sequence replication (Guatelli, J. et al., 1990, PNAS USA 87: 1874-1878); and, transcription mediated amplification (U.S. Pat. Nos. 5,480,784 and 5,399,491), commonly referred to as TMA. For further discussion of known amplification methods see Persing, David H., 1993, “In Vitro Nucleic Acid Amplification Techniques” in Diagnostic Medical Microbiology: Principles and Applications (Persing et al., Eds.), pp. 51-87 (American Society for Microbiology, Washington, D.C.).

Illustrative transcription-based amplification systems of the present invention include TMA, which employs an RNA polymerase to produce multiple RNA transcripts of a target region (U.S. Pat. Nos. 5,480,784 and 5,399,491). TMA uses a “promoter-primer” that hybridizes to a target nucleic acid in the presence of a reverse transcriptase and an RNA polymerase to form a double-stranded promoter from which the RNA polymerase produces RNA transcripts. These transcripts can become templates for further rounds of TMA in the presence of a second primer capable of hybridizing to the RNA transcripts. Unlike PCR, LCR or other methods that require heat denaturation, TMA is an isothermal method that uses an RNase H activity to digest the RNA strand of an RNA:DNA hybrid, thereby making the DNA strand available for hybridization with a primer or promoter-primer. Generally, the RNase H activity associated with the reverse transcriptase provided for amplification is used.

In illustrative TMA method, one amplification primer is an oligonucleotide promoter-primer that comprises a promoter sequence which becomes functional when double-stranded, located 5′ of a target-binding sequence, which is capable of hybridizing to a binding site of a target RNA at a location 3′ to the sequence to be amplified. A promoter-primer may be referred to as a “T7-primer” when it is specific for T7 RNA polymerase recognition. Under certain circumstances, the 3′ end of a promoter-primer, or a subpopulation of such promoter-primers, may be modified to block or reduce primer extension. From an unmodified promoter-printer, reverse transcriptase creates a cDNA copy of the target RNA, while RNase H activity degrades the target RNA. A second amplification primer then binds to the cDNA. This primer may be referred to as a “non-T7 primer” to distinguish it from a “T7-primer.” From this second amplification printer, reverse transcriptase creates another DNA strand, resulting in a double-stranded DNA with a functional promoter at one end. When double-stranded, the promoter sequence is capable of binding an RNA polymerase to begin transcription of the target sequence to which the promoter-primer is hybridized. An RNA polymerase uses this promoter sequence to produce multiple RNA transcripts (i.e., amplicons), generally about 100 to 1,000 copies. Each newly-synthesized amplicon can anneal with the second amplification primer. Reverse transcriptase can then create a DNA copy, while the RNase H activity degrades the RNA of this RNA:DNA duplex. The promoter-primer can then bind to the newly synthesized DNA, allowing the reverse transcriptase to create a double-stranded DNA, from which the RNA polymerase produces multiple amplicons. Thus, a billion-fold isothermic amplification can be achieved using two amplification primers.

In certain embodiments, other techniques may be used to evaluate RNA transcripts of the transcripts from a particular cDNA library, including microarray analysis (Han, M., et al., Nat Biotechnol, 19: 631-635, 2001; Bao, P., et al., Anal Chem, 74: 1792-1797, 2002; Schena et al., Proc. Natl. Acad. Sci. USA 93:10614-19, 1996; and Heller et al., Proc. Natl. Acad. Sci. USA 94:2150-55, 1997) and SAGE (serial analysis of gene expression). Like MPSS, SAGE is digital and can generate a large number of signature sequences. (see e.g., Velculescu, V. E., et al., Trends Genet, 16: 423-425., 2000; Tuteja R. and Tuteja N. Bioessays. 2004 August; 26(8):916-22), although orders of magnitude fewer than that are available from techniques such as MPSS.

In certain embodiments, the term “microarray” includes a “nucleic acid microarray” having a substrate-bound plurality of nucleic acids, hybridization to each of the plurality of bound nucleic acids being separately detectable. The substrate can be solid or porous, planar or non-planar, unitary or distributed. Nucleic acid microarrays include all the devices so called in Schena (ed.), DNA Microarrays: A Practical Approach (Practical Approach Series), Oxford University Press (1999); Nature Genet. 21(1) (suppl.): 1-60 (1999); Schena (ed.), Microarray Biochip: Tools and Technology, Eaton Publishing Company/BioTechniques Books Division (2000). Nucleic acid microarrays may include a substrate-bound plurality of nucleic acids in which the plurality of nucleic acids are disposed on a plurality of beads, rather than on a unitary planar substrate, as described, for example, in Brenner et al., Proc. Natl. Acad. Sci. USA 97(4): 1665-1670 (2000). Examples of nucleic acid microarrays may be found in U.S. Pat. Nos. 6,391,623, 6,383,754, 6,383,749, 6,380,377, 6,379,897, 6,376,191, 6,372,431, 6,351,712 6,344,316, 6,316,193, 6,312,906, 6,309,828, 6,309,824, 6,306,643, 6,300,063, 6,287,850, 6,284,497, 6,284,465, 6,280,954, 6,262,216, 6,251,601, 6,245,518, 6,263,287, 6,251,601, 6,238,866, 6,228,575, 6,214,587, 6,203,989, 6,171,797, 6,103,474, 6,083,726, 6,054,274, 6,040,138, 6,083,726, 6,004,755, 6,001,309, 5,958,342, 5,952,180, 5,936,731, 5,843,655, 5,814,454, 5,837,196, 5,436,327, 5,412,087, and 5,405,783, the disclosures of which are incorporated by reference.

Additional examples include nucleic acid arrays that are commercially available from Affymetrix (Santa Clara, Calif.) under the brand name GENECHIP™. Further exemplary methods of manufacturing and using arrays are provided in, for example, U.S. Pat. Nos. 7,078,629; 7,011,949; 7,011,945; 6,936,419; 6,927,032; 6,924,103; 6,921,642; and 6,818,394.

The present invention as related to arrays and microarrays also contemplates many uses for polymers attached to solid substrates. These uses include gene expression monitoring, profiling, library screening, genotyping and diagnostics. Gene expression monitoring and profiling methods and methods useful for gene expression monitoring and profiling are shown in U.S. Pat. Nos. 5,800,992, 6,013,449, 6,020,135, 6,033,860, 6,040,138, 6,177,248 and 6,309,822. Genotyping and uses therefore are shown in U.S. Ser. Nos. 10/442,021, 10/013,598 (U.S. Application No. 2003/0036069), and U.S. Pat. Nos. 5,925,525, 6,268,141, 5,856,092, 6,267,152, 6,300,063, 6,525,185, 6,632,611, 5,858,659, 6,284,460, 6,361,947, 6,368,799, 6,673,579 and 6,333,179. Other methods of nucleic acid amplification, labeling and analysis that may be used in combination with the methods disclosed herein are embodied in U.S. Pat. Nos. 5,871,928, 5,902,723, 6,045,996, 5,541,061, and 6,197,506.

As will be apparent to persons skilled in the art, certain embodiments may employ oligonucleotides, such as primers or probes, for amplification or detection, as described herein. Oligonucleotides of a defined sequence and chemical structure may be produced by techniques known to those of ordinary skill in the art, such as by chemical or biochemical synthesis, and by in vitro or in vivo expression from recombinant nucleic acid molecules, e.g., bacterial or viral vectors. In certain embodiments, an oligonucleotide does not consist solely of wild-type chromosomal DNA or the in vivo transcription products thereof.

Oligonucleotides or primers may be modified in any way, as long as a given modification is compatible with the desired function of a given oligonucleotide. One of ordinary skill in the art can easily determine whether a given modification is suitable or desired for any given oligonucleotide of the present invention. Relevant AARS oligonucleotides are described in greater detail elsewhere herein.

While the design and sequence of oligonucleotides depends on their function as described herein, several variables are generally taken into account. Among the most relevant are: length, melting temperature (Tm), specificity, complementarity with other oligonucleotides in the system, G/C content, polypyrimidine (T, C) or polypurine (A, G) stretches, and the 3′-end sequence. Controlling for these and other variables is a standard and well known aspect of oligonucleotide design, and various computer programs are readily available to screen large numbers of potential oligonucleotides for optimal ones.

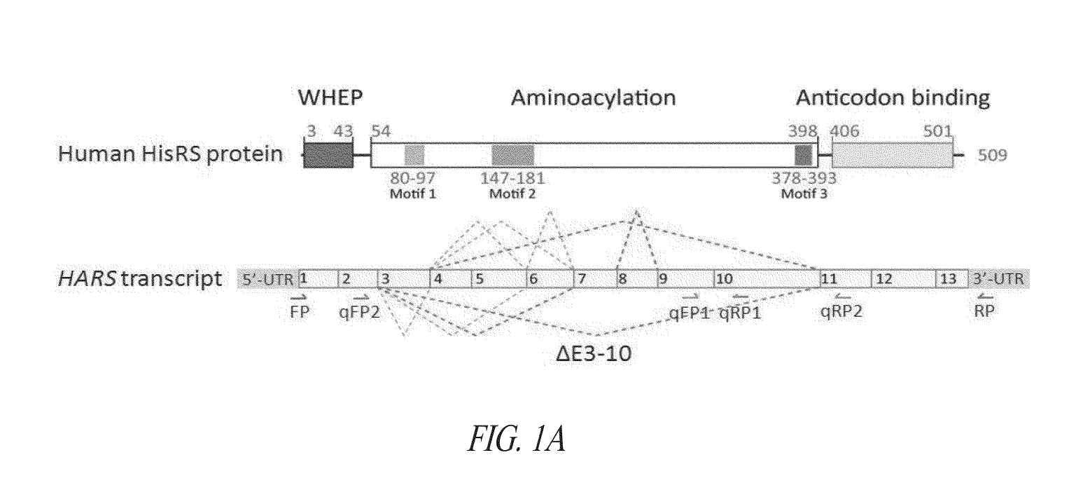

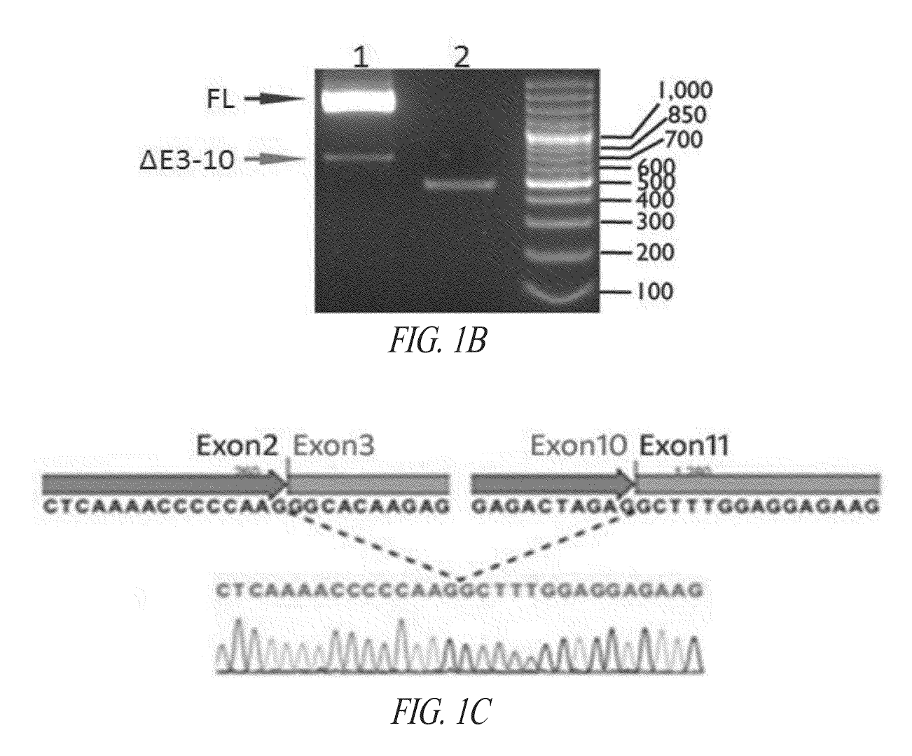

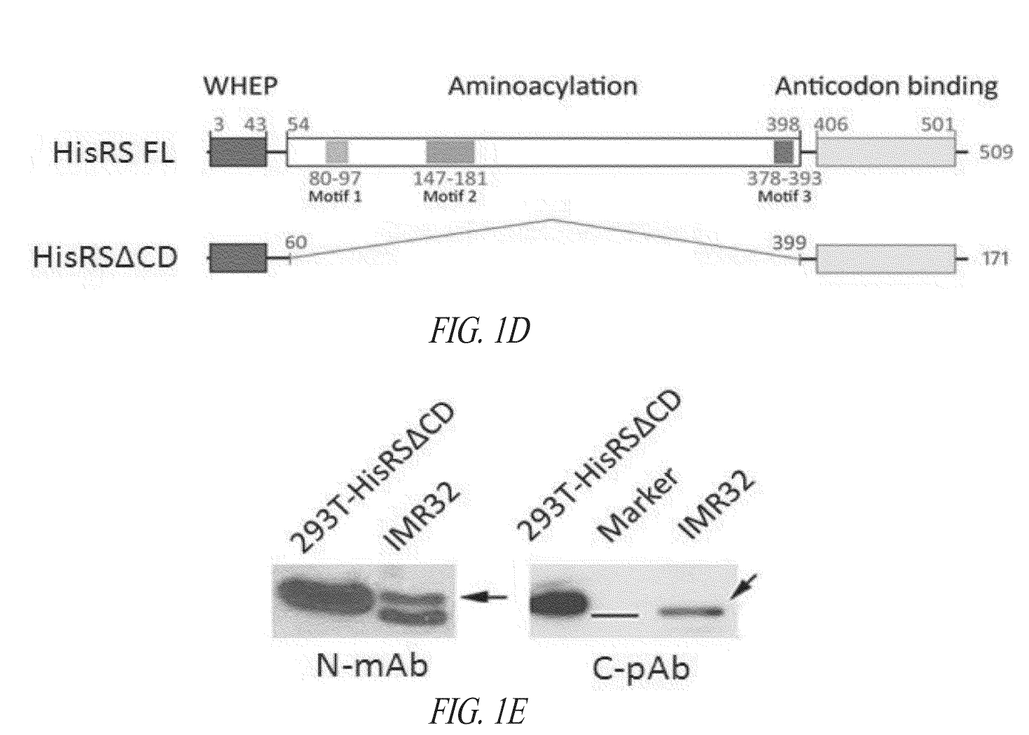

Certain embodiments therefore include methods for detecting a target AARS polynucleotide in a sample, the polynucleotide comprising the sequence of a reference AARS polynucleotide, as described herein, comprising a) hybridizing the sample with a probe comprising a sequence complementary to the target polynucleotide in the sample, and which probe specifically hybridizes to said target polynucleotide, under conditions whereby a hybridization complex is formed between said probe and said target polynucleotide or fragments thereof, and b) detecting the presence or absence of said hybridization complex, and optionally, if present, the amount thereof. Also included are methods for detecting a target HRS polynucleotide in a sample, the polynucleotide comprising the sequence of a reference HRS polynucleotide, as described herein, comprising a) amplifying the target polynucleotide or fragment thereof, and b) detecting the presence or absence of said amplified target polynucleotide or fragment thereof, and, optionally, if present, the amount thereof. Specific embodiments relate to the detection of AARS splice variants, such as by detecting a unique splice junction of the splice variant, whether by hybridization, amplification, or other detection method. FIG. 1C shows an exemplary, unique splice junction for the HRSΔCD splice variant of SEQ ID NO:7.

Embodiments of the present invention include a variety of HRS polypeptide-based detection techniques, including antibody-based detection techniques. Included in these embodiments are the use of HRS polypeptides to detect, quantitate, or epitope map anti-HRS antibodies in a biological sample, such as serum, whole blood or plasma. Certain embodiments may employ standard methodologies and detectors such as western blotting and immunoprecipitation, enzyme-linked immunosorbent assays (ELISA), flow cytometry, and immunofluorescence assays (IFA), which utilize an imaging device.

Certain embodiments may employ “arrays,” such as “microarrays.” In certain embodiments, a “microarray” may also refer to a “peptide microarray” or “protein microarray” having a substrate-bound collection or plurality of polypeptides, the binding to each of the plurality of bound polypeptides being separately detectable. Alternatively, the peptide, microarray may have a plurality of binders, including but not limited to monoclonal antibodies, polyclonal antibodies, phage display binders, yeast 2 hybrid binders, and aptamers, which can specifically detect the binding of the HRS polypeptides described herein. The array may be based on autoantibody detection of these HRS polypeptides, as described, for example, in Robinson et al., Nature Medicine 8(3):295-301 (2002). Examples of peptide arrays may be found in WO 02/31463, WO 02/25288, WO 01/94946, WO 01/88162, WO 01/68671, WO 01/57259, WO 00/61806, WO 00/54046, WO 00/47774, WO 99/40434, WO 99/39210, and WO 97/42507 and U.S. Pat. Nos. 6,268,210, 5,766,960, and 5,143,854, each of which are incorporated by reference.

Certain embodiments may employ MS or other molecular weight-based methods for diagnostically detecting HRS polypeptide sequences. Mass spectrometry (MS) refers generally to an analytical technique for determining the elemental composition of a sample or molecule. MS may also be used for determining the chemical structures of molecules, such as peptides and other chemical compounds.

Generally, the MS principle consists of ionizing chemical compounds to generate charged molecules or molecule fragments, and then measuring their mass-to-charge ratios. In an illustrative MS procedure: a sample is loaded onto the MS instrument, and undergoes vaporization, the components of the sample are ionized by one of a variety of methods (e.g., by impacting them with an electron beam) which results in the formation of positively charged particles, the positive ions are then accelerated by a magnetic field, computations are performed on the mass-to-charge ratio (m/z) of the particles based on the details of motion of the ions as they transit through electromagnetic fields, and, detection of the ions, which in step prior were sorted according to m/z.

An illustrative MS instruments has three modules: an ion source, which converts gas phase sample molecules into ions (or, in the case of electrospray ionization, move ions that exist in solution into the gas phase); a mass analyzer, which sorts the ions by their masses by applying electromagnetic fields; and a detector, which measures the value of an indicator quantity and thus provides data for calculating the abundances of each ion present.

The MS technique has both qualitative and quantitative uses, including identifying unknown compounds, determining the isotopic composition of elements in a molecule, and determining the structure of a compound by observing its fragmentation. Other uses include quantifying the amount of a compound in a sample or studying the fundamentals of gas phase ion chemistry (the chemistry of ions and neutrals in a vacuum). Included are gas chromatography-mass spectrometry (GC/MS or GC-MS), liquid chromatography mass spectrometry (LC/MS or LC-MS), and ion mobility spectrometry/mass spectrometry (IMS/MS or IMMS). Accordingly, MS techniques may be used according to any of the methods provided herein to measure the presence or levels of an AARS polypeptide of the invention in a biological sample, and to compare those levels to a control sample or a pre-determined value.

Certain embodiments may employ cell-sorting or cell visualization or imaging devices/techniques to detect or quantitate the presence or levels of AARS polynucleotides or polypeptides. Examples include flow cytometry or FACS, immunofluorescence analysis (IFA), and in situ hybridization techniques, such as fluorescent in situ hybridization (FISH).

Certain embodiments may employ conventional biology methods, software and systems for diagnostic purposes. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, for example Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics Application in Biological Science and Medicine (CRC Press, London, 2000) and Ouelette and Bzevanis Bioinformatics: A Practical Guide for Analysis of Gene and Proteins (Wiley & Sons, Inc., 2nd ed., 2001). See U.S. Pat. No. 6,420,108.

Certain embodiments may employ various computer program products and software for a variety of purposes, such as probe design, management of data, analysis, and instrument operation. See, U.S. Pat. Nos. 5,593,839, 5,795,716, 5, 729, 5,974,164, 6,066,454, 6,090,555, 6,185,561, 6,188,783, 6,223,127, 6,229,911 and 6,308,170.

The whole genome sampling assay (WGSA) is described, for example in Kennedy et al., Nat. Biotech. 21, 1233-1237 (2003), Matsuzaki et al., Gen. Res. 14: 414-425, (2004), and Matsuzaki, et al., Nature Methods 1:109-111 (2004). Algorithms for use with mapping assays are described, for example, in Liu et al., Bioinformatics. 19: 2397-2403 (2003) and Di et al. Bioinformatics. 21:1958 (2005). Additional methods related to WGSA and arrays useful for WGSA and applications of WGSA are disclosed, for example, in U.S. Patent Application Nos. 60/676,058 filed Apr. 29, 2005, 60/616,273 Oct. 5, 2004, 10/912,445, 11/044,831, 10/442,021, 10/650,332 and 10/463,991. Genome wide association studies using mapping assays are described in, for example, Hu et al., Cancer Res.; 65(7):2542-6 (2005), Mitra et al., Cancer Res., 64(21):8116-25 (2004), Butcher et al., Hum Mol Genet., 14(10):1315-25 (2005), and Klein et al., Science. 308(5720):385-9 (2005).

Additionally, certain embodiments may include methods for providing genetic information over networks such as the Internet as shown, for example, in U.S. application Ser. Nos. 10/197,621, 10/063,559 (United States Publication Number 2002/0183936), 10/065,856, 10/065,868, 10/328,818, 10/328,872, 10/423,403, and 60/482,389.

### EXAMPLES

### Example 1

### Identification of Alternative Splice Variants of Human HRS by Deep Sequencing of AARS-Transcriptome Enriched cDNA

Based on its sequence, the 509 amino acid human histidyl-tRNA synthetase (HRS; or HisRS) is a class II tRNA synthetase composed of a core catalytic domain, a C-terminal anticodon binding domain (ABD), and an N-terminal coiled-coiled WHEP domain (FIG. 1A). The catalytic aminoacylation domain is shared by all class II tRNA synthetases, which have a characteristic 7-stranded β-structure and flanking α-helices, with 3 class-defining conserved sequence motifs.

A high-throughput transcriptome sequencing technique was employed to achieve a comprehensive identification of alternatively spliced forms of HRS. Because whole transcriptome sequencing limits the read-depth of the exome of individual genes, an amplification-based transcriptome sequencing method was developed for a more thorough discovery of splice variants. Generally, RNA was reverse transcribed to cDNA by primers specific to the target gene, and then amplified using primers targeting their exon regions at positions close to the exon-exon junctions. This method allowed sensitive detection of low-abundant splice variants and was mainly designed for discovery of splice variants having exon-skipping events.

Specifically, the polyA⁺ RNA of human tissues including adult brain, fetal brain and peripheral blood leukocytes were purchased from Clontech. Total RNA of human leukemia Jurkat T cells, Burkitt's lymphoma Raji, and monocytic leukemia THP-1 cells was extracted using PureLink™ RNA Mini kit (Invitrogen), and analyzed by a NanoDrop 1000 spectrometer for quality and quantity. Genomic DNA was digested using TURBO DNase in the TURBO DNA-free Kit (Ambion, invitrogen). Messenger RNA (mRNA) vas isolated from total RNA using the FastTrack MAG Maxi mRNA Isolation kit (Invitrogen).

To enrich the transcriptome of AARS genes, a PCR-based method was employed using AARS-gene exon-specific primers. Here, complementary DNA (cDNA) was synthesized from RNA samples using a Superscript III First-Strand Synthesis Kit (Invitrogen) and reverse primers targeting AARS exons. Double-stranded cDNA was generated by multiplex PCR using AARS-gene exon-specific primer sets, and then purified by Nucleospin Extract II Kit (Macherey-Nagel). The double-stranded PCR products were constructed into cDNA libraries using a Multiplexing Sample Preparation Oligonucleotide Kit (Illumina) and sequenced by the HiSeq 2000 sequencing system (Illumina).

Deep sequencing reads were mapped and counted using rSeq version 4 (4) for the number of sequencing reads mapped to alternatively spliced exon-exon junctions. Annotated exon splice sites of the AARS genes were obtained from RefGene of NCBI based on the human reference genome (NCBI version 36, hg18). The results are shown in Table S1 below.

TABLE S1
Deep sequencing reads in HARS exon regions of AARS-transcriptome enriched cDNA of
human tissues and cells.

| Deep sequencing reads | | | | | | | AceView |
|---|---|---|---|---|---|---|---|
| | Adult | Fetal | Total | Jurkat T | Raji B | THP1 | database |
| Human samples | brain | brain | leukocytes | cells | cells | monocytes | annotations^{#} |
| Total reads in HARS | 581839 | 983047 | 179556 | 27214 | 20902 | 144987 | |
| exon regions | | | | | | | |
| Reads within exons | 419244 | 807656 | 160652 | 23801 | 15133 | 140782 | |
| Reads covering exon- | 162595 | 175391 | 18904 | 3413 | 5769 | 4205 | |
| exon junctions | | | | | | | |
| Exon1-2 | 36215 | 25365 | 196 | 60 | 0 | 294 | |
| Exon2-3 | 98054 | 28887 | 470 | 159 | 3 | 530 | |
| *Exon2-4 (ΔE3) | 1581 | 6970 | 8 | 6 | 0 | 1 | testis (3), |
| | | | | | | | amygdala (1), |
| | | | | | | | kidney, tumor |
| | | | | | | | tissue (1) |
| *Exon2-6 (ΔE3-5) | 0 | 7 | 0 | 0 | 0 | 0 | hippocampus |
| | | | | | | | (3), liver, tumor |
| | | | | | | | tissue (2), lung |
| | | | | | | | (2), skin (2) and |
| | | | | | | | 26 other tissues |
| *Exon2-7 (ΔE3-6) | 0 | 24 | 0 | 0 | 0 | 0 | not annotated |
| *Exon2-11 (ΔE3-10) | 50 | 0 | 0 | 7 | 0 | 0 | not annotated |
| Exon3-4 | 8255 | 30441 | 16186 | 402 | 309 | 2855 | |
| *Exon3-6 (ΔE4-5) | 10 | 98 | 16 | 0 | 0 | 0 | blastocyst (1), |
| | | | | | | | choriocarcinoma |
| | | | | | | | (1), cord blood |
| | | | | | | | (1), epithelioid |
| | | | | | | | carcinoma (1) |
| | | | | | | | and 8 other |
| | | | | | | | tissues |
| *Exon3-7 (ΔE4-6) | 0 | 2 | 6 | 0 | 0 | 0 | cerebellum (2) |
| *Exon3-11 (ΔE4-10) | 11 | 0 | 0 | 0 | 0 | 0 | not annotated |
| Exon4-5 | 1176 | 870 | 101 | 14 | 36 | 61 | |
| Exon5-6 | 610 | 1218 | 21 | 1 | 6 | 6 | |
| *Exon5-7 (ΔE6) | 28 | 49 | 38 | 0 | 0 | 0 | embryonic stem |
| | | | | | | | cells, cell lines |
| | | | | | | | H1, H7, and h9 |
| | | | | | | | (1), |
| | | | | | | | schizophrenic |
| | | | | | | | brain S-11 |
| | | | | | | | frontal lobe (1) |
| Exon6-7 | 1938 | 27828 | 366 | 12 | 5092 | 108 | |
| Exon7-8 | 273 | 1155 | 126 | 1 | 245 | 49 | |
| *Exon7-9 (ΔE8) | 0 | 0 | 1 | 0 | 0 | 0 | not annotated |
| Exon8-9 | 1638 | 815 | 38 | 6 | 59 | 43 | |
| Exon9-10 | 861 | 1171 | 29 | 0 | 19 | 7 | |
| Exon10-11 | 1265 | 508 | 86 | 4 | 0 | 5 | |
| Exon11-12 | 1962 | 2953 | 32 | 26 | 0 | 10 | |
| Exon12-13 | 8668 | 47030 | 1184 | 2715 | 0 | 236 | |

*Non-canonical exon junction (exon-skipping splicing event) identified by deep sequencing in the current study
^{#}Shown in the brackets is the number of clones from the respective tissue with sequence containing the corresponding non-canonical exon junction

When compared to other human exome sequencing efforts, this method was found to significantly enhance the sequencing depth, yielding a >2800 fold increase in sequencing reads after enrichment. The exon-skipping events of the HARS gene were concentrated on the region of exons 3 to 10 which encode the aminoacylation domain (FIG. 1A, Table S1). If these splice variants give rise to protein products, the generated HRS isoforms are expected to have partially or completely disrupted enzymatic activity. Thus, these splice variants may be endowed with novel biological functions through new domain compositions and structures. Possibly, they could be immunogenic or associated with pathologies when abnormally regulated or secreted.

### Example 2

### Validation and Expression Analysis of a Splice Variant HRSΔCD that Skips the Entire Catalytic Domain

HRSΔCD, the splice variant with the largest deletion, has the skipping of exons 3 to 10 (ΔE3-10) that encode the entire aminoacylation domain (see FIG. 1A). HRSΔCD was also found with 50 sequencing reads in human adult brain and 7 reads in Jurkat T lymphocytes (see Table S1). The putative protein product would carry no aminoacylation activity, but retains the N-terminal 60 amino acids and the C-terminal ABD. To further verify this splice variant and obtain a more complete sequence of its transcript, the polymerase chain reaction (PCR) was performed using the printers in Table S2 below.

TABLE S2
Nucleotide sequences of PCR and qPCR primers.

| | | |
|---|---|---|
| Primer Name | Target region | Nucleotide sequence |

HisRS PCR and qPCR primers

| | | |
|---|---|---|
| FP | 5'-UTR/Exon1 | 5'-AGTGGACAGCCGGGATGG |
| | | CAGAGC-3' |
| | | (SEQ ID NO: 22) |
| RP | 3'-UTR | 5'-ATAGTGCCAGTCCCACTT |
| | | CC-3' |
| | | (SEQ ID NO: 23) |
| qFP1 | Exon9 | 5'-CCCTGGTGGAACAGCTGC |
| | | TC-3' |
| | | (SEQ ID NO: 24) |
| qRP1 | Exon10 | 5'-CATAGATCACCCCAGTGT |
| | | AGTA-3' |
| | | (SEQ ID NO: 25) |
| qFP2 | Exon2 | 5'-TGTGCTCAAAACCCCCAA |
| | | G-3' |
| | | (SEQ ID NO: 26) |
| qRP2 | Exon11 | 5'-TGTGTCTCCGTGGTCCGT |
| | | A-3' |
| | | (SEQ ID NO: 27) |

Reference gene qPCR primers

| | | |
|---|---|---|
| RPL9-qFP | Exon4 | 5'-AAATGGTGGGGTAACAGA |
| | | AAG-3' |
| | | (SEQ ID NO: 28) |
| RPL9-qRP | Exon5 | 5'-GACGTTGATGGGGAAGTG |
| | | A-3' |
| | | (SEQ ID NO: 29) |
| RPS11-qFP | Exon2 | 5'-TTCAGACTGAGCGTGCCT |
| | | AC-3' |
| | | (SEQ ID NO: 30) |
| RPS11-qRP | Exon3 | 5'-GTGCCCTCAATAGCCTCC |
| | | TT-3' |
| | | (SEQ ID NO: 31) |

Total RNA of human neuroblastoma IMR-32 cells was prepared as described above and the first strand cDNA was synthesized using oligo-dT primers. PCR reactions were performed by primers targeting the 5′-UTR/Exon1 and 3′-UTR regions of the HARS gene, and the PCR product was validated by sequencing. Here, a PCR reaction with the cDNA template of mRNA from human neuroblastoma IMR32 cells, together with a pair of primers targeting the 5′-UTR/Exon1 and 3′-UTR regions of the HARS gene, amplified a product with a size shorter than the expected band of the full-length (FL) transcript (see FIGS. 1A and 1B, Table S2). This shorter PCR product was subjected to sequencing, and confirmed to bear the Exon2-11 junction of HRSΔCD (see FIG. 1C). Based on the sequence of the PCR product, the HRSΔCD transcript has exons 3 to 10 (1014 nt) removed, but still retains the 5′- and 3′-UTR region and the remaining exons of the FL transcript. It is therefore expected to translate into a protein with the in-frame deletion of the entire aminoacylation domain (residues 61-398), and thereby join the N-terminal WHEP domain to the C-terminal ABD (see FIG. 1D).

The SYBR green quantitative real-time PCR (qPCR) method was employed to examine the mRNA expression level of native HRS and of HRSΔCD transcripts in various human tissues. Using a variety of methods, qPCR reactions were optimized to produce specific PCR products with high efficiency. All amplified products were designed to cover exon junctions and to exclude amplicons derived from intronic regions. After optimization, a pair of primers targeting Exon9 and Exon10 was used to amplify the full length transcripts (see FIG. 1A, Table S2). For HRSΔCD, a pair of primers targeting Exon2 and Exon11 was employed in qPCR reactions having a short extension time (30 sec), which thereby attenuated amplification of the longer FL transcript. Specifically, each 20 μl qPCR reaction was composed of 2 μl cDNA, 250 nM of each of forward and reverse primers and 1× FastStart Universal Probe Master with ROX (Roche Diagnostics). The qPCR was performed in triplicates in a 384-well plate on the ABI ViiA 7 Real-Time PCR System (Applied Biosystems), using thermal cycling steps as follows: 2 min at 50° C., 10 min at 95° C., followed by 40 cycles of 95° C. for 30 sec and then 60° C. for 30 sec. A melt curve was generated at the end of the PCR cycles. The qPCR data was analyzed using ViiA 7 RUO Software (Applied Biosystems). Gene expression was normalized to house-keeping genes RPL9 and RPS11 as previously described

Using the optimized qPCR reactions, the presence of the HRS transcripts was analyzed across 13 human tissues, including those of the immune system (total leukocytes, bone marrow %, spleen), circulatory system (lung, heart, kidney), digestive system (liver, pancreas, small intestine, colon) and others (thyroid, adipose cells, skeletal muscle). The FL transcript for HRS was found in skeletal muscle to be more than 3 times more abundant than the median value seen in other tissues (see FIG. 5A). The whole panel analysis of HRSΔCD mRNA expression was limited in some tissues by the non-specific PCR products consistently generated with the prioritized primers. Amongst those that could be analyzed, the mRNA level of HRSΔCD was highest in skeletal muscle (about 3-fold above the median level, FIG. 5B). The mRNA expression of HRSΔCD relative to HRS FL is highest in lung (FIG. 5C), suggesting a potential association with IIM/ILD.

Western blot methods were then used to detect the HRSΔCD splice variant. These experiments employed two separate antibodies, one having binding specificity for the N-terminal region of HRS and the other having binding specificity for the C-terminal region of HRS. In view of the relatively small amounts of the mRNAs that correspond to these splice variants, and due to the difficulty in obtaining adequate amounts of human tissues, human cell lines cultured in vitro were employed. Because the HRSΔCD transcript was detected in the total RNA of IMR32 cells, its protein product was probed using total cell extracts of IMR32 cells with a monoclonal antibody raised against the N-terminus (1-97) of human HRS, and a polyclonal antibody generated by a peptide from the C-terminus.

Specifically, IMR-32 cells or HEK293T cells transiently transfected with a HRSΔCD construct were lysed by 50 mM Tris buffer (pH 8.0) containing 1% Triton X-100 and 5 mM EDTA. After incubation on ice for 30 minutes, lysed cells were centrifuged at 24,000×g 4° C. for 15 min, and the supernatant was collected and analyzed for protein concentration by BioAssay (Biorad). Whole cell lysates containing 50 μg proteins were loaded onto a NuPAGE 4-12% Bis-Tris gel for electrophoresis (Invitrogen, Carlsbad, Calif.) and transferred to a nitrocellulose membrane. The membranes were stained with a monoclonal antibody directed against N-terminal 1-97 amino acids of HRS (Abnova) and a polyclonal antibody against the C-terminus of HRS (Abcam) separately.

Both antibodies reacted with the same species having a MW of about 20 kDa (see FIG. 1E; and FIG. 5D). This protein is close in size to the recombinant HRSΔCD protein overexpressed in HEK 293T cells. Consistent with the relatively low amounts of its mRNA, HRSΔCD is much smaller in amount than that of full-length HRS detected by the same antibodies.

### Example 3

### Structure Determination of Human HRS by X-Ray Crystallography

Crystal structures of E. coli and T. thermophilus and of eukaryotic parasite T. brucei and T. cruzi in apo and histidine- or His-AMP-bound forms have been published. All such structures are α₂ dimers and, as expected for a class II synthetase, all have the characteristic and well conserved anti-parallel β-sheet fold flanked by α-helices in the catalytic domain. The HESs all have an α/β fold in the anticodon binding domain. The adenine binding pocket and the topology of an extra domain inserted between the characteristic conserved motifs 2 and 3 of the class II AARS catalytic core is substantially different in bacterial and eukaryote parasitic forms of the enzyme. So far no structure has been reported for a higher eukaryote form of HRS.

The cDNA encoding native human cytoplasmic HRS and the splice variant HRSΔCD were cloned into a modified pET32 vector and fused to the N-terminal thioredoxin-His₆-tags. The fusion proteins were expressed in E. coli BL21(DE3) and first purified by Ni²⁺-NTA affinity chromatography Next, the thioredoxin-His₆-tag was removed by protease-3C digestion. The cleaved protein mixtures were further separated by a size-exclusion chromatography in a buffer containing 50 mM Tris (pH 7.5), 100 mM NaCl, 1 mM EDTA and 1 mM DYE Native HRS and HRSΔCD mutants were created using the standard PCR-based mutagenesis method. The mutant proteins were purified using a protocol identical to that used for native HRS and HRSΔCD. Analytical gel filtration chromatography was carried out on an AKTA FPLC system (GE Healthcare). Proteins were loaded onto a Superose 12 10/300 GL column (GE Healthcare) equilibrated with a buffer containing 50 mM Tris (pH 7.5), 100 mM NaCl, 1 in M EDTA and 1 mM DTI.

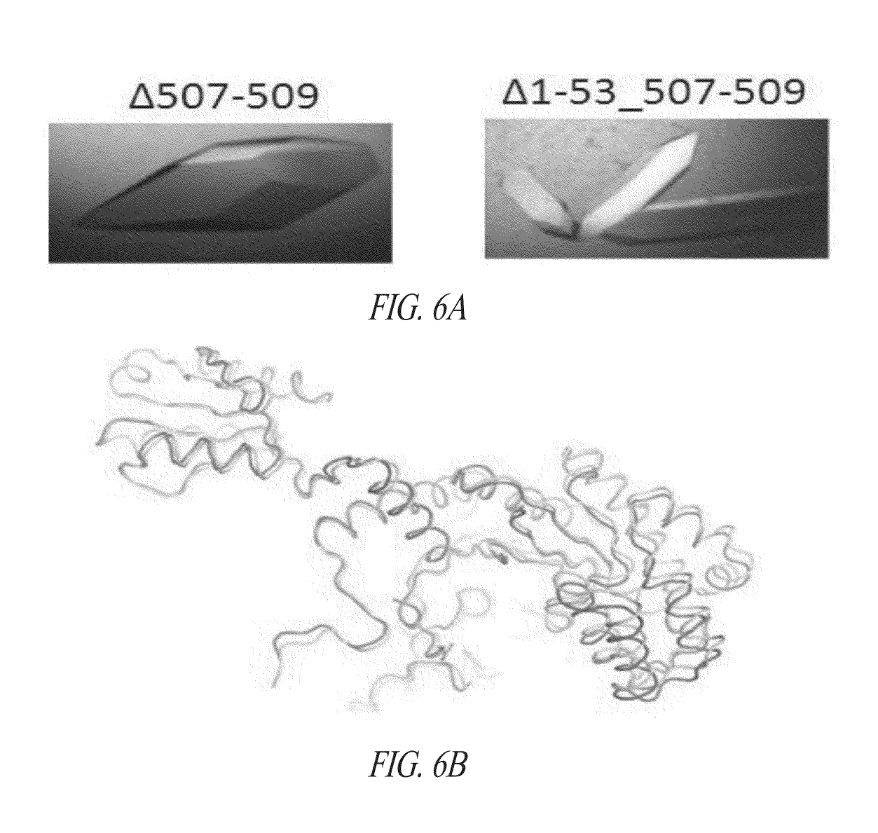

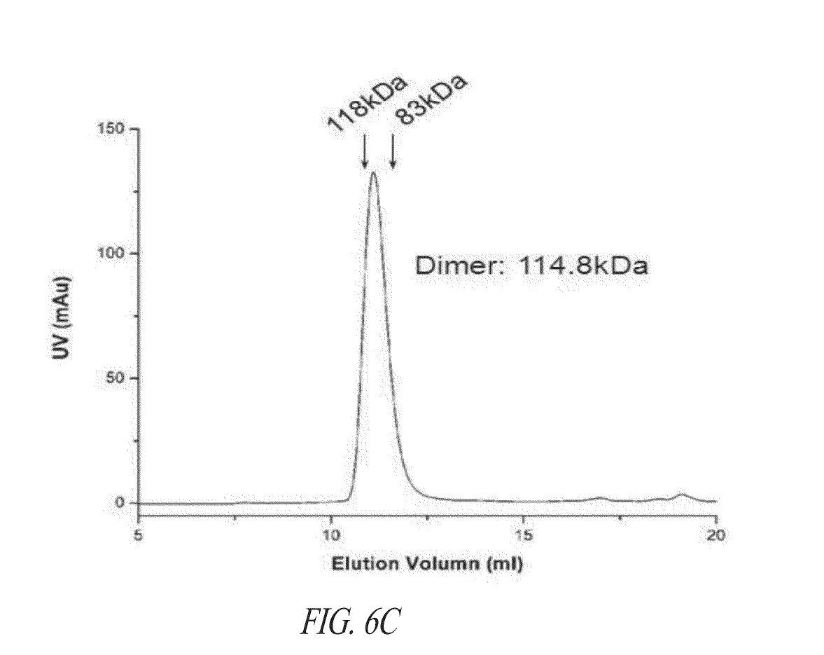

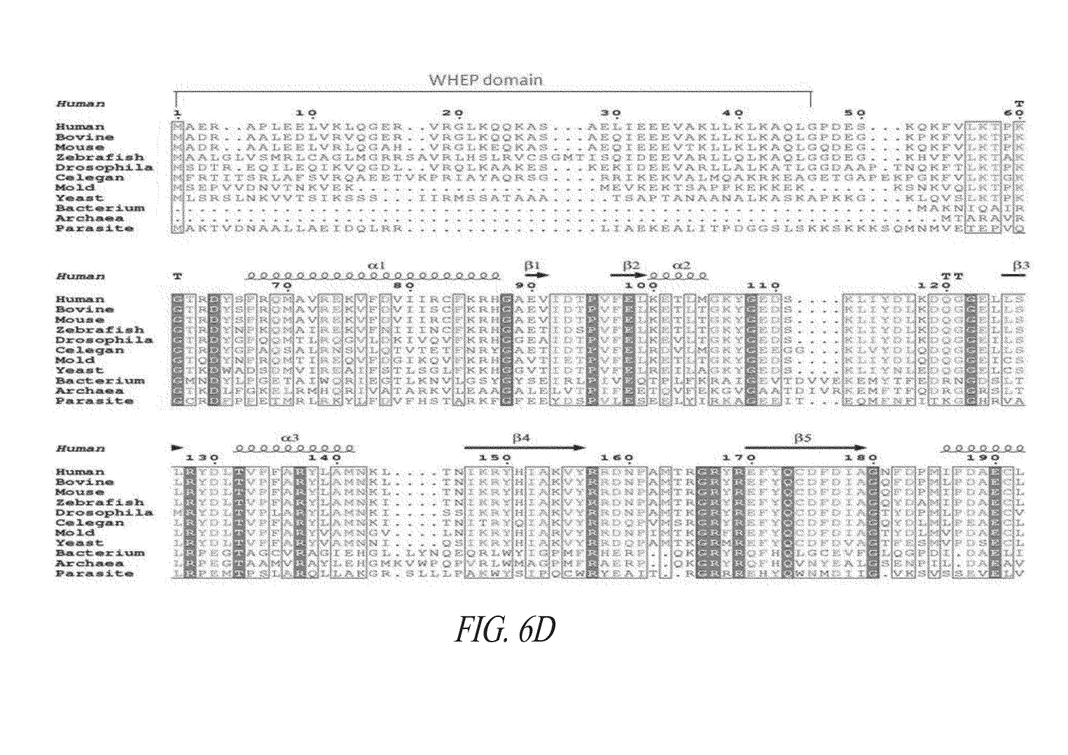

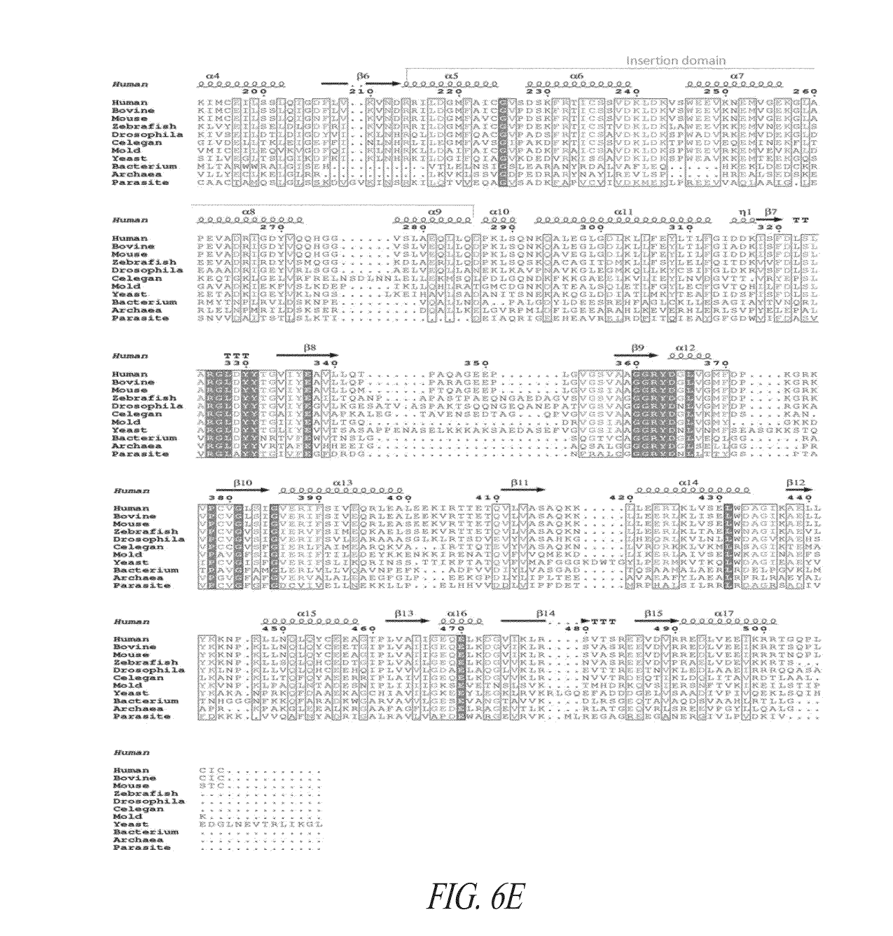

Purified recombinant HRS protein aggregated in the normal buffer conditions employed. However, by mapping cysteines in the human HRS sequence to the known structure of T. brucei and T. cruzi HRS, it was found that two cysteines (C507 and C509) at the very C-terminus may be solvent-exposed. Three residues at the C-terminus were thus removed (see FIG. 2A), and this truncation variant Δ507-509 did not aggregate on PAGE gels, even without added reducing agent such as DTT. To further improve the potential for crystal quality, the boundary of HRS was optimised by removing the flexible N-terminal region in different mutants (see FIG. 6A), to generate a Δ1-53_{—}Δ507-509 variant of HRS.

Crystals of HRS_{—}Δ507-509 and Δ1-53_{—}Δ507-509 were obtained by the hanging drop vapor diffusion method at 16° C. To set up a banging drop, 1 μl of protein sample was mixed with 1 μl of crystallization solution with 0.2 M ammonium citrate. 20% PEGMME 2000, and buffer (pH 7.0) (for Δ507-509), or 0.1 M imidazole (pH 7.0) and 20% v/v PEGMME 550 (for Δ1-53_{—}507-509). Before diffraction experiments, crystals were soaked in crystallization solution containing 30% glycerol for cryoprotection. The diffraction qualities of Δ507-509 crystals were improved by a fairly robust dehydration process. Specifically, crystals were soaked in crystallization solution containing 10-20% glycerol for 5-10 mins. The diffraction data were collected at the Shanghai Synchrotron Radiation Facility and were processed and scaled using HKL2000.

The initial phase of the structure determination of HRS_{—}Δ507-509 was determined by molecular replacement using the structural models of Trypanosoma HRS (PDB code: 3HR1). The phase was improved by density modifications with RESOLVE. The initial model was built in COOT. The crystal structure of HRS_{—}Δ1-53_{—}Δ507-509 was subsequently determined by using the initial model of Δ507-509 to perform molecular replacement. The models were refined in Refmac5 and PHENIX. Specifically, the model quality of Δ507-509 was improved by using the well refined model of Δ1-53_{—}507-509 as a reference during refinement. For Δ1-53_{—}Δ507-509, an additional TLS refinement was performed in PHENIX at the final stage. The final refinement statistics are listed in Table S3. All structure figures were prepared by PyMOL

Large crystals were obtained using C-terminal truncation variant (HRS_{—}Δ507-509), which diffracted to 3.2 Å resolution (see FIG. 6A). The space group was determined to be P4₁2₁2 with the unit cell dimensions a=b=100.4 Å, c=257.1 Å (see Table S3 below). As noted above, the crystal structure was solved by molecular replacement using T. brucei HRS (PDB: 3HR1) as the template. In the crystal structure of human HRS Δ507-509, the N-terminal WHEP domain is not visible and thus this domain is not tightly packed with the structural core (see FIG. 6B). The loose packing of the N-terminal domain is also supported by a previous study of the trypanosomal HRS, which showed that its N-terminus was amenable to enzymatic cleavage during expression.

Large crystals were also obtained using the N-terminal and C-terminal truncation variant (HRS_{—}Δ1-53_{—}Δ507-509), which diffracted at 2.4 Å resolution (see FIG. 6A). The space group was determined to be P4₁2₁2 with the unit cell dimensions a=b=93.5 Å, c=254.5 Å (see Table S3 below). This structure is essentially identical to that of the HRS Δ507-509 (see FIG. 6B), and shows a dimeric composition that agrees with the molecular weight determined by size exclusion chromatography (see FIG. 6C).

TABLE S3
Statistics of data collection and model
refinement of human HRS crystal structures.

| | |
|---|---|
| HisRS_Δ507-509 | HisRS_Δ1-53_Δ507-509 |

Data collection

| | | |
|---|---|---|
| Space group | P4₁2₁2 | P4₁2₁2 |
| Unit cell parameters | a = b = 100.4, | a = b = 93.5, |
| (Å) | c = 257.1 | c = 254.5 |
| Resolution range (Å) | 50-3.1 (3.15-3.1) | 50-2.4 (2.44-2.4) |
| No. of unique | 24210 (1191) | 45571 (2212) |
| reflections | | |
| Redundancy | 5.5 (5.6) | 6.1 (5.8) |
| I/σ | 22.6 (2.4) | 21.8 (2.3) |
| Completeness (%) | 98.8 (99.9) | 99.8 (99.9) |
| R_{merge} (%)^{a} | 6.9 (69.6) | 7.4 (67.9) |

Structure refinement

| | | |
|---|---|---|
| Resolution (Å) | 50-3.1 (3.2-3.1) | 50-2.4 (2.49-2.4) |
| R_{cryst}/R_{free} (%)^{b} | 27.1 (34.4)/ | 19.1 (26.8)/ |
| | 32.7 (40.0) | 25.0 (35.1) |
| r.m.s.d bonds (Å)/ | 0.014/1.5 | 0.005/0.9 |
| angles (°) | | |
| Average B factor | 55.0 | 54.4 |
| No. of atoms | | |
| protein atoms | 6430 | 6907 |
| water molecules | | 166 |
| other molecules | | 21 |
| No. of reflections | | |
| working set | 22659 | 42096 |
| test set | 1213 | 2124 |
| Ramachandran plot | | |
| most favored regions | 88.2 | 92.7 |
| (%) | | |
| additionally allowed | 11.0 | 7.3 |
| (%) | | |
| generously allowed | 0.8 | 0.0 |
| (%) | | |

Numbers in parentheses represent the value for the highest resolution shell.
^{a}R_{merge} = Σ|Iᵢ − Iₘ|/ΣIᵢ, where Iᵢ is the intensity of the measured reflection and Iₘ is the mean intensity of all symmetry related reflections.
^{b}R_{cryst} = Σ||F_{obs}| − |F_{calc}||/Σ|F_{obs}|, where F_{obs} and F_{calc} are observed and calculated structure factors.
R_{free} = Σ_{T}||F_{obs}| − |F_{calc}||/Σ_{T}|F_{obs}|, where T is a test data set of about 5% of the total reflections randomly chosen and set aside prior to refinement.

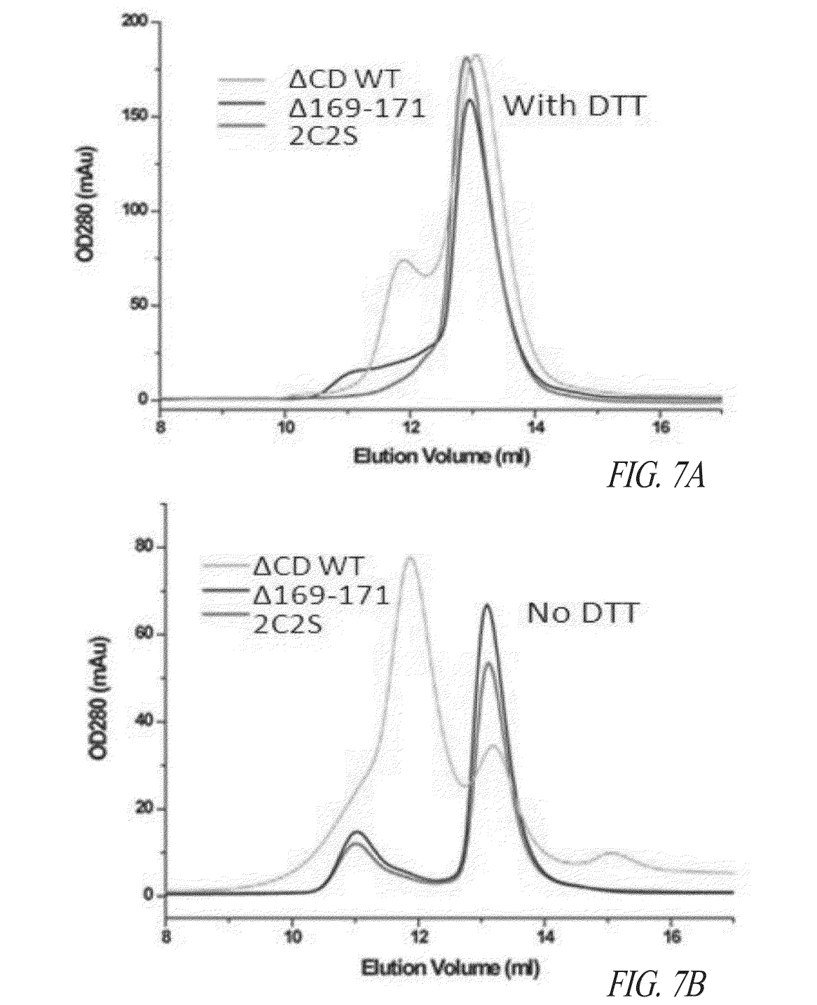

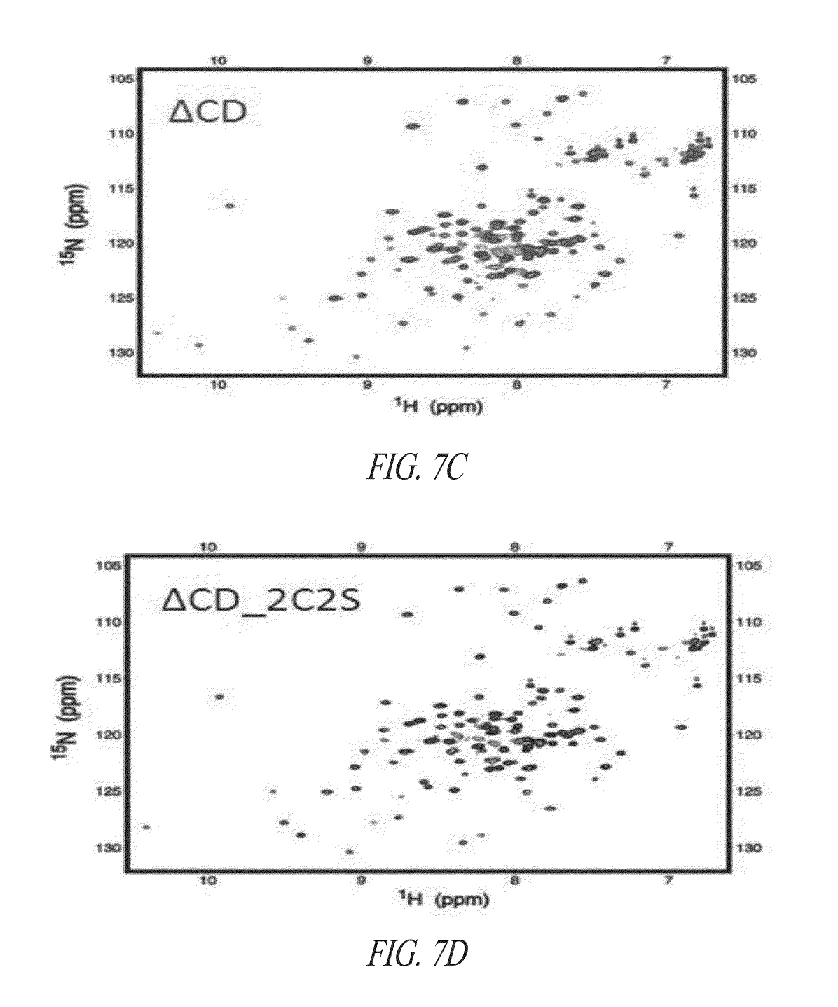

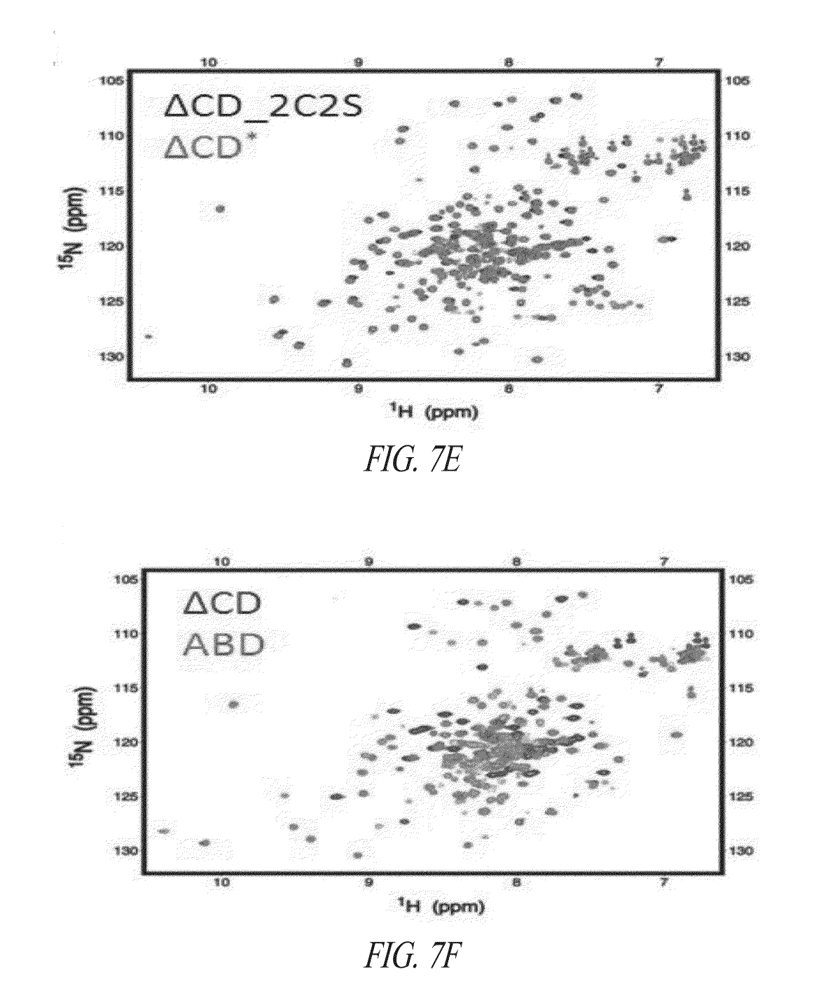

According to the structure of human HRS Δ1-53_{—}507-509, the overall fold of the CD and ABD of human HRS is similar to its bacterial, archaeal and T. brucei and T. cruzi homologs (FIG. 2C). The most prominent difference among these structures is in the additional domain inserted between conserved motifs 2 and 3 of the class II catalytic core. This insertion domain increases in size from prokaryotes to eukaryotes; and is not conserved in either sequence or structure between prokaryotic and eukaryotic HRSs (FIG. 7D). With the exception of a missing α9 helix in the insertion domain of eukaryote parasite homologs, the primary sequence and secondary structure elements of human HRS are similar to those of the parasite homologs. It was previously proposed that the insertion domain may contact the acceptor stem of the tRNA. Superposition of core structures of human, T. brucei, T. cruzi and T. thermophilus HRS also reveals the orientation difference of the insertion domains (FIG. 2D).

### Example 4

### Structure Determination of the Splice Variant HRSΔCD by NMR Spectroscopy

Similar to native HRS, wild-type HRSΔCD formed oligomers even in the presence of 1 mM DTT (see FIG. 7A). To avoid the disulfide formation, the C-terminal Cys169 and Cys171 (corresponding to C507 and C509 in HRS) were changed to serines (2C2S, FIG. 3A). The HRSΔCD_{—}2C2S proteins were mostly monomeric in solution (see FIGS. 7A and 7B), and the ¹H-¹⁵N heteronuclear single quantum coherence (HSQC) spectrum showed an increase in peak count and more uniform peak shape compared to that of the wild-type HRSΔCD (see FIGS. 7C and 7D). But the peak number was still less than expected and, together with the presence of broadened peaks, it was concluded that this protein still had non-specific interactions and was not sufficiently homogeneous for structure determination. Based on the solved crystal structure of HRS, it seemed likely that the absence of the CD in HRSΔCD exposed the hydrophobic inter-domain interface of the ABD, leading to non-specific hydrophobic interactions and thereby introducing heterogeneity.

Accordingly, to decrease the hydrophobicity, Trp94 (corresponding to Trp432 in the numbering of the sequence of full-length HRS and located at the center of the hydrophobic interface) was substituted by the more hydrophilic glutamine (Gln). This substitution greatly improved the protein homogeneity as demonstrated by the ¹H-¹⁵N HSQC spectrum, which displayed well dispersed peaks with a peak yield >95% (see FIG. 3B). In addition, comparing HRSΔCD 2C2S_W94Q mutant to the wild-type and 2C_{—}2S mutants, the shared HSQC peaks of the proteins exhibited no obvious chemical shifts, indicating that the substitutions did not alter the protein conformation (see FIGS. 7C and 7E). Therefore, the HRSΔCD 2C2S_W94Q mutant was used for further structural characterizations.

Initial attempts were made to solve the structure of HRSΔCD_{—}2C2S_W94Q by X-ray crystallography, but extensive trials failed to obtain well diffracting crystals. Because the ¹⁵N-¹H HSQC spectrum of HRSΔCD_{—}2C2S_W94Q is well dispersed and contains only one set of peaks, showing that this protein forms a well-folded structure in solution, its structure could be determined to a high resolution by nuclear magnetic resonance (NMR) spectroscopy.

NMR samples contained 0.8 mM of the HRSΔCD wild-type and 2C2S_W94Q mutant proteins in 50 mM potassium phosphate ((pH 6.5), with 1 mM DTT, 1 mM EDTA) in 90% H₂O/10% D₂O or 99.9% D₂O. NMR spectra were acquired at 30° C. on Varian Inova 750- and 800-MHz spectrometers, each equipped with an actively z-gradient shielded triple resonance probe. Backbone and side-chain resonance assignments of HRSΔCD_{—}2C2S_W94Q were achieved by the standard heteronuclear correlation experiments.

For NMR structural calculations, inter-proton distance restraints were obtained from a suite of three-dimensional, ¹³C- and ¹⁵N-separated NOESY experiments using a mixing time of 100 ins. Based on the NOE patterns and backbone secondary chemical shifts, hydrogen bonding restraints were generated from the standard secondary structure of the protein. The backbone dihedral angle restraints (φ and ψ angles) were derived from the chemical shift analysis program TALOS. Structures were calculated using the program Crystallography &. NMR System (CNS) (see Brunger et al., Acta Crystallogr D Biol Crystallogr. 54(Pt 5):905-21, 1998). Figures were generated using PYMOL (http://pymol.sourceforge.net/) and MOLMOL. The results are shown in FIG. 3 and Table S4 below.

TABLE S4
NMR structural statistics for the family of 20
structures of HisRSΔCD_2C2S_W94Q^{a}

| NMR distance and dihedral constraints | |
|---|---|
| Distance constraints | |
| Total NOE | 2397 |
| Intra-residue | 978 |
| Inter-residue | |
| Sequential (\|i − j\| = 1) | 491 |
| Medium-range (\|i − j\| < 4) | 404 |
| Long-range (\|i − j\| > 5) | 929 |
| Intermolecular | 0 |
| Hydrogen bonds | 148 |
| Total dihedral angle restraints | 216 |
| φ | 108 |
| ψ | 108 |
| Structure statistics | |
| Violations (mean and s.d.) | |
| Distance constraints (Å) | 0.001 ± 0.001 |
| Dihedral angle constraints (°) | 0.574 ± 0.063 |
| Max. dihedral angle violation (°) | |
| Max. distance constraint violation (Å) | |
| Deviations from idealized geometry | |
| Bond lengths (Å) | 0.002 ± 0.000 |
| Bond angles (°) | 0.429 ± 0.022 |
| Impropers (°) | 0.347 ± 0.047 |
| Mean energies (kcal mol⁻¹) | |
| E_{NOE}^{b} | 18.94 ± 4.08 |
| E_{cdih}^{b} | 1.31 ± 0.46 |
| E_{L-J} | −136 ± 54 |
| Ramachandran plot^{c} (%) | |
| most favorable regions | 79.7 |
| additional allowed regions | 14.2 |
| generously allowed regions | 4.3 |
| disallowed regions | 1.8 |
| Coordinate precision | |
| Atomic r.m.s. difference (Å)^{d} | |
| Residues 1-45 for the WHEP domain | |
| Heavy | 1.081 |
| Backbone | 0.447 |
| Residues 69-165 for the ABD | |
| Heavy | 1.468 |
| Backbone | 0.872 |

^{a}None of the structures exhibits distance violations greater than 0.3 Å or dihedral angle violations greater than 4°.
^{b}The final values of the square-well NOE and dihedral angle potentials were calculated with force constants of 50 kcal mol⁻¹ and 200 kcal mol⁻¹ rad⁻², respectively.
^{c}The program Procheck was used to assess the overall quality of the structures.
^{d}The precision of the atomic coordinates is defined as the average r.m.s. difference between 20 final structures and the mean coordinates of the protein.

The ensemble of 20 NMR structures of HRSΔCD 2C2S_W94Q are well defined, with a RMSD of 0.447 Å for backbone atoms and 1.081 Å for heavy atoms of the WHEP domain, and a RMSD of 0.872 Å for backbone atoms and 1.468 Å for heavy atoms of the ABD (see FIG. 3C). The WHEP domain adopts an antiparallel bi-helical structure. The ABD of HRSΔCD_{—}2C2S_W94Q forms a compact mixed α/β fold. The WHEP and ABD domains are connected by a 27 amino acid, highly flexible linker (see FIG. 3C). No long-distance NOE couplings between the residues of the two domains were found in NMR spectra. This lack of couplings showed that the two domains do not make contacts. As a further support, we purified the ABD (residues 398-506) alone and, when comparing its HSQC spectrum with that of the ABD in HRSΔCD_{—}2C2S_W94Q, these amino acids showed largely the same chemical shifts (see FIG. 7F). Thus, HRSΔCD_{—}2C2S_W94Q appears as a dumbbell-like structure with “free-floating” N- and C-terminal domains.

In HRSΔCD_{—}2C2S_W94Q, the packing interactions of the ABD with the CD have been released. Comparing the ABDs in the NMR structure of HRSΔCD_{—}2C2S_W94Q with that of the crystal structure of HRS Δ1-53_{—}507-509, the structural elements and overall folds mostly are the same (see FIG. 3E). However, a prominent difference was found at helix α15 and the loop preceding it (see FIG. 6D). In HRS this helix and the loop are rigidly packed with the CD. In HRSΔCD_{—}2C2S_W94Q this region becomes flexible and moves inward, due to the lack of packing interactions with the CD.

### Example 5

### Association of HRSΔCD with IIM and ILD

Human HRS is associated with idiopathic inflammatory myopathies (IIM) and interstitial lung disease (ILD). HRS or its constituent peptides have been implicated in the etiology of these diseases. For patients with or ILD, Jo-1 autoantibodies target the N-terminal region of HisRS. Accordingly, experiments were performed to assess the interaction of the HisRSΔCD splice variant with Jo-1 autoantibodies.

For this experiment, two lots (7B04507 and 4L34811) of human Jo-1 antibodies from two patient donors were obtained from Raybiotech Inc. (Norcross, Ga.). For the ELISA test, the 96-well EIA/RIA plate (Corning, N.Y.) was coated with 50 μl recombinant proteins (2 μg/ml) PBS buffer and incubated overnight at 4° C. After washing five times with PBS plus 0.1% Tween-20, the wells were blocked for 1 hr with 1% BSA in PBS. Then, human Jo-1 antibodies in two-fold serial dilutions (from 1/1000 to 1/128,000) were added and incubated for 1.5 hours. Following 1 hour incubation with HRP-conjugated goat anti-human IgG (0.1 μg/ml, AbD Serotec, Raleigh, N.C.), 3,3,5,5-tetramethylbenzidine (TMB) (50 μl, Thermo Scientific, Rockford, Ill.) was added and the reaction was terminated by 2N H₂SO₄ (50 μl). The absorbance at 450 nm was measured by a FLUOstar OPTIMA (BMG LABTECH, Offenburg, Germany) instrument. The data were plotted as OD₄₅₀ against antibody dilution factor, and the curve fitting was performed by one site-specific binding with a Hill coefficient of 1, using Prism 4 software

FIG. 4 shows that Jo-1 antibodies from patients react with HisRSΔCD. In addition, a fragment that approximately corresponds to the N-terminal WHEP domain of HisRSΔCD is commonly found in patient samples.

Granzyme B was then assessed for its ability to cleave the HRSΔCD splice variant. For this experiment, recombinant human granzyme B was purchased from R&D systems (Minneapolis, Minn.). Following the manufacturer's instructions, Granzyme B was first incubated for 4 hours with cathepsin C (R&D systems, Minneapolis, Minn.) for activation. The reaction mixture (50 μl) was composed of recombinant proteins (0.3 μg/μl) and activated granzyme B (5 ng/μl) and incubated at 37° C. for 1 hour. The reaction was stopped by adding sampling buffer and boiling for 10 minutes. The samples were subjected to NuPAGE 4-12% Bis-Tris gel electrophoresis (Invitrogen, Carlsbad, Calif.) and transferred to nitrocellulose membrane. The membrane was stained with a C-His tag antibody (Invitrogen, Carlsbad, Calif.) to track protein cleavage. Here, treatment of HisRSΔCD with granzyme B released the N-terminal domain of HRSΔCD (data not shown).

Overall, these results suggest that the HisRSΔCD splice variant could be associated with IIM and/or ILD.

1-49. (canceled)

50. A method of drug design, comprising the step of using the structural coordinates of a human histidyl tRNA synthetase (HRS) polypeptide comprising the coordinates of Table S2 or Table S3, to computationally evaluate an agent for binding to an (exposed) binding site of the HRS polypeptide.

51. A method of identifying an agent that binds to a human histidyl-tRNA synthetase (HRS) polypeptide, comprising: (a) obtaining structural coordinates of (i) an x-ray crystallographic structure of human HRS as characterized by Table S2, or (ii) a three-dimensional nuclear magnetic resonance (NMR) spectroscopy structure of human HRS as characterized by Table S3, +/− a root mean square deviation from the backbone atoms that is not more than 1.5 \acute{Å}; and (b) using the structural coordinates and one or more molecular modeling techniques to identify an agent that binds to the human HRS polypeptide.

52. The method of claim 51, where (b) comprises generating a three-dimensional representation of human HRS on a digital computer, where the three-dimensional representation has (i) the x-ray crystallographic structure coordinates of Table S2, or (ii) the three-dimensional nuclear magnetic resonance (NMR) spectroscopy structure coordinates of Table S3, +/− a root mean square deviation from the backbone atoms that is not more than 1.5 \acute{Å}; and using the three-dimensional representation from to identify an agent that binds to the HRS polypeptide.

53. The method of claim 52, where (b) comprises using software comprised by the digital computer to design the agent.

54. The method of claim 52, where the digital computer comprises (structural coordinates of) a library of candidate agents, and where (b) comprises using software comprised by the digital computer to identify (or select) the agent from the library of candidate agents.

55. The method claim 52, comprising using the three-dimensional representation of human HRS to derivatize the agent and thereby alter its ability to bind to the HRS polypeptide.

56. The method of claim 51, comprising (c) optionally synthesizing or otherwise obtaining the agent; and (d) contacting the agent with the HRS polypeptide to determine the ability of the agent to bind to the HRS polypeptide.

57. The method of claim 51, comprising (c) optionally synthesizing or otherwise obtaining the agent; and (d) contacting the agent with the HRS polypeptide to measure the ability of the agent to modulate at least one non-canonical and/or canonical activity of a HRS polypeptide.

58. The method of claim 57, where the agent fully or partially antagonizes at least one non-canonical activity of the human HRS polypeptide.

59. The method of claim 57, where the agent fully or partially agonizes at least one non-canonical activity of the human HRS polypeptide.

60. The method of claim 56, where the agent antagonizes the binding of wild-type human HRS to a disease-associated autoantibody.

61. The method of claim 57, where the agent does not significantly antagonize the canonical activity of human HRS.

62. The method of claim 57, comprising assessing the structure-activity relationship (SAR) of the agent, to correlate its structure with modulation of the non-canonical and/or canonical activity, and optionally derivatizing the compound to alter its ability to modulate the non-canonical and/or canonical activity.

63. The method of claim 51, were the agent is a polypeptide or peptide, an antibody or antigen-binding fragment thereof, a peptide mimetic, an adnectin, a small molecule, or an aptamer.

64. The method of claim 51, where the crystallographic structure is characterized by (i) a space group of P4₁2₁2 and unit cell dimensions of a=b=100.4 \acute{Å}, c=257.1 \acute{Å}, or (ii) a space group of P4₁2₁2 and unit cell dimensions of a=b=93.5 \acute{Å}, c=254.5 \acute{Å}.

65. A computer program for instructing a digital computer to perform the method of generating a three-dimensional model of a human histidyl-tRNA synthetase (HRS) polypeptide on a computer screen, where the three-dimensional model has (i) x-ray crystallographic structure coordinates of Table S2, or (ii) nuclear magnetic resonance (NMR) spectroscopy structure coordinates of Table S3, +/− a root mean square deviation from the backbone atoms that is not more than 1.5 \acute{Å}; and optionally the same or different computer program for instructing the digital computer to identify an agent that binds to the human HRS polypeptide.

66. The computer program of claim 65, for instructing the digital computer to design an agent that binds to the human HRS polypeptide.

67. The computer program of claim 65, where the digital computer comprises (structural coordinates of) a library of candidate agents, and the computer program is for instructing the digital computer to identify (or select) the agent from the library of candidate agents.

68. A computer readable medium having computer-readable code embodied thereon, the computer-readable code comprising structural coordinates of a human histidyl-tRNA synthetase (HRS) polypeptide characterized by (a) the x-ray crystallographic structure of Table S2, or (b) the nuclear magnetic resonance (NMR) spectroscopy structure of Table S3, +/− a root mean square deviation from the backbone atoms that is not more than 1.5 \acute{Å}.

69. The computer readable medium of claim 68, where the crystallographic structure is characterized by (i) a space group of P4₁2₁2 and unit cell dimensions of a=b=100.4 \acute{Å}, c=257.1 \acute{Å}, or (ii) a space group of P4₁2₁2 and unit cell dimensions of a=b=93.5 \acute{Å}, c=254.5 \acute{Å}.

70. A crystallized human histidyl-tRNA synthetase polypeptide that is characterized by (a) a space group of P4₁2₁2 and unit cell dimensions of a=b=100.4 \acute{Å}, c=257.1 \acute{Å}, or (b) a space group of P4₁2₁2 and unit cell dimensions of a=b=93.5 \acute{Å}, c=254.5 \acute{Å}.


SEQUENCE LISTING (37 sequences)

SEQ ID NO: 1 - protein, 509 aa, Homo sapiens
MAERAALEELVKLQGERVRGLKQQKASAELIEEEVAKLLKLKAQLGPDESKQKFVLKTPKGTRDYSPRQMAVREKVFDVIIRCFKRHGAEVIDTPVFELKETLMGKYGEDSKLIYDLKDQGGELLSLRYDLTVPFARYLAMNKLTNIKRYHIAKVYRRDNPAMTRGRYREFYQCDFDIAGNFDPMIPDAECLKIMCEILSSLQIGDFLVKVNDRRILDGMFAICGVSDSKFRTICSSVDKLDKVSWEEVKNEMVGEKGLAPEVADRIGDYVQQHGGVSLVEQLLQDPKLSQNKQALEGLGDLKLLFEYLTLFGIDDKISFDLSLARGLDYYTGVIYEAVLLQTPAQAGEEPLGVGSVAAGGRYDGLVGMFDPKGRKVPCVGLSIGVERIFSIVEQRLEALEEKIRTTETQVLVASAQKKLLEERLKLVSELWDAGIKAELLYKKNPKLLNQLQYCEEAGIPLVAIIGEQELKDGVIKLRSVTSREEVDVRREDLVEEIKRRTGQPLCIC

SEQ ID NO: 2 - protein, 506 aa, Homo sapiens
MPLLGLLPRRAWASLLSQLLRPPCASCTGAVRCQSQVAEAVLTSQLKAHQEKPNFIIKTPKGTRDLSPQHMVVREKILDLVISCFKRHGAKGMDTPAFELKETLTEKYGEDSGLMYDLKDQGGELLSLRYDLTVPFARYLAMNKVKKMKRYHVGKVWRRESPTIVQGRYREFCQCDFDIAGQFDPMIPDAECLKIMCEILSGLQLGDFLIKVNDRRIVDGMFAVCGVPESKFRAICSSIDKLDKMAWKDVRHEMVVKKGLAPEVADRIGDYVQCHGGVSLVEQMFQDPRLSQNKQALEGLGDLKLLFEYLTLFGIADKISFDLSLARGLDYYTGVIYEAVLLQTPTQAGEEPLNVGSVAAGGRYDGLVGMFDPKGHKVPCVGLSIGVERIFYIVEQRMKTKGEKVRTTETQVFVATPQKNFLQERLKLIAELWDSGIKAEMLYKNNPKLLTQLHYCESTGIPLVVIIGEQELKEGVIKIRSVASREEVAIKRENFVAEIQKRLSES

SEQ ID NO: 3 - protein, 465 aa, Homo sapiens
LGPDESKQKFVLKTPKGTRDYSPRQMAVREKVFDVIIRCFKRHGAEVIDTPVFELKETLMGKYGEDSKLIYDLKDQGGELLSLRYDLTVPFARYLAMNKLTNIKRYHIAKVYRRDNPAMTRGRYREFYQCDFDIAGNFDPMIPDAECLKIMCEILSSLQIGDFLVKVNDRRILDGMFAICGVSDSKFRTICSSVDKLDKVSWEEVKNEMVGEKGLAPEVADRIGDYVQQHGGVSLVEQLLQDPKLSQNKQALEGLGDLKLLFEYLTLFGIDDKISFDLSLARGLDYYTGVIYEAVLLQTPAQAGEEPLGVGSVAAGGRYDGLVGMFDPKGRKVPCVGLSIGVERIFSIVEQRLEALEEKIRTTETQVLVASAQKKLLEERLKLVSELWDAGIKAELLYKKNPKLLNQLQYCEEAGIPLVAIIGEQELKDGVIKLRSVTSREEVDVRREDLVEEIKRRTGQPLCIC

SEQ ID NO: 4 - protein, 456 aa, Homo sapiens
FVLKTPKGTRDYSPRQMAVREKVFDVIIRCFKRHGAEVIDTPVFELKETLMGKYGEDSKLIYDLKDQGGELLSLRYDLTVPFARYLAMNKLTNIKRYHIAKVYRRDNPAMTRGRYREFYQCDFDIAGNFDPMIPDAECLKIMCEILSSLQIGDFLVKVNDRRILDGMFAICGVSDSKFRTICSSVDKLDKVSWEEVKNEMVGEKGLAPEVADRIGDYVQQHGGVSLVEQLLQDPKLSQNKQALEGLGDLKLLFEYLTLFGIDDKISFDLSLARGLDYYTGVIYEAVLLQTPAQAGEEPLGVGSVAAGGRYDGLVGMFDPKGRKVPCVGLSIGVERIFSIVEQRLEALEEKIRTTETQVLVASAQKKLLEERLKLVSELWDAGIKAELLYKKNPKLLNQLQYCEEAGIPLVAIIGEQELKDGVIKLRSVTSREEVDVRREDLVEEIKRRTGQPLCIC

SEQ ID NO: 5 - protein, 506 aa, Homo sapiens
MAERAALEELVKLQGERVRGLKQQKASAELIEEEVAKLLKLKAQLGPDESKQKFVLKTPKGTRDYSPRQMAVREKVFDVIIRCFKRHGAEVIDTPVFELKETLMGKYGEDSKLIYDLKDQGGELLSLRYDLTVPFARYLAMNKLTNIKRYHIAKVYRRDNPAMTRGRYREFYQCDFDIAGNFDPMIPDAECLKIMCEILSSLQIGDFLVKVNDRRILDGMFAICGVSDSKFRTICSSVDKLDKVSWEEVKNEMVGEKGLAPEVADRIGDYVQQHGGVSLVEQLLQDPKLSQNKQALEGLGDLKLLFEYLTLFGIDDKISFDLSLARGLDYYTGVIYEAVLLQTPAQAGEEPLGVGSVAAGGRYDGLVGMFDPKGRKVPCVGLSIGVERIFSIVEQRLEALEEKIRTTETQVLVASAQKKLLEERLKLVSELWDAGIKAELLYKKNPKLLNQLQYCEEAGIPLVAIIGEQELKDGVIKLRSVTSREEVDVRREDLVEEIKRRTGQPL

SEQ ID NO: 6 - protein, 453 aa, Homo sapiens
FVLKTPKGTRDYSPRQMAVREKVFDVIIRCFKRHGAEVIDTPVFELKETLMGKYGEDSKLIYDLKDQGGELLSLRYDLTVPFARYLAMNKLTNIKRYHIAKVYRRDNPAMTRGRYREFYQCDFDIAGNFDPMIPDAECLKIMCEILSSLQIGDFLVKVNDRRILDGMFAICGVSDSKFRTICSSVDKLDKVSWEEVKNEMVGEKGLAPEVADRIGDYVQQHGGVSLVEQLLQDPKLSQNKQALEGLGDLKLLFEYLTLFGIDDKISFDLSLARGLDYYTGVIYEAVLLQTPAQAGEEPLGVGSVAAGGRYDGLVGMFDPKGRKVPCVGLSIGVERIFSIVEQRLEALEEKIRTTETQVLVASAQKKLLEERLKLVSELWDAGIKAELLYKKNPKLLNQLQYCEEAGIPLVAIIGEQELKDGVIKLRSVTSREEVDVRREDLVEEIKRRTGQPL

SEQ ID NO: 7 - protein, 170 aa, Homo sapiens
MAERAALEELVKLQGERVRGLKQQKASAELIEEEVAKLLKLKAQLGPDESKQKFVLKTPKALEEKIRTTETQVLVASAQKKLLEERLKLVSELWDAGIKAELLYKKNPKLLNQQYCEEAGIPLVAIIGEQELKDGVIKLRSVTSREEVDVRREDLVEEIKRRTGQPLCIC

SEQ ID NO: 8 - protein, 170 aa, Artificial Sequence
  HRS variant having deletion of residues 61-398, and substitutions
MAERAALEELVKLQGERVRGLKQQKASAELIEEEVAKLLKLKAQLGPDESKQKFVLKTPKALEEKIRTTETQVLVASAQKKLLEERLKLVSELQDAGIKAELLYKKNPKLLNQQYCEEAGIPLVAIIGEQELKDGVIKLRSVTSREEVDVRREDLVEEIKRRTGQPLSIS

SEQ ID NO: 9 - protein, 509 aa, Mus Musculus
MADRAALEELVRLQGAHVRGLKEQKASAEQIEEEVTKLLKLKAQLGQDEGKQKFVLKTPKGTRDYSPRQMAVREKVFDVIIRCFKRHGAEVIDTPVFELKETLTGKYGEDSKLIYDLKDQGGELLSLRYDLTVPFARYLAMNKLTNIKRYHIAKVYRRDNPAMTRGRYREFYQCDFDIAGQFDPMIPDAECLKIMCEILSSLQIGNFLVKVNDRRILDGMFAVCGVPDSKFRTICSSVDKLDKVSWEEVKNEMVGEKGLAPEVADRIGDYVQQHGGVSLVEQLLQDPKLSQNKQAVEGLGDLKLLFEYLILFGIDDKISFDLSLARGLDYYTGVIYEAVLLQMPTQAGEEPLGVGSIAAGGRYDGLVGMFDPKGRKVPCVGLSIGVERIFSIVEQRLEASEEKVRTTETQVLVASAQKKLLEERLKLVSELWDAGIKAELLYKKNPKLLNQLQYWEEAGIPLVAIIGEQELRDGVIKLRSVASREEVDVRREDLVEEIRRRTNQPLSTC

SEQ ID NO: 10 - protein, 509 aa, Canis lupus familiaris
MAERAALEELVRLQGERVRGLKQQKASAEQIEEEVAKLLKLKAQLGPDEGKQKFVLKTPKGTRDYSPRQMAVREKVFDVIISCFKRHGAEVIDTPVFELKETLTGKYGEDSKLIYDLKDQGGELLSLRYDLTVPFARYLAMNKLTNIKRYHIAKVYRRDNPAMTRGRYREFYQCDFDIAGQFDPMIPDAECLEIMCEILRSLQIGDFLVKVNDRRILDGMFAICGVPDSKFRTICSSVDKLDKVSWEEVKNEMVGEKGLAPEVADHIGDYVQQHGGISLVEQLLQDPELSQNKQALEGLGDLKLLFEYLTLFGIADKISFDLSLARGLDYYTGVIYEAVLLQTPVQAGEEPLGVGSVAAGGRYDGLVGMFDPKGRKVPCVGLSIGVERIFSIVEQRLEATEEKVRTTETQVLVASAQKKLLEERLKLVSELWNAGIKAELLYKKNPKLLNQLQYCEEAGIPLVAIIGEQELKDGVIKLRSVASREEVDVPREDLVEEIKRRTSQPFCIC

SEQ ID NO: 11 - protein, 509 aa, Bos taurus
MADRAALEDLVRVQGERVRGLKQQKASAEQIEEEVAKLLKLKAQLGPDEGKPKFVLKTPKGTRDYSPRQMAVREKVFDVIISCFKRHGAEVIDTPVFELKETLTGKYGEDSKLIYDLKDQGGELLSLRYDLTVPFARYLAMNKLTNIKRYHIAKVYRRDNPAMTRGRYREFYQCDFDIAGQFDPMLPDAECLKIMCEILSSLQIGDFLVKVNDRRILDGMFAICGVPDSKFRTICSSVDKLDKVSWEEVKNEMVGEKGLAPEVADRIGDYVQQHGGVSLVEQLLQDPKLSQNKQALEGLGDLKLLFEYLTLFGIADKISFDLSLARGLDYYTGVIYEAVLLQPPARAGEEPLGVGSVAAGGRYDGLVGMFDPKGRKVPCVGLSIGVERIFSIVEQRLEALEEKVRTTETQVLVASAQKKLLEERLKLISELWDAGIKAELLYKKNPKLLNQLQYCEETGIPLVAIIGEQELKDGVIKLRSVASREEVDVRREDLVEEIKRRTSQPLCIC

SEQ ID NO: 12 - protein, 508 aa, Rattus norvegicus
MADRAALEELVRLQGAHVRGLKEQKASAEQIEEEVTKLLKLKAQLGHDEGKQKFVLKTPKGTRDYSPRQMAVREKVFDVIIRCFKRHGAEVIDTPVFELKETLTGKYGEDSKLIYDLKDQGGELLSLRYDLTVPFARYLAMNKLTNIKRYHIAKVYRRDNPAMTRGRYREFYQCDFDIAGQFDPMIPDAECLKIMCEILSSLQIGNFQVKVNDRRILDGMFAVCGVPDSKFRTICSSVDKLDKVSWEEVKNEMVGEKGLAPEVADRIGDYVQQHGGVSLVEQLLQDPKLSQNKQAVEGLGDLKLLFEYLTLFGIDDKISFDLSLARGLDYYTGVIYEAVLLQMPTQAGEEPLGVGSIAAGGRYDGLVGMFDPKGRKVPCVGLSIGVERIFSIVEQKLEASEEKVRTTETQVLVASAQKKLLEERLKLISELWDAGIKAELLYKKNPKLLNQLQYCEEAGIPLVAIIGEQELKDGVIKLRSVTSREEVDVRREDLVEEIRRRTSQPLSM

SEQ ID NO: 13 - protein, 500 aa, Gallus Gallus
MADEAAVRQQAEVVRRLKQDKAEPDEIAKEVAKLLEMKAHLGGDEGKHKFVLKTPKGTRDYGPKQMAIRERVFSAIIACFKRHGAEVIDTPVFELKETLTGKYGEDSKLIYDLKDQGGELLSLRYDLTVPFARYLAMNKITNIKRYHIAKVYRRDNPAMTRGRYREFYQCDFDIAGQFDPMIPDAECLKIVQEILSDLQLGDFLIKVNDRRILDGMFAVCGVPDSKFRTICSSVDKLDKMPWEEVRNEMVGEKGLSPEAADRIGEYVQLHGGMDLIEQLLQDPKLSQNKLVKEGLGDMKLLFEYLTLFGITGKISFDLSLARGLDYYTGVIYEAVLLQQNDHGEESVSVGSVAGGGRYDGLVGMFDPKGRKVPCVGISIGIERIFSILEQRVEASEEKIRTTETQVLVASAQKKLLEERLKLISELWDAGIKAEVLYKKNPKLLNQLQYCEDTGIPLVAIVGEQELKDGVVKLRVVATGEEVNIRRESLVEEIRRRTNQL

SEQ ID NO: 14 - protein, 437 aa, Danio rerio
MAALGLVSMRLCAGLMGRRSAVRLHSLRVCSGMTISQIDEEVARLLQLKAQLGGDEGKHVFVLKTAKGTRDYNPKQMAIREKVFNIIINCFKRHGAETIDSPVFELKETLTGKYGEDSKLIYDLKDQGGELLSLRYDLTVPFARYLAMNKITNIKRYHIAKVYRRDNPAMTRGRYREFYQCDFDIAGQYDAMIPDAECLKLVYEILSELDLGDFRIKVNDRRILDGMFAICGVPDEKFRTICSTVDKLDKLAWEEVKKEMVNEKGLSEEVADRIRDYVSMQGGKDLAERLLQDPKLSQSKQACAGITDMKLLFSYLELFQITDKVVFDLSLARGLDYYTGVIYEAILTQANPAPASTPAEQNGAEDAGVSVGSVAGGGRYDGLVGMFDPKAGKCPVWGSALALRGSSPSWSRRQSCLQRRCAPLKLKCLWLQHRRTF

SEQ ID NO: 15 - DNA, 1527 bp, Homo sapiens
atggcagagcgtgcggcgctggaggagctggtgaaacttcagggagagcgcgtgcgaggcctcaagcagcagaaggccagcgccgagctgatcgaggaggaggtggcgaaactcctgaaactgaaggcacagctgggtcctgatgaaagcaaacagaaatttgtgctcaaaacccccaagggcacaagagactatagtccccggcagatggcagttcgcgagaaggtgtttgacgtaatcatccgttgcttcaagcgccacggtgcagaagtcattgatacacctgtatttgaactaaaggaaacactgatgggaaagtatggggaagactccaagcttatctatgacctgaaggaccagggcggggagctcctgtcccttcgctatgacctcactgttccttttgctcggtatttggcaatgaataaactgaccaacattaaacgctaccacatagcaaaggtatatcggcgggataacccagccatgacccgtggccgataccgggaattctaccagtgtgattttgacattgctgggaactttgatcccatgatccctgatgcagagtgcctgaagatcatgtgcgagatcctgagttcacttcagataggcgacttcctggtcaaggtaaacgatcgacgcattctagatgggatgtttgctatctgtggtgtttctgacagcaagttccgtaccatctgctcctcagtagacaagctggacaaggtgtcctgggaagaggtgaagaatgagatggtgggagagaagggccttgcacctgaggtggctgaccgcattggggactatgtccagcaacatggtggggtatccctggtggaacagctgctccaggatcctaaactatcccaaaacaagcaggccttggagggcctgggagacctgaagttgctctttgagtacctgaccctatttggcattgatgacaaaatctcctttgacctgagccttgctcgagggctggattactacactggggtgatctatgaggcagtgctgctacagaccccagcccaggcaggggaagagcccctgggtgtgggcagtgtggctgctggaggacgctatgatgggctagtgggcatgttcgaccccaaagggcgcaaggtgccatgtgtggggctcagcattggggtggagcggattttctccatcgtggaacagagactagaggctttggaggagaagatacggaccacggagacacaggtgcttgtggcatctgcacagaagaagctgctagaggaaagactaaagcttgtctcagaactgtgggatgctgggatcaaggctgagctgctgtacaagaagaacccaaagctactgaaccagttacagtactgtgaggaggcaggcatcccactggtggctatcatcggcgagcaggaactcaaggatggggtcatcaagctccgttcagtgacgagcagggaagaggtggatgtccgaagagaagaccttgtggaggaaatcaaaaggagaacaggccagcccctctgcatctgc

SEQ ID NO: 16 - DNA, 513 bp, Artificial Sequence
  Codon optimized HRS splice variant
atggcagagcgtgcggcgctggaggagctggtgaaacttcagggagagcgcgtgcgaggcctcaagcagcagaaggccagcgccgagctgatcgaggaggaggtggcgaaactcctgaaactgaaggcacagctgggtcctgatgaaagcaaacagaaatttgtgctcaaaacccccaaggctttggaggagaagatacggaccacggagacacaggtgcttgtggcatctgcacagaagaagctgctagaggaaagactaaagcttgtctcagaactgtgggatgctgggatcaaggctgagctgctgtacaagaagaacccaaagctactgaaccagttacagtactgtgaggaggcaggcatcccactggtggctatcatcggcgagcaggaactcaaggatggggtcatcaagctccgttcagtgacgagcagggaagaggtggatgtccgaagagaagaccttgtggaggaaatcaaaaggagaacaggccagcccctctgcatctgc

SEQ ID NO: 17 - DNA, 15 bp, Homo sapiens
aaacaaaacaaaaca

SEQ ID NO: 18 - DNA, 10 bp, Homo sapiens
aaacaaaaca

SEQ ID NO: 19 - DNA, 10 bp, Homo sapiens
caaaacaaaa

SEQ ID NO: 20 - DNA, 15 bp, Homo sapiens
caaaacaaaacaaaa

SEQ ID NO: 21 - DNA, 10 bp, Homo sapiens
acaaaacaaa

SEQ ID NO: 22 - DNA, 24 bp, Homo sapiens
  misc_feature (1)..(24): Forward primer targeting 5′UTR/Exon1
agtggacagccgggatggcagagc

SEQ ID NO: 23 - DNA, 20 bp, Homo sapiens
  misc_feature (1)..(20): Reverse primer targeting 3′-UTR
atagtgccagtcccacttcc

SEQ ID NO: 24 - DNA, 20 bp, Homo sapiens
  misc_feature (1)..(20): Primer
ccctggtggaacagctgctc

SEQ ID NO: 25 - DNA, 22 bp, Homo sapiens
  misc_feature (1)..(22): Primer
catagatcaccccagtgtagta

SEQ ID NO: 26 - DNA, 19 bp, Homo sapiens
  misc_feature (1)..(19): Primer
tgtgctcaaaacccccaag

SEQ ID NO: 27 - DNA, 19 bp, Homo sapiens
  misc_feature (1)..(19): Primer
tgtgtctccgtggtccgta

SEQ ID NO: 28 - DNA, 21 bp, Homo sapiens
  misc_feature (1)..(21): Primer
aaatggtggggtaacagaaag

SEQ ID NO: 29 - DNA, 19 bp, Homo sapiens
  misc_feature (1)..(19): Primier
gacgttgatggggaagtga

SEQ ID NO: 30 - DNA, 20 bp, Homo sapiens
  misc_feature (1)..(20): Primier
ttcagactgagcgtgcctac

SEQ ID NO: 31 - DNA, 20 bp, Homo sapiens
  misc_feature (1)..(20): Primier
gtgccctcaatagcctcctt

SEQ ID NO: 32 - protein, 522 aa, Drosophila melanogaster
MSDTREQILEQIKVQGDLVRQLKAAKESKEKIDEEVARLLALKATLGGDAAPTNQKFTLKTPKGTRDYGPQQMTLRQGVLDKIVQVFKRHGGEAIDTPVFELKEVLTGKYGEDSKLIYDLKDQGGEILSMRYDLTVPLARYLAMNKISSIKRYHIAKVYRRDNPAMTKGRYREFYQCDFDIAGTYDPMLPDAECVKIVSEILDTLDIGDYVIKLNHRQLLDGMFQACGVPADSFRTICSAVDKLDKSPWADVRKEMVDEKGLDEAAADRIGEYVRLSGGAELVEQLLANEKLKAVPNAVKGLEGMKQLLKYCSIFGLDKRVSFDLSLARGLDYYTGVIYEGVLKGESATVASPAKTSQQNGEQANEPATVGSVAGGGRYDNLVGMFDPRGKAVPCVGVSIGVERIFSVLEARAAASGLKLRTSDVEVYVASAHKGLHEQRLKVLNLLWDAGVKAEHSYKLNPKLLVQLQHCEEHQIPLVVVLGDAELAQGLVKLREVTTREETNVKLEDLAAEIRRRQQASA

SEQ ID NO: 33 - protein, 524 aa, Caenorhabditis elegans
MSSKMTAERKAILMQEAQALGDEIRQLKLDKADQAIIKEKVALMQAKRKEAGETGAPEKPGKFVLKTGKGTRDYGPAQSALRNSVLQTVTETFNRYGAETIDTPVFELRDVLMGKYGEEGGKLVYDLQDQGGELLSLRYDLTVPFARYLAMNKITNITRYQIAKVYRRDQPVMSRGRYREFYQCDFDIAGQYDLMLPEAECLGIVDELLTKLEIGEFFINLNHRLILEGMFAVSGIPAKDFKTICSSVDKLDKTPWEDVEQEMINEKFLTKEQTGKLGELVRFRELNSDLNNLELLEKMSQLPDLGQNDKFKKGAEELKVLIEYLNVDGVTTVRYEPSLARGLDYYTGAIYEAVAPKALEGTAVENSEDTAGQPVGVGSVAAGGRYDGLVKMFDSKANVPCCGVSFGIERLFAIMEARQKVAIRTTQTEVYVASAQKNLVRDRKKLVKMLRSAGIKTEMALKANPKLLTQFQYAEERRIPLAIVIGEQELKDGVVKLRNVVTRDEQTIKLDQLITAVRDTLAAL

SEQ ID NO: 34 - protein, 546 aa, Saccharomyces cerevisiae
MLSRSLNKVVTSIKSSSIIRMSSATAAATSAPTANAANALKASKAPKKGKLQVSLKTPKGTKDWADSDMVIREAIFSTLSGLFKKHGGVTIDTPVFELREILAGKYGEDSKLIYNLEDQGGELCSLRYDLTVPFARYVAMNNIQSIKRYHIAKVYRRDQPAMTKGRMREFYQCDFDVAGTFESMVPDSECLSILVEGLTSLGIKDFKIKLNHRKILDGIFQIAGVKDEDVRKISSAVDKLDKSPWEAVKKEMTEEKGQSEETADKIGEYVKLNGSLKEIHAVLSADANITSNEKAKQGLDDIATLMKYTEAFDIDSFISFDLSLARGLDYYTGLIYEVVTSASAPPENASELKKKAKSAEDASEFVGVGSIAAGGRYDNLVNMFSEASGKKSTQIPCVGISFGVERIFSLIKQRINSSTTIKPTATQVFVMAFGGGKDWTGYLPERMKVTKQLWDAGIEAEYVYKAKANPRKQFDAAEKAGCHIAVILGKEEYLEGKLRVKRLGQEFADDDGELVSAADIVPIVQEKLSQIHEDGLNEVTRLIKGL

SEQ ID NO: 35 - protein, 477 aa, Trypanosoma brucei
MAKTVDNAALLAEIDQLRRLIAEKEALITPDGGSLSKKSKKKSQMNMVETEPVQGCRDFPPETMRLRKYLFDVFHSTARKFGFEEYDSPVLESEELYIRKAGEEITEQMFNFITKGGHRVALRPEMTPSLARQLLAKGRSLLLPAKWYSIPQCWRYEAITRGRRREHYQWNMDIIGVKSVSSEVELVCAACTAMQSLGLSSKDVGVKINSRKILQTVVEQAGVSADKFAPVCVIVDKMEKLPREEVVAQLAAIGLESNVVDAITSTLSLKTIDEIAQRIGEEHEAVRELRDFITQIEAYGFGDWVIFDASVVRGLAYYTGIVFEGFDRDGNFRALCGGGRYDNLLTTYGSPTAVPCVGFGFGDCVIVELLNEKKLLPELHHVVDDLVIPFDETMRPHALSILRRLRDAGRSADIVFDKKKVVQAFNYADRIGALRAVLVAPDEWARGEVRVKMLREGAGREEGANERGIVLPVDKIV

SEQ ID NO: 36 - protein, 421 aa, Thermus thermophilus
MTARAVRGTKDLFGKELRMHQRIVATARKVLEAAGALELVTPIFEETQVFEKGVGAATDIVRKEMFTFQDRGGRSLTLRPEGTAAMVRAYLEHGMKVWPQPVRLWMAGPMFRAERPQKGRYRQFHQVNYEALGSENPILDAEAVVLLYECLKELGLRRLKVKLSSVGDPEDRARYNAYLREVLSPHREALSEDSKERLELNPMRILDSKSERDQALLKELGVRPMLDFLGEEARAHLKEVERHLERLSVPYELEPALVRGLDYYVRTAFEVHHEEIGAQSALGGGGRYDGLSELLGGPRVPGVGFAFGVERVALALEAEGFGLPEEKGPDLYLIPLTEEAVAEAFYLAEALRPRLRAEYALAPRKPAKGLEEALKRGAAFAGFLGEDELRAGEVTLKRLATGEQVRLSREEVPGYLLQALG

SEQ ID NO: 37 - protein, 424 aa, Escherichia coli
MAKNIQAIRGMNDYLPGETAIWQRIEGTLKNVLGSYGYSEIRLPIVEQTPLFKRAIGEVTDVVEKEMYTFEDRNGDSLTLRPEGTAGCVRAGIEHGLLYNQEQRLWYIGPMFRHERPQKGRYRQFHQLGCEVFGLQGPDIDAELIMLTARWWRALGISEHVTLELNSIGSLEARANYRDALVAFLEQHKEKLDEDCKRRMYTNPLRVLDSKNPEVQALLNDAPALGDYLDEESREHFAGLCKLLESAGIAYTVNQRLVRGLDYYNRTVFEWVTNSLGSQGTVCAGGRYDGLVEQLGGRATPAVGFAMGLERLVLLVQAVNPEFKADPVVDIYLVASGADTQSAAMALAERLRDELPGVKLMTNHGGGNFKKQFARADKWGARVAVVLGESEVANGTAVVKDLRSGEQTAVAQDSVAAHLRTLLG